(19) United States
(12) Patent Application Publication
(10) Pub. No.: US 2024/0275467 A1
(43) Pub. Date: Aug. 15, 2024

(54) METHOD AND APPARATUS FOR BEAM FAILURE RECOVERY IN NETWORK COOPERATIVE COMMUNICATION

(71) Applicant: SAMSUNG ELECTRONICS CO., LTD., Suwon-si (KR)

(72) Inventors: Youngrok JANG, Suwon-si (KR); Ameha Tsegaye ABEBE, Suwon-si (KR); Seongmok LIM, Suwon-si (KR); Hyoungju JI, Suwon-si (KR)

(21) Appl. No.: 18/429,380

(22) Filed: Jan. 31, 2024

(30) Foreign Application Priority Data
Jan. 31, 2023 (KR) 10-2023-0012554

(51) Int. Cl. H04B 7/06; H04L 5/00

(52) U.S. Cl. CPC H04B 7/06968; H04B 7/06964; H04L 5/0053

(57) ABSTRACT

The disclosure relates to a 5G or 6G communication system for supporting a higher data transmission rate. The disclosure relates to the operation of a UE and a base station in a wireless communication system and, more specifically, to a method of transmitting or receiving an uplink reference signal in a wireless communication system and an apparatus capable of performing the same. The disclosure also relates to an apparatus and a method for effectively providing services in a mobile communication system.

### CROSS-REFERENCE TO RELATED APPLICATION

This application is based on and claims priority under 35 U.S.C. § 119 to Korean Patent Application No. 10-2023-0012554, filed on Jan. 31, 2023, in the Korean Intellectual Property Office, the disclosure of which is herein incorporated by reference in its entirety.

### BACKGROUND

### 1. Field

The disclosure relates to the operation of a UE and a base station in a wireless communication system. More specifically, the disclosure relates to a method for a beam failure recovery in network cooperative communication and an apparatus capable of performing the same.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G.

In the initial stage of 5G mobile communication technologies, in order to support services and to satisfy performance requirements in connection with enhanced Mobile BroadBand, (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there is ongoing discussion regarding improvement and performance enhancement of initial 5G mobile communication technologies in view of services to be supported by 5G mobile communication technologies, and there has been physical layer standardization regarding technologies such as V2X for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is impossible, and positioning.

Moreover, there has been ongoing standardization in wireless interface architecture/protocol fields regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR), and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

A disclosed embodiment is to provide an apparatus and a method of effectively providing services in a mobile communication system.

The technical objectives to be achieved by various embodiments of the disclosure are not limited to the technical objectives mentioned above, and other technical objectives not mentioned may be considered by those skilled in the art from various embodiments of the disclosure to be described below.

According to an embodiment of the disclosure, a method performed by a user equipment (UE) in a communication system is provided.

According to an embodiment of the disclosure, the method includes: receiving a first configuration associated with a unified transmission configuration indication (TCI) state and a second configuration associated with beam failure recovery, wherein the second configuration includes a first failure detection set associated with a first reference signal list and a second failure detection set associated with a second reference signal list; transmitting, based on the second configuration, information on a first reference signal in the first reference signal list and information on a second reference signal in the second reference signal list; and in case that the UE is configured with a plurality of control resource sets (CORESETs) including a first CORESET and a second CORESET, wherein a CORESET pool index value of 1 is configured for the second CORESET: receiving, based on a first TCI state corresponding to the first CORESET, a first physical downlink control channel (PDCCH) in the first CORESET and a first physical downlink shared channel (PDSCH) scheduled by the first PDCCH by using a quasi co-location parameter associated with the first reference signal; and receiving, based on a second TCI state corresponding to the second CORESET, a second PDCCH in the second CORESET and a second PDSCH scheduled by the second PDCCH by using a quasi co-location parameter associated with the second reference signal.

According to an embodiment of the disclosure, the method further includes: receiving, based on the first TCI state, a first aperiodic channel state reference signal (CSI-RS) by using the quasi co-location parameter associated with the first reference signal; and receiving, based on the second TCI state, a second aperiodic CSI-RS by using the quasi co-location parameter associated with the second reference signal.

According to an embodiment of the disclosure, the further method includes: transmitting, based on the first TCI state or a first uplink (UL) TCI state, first uplink signals by using a spatial domain filter associated with the first reference signal, wherein the first reference signal is used for obtaining a downlink pathloss estimate to determine transmission power for the first uplink signals; and transmitting, based on the second TCI state or a second UL TCI state, second uplink signals by using a spatial domain filter associated with the second reference signal, wherein the second reference signal is used for obtaining a downlink pathloss estimate to determine transmission power for the second uplink signals.

According to an embodiment of the disclosure, the first uplink signals and the second uplink signals respectively include a physical uplink shared channel (PUSCH), a physical uplink control channel (PUCCH), and a sounding reference signal (SRS).

According to an embodiment of the disclosure, the further method includes: in case that the UE is indicated with a third TCI state and a fourth TCI state in a codepoint of downlink control information (DCI): receiving, based on the third TCI state, first downlink signals by using a quasi co-location parameter associated with the first reference signal; and receiving, based on the fourth TCI state, second downlink signals by using a quasi co-location parameter associated with the second reference signal.

According to an embodiment of the disclosure, the method further includes: transmitting, based on the third TCI state, third uplink signals by using a spatial domain filter associated with the first reference signal, wherein the first reference signal is used for obtaining a downlink pathloss estimate to determine transmission power for the third uplink signals; and transmitting, based on the fourth TCI state, fourth uplink signals by using a spatial domain filter associated with the second reference signal, wherein the second reference signal is used for obtaining a downlink pathloss estimate to determine transmission power for the fourth uplink signals.

According to an embodiment of the disclosure, the CORESET pool index value of 0 is configured for the first CORESET or the CORESET pool index value is not configured for the first CORESET.

According to an embodiment of the disclosure, the method further includes receiving DCI scheduling a first PUSCH on a PDCCH.

According to an embodiment of the disclosure, the DCI scheduling the first PUSCH includes a toggled new data indicator (NDI) field and a hybrid automatic repeat request (HARQ) process number.

According to an embodiment of the disclosure, the HARQ process number is the same as a HARQ process number in DCI scheduling a second PUSCH on which the information on the first reference signal and the information on the second reference signal are transmitted.

According to an embodiment of the disclosure, the first PDCCH, the first PDSCH, the second PDCCH and the second PDSCH are received after 28 symbols from a last symbol of the PDCCH.

According to an embodiment of the disclosure, a user equipment (UE) in a communication system is provided.

According to an embodiment of the disclosure, the UE includes: a transceiver; and a processor coupled with the transceiver, configured to: receive a first configuration associated with a unified transmission configuration indication (TCI) state and a second configuration associated with beam failure recovery, wherein the second configuration includes a first failure detection set associated with a first reference signal list and a second failure detection set associated with a second reference signal list; transmit, based on the second configuration, information on a first reference signal in the first reference signal list and information on a second reference signal in the second reference signal list; and in case that the UE is configured with a plurality of control resource sets (CORESETs) including a first CORESET and a second CORESET, wherein a CORESET pool index value of 1 is configured for the second CORESET: receive, based on a first TCI state corresponding to the first CORESET, a first physical downlink control channel (PDCCH) in the first CORESET and a first physical downlink shared channel (PDSCH) scheduled by the first PDCCH by using a quasi co-location parameter associated with the first reference signal; and receive, based on a second TCI state corresponding to the second CORESET, a second PDCCH in the second CORESET and a second PDSCH scheduled by the second PDCCH by using a quasi co-location parameter associated with the second reference signal.

According to an embodiment of the disclosure, the processor is further configured to: receive, based on the first TCI state, a first aperiodic channel state reference signal (CSI-RS) by using the quasi co-location parameter associated with the first reference signal; and receive, based on the second TCI state, a second aperiodic CSI-RS by using the quasi co-location parameter associated with the second reference signal.

According to an embodiment of the disclosure, the processor is further configured to: transmit, based on the first TCI state or a first uplink (UL) TCI state, first uplink signals by using a spatial domain filter associated with the first reference signal, wherein the first reference signal is used for obtaining a downlink pathloss estimate to determine transmission power for the first uplink signals; and transmit, based on the second TCI state or a second UL TCI state, second uplink signals by using a spatial domain filter associated with the second reference signal, wherein the second reference signal is used for obtaining a downlink pathloss estimate to determine transmission power for the second uplink signals.

According to an embodiment of the disclosure, the first uplink signals and the second uplink signals respectively include a physical uplink shared channel (PUSCH), a physical uplink control channel (PUCCH), and a sounding reference signal (SRS).

According to an embodiment of the disclosure, the processor is further configured to: in case that the UE is indicated with a third TCI state and a fourth TCI state in a codepoint of downlink control information (DCI): receive, based on the third TCI state, first downlink signals by using a quasi co-location parameter associated with the first reference signal; and receive, based on the fourth TCI state, second downlink signals by using a quasi co-location parameter associated with the second reference signal.

According to an embodiment of the disclosure, the processor is further configured to: transmit, based on the third TCI state, third uplink signals by using a spatial domain filter associated with the first reference signal, wherein the first reference signal is used for obtaining a downlink pathloss estimate to determine transmission power for the third uplink signals; and transmit, based on the fourth TCI state, fourth uplink signals by using a spatial domain filter associated with the second reference signal, wherein the second reference signal is used for obtaining a downlink pathloss estimate to determine transmission power for the fourth uplink signals.

According to an embodiment of the disclosure, the CORESET pool index value of 0 is configured for the first CORESET or the CORESET pool index value is not configured for the first CORESET.

According to an embodiment of the disclosure, the processor is further configured to receive DCI scheduling a first PUSCH on a PDCCH.

According to an embodiment of the disclosure, the DCI scheduling the first PUSCH includes a toggled new data indicator (NDI) field and a hybrid automatic repeat request (HARQ) process number.

According to an embodiment of the disclosure, the HARQ process number is the same as a HARQ process number in DCI scheduling a second PUSCH on which the information on the first reference signal and the information on the second reference signal are transmitted.

According to an embodiment of the disclosure, the first PDCCH, the first PDSCH, the second PDCCH and the second PDSCH are received after 28 symbols from a last symbol of the PDCCH.

According to an embodiment of the disclosure, a method performed by a base station in a communication system is provided.

According to an embodiment of the disclosure, the method includes: transmitting a first configuration associated with a unified transmission configuration indication (TCI) state and a second configuration associated with beam failure recovery, wherein the second configuration includes a first failure detection set associated with a first reference signal list and a second failure detection set associated with a second reference signal list; receiving information on a first reference signal in the first reference signal list and information on a second reference signal in the second reference signal list; and in case that a plurality of control resource sets (CORESETs) including a first CORESET and a second CORESET is configured, wherein a CORESET pool index value of 1 is configured for the second CORESET: transmitting, based on a first TCI state corresponding to the first CORESET, a first physical downlink control channel (PDCCH) in the first CORESET and a first physical downlink shared channel (PDSCH) scheduled by the first PDCCH by using a quasi co-location parameter associated with the first reference signal; and transmitting, based on a second TCI state corresponding to the second CORESET, a second PDCCH in the second CORESET and a second PDSCH scheduled by the second PDCCH by using a quasi co-location parameter associated with the second reference signal.

According to an embodiment of the disclosure, the method further includes: in case that a third TCI state and a fourth TCI state is indicated in a codepoint of downlink control information (DCI): transmitting, based on the third TCI state, first downlink signals by using a quasi co-location parameter associated with the first reference signal; and transmitting, based on the fourth TCI state, second downlink signals by using a quasi co-location parameter associated with the second reference signal.

According to an embodiment of the disclosure, the method further includes transmitting DCI scheduling a first PUSCH on a PDCCH.

According to an embodiment of the disclosure, the DCI scheduling the first PUSCH includes a toggled new data indicator (NDI) field and a hybrid automatic repeat request (HARQ) process number.

According to an embodiment of the disclosure, the HARQ process number is the same as a HARQ process number in DCI scheduling a second PUSCH on which the information on the first reference signal and the information on the second reference signal are received.

According to an embodiment of the disclosure, the first PDCCH, the first PDSCH, the second PDCCH and the second PDSCH are transmitted after 28 symbols from a last symbol of the PDCCH.

According to an embodiment of the disclosure, a base station in a communication system is provided.

According to an embodiment of the disclosure, the base station includes: a transceiver; and a processor coupled with the transceiver, configured to: transmit a first configuration associated with a unified transmission configuration indication (TCI) state and a second configuration associated with beam failure recovery, wherein the second configuration includes a first failure detection set associated with a first reference signal list and a second failure detection set associated with a second reference signal list; receive information on a first reference signal in the first reference signal list and information on a second reference signal in the second reference signal list; and in case that a plurality of control resource sets (CORESETs) including a first CORESET and a second CORESET is configured, wherein a CORESET pool index value of 1 is configured for the second CORESET: transmit, based on a first TCI state corresponding to the first CORESET, a first physical downlink control channel (PDCCH) in the first CORESET and a first physical downlink shared channel (PDSCH) scheduled by the first PDCCH by using a quasi co-location parameter associated with the first reference signal; and transmit, based on a second TCI state corresponding to the second CORESET, a second PDCCH in the second CORESET and a second PDSCH scheduled by the second PDCCH by using a quasi co-location parameter associated with the second reference signal.

According to an embodiment of the disclosure, the processor is further configured to: in case that a third TCI state and a fourth TCI state is indicated in a codepoint of downlink control information (DCI): transmit, based on the third TCI state, first downlink signals by using a quasi co-location parameter associated with the first reference signal; and transmit, based on the fourth TCI state, second downlink signals by using a quasi co-location parameter associated with the second reference signal.

According to an embodiment of the disclosure, the processor is further configured to transmit DCI scheduling a first PUSCH on a PDCCH.

According to an embodiment of the disclosure, the DCI scheduling the first PUSCH includes a toggled new data indicator (NDI) field and a hybrid automatic repeat request (HARQ) process number.

According to an embodiment of the disclosure, the HARQ process number is the same as a HARQ process number in DCI scheduling a second PUSCH on which the information on the first reference signal and the information on the second reference signal are received.

According to an embodiment of the disclosure, the first PDCCH, the first PDSCH, the second PDCCH and the second PDSCH are transmitted after 28 symbols from a last symbol of the PDCCH.

The above-described various embodiments of the disclosure are merely some of the preferred embodiments of the disclosure, and various embodiments reflecting the technical features of the disclosure may be derived and understood by those skilled in the art based on the following detailed description of the disclosure.

A disclosed embodiment provides an apparatus and a method of effectively providing services in a mobile communication system.

The effects that can be achieved through the disclosure are not limited to the effects mentioned in the various embodiments, and other effects not mentioned will be clearly understood by those skilled in the art from the description below.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates the basic structure of a time-frequency domain in a wireless communication system according to an embodiment of the disclosure;

FIG. 2 illustrates the structure of frames, subframes, and slots in a wireless communication system according to an embodiment of the disclosure;

FIG. 3 illustrates an example of bandwidth part configuration in a wireless communication system according to an embodiment of the disclosure;

FIG. 4 illustrates an example of base station beam allocation according to TCI state configuration in a wireless communication system according to an embodiment of the disclosure;

FIG. 5 illustrates radio protocol structures of a base station and a UE in single cell, carrier aggregation, and dual connectivity situations in a wireless communication system according to an embodiment of the disclosure;

FIG. 6 illustrates a radio link monitoring (RLM) reference signal (RS) selection process according to an embodiment of the disclosure;

FIG. 7 illustrates an example of a configuration of a control resource set of a downlink control channel in a wireless communication system according to an embodiment of the disclosure;

FIG. 8 illustrates an example of a basic unit of time and frequency resources constitution a downlink control channel in a wireless communication system according to an embodiment of the disclosure;

FIG. 9 illustrates an example of a method for TCI state allocation for a PDCCH in a wireless communication system according to an embodiment of the disclosure;

FIG. 10 illustrates a TCI indication MAC CE signaling structure for a PDCCH DMRS in a wireless communication system according to an embodiment of the disclosure;

FIG. 11 illustrates a control resource set and a beam configuration example of search spaces in a wireless communication system according to an embodiment of the disclosure;

FIG. 12 illustrates a process for beam configuration and activation of a PDSCH in a wireless communication system according to an embodiment of the disclosure;

FIG. 13 illustrates an example of an antenna port configuration and resource allocation for cooperative communication in a wireless communication system according to an embodiment of the disclosure;

FIG. 14 illustrates an example of a configuration of downlink control information (DCI) for cooperative communication in a wireless communication system according to an embodiment of the disclosure;

FIG. 15 illustrates an enhanced PDSCH TCI state activation/deactivation MAC-CE structure in a wireless communication system according to an embodiment of the disclosure;

FIG. 16 illustrates another MAC-CE structure for activating and indicating a joint TCI state, or separate DL or UL TCI state in a wireless communication system according to an embodiment of the disclosure;

FIG. 17 illustrates a beam application time that may be considered when using a unified TCI method in a wireless communication system according to an embodiment of the disclosure;

FIG. 18 illustrates a response process of a base station with respect to a BFR request signal of a UE during PCell BFR operation according to an embodiment of the disclosure;

FIG. 19 illustrates a response process of a base station with respect to a BFR request signal of a UE during SCell BFR operation according to an embodiment of the disclosure;

FIG. 20 illustrates a structure of a BFR MAC-CE according to an embodiment of the disclosure;

FIG. 21 illustrates a response process of a base station with respect to a BFR request signal of a UE during BFR operation for each TRP according to an embodiment of the disclosure;

FIG. 22 illustrates a structure of an enhanced BFR MAC-CE according to an embodiment of the disclosure;

FIG. 23 illustrates a flowchart of the operation of a UE according to an embodiment of the disclosure;

FIG. 24 illustrates a flowchart of the operation of a base station according to an embodiment of the disclosure;

FIG. 25 illustrates a structure of a UE in a wireless communication system according to an embodiment of the disclosure; and

FIG. 26 illustrates a structure of a base station in a wireless communication system according to an embodiment of the disclosure.

### DETAILED DESCRIPTION

Hereinafter, embodiments of the disclosure will be described in detail with reference to the accompanying drawings.

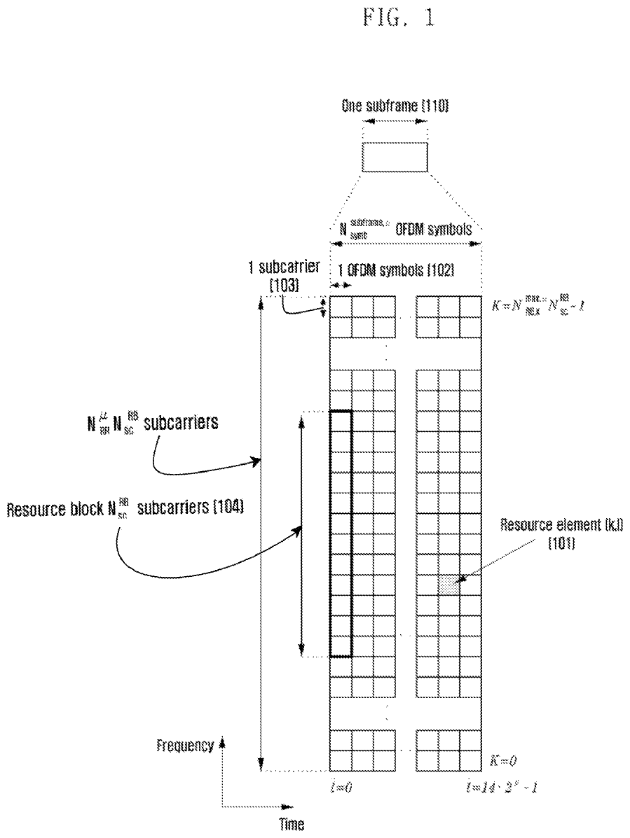

FIGS. 1 through 26, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

In describing the embodiments, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing communication functions. In the disclosure, a “downlink (DL)” refers to a radio link via which a base station transmits a signal to a terminal, and an “uplink (UL)” refers to a radio link via which a terminal transmits a signal to a base station. Furthermore, in the following description, LTE or LTE-A systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, or other similar services. In addition, based on determinations by those skilled in the art, the embodiments of the disclosure may also be applied to other communication systems through some modifications without significantly departing from the scope of the disclosure.

Herein, it will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in the embodiments of the disclosure, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more CPUs within a device or a security multimedia card. Furthermore, the “unit” in the embodiments may include one or more processors.

A wireless communication system is advancing to a broadband wireless communication system for providing high-speed and high-quality packet data services using communication standards, such as high-speed packet access (HSPA) of 3GPP, LTE {long-term evolution or evolved universal terrestrial radio access (E-UTRA)}, LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink indicates a radio link through which a user equipment (UE) (or a mobile station (MS)) transmits data or control signals to a base station (BS) (eNode B), and the downlink indicates a radio link through which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique are required to be improved. In addition, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km2) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC, which is a cellular-based mission-critical wireless communication service, may be used for remote control for robots or machines, industrial automation, unmanned aerial vehicles, remote health care, emergency alert, and the like. Thus, URLLC must provide communication with ultra-low latency and ultra-high reliability. For example, a service supporting URLLC must satisfy an air interface latency of less than 0.5 ms, and also requires a packet error rate of 10-5 or less. Therefore, for the services supporting URLLC, a 5G system must provide a transmit time interval (TTI) shorter than those of other services, and also may require a design for assigning a large number of resources in a frequency band in order to secure reliability of a communication link.

The three 5G services, that is, eMBB, URLLC, and mMTC, may be multiplexed and transmitted in a single system. In this case, different transmission/reception techniques and transmission/reception parameters may be used between services in order to satisfy different requirements of the respective services. Of course, 5G is not limited to the above-described three services.

### NR Time-Frequency Resources

Hereinafter, the frame structure of a 5G system will be described in more detail with reference to the accompanying drawings.

FIG. 1 illustrates the basic structure of a time-frequency domain in a wireless communication system according to an embodiment of the disclosure. The time-frequency domain is a radio resource domain used to transmit data or control channels in a 5G system.

In FIG. 1, the horizontal axis denotes a time domain, and the vertical axis denotes a frequency domain. The basic unit of resources in the time and frequency domains is a resource element (RE) 101, which may be defined as one orthogonal frequency division multiplexing (OFDM) symbol 102 along the time axis and one subcarrier 103 along the frequency axis. In the frequency domain, N_{SC}^{RB} (for example, 12) consecutive REs may constitute one resource block (RB) 104. In the time domain, one subframe 110 may include multiple OFDM symbols 102. For example, the length of one subframe may be 1 ms.

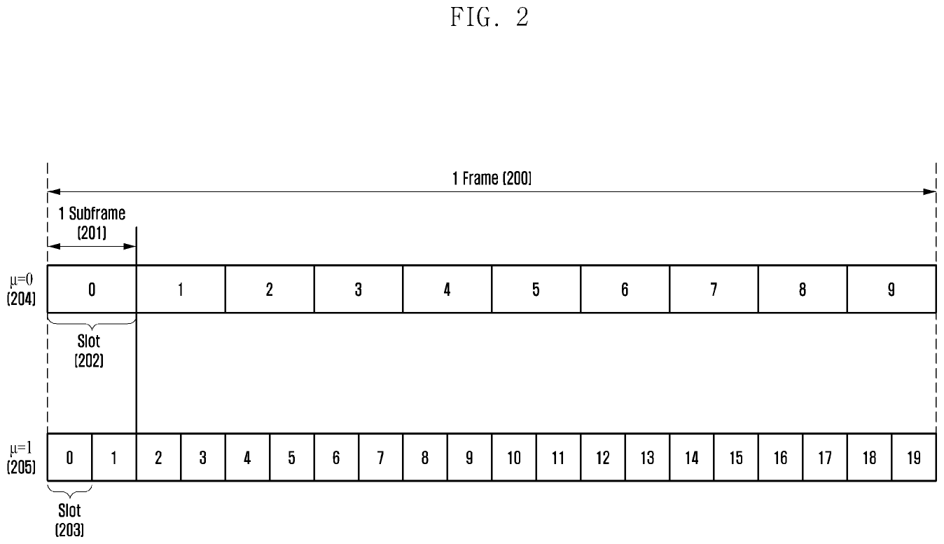

FIG. 2 illustrates the structure of frames, subframes, and slots in a wireless communication system according to an embodiment of the disclosure.

FIG. 2 illustrates an example of the structure of a frame 200, a subframe 201, and a slot 202. One frame 200 may be defined as 10 ms. One subframe 201 may be defined as 1 ms. Therefore, one frame 200 may include a total of ten subframes 201. One slot 202 or 203 may be defined as 14 OFDM symbols (that is, the number of symbols per one slot N_{symb}^{slot}=14). One subframe 201 may include one slot or multiple slots 202 and 203. The number of slots 202 and 203 per one subframe 201 may differ depending on configuration values u 204 and 205 regarding the subcarrier spacing. The example in FIG. 2 illustrates a case in which the subcarrier spacing configuration value is μ=0 (204), and a case in which μ=1 (205). In the case of μ=0 (204), one subframe 201 may include one slot 202. In the case of μ=1 (205), one subframe 201 may include two slots 203. That is, the number of slots per one subframe Nₛₗₒₜ^{subframe,μ} may differ depending on the subcarrier spacing configuration value μ, and the number of slots per one frame Nₛₗₒₜ^{frame,μ} may differ accordingly. Nₛₗₒₜ^{subframe,μ} and Nₛₗₒₜ^{frame,μ} may be defined according to each subcarrier spacing configuration μ as in Table 1 below:

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### Bandwidth Part (BWP)

Next, bandwidth part (BWP) configuration in a 5G communication system will be described in detail with reference to the accompanying drawings.

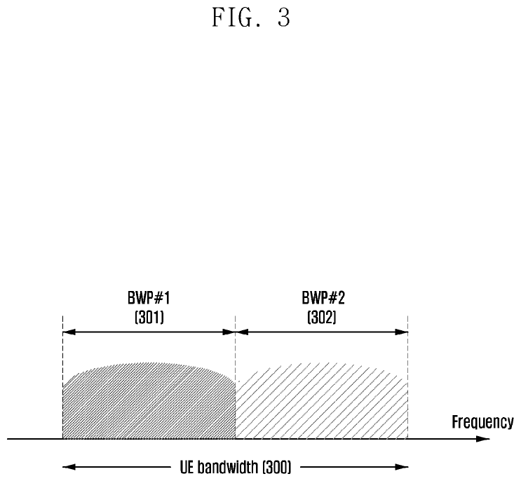

FIG. 3 illustrates an example of bandwidth part configuration in a wireless communication system according to an embodiment of the disclosure.

FIG. 3 illustrates an example in which a UE bandwidth 300 is configured to include two bandwidth parts, that is bandwidth part #1 (BWP #1) 301 and bandwidth part #2 (BWP #2) 302. A base station may configure one or multiple bandwidth parts for a UE, and may configure the following pieces of information with regard to each bandwidth part.

TABLE 2

| BWP ::= | SEQUENCE { |
|---|---|
| bwp-Id | BWP-Id, |
| (bandwidth part identifier) | |
| locationAndBandwidth | INTEGER (1..65536), |
| (bandwidth part location) | |
| subcarrierSpacing | ENUMERATED {n0, n1, |
| | n2, n3, n4, n5}, |
| (subcarrier spacing) | |
| cyclicPrefix | ENUMERATED { extended } |

(prefix)cyclic
}

The above example is not limiting, and various parameters related to the bandwidth part may be configured for the UE, in addition to the above configuration information. The above pieces of information may be transferred from the base station to the UE through upper layer signaling, for example, radio resource control (RRC) signaling. One configured bandwidth part or at least one bandwidth part among multiple configured bandwidth parts may be activated. Whether or not to activate a configured bandwidth part may be semi-statically transferred from the base station to the UE through RRC signaling, or dynamically transferred through downlink control information (DCI).

According to some embodiment, the UE, prior to radio resource control (RRC) connection, may have an initial BWP for initial access configured by the base station through a master information block (MIB). To be more specific, the UE may receive configuration information regarding a control resource set (CORESET) and a search space which may be used to transmit a PDCCH for receiving system information (which may correspond to remaining system information (RMSI) or system information block 1 (SIB1) necessary for initial access through the MIB in the initial access step. Each of the control resource set and the search space configured by the MIB may be considered as identity (ID) 0. The base station may notify the UE of configuration information, such as frequency allocation information regarding control resource set #0, time allocation information, and numerology, through the MIB. In addition, the base station may notify the UE of configuration information regarding the monitoring cycle and occasion regarding control resource set #0, that is, configuration information regarding control resource set #0, through the MIB. The UE may consider that a frequency domain configured by control resource set #0 acquired from the MIB is an initial bandwidth part for initial access. The ID of the initial bandwidth part may be considered to be 0.

The bandwidth part-related configuration supported by 5G may be used for various purposes.

According to some embodiments, if the bandwidth supported by the UE is smaller than the system bandwidth, this may be supported through the bandwidth part configuration. For example, the base station may configure the frequency location (configuration information 2) of the bandwidth part for the UE such that the UE can transmit/receive data at a specific frequency location within the system bandwidth.

In addition, according to some embodiments, the base station may configure multiple bandwidth parts for the UE for the purpose of supporting different numerologies. For example, in order to support a UE's data transmission/reception using both a subcarrier spacing of 15 kHz and a subcarrier spacing of 30 kHz, two bandwidth parts may be configured as subcarrier spacings of 15 kHz and 30 kHz, respectively. Different bandwidth parts may be subjected to frequency division multiplexing, and when data is to be transmitted/received at a specific subcarrier spacing, the bandwidth part configured as the corresponding subcarrier spacing may be activated.

In addition, according to some embodiments, the base station may configure bandwidth parts having different sizes of bandwidths for the UE for the purpose of reducing power consumed by the UE. For example, if the UE supports a substantially large bandwidth (for example, 100 MHz) and always transmits/receives data with the corresponding bandwidth, a substantially large amount of power consumption may occur. Particularly, it may be substantially inefficient from the viewpoint of power consumption to unnecessarily monitor the downlink control channel with a large bandwidth of 100 MHz in the absence of traffic. In order to reduce power consumed by the UE, the base station may configure a bandwidth part of a relatively small bandwidth, for example, a bandwidth part of 20 MHz, for the UE. The UE may perform a monitoring operation in the 20 MHz bandwidth part in the absence of traffic, and may transmit/receive data with the 100 MHz bandwidth part as instructed by the base station if data has occurred.

In connection with the bandwidth part configuring method, UEs, before being RRC-connected, may receive configuration information regarding the initial bandwidth part through a master information block (MIB) in the initial access step. To be more specific, a UE may have a control resource set (CORESET) configured for a downlink control channel which may be used to transmit downlink control information (DCI) for scheduling a system information block (SIB) from the MIB of a physical broadcast channel (PBCH). The bandwidth of the control resource set configured by the MIB may be considered as the initial bandwidth part, and the UE may receive, through the configured initial bandwidth part, a physical downlink shared channel (PDSCH) through which an SIB is transmitted. The initial bandwidth part may be used not only for the purpose of receiving the SIB, but also for other system information (OSI), paging, random access, or the like.

### BWP Change

If a UE has one or more bandwidth parts configured therefor, the base station may instruct to the UE to change (or switch) the bandwidth parts by using a bandwidth part indicator field inside DCI. As an example, if the currently activated bandwidth part of the UE is bandwidth part #1 301 in FIG. 3, the base station may indicate bandwidth part #2 302 with a bandwidth part indicator inside DCI, and the UE may change the bandwidth part to bandwidth part #2 302 indicated by the bandwidth part indicator inside received DCI.

As described above, DCI-based bandwidth part changing may be indicated by DCI for scheduling a PDSCH or a PUSCH, and a UE, upon receiving a bandwidth part change request, needs to be able to receive or transmit the PDSCH or PUSCH scheduled by the corresponding DCI in the changed bandwidth part with no problem. To this end, a requirement regarding the delay time (T_{BWP}) required during a bandwidth part change are specified standards, and may be defined, for example, in Table 3 as follows:

TABLE 3

| | |
|---|---|
| NR Slot | BWP switch delay T_{BWP} (slots) |

| μ | length (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

^{Note 1}
Depends on UE capability.
Note 2:
If the BWP switch involves changing of SCS, the BWP switch delay is determined by the larger one between the SCS before BWP switch and the SCS after BWP switch.

The requirement regarding the bandwidth part change delay time supports type 1 or type 2, depending on the capability of the UE. The UE may report the supportable bandwidth part delay time type to the base station.

If the UE has received DCI including a bandwidth part change indicator in slot n, according to the above-described requirement regarding the bandwidth part change delay time, the UE may complete a change to the new bandwidth part indicated by the bandwidth part change indicator at a timepoint not later than slot n+T_{BWP}, and may transmit/receive a data channel scheduled by the corresponding DCI in the newly changed bandwidth part. If the base station wants to schedule a data channel by using the new bandwidth part, the base station may determine time domain resource allocation regarding the data channel in view of the UE's bandwidth part change delay time (T_{BWP}). That is, when scheduling a data channel by using the new bandwidth part, the base station may schedule the corresponding data channel after the bandwidth part change delay time, in connection with the method for determining time domain resource allocation regarding the data channel. Accordingly, the UE may not expect that the DCI that indicates a bandwidth part change will indicate a slot offset (K0 or K2) value smaller than the bandwidth part change delay time (T_{BWP}).

If the UE has received DCI (for example, DCI format 1_1 or 0_1) indicating a bandwidth part change, the UE may perform no transmission or reception during a time interval from the third symbol of the slot used to receive a PDCCH including the corresponding DCI to the start point of the slot indicated by a slot offset (K0 or K2) value indicated by a time domain resource allocation indicator field in the corresponding DCI. For example, if the UE has received DCI indicating a bandwidth part change in slot n, and if the slot offset value indicated by the corresponding DCI is K, the UE may perform no transmission or reception from the third symbol of slot n to the symbol before slot n+K (that is, the last symbol of slot n+K−1).

### QCL, TCI State

In a wireless communication system, one or more different antenna ports (which may be replaced with one or more channels, signals, and combinations thereof, but will be referred to as different antenna ports, as a whole, for convenience of description of the disclosure) may be associated with each other by a quasi-co-location (QCL) configuration as in Table 4 below. A TCI state is for publishing the QCL relation between a PDCCH (or a PDCCH DRMS) and another RS or channel. The description that a reference antenna port A (reference RS #A) and another target antenna port B (target RS #B) are QCLed with each other means that the UE is allowed to apply some or all of large-scale channel parameters estimated in the antenna port A to channel measurement form the antenna port B. The QCL needs to be associated with different parameters according to the situation such as 1) time tracking influenced by average delay and delay spread, 2) frequency tracking influenced by Doppler shift and Doppler spread, 3) radio resource management (RRM) influenced by average gain, or 4) beam management (BM) influenced by a spatial parameter. Accordingly, four types of QCL relations are supported in NR as in Table 4 below:

TABLE 4

| QCL type | Large-scale characteristics |
|---|---|
| A | Doppler shift, Doppler spread, |
| | average delay, delay spread |
| B | Doppler shift, Doppler spread |
| C | Doppler shift, average delay |
| D | Spatial Rx parameter |

The spatial RX parameter may refer to some or all of various parameters as a whole, such as angle of arrival (AoA), power angular spectrum (PAS) of AoA, angle of departure (AoD), PAS of AoD, transmit/receive channel correlation, transmit/receive beamforming, and spatial channel correlation.

The QCL relation may be configured for the UE through RRC parameter TCI-state and QCL-info as in Table 5 below. Referring to Table 5, the base station may configure one or more TCI states for the UE, thereby informing of a maximum of two kinds of QCL relations (qcl-Type1, qcl-Type2) regarding the RS that refers to the ID of the TCI state, that is, the target RS. Each piece of QCL information (QCL-Info) that each TCI state includes the serving cell index and the BWP index of the reference RS indicated by the corresponding QCL information, the type and ID of the reference BS, and a QCL type as in Table 4 above.

TABLE 5

| | |
|---|---|
| TCI-State ::= | SEQUENCE { |
| tci-StateId | TCI-StateId, |

(ID of corresponding TCI state)

| | |
|---|---|
| qcl-Type1 | QCL-Info, |

(QCL information of first refernece RS of RS (target RS) referring to corresponding TCI state
ID)

| | | |
|---|---|---|
| qcl-Type2 | QCL-Info | OPTIONAL, -- Need R |

```
  (QCL information of second refernece RS of RS (target RS) referring to corresponding TCI state
ID)
  ...
}
```

| QCL-Info ::= | SEQUENCE { | |
|---|---|---|
| cell | ServCellIndex | OPTIONAL, -- Need R |

(serving cell index of reference RS indicated by corresponding QCL information)

| | | |
|---|---|---|
| bwp-Id | BWP-Id | OPTIONAL, -- Cond CSI- |

RS-Indicated
(BWP index of reference RS indicated by corresponding QCL information)

| | |
|---|---|
| referenceSignal | CHOICE { |
| csi-rs | NZP-CSI-RS-ResourceId, |
| ssb | SSB-Index |

```
    (one of CSI-RS ID or SSB ID indicated by corresponding QCL information)
  },
```

| | |
|---|---|
| qcl-Type | ENUMERATED {typeA, typeB, typeC, typeD}, |

...
}

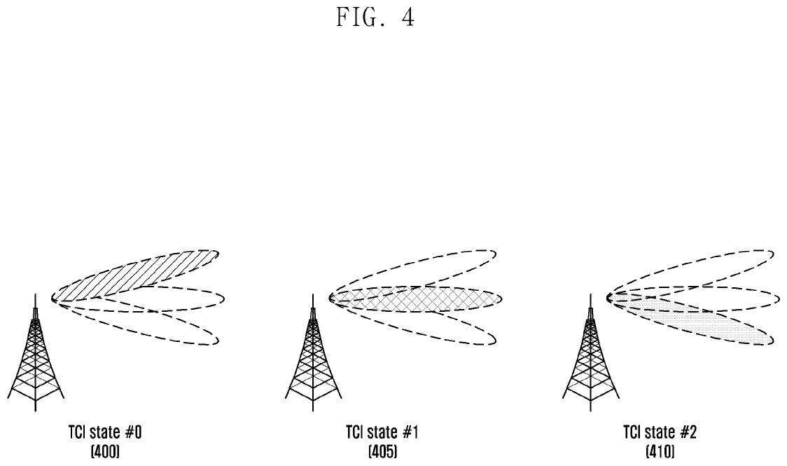

FIG. 4 illustrates an example of base station beam allocation according to TCI state configuration in a wireless communication system according to an embodiment of the present disclosure.

Referring to FIG. 4, the base station may transfer information regarding N different beams to the UE through N different TCI states. For example, in the case of N=3 as in FIG. 4, the base station may configure qcl-Type2 parameters included in three TCI states 400, 405, and 410 in QCL type D while being associated with CSI-RSs or SSBs corresponding to different beams, thereby notifying that antenna ports referring to the different TCI states 400, 405, and 410 are associated with different spatial Rx parameters (that is, different beams).

Tables 6 to 10 below enumerate valid TCI state configurations according to the target antenna port type.

More particularly, Table 6 enumerates valid TCI state configurations when the target antenna port is a CSI-RS for tracking (TRS). The TRS refers to an NZP CSI-RS which has no repetition parameter configured therefor, and trs-Info of which is configured as “true”, among CRI-RSs. In Table 6, configuration no. 3 may be used for an aperiodic TRS.

TABLE 6

| | | | DL RS 2 | qcl-Type2 |
|---|---|---|---|---|
| Valid TCI state | DL | qcl- | (if | (if |
| Configuration | RS 1 | Type1 | configured) | configured) |
| 1 | SSB | QCL-TypeC | SSB | QCL-TypeD |
| 2 | SSB | QCL-TypeC | CSI-RS (BM) | QCL-TypeD |
| 3 | TRS | QCL-TypeA | TRS (same as | QCL-TypeD |
| | (periodic) | | DL RS 1) | |

More particularly, Table 7 enumerates valid TCI state configurations when the target antenna port is a CSI-RS for CSI. The CSI-RS for CSI refers to an NZP CSI-RS which has no parameter indicating repetition (for example, repetition parameter) configured therefor, and trs-Info of which is not configured as “true”, among CRI-RSs.

TABLE 7

| | | | DL RS 2 | qcl-Type2 |
|---|---|---|---|---|
| Valid TCI state | DL | qcl- | (if | (if |
| Configuration | RS 1 | Type1 | configured) | configured) |
| 1 | TRS | QCL-TypeA | SSB | QCL-TypeD |
| 2 | TRS | QCL-TypeA | CSI-RS (BM) | QCL-TypeD |
| 3 | TRS | QCL-TypeA | TRS (same as | QCL-TypeD |
| | (periodic) | | DL RS 1) | |
| 4 | TRS | QCL-TypeB | | |

More particularly, Table 8 enumerates valid TCI state configurations when the target antenna port is a CSI-RS for beam management (BM) (which has the same meaning as CSI-RS for L1 RSRP reporting). The CSI-RS for BM refers to an NZP CSI-RS which has a repetition parameter configured to have a value of “on” or “off”, and trs-Info of which is not configured as “true”, among CRI-RSs.

TABLE 8

| | | | DL RS 2 | qcl-Type2 |
|---|---|---|---|---|
| Valid TCI state | DL | qcl- | (if | (if |
| Configuration | RS 1 | Type1 | configured) | configured) |
| 1 | TRS | QCL-TypeA | TRS (same as | QCL-TypeD |
| | | | DL RS 1) | |
| 2 | TRS | QCL-TypeA | CSI-RS (BM) | QCL-TypeD |
| 3 | SS/PBCH | QCL-TypeC | SS/PBCH | QCL-TypeD |
| | Block | | Block | |

More particularly, Table 9 enumerates valid TCI state configurations when the target antenna port is a PDCCH DMRS.

TABLE 9

| | | | DL RS 2 | qcl-Type2 |
|---|---|---|---|---|
| Valid TCI state | DL | qcl- | (if | (if |
| Configuration | RS 1 | Type1 | configured) | configured) |
| 1 | TRS | QCL-TypeA | TRS (same as | QCL-TypeD |
| | | | DL RS 1) | |
| 2 | TRS | QCL-TypeA | CSI-RS (BM) | QCL-TypeD |
| 3 | CSI-RS | QCL-TypeA | CSI-RS (same as | QCL-TypeD |
| | (CSI) | | DL RS 1) | |

More particularly, Table 10 enumerates valid TCI state configurations when the target antenna port is a PDSCH DMRS.

TABLE 10

| | | | DL RS 2 | qcl-Type2 |
|---|---|---|---|---|
| Valid TCI state | DL | qcl- | (if | (if |
| Configuration | RS 1 | Type1 | configured) | configured) |
| 1 | TRS | QCL-TypeA | TRS | QCL-TypeD |
| 2 | TRS | QCL-TypeA | CSI-RS | QCL-TypeD |
| | | | (BM) | |
| 3 | CSI-RS | QCL-TypeA | CSI-RS | QCL-TypeD |
| | (CSI) | | (CSI) | |

According to a representative QCL configuration method based on Tables 6 to 10 above, the target antenna port and reference antenna port for each step are configured and operated such as “SSB”→“TRS”→“CSI-RS for CSI, or CSI-RS for BM, or PDCCH DMRS, or PDSCH DMRS”. Accordingly, it is possible to help the UE's receiving operation by associating statistical characteristics that can be measured from the SSB and TRS with respective antenna ports.

### Unified TCI State

Hereinafter, a method of indicating and activating a single TCI state based on a unified TCI method will be described. The unified TCI method may refer to a method of managing transmission and reception beam management methods, which have been previously distinguished as a TCI state method used for downlink reception of a UE and a spatial relation information method used for uplink transmission in Rel-15 and 16, by unifying them into a TCI state. Therefore, in case of receiving indications from the base station based on the unified TCI method, the UE may perform beam management using a TCI state even for uplink transmissions. When the UE has been configured with a TCI-state having tci-stateId-r17, which is higher layer signaling, from the base station, the UE may perform an operation based on the unified TCI method by using the corresponding TCI-state. TCI-state may exist as two types, namely, a joint TCI state or a separate TCI state.

The first type of a TCI state is a joint TCI state, and in this case, a UE may receive, from a base station, an indication of a TCI state to be applied to both uplink transmission and downlink reception through a single TCI-state. When the UE has received an indication of a TCI-State based on a joint TCI-State, the UE may receive an indication of parameters to be used for downlink channel estimation by using an RS corresponding to qcl-Type1 in the TCI-State based on the corresponding joint TCI-State, and parameters to be used for downlink reception beam or reception filter by using an RS corresponding to qcl-Type2. When the UE has received a TCI-State based on a joint TCI-State, the UE may receive an indication of parameters to be used for the uplink transmission beam or transmission filter using the RS corresponding to qcl-Type2 in the TCI-State based on the joint DL/UL TCI-State. In this case, in case that the UE receives an indication of a joint TCI state, the UE may apply the same beam for both uplink transmission and downlink reception.

The second type of a TCI state is a separate TCI state, and in this case, a UE may separately receive, from a base station, an indication of the UL TCI state to be applied for uplink transmission and the DL TCI state to be applied for downlink reception. When the UE has received an indication of a UL TCI state, the UE may receive an indication of parameters to be used as the uplink transmission beam or transmission filter, by using the reference RS or source RS configured within the corresponding UL TCI state. When the UE has received an indication of a DL TCI state, the UE may receive an indication of parameters to be used for downlink channel estimation using the RS corresponding to qcl-Type1 configured within the DL TCI state, and parameters to be used for downlink reception beam or reception filter using the RS corresponding to qcl-Type2.

When the UE receives an indication of both the DL TCI state and the UL TCI state, the UE may receive an indication of parameters to be used as the uplink transmission beam or transmission filter using the reference RS or source RS configured in the corresponding UL TCI state, parameters to be used for downlink channel estimation using the RS corresponding to qcl-Type1 configured in the corresponding DL TCI state, and parameters to be used as the downlink reception beam or reception filter using the RS corresponding to qcl-Type2. In this case, in case that the reference RSs or the source RSs configured in the DL TCI state and the UL TCI state received by the UE are different, the UE may apply the beam for the uplink transmission and the downlink reception separately based on the received UL TCI state and the DL TCI state, respectively.

The UE may be configured with up to 128 joint TCI states for each specific bandwidth part in a specific cell via higher layer signaling, configured with up to 64 or 128 DL TCI states in the separate TCI state for each specific bandwidth part in a specific cell based on UE capability report via higher layer signaling, and the DL TCI state in the separate TCI state and the joint TCI state may use the same higher layer signaling structure. For example, if 128 joint TCI states are configured and 64 DL TCI states are configured in the separate TCI state, the 64 DL TCI states may be included in the 128 joint TCI states.

Up to 32 or 64 UL TCI states in the separate TCI state may be configured for each specific bandwidth part in a specific cell based on UE capability report via higher layer signaling. Similar to the relationship between the DL TCI state in the separate TCI state and the joint TCI state, the UL TCI states in the separate TCI and the joint TCI state may use the same higher layer signaling structure, or the UL TCI state in the separate TCI may use a different higher layer signaling structure from that of the joint TCI state and the DL TCI state in the separate TCI state.

The use of these different or identical higher layer signaling structures may be defined in a specification, or may be distinguished by another higher layer signaling configured by the base station, based on UE capability report that includes information about which of the two usage methods the UE can support.

The UE may receive a transmission/reception beam-related indication in a unified TCI method using either the joint TCI state or the separate TCI state configured by the base station. The UE may be configured with whether to use the joint TCI state or the separate TCI state from the base station via higher layer signaling.

The UE receives a transmission/reception beam-related indication using one of the methods selected from the joint TCI state and the separate TCI state via higher layer signaling, and in this case, a method for transmission/reception beam indication from the base station may include an MAC-CE-based indication method and an MAC-CE-based activation and DCI-based indication method.

When the UE receives transmission/reception beam-related indication using the joint TCI state method through higher layer signaling, the UE may perform a transmission/reception beam application operation by receiving a MAC-CE indicating the joint TCI state from the base station, and the base station may schedule the reception of a PDSCH including the MAC-CE to the UE via a PDCCH. When one joint TCI state is included in the MAC-CE, the UE may determine an uplink transmission beam or transmission filter and a downlink reception beam or reception filter using the joint TCI state indicated starting 3 ms after the transmission of the PUCCH including the HARQ-ACK information indicating successful reception of the PDSCH including the MAC-CE. When two or more joint TCI states are included in the MAC-CE, the UE may identify that multiple joint TCI states indicated by the MAC-CE, starting 3 ms after the transmission of the PUCCH including the HARQ-ACK information indicating successful reception of the PDSCH including the MAC-CE correspond to each codepoint in the TCI state field of DCI format 1_1 or 1_2 and activate the indicated joint TCI states. Thereafter, the UE may receive DCI format 1_1 or 1_2 and apply the one joint TCI state indicated by the TCI state field in the corresponding DCI to the uplink transmission and downlink reception beams. In this case, DCI format 1_1 or 1_2 may include downlink data channel scheduling information (with DL assignment) or may not (without DL assignment).

In case that the UE receives a transmission/reception beam-related indication using the separate TCI state method through higher layer signaling, the UE may perform a transmission/reception beam adaptation operation by receiving a MAC-CE indicating the separate TCI state from the base station, and the base station may schedule the reception of PDSCHs including the corresponding MAC-CE to the UE via PDCCH. When there is only one separate TCI state set included in the MAC-CE, the UE may determine an uplink transmission beam or transmission filter and a downlink reception beam or reception filter using the separate TCI states included within the indicated separate TCI state set starting 3 ms after the transmission of the PUCCH including the HARQ-ACK information indicating successful reception of the corresponding PDSCH. A set of separate TCI states may refer to a single or multiple separate TCI states that a single codepoint in the TCI state field within DCI format 1_1 or 1_2 may have, and a set of separate TCI states may include one DL TCI state, one UL TCI state, or one DL TCI state and one UL TCI state. When there are two or more sets of separate TCI states included in the MAC-CE, the UE may identify that the multiple separate TCI state sets indicated by the MAC-CE correspond to each codepoint in the TCI state field of DCI format 1_1 or 1_2, starting 3 ms after the transmission of the PUCCH including the HARQ-ACK information indicating successful reception of the PDSCH, and activate the indicated separate TCI state sets. In this case, each codepoint in the TCI state field of DCI format 1_1 or 1_2 may indicate one DL TCI state, one UL TCI state, or one DL TCI state and one UL TCI state. The UE may receive DCI format 1_1 or 1_2 and apply a set of separate TCI states, indicated by the TCI state field within the corresponding DCI, to the uplink transmission and downlink reception beams. In this case, DCI format 1_1 or 1_2 may include downlink data channel scheduling information (with DL assignment) or may not (without DL assignment).

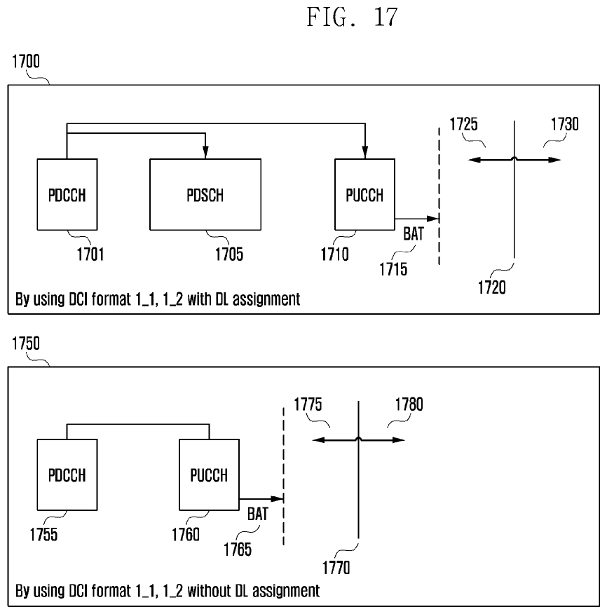

FIG. 17 illustrates a beam application time that may be considered when using a unified TCI method in a wireless communication system according to an embodiment of the disclosure. As described above, a UE may receive, from a base station, DCI format 1_1 or 1_2 including downlink data channel scheduling information (with DL assignment) or not including the same (without DL assignment), and may apply one joint TCI state or a set of separate TCI states, indicated by a TCI state field within the corresponding DCI, to the uplink transmission and downlink reception beams.
DCI format 1_1 or 1_2 with DL assignment (17-00): when a UE receives DCI format 1_1 or 1_2 including downlink data channel scheduling information from a base station (indicated by reference numeral 17-01) indicating one joint TCI state or a set of separate TCI states based on the unified TCI method, the UE may receive a PDSCH scheduled based on the received DCI (indicated by reference numeral 17-05) and transmit a PUCCH including HARQ-ACK indicating successful reception of the DCI and PDSCH (indicated by reference numeral 17-10). In this case, the HARQ-ACK may include both whether the reception of DCI and PDSCH is successful or not, and when at least one of the DCI and the PDSCH is not received, the UE may transmit a NACK, and when both the DCI and the PDSCH are received successfully, the UE may transmit an ACK.
DCI format 1_1 or 1_2 without DL assignment (17-50): When the UE receives DCI format 1_1 or 1_2 that does not include downlink data channel scheduling information from the base station (indicated by reference numeral 17-55) and indicates one joint TCI state or a set of separate TCI states based on the unified TCI method, the UE may assume at least one combination of the following details for the corresponding DCI:
   A CRC scrambled using CS-RNTI is included.
   All bits assigned to all fields used as redundancy version (RV) fields have a value of 1.
   All bits assigned to all fields used as modulation and coding scheme (MCS) fields have a value of 1.
   All bits assigned to all fields used as new data indication (NDI) fields have a value of 0.
   For frequency domain resource allocation (FDRA) Type 0, all bits assigned to the FDRA field have a value of 0; for FDRA Type 1, all bits assigned to the FDRA field have a value of 1; and for FDRA method of dynamicSwitch, all bits assigned to the FDRA field have a value of 0.

The UE may, by assuming the above details, transmit a PUCCH including HARQ-ACK indicating successful reception of DCI format 1_1 or 1_2 or not (indicated by reference numeral 17-60).
For both DCI format 1_1 or 1_2 with DL assignment (17-00) and without DL assignment (17-50), if a new TCI state indicated via DCI 17-01 or 17-55 is the same as the TCI state previously indicated and being applied to the uplink transmission and downlink reception beams, the UE may maintain the previously applied TCI state, and if the new TCI state is different from the previously indicated TCI state, the UE may determine the time of application of the joint TCI state or the set of separate TCI states that may be indicated from the TCI state field included in the DCI to be after the first slot 17-20 or 17-70 after a time corresponding to the beam application time (BAT) 17-15 or 17-65 after the PUCCH transmission (indicated by reference numeral 17-30 or 17-80), and may use the previously indicated TCI-state until before the corresponding slot 17-20 or 17-70 (indicated by reference numeral 17-25 or 17-75).
For both DCI formats 1_1 or 1_2 with DL assignment (indicated by reference numeral 17-00) and without DL assignment (indicated by reference numeral 17-50), the BAT may be configured as a specific number of OFDM symbols based on UE capability report information via higher layer signaling, and the numerology for the BAT and the first slot after the BAT may be determined based on the smallest numerology of all cells applied by the set of separate TCI states or the joint TCI state indicated via DCI.

The UE may apply one joint TCI state, indicated via MAC-CE or DCI, to the reception of all control resource sets connected to the UE-specific search space, to the reception of PDSCHs and the transmission of PUSCHs scheduled with PDCCHs transmitted from the corresponding control resource sets, and to the transmission of all PUCCH resources.

In case that the one set of separate TCI states indicated via MAC-CE or DCI includes one DL TCI state, the UE may apply one set of separate TCI states to the reception of all control resource sets connected to the UE-specific search space, to the reception of PDSCHs scheduled with PDCCHs transmitted from the corresponding control resource sets, and to all PUSCH and PUCCH resources based on the previously indicated UL TCI states.

In case that one set of separate TCI states indicated via MAC-CE or DCI includes one UL TCI state, the UE may apply the UL TCI state to all of PUSCH and PUCCH resources, to the reception of all of control resource sets connected to the UE-specific search space, and to the reception of PDSCHs scheduled with PDCCHs transmitted from the corresponding control resource sets.

In case that one set of separate TCI states indicated via MAC-CE or DCI includes one DL TCI state and one UL TCI state, the UE may apply the DL TCI state to the reception of all of control resource sets connected to the UE-specific search space and to the reception of PDSCHs scheduled with PDCCHs transmitted from the corresponding control resource sets, and may apply the UL TCI state to all of PUSCH and PUCCH resources.

### Unified TCI State MAC-CE

Hereinafter, a method for indicating and activating a single TCI state based on a unified TCI method will be described. A UE may receive scheduling of a PDSCH including the following MAC-CE from a base station, and from 3 slots after transmission of HARQ-ACK for the corresponding PDSCH to the base station, may interpret each code point of a DCI state field in DCI format 1_1 or 1_2, based on information in the MAC-CE received from the base station. In other words, the UE may activate each entry of the MAC-CE received from the base station at each code point in the TCI state field in DCI format 1_1 or 1_2.

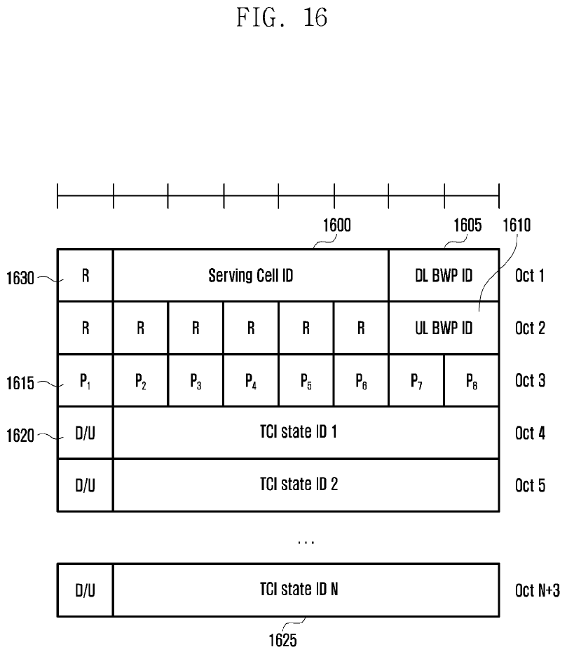

FIG. 16 illustrates another MAC-CE structure for activating and indicating a joint TCI state or a separate DL or UL TCI state in a wireless communication system according to an embodiment of the disclosure. The meaning of each field in the corresponding MAC-CE structure may be as follows:
Serving Cell ID (16-00): This field may indicate a serving cell to which the corresponding MAC-CE is to be applied. This field may be 5 bits in length. If a serving cell indicated by this field is included in one or more of simultaneousU-TCI-UpdateList1, simultaneousU-TCI-UpdateList2, simultaneousU-TCI-UpdateList3, or simultaneousU-TCI-UpdateList4, which are higher layer signaling, the corresponding MAC-CE may be applied to all of serving cell included in one or more of the following lists of simultaneousU-TCI-UpdateList1, simultaneousU-TCI-UpdateList2, simultaneousU-TCI-UpdateList3, simultaneousU-TCI-UpdateList4 that includes the serving cell indicated by this field.
DL BWP ID (16-05): This field may indicate a DL BWP to which the corresponding MAC-CE is to be applied, and the meaning of each codepoint in this field may correspond to each codepoint of a bandwidth part indicator in DCI. This field may be 2 bits in length.
UL BWP ID (16-10): This field may indicate an UL BWP to which the corresponding MAC-CE is to be applied, and the meaning of each codepoint in this field may correspond to each codepoint of the bandwidth part indicator in the DCI. This field may be 2 bits in length.
Pi (16-15): This field may indicate whether each codepoint of the TCI state field in DCI format 1_1 or 1_2 has multiple TCI states or one TCI state. Pi having a value of 1 signifies that the corresponding i-th codepoint has multiple TCI states, and this may signify that the codepoint may include a separate DL TCI state and a separate UL TCI state. Pi having a value of 0 may signify that the corresponding i-th codepoint has a single TCI state, and this may signify that the codepoint may include either a joint TCI state, a separate DCI TCI state, or a separate UL TCI state.
D/U (16-20): This field may indicate whether the TCI state ID field within the same octet is a joint TCI state, a separate DL TCI state, or a separate UL TCI state. If this field is 1, the TCI state ID field within the same octet may be a joint TCI state or a separate DL TCI state. If this field is 0, the TCI state ID field within the same octet may be a separate UL TCI state.
TCI state ID (16-25): This field may indicate the TCI state that may be identified by TCI-StateId which is higher layer signaling. When the D/U field is configured to be 1, this field may be used to represent the TCI-StateId, which can be represented by 7 bits. When the D/U field is configured as 0, the most significant bit (MSB) of this field may be considered as a reserved bit, and the remaining 6 bits may be used to represent UL-TCIState-Id which is higher layer signaling. The maximum number of TCI states that can be activated is 8 for joint TCI states and 16 for separate DL or UL TCI states.
R: reserved bit, which may be configured as 0.

For the MAC-CE structure of FIG. 16 described above, the UE may include a third octet including the fields P₁, P₂, . . . , P₈ in FIG. 16 in the MAC-CE structure regardless of whether the unifiedTCI-StateType-r17 in MIMOparam-r17 in ServingCellConfig, which is higher layer signaling, is configured as joint or separate. In this case, the UE may perform TCI state activation using a fixed MAC-CE structure independent of the higher layer signaling configured from the base station. In another example, for the MAC-CE structure of FIG. 16 described above, the UE may omit the third octet including the fields P₁, P₂, . . . , P₈ in FIG. 16 when the unifiedTCI-StateType-r17 in MIMOparam-r17 in ServingCellConfig, which is higher layer signaling, is configured as joint. In this case, the UE may save up to 8 bits of the payload of the corresponding MAC-CE depending on the higher layer signaling configured from the base station. Furthermore, all of the D/U fields located in the first bit of the fourth octet in FIG. 16 may be considered R fields, and all of the corresponding R fields may be set to be 0 bits.

### Regarding CA/DC

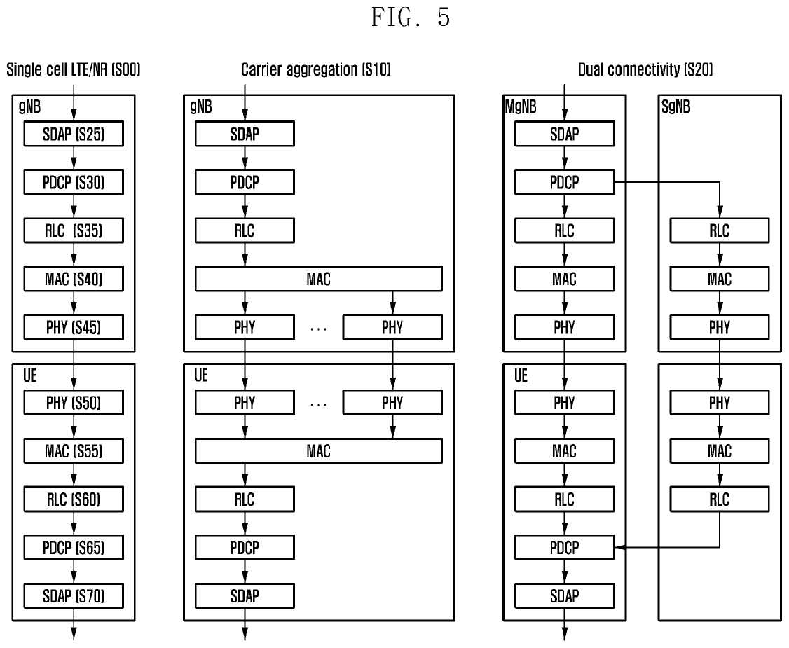

FIG. 5 illustrates a radio protocol structure of a base station and a UE in a single cell, carrier aggregation, and dual connectivity situation in a wireless communication system according to an embodiment of the disclosure.

Referring to FIG. 5, the radio protocol of the next generation mobile communication system includes, for each of a UE and an NR base station, NR service data adaptation protocols (NR SDAPs) S25 and S70, NR packet data convergence protocols (NR PDCPs) S30 and S65, and NR radio link controls (NR RLCs) S35 and S60, and NR medium access control (NR MACs) S40 and S55.

The main functions of the NR SPAPs S25 and S70 may include some of the following functions:
Transfer of user plane data;
Mapping between a QoS flow and a data bearer (DRB) for both DL and UL;
Marking QoS flow ID in both DL and UL packets; and
Reflective QoS flow to DRB mapping for the UL SDAP PDUs.

With respect to the SDAP layer device, a UE may receive, through an RRC message, a configuration associated with whether to use a header of the SDAP layer device or whether to use a function of the SDAP layer device, according to each PDCP layer device, each bearer, and each logical channel. When the SDAP header is configured, the UE is indicated by a one-bit NAS reflective QoS indicator (NAS reflective QoS) and a one-bit AS reflective QoS indicator (AS reflective QoS) of the SDAP header to update or reconfigure mapping information between a data bearer and a QoS flow of uplink and downlink. The SDAP header may include QoS flow ID information indicating QoS. The QoS information may be used as a data processing priority for supporting smooth services, scheduling information, or the like.

The main functions of the NR PDCPs S30 and S65 may include some of the following functions:
Header compression and decompression: ROHC only;
Transfer of user data;
In-sequence delivery of higher layer PDUs;
Out-of-sequence delivery of higher layer PDUs;
PDCP PDU reordering for reception;
Duplicate detection of lower layer SDUs;
Retransmission of PDCP SDUs;
Ciphering and deciphering; and
Timer-based SDU discard in uplink.

In the above, a reordering function of the NR PDCP device refers to a function of sequentially reordering PDCP PDUs, received from a lower layer, based on a PDCP sequence number (SN), and may include a function of transmitting data to a higher layer in the sequence of reordering. Alternatively, the reordering function of the NR PDCP device may include a function of transmitting data without considering the sequence, a function of reordering the sequence and recording missing PDCP PDUs, a function of providing a state report on the missing PDCP PDUs to a transmission side, and a function of requesting retransmission for the missing PDCP PDUs.

The main functions of the NR RLCs S35 and S60 may include some of the following functions:
Transfer of higher layer PDUs;
In-sequence delivery of higher layer PDUs;
Out-of-sequence delivery of higher layer PDUs;
Error Correction through ARQ;
Concatenation, segmentation and reassembly of RLC SDUs;
Re-segmentation of RLC data PDUs;
Reordering of RLC data PDUs;
Duplicate detection;
Protocol error detection;
RLC SDU discard; and
RLC re-establishment.

The in-sequence delivery function of the NR RLC device refers to a function of transmitting RLC SDUs, received from a lower layer, to a higher layer in the sequence of reception. The in-sequence delivery function of the NR RLC device may include: if one RLC SDU is originally segmented into multiple RLC SDUs and received, a function of reassembling and transmitting the multiple RLC SDUs; a function of reordering the received RLC PDUs based on an RLC sequence number (SN) or PDCP SN; a function of reordering the sequence and recording missing RLC PDUs; a function of providing a state report on the missing RLC PDUs to a transmission side; and a function of requesting retransmission for the missing RLC PDUs. When the missing RLC SDU occurs, the in-sequence delivery function of the NR RLC device may include a function of sequentially transmitting only the RLC SDUs prior to the missing RLC SDU to a higher layer or sequentially transmitting all the RLC SDUs received before a timer starts to a higher layer if a predetermined timer expires although there is a missing RLC SDU. Alternatively, the in-sequence delivery function of the NR RLC device may include a function of sequentially transmitting all RLC SDUs received so far to a higher layer if a predetermined timer expires although there is a missing RLC SDU. In addition, the RLC PDUs may be processed in the sequence that the RLC PDUS are received (in the sequence of arrival regardless of the sequence of serial number and sequence number), and may be transmitted to a PDCP device out of sequence delivery. In a case of segments, the in-sequence delivery function may include a function of receiving segments stored in a buffer or segments to be received later, reconfiguring the segments in one complete RLC PDU, processing the RLC PDU, and transmitting the RLC PDU to the PDCP device. The NR RLC layer may not include a concatenation function, and the concatenation function may be performed by the NR MAC layer or may be replaced by a multiplexing function of the NR MAC layer.

In the above, the out-of-sequence delivery function of the NR RLC device refers to a function of directly transmitting the RLC SDUs, received from the lower layer, to a higher layer regardless of the order, and may include, if one RLC SDU has been originally segmented into multiple RLC SDUs and received, a function of reassembling the multiple RLC SDUs and transmitting the same, and a function of storing the RLC SNs or PDCP SNs of the received RLC PDUs, reordering the sequence, and recording the missing RLC PDUs.

The NR MACs S40 and S55 may be connected to multiple NR RLC layer devices configured in one UE, and the main functions of the NR MAC may include some of the following functions:
Mapping between logical channels and transport channels;
Multiplexing/de-multiplexing of MAC SDUs;
Scheduling information reporting;
Error correction through HARQ;
Priority handling between logical channels of one UE;
Priority handling between UEs by means of dynamic scheduling;
MBMS service identification;
Transport format selection; and
Padding.

The NR PHY layers S45 and S50 may perform an operation of channel-coding and modulating higher layer data, generating the higher layer data into an OFDM symbol, transmitting the OFDM symbols via a radio channel, or demodulating and channel decoding of the OFDM symbols received via the radio channel, and transferring the OFDM symbol to a higher layer.

The detailed structure of the radio protocol structure may be variously changed according to a carrier (or cell) operating method. For example, when the base station performs single carrier (or cell)-based data transmission to the UE, the base station and the UE use a protocol structure, which has a single structure for each layer, such as S00. On the other hand, when the base station transmits data to the UE based on carrier aggregation (CA) using multiple carriers in a single TRP, the base station and the UE has a single structure up to RLC but uses a protocol structure of multiplexing a PHY layer through a MAC layer, such as S10. As another example, when the base station transmits data to the UE based on dual connectivity (DC) using multiple carriers in multiple TRP, the base station and the UE has a single structure up to RLC, but uses a protocol structure of multiplexing a PHY layer through a MAC layer, such as S20.

### Regarding RLM RS

Next, a method for selecting or determining an RLM RS when a radio link monitoring reference signal (RLM RS) is configured or not. The UE may be configured with a set of RLM RS for each downlink bandwidth part of SpCell from a base station through RadioLinkMonitoringRS in RadioLinkMonitoringConfig, which is higher layer signaling, and the specific higher layer signaling structure is as follows in Table 11.

```
TABLE 11
RadioLinkMonitoringConfig ::= SEQUENCE {
  failureDetectionResourcesToAddModList SEQUENCE
(SIZE(1..maxNrofFailureDetectionResources)) OF RadioLinkMonitoringRS OPTIONAL, --
Need N
  failureDetectionResourcesToReleaseList SEQUENCE
(SIZE(1..maxNrofFailureDetectionResources)) OF RadioLinkMonitoringRS-Id OPTIONAL, --
Need N
  beamFailureInstanceMaxCount ENUMERATED {n1, n2, n3, n4, n5, n6, n8, n10}
```

OPTIONAL, -- Need R

beamFailureDetectionTimer ENUMERATED {pbfd1, pbfd2, pbfd3, pbfd4, pbfd5, pbfd6,

| | |
|---|---|
| pbfd8, pbfd10} | OPTIONAL, -- Need R |

...
}
RadioLinkMonitoringRS ::= SEQUENCE {

| | |
|---|---|
| radioLinkMonitoringRS-Id | RadioLinkMonitoringRS-Id, |
| purpose | ENUMERATED {beamFailure, rlf, both}, |
| detectionResource | CHOICE { |
| ssb-Index | SSB-Index, |
| csi-RS-Index | NZP-CSI-RS-ResourceId |

},
. . .
}

Table 12 below indicates the number of RLM RSs that can be configured or selected for a specific use depending on the maximum number of SSBs (Lₘₐₓ) per half frame. As shown in Table 12 below, depending on the value of Lₘₐₓ, N_{LR-RLM} RSs may be used for link recovery or radio link monitoring, and N_{RLM} RSs among N_{LR-RLM} RSs may be used for radio link monitoring.

TABLE 12

| Lₘₐₓ | N_{LR-RLM} | N_{RLM} |
|---|---|---|
| 4 | 2 | 2 |
| 8 | 6 | 4 |
| 64 | 8 | 8 |

When RadioLinkMonitoringRS, which is higher layer signaling, is not configured for the UE, and when the UE is configured with a TCI state for receiving a PDCCH in a control resource set and at least one CSI-RS is included in the corresponding TCI state, the RLM RS may be selected according to the following RLM RS selection methods:
RLM RS selection Method 1: When the activated TCI state to be used for PDCCH reception has one reference RS (i.e., one activated TCI state has only one of QCL-TypeA, B, or C), the UE may select, as the RLM RS, the reference RS of the activated TCI state to be used for PDCCH reception.
RLM RS selection Method 2: When the activated TCI state to be used for PDCCH reception has two reference RSs (i.e., one activated TCI state has one of QCL-TypeA, B, or C and further has QCL-TypeD), the UE may select the reference RS of QCL-TypeD as the RLM-RS. The UE does not expect that two QCL-TypeDs are configured in one activated TCI state).
RLM RS selection Method 3: The UE does not expect that an aperiodic or semi-persistent RS is selected as the RLM RS.
RLM RS selection Method 4: When Lmax=4, the UE may select NRLM RSs (since Lmax is 4, two RSs may be selected). The selection of the RLM RS is performed from among the reference RSs of the TCI state configured in a control resource set for PDCCH reception, based on the above RLM RS selection Methods 1 to 3, the short period of the search space to which the control resource set is connected is determined as high priority, and the RLM RS selection is performed from the reference RS of the TCI state configured in the control resource set connected to the search space of the shortest period. When there are multiple control resource sets connected to multiple search spaces having the same period, the RLM RS selection is performed from the reference RS of the TCI state configured in a higher control resource set index.

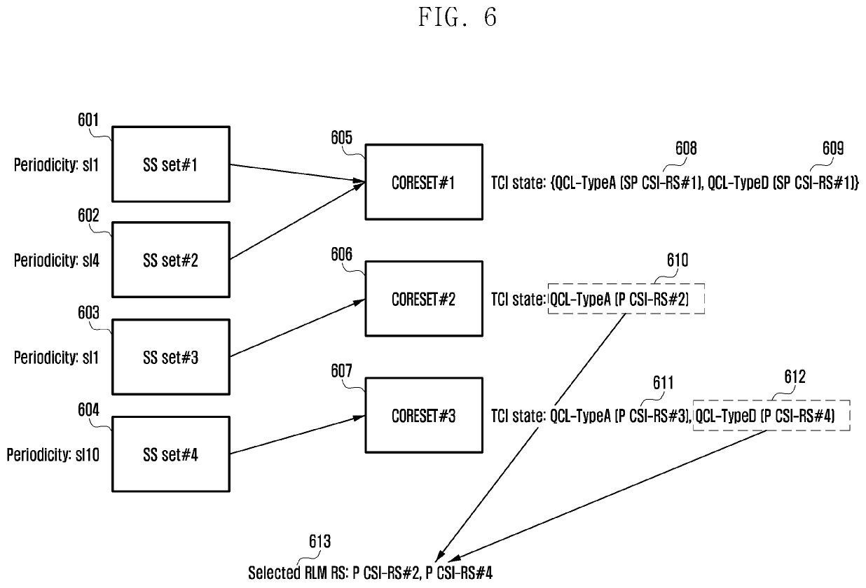

FIG. 6 illustrates an RLM RS selection process according to an embodiment of the disclosure. FIG. 6 illustrates a CORESET #1 605 to a CORESET #3 607 connected to search spaces #1 to #4 601 to 604 having different periods within the activated DL BWP, and the reference RS of the TCI state configured in each CORESET. Based on the RLM RS selection Method 4, the RLM RS selection uses the TCI state configured in the CORESET connected to the search space of the shortest period, but because the search space #1 601 and the search space #3 603 have the same period, the reference RS of the TCI state configured in the CORESET #2 having a higher index between the CORESET #1 605 and the CORESET #2 606 connected to respective search spaces may be used as the highest priority in the RLM RS selection. In addition, because the TCI state configured in the CORESET #2 has only QCL-TypeA, and the reference RS thereof is a periodic RS, the P CSI-RS #2 610 may be first selected as the RLM RS by the RLM RS selection Methods 1 and 3. The reference RS of QCL-TypeD may be a selection candidate by the RLM RS selection Method 2 among the reference RSs of the TCI state configured in the CORESET #1 having the next priority, but the corresponding RS is a semi-persistent RS 609, and thus is not selected as the RLM RS by the RLM RS selection Method 3. Therefore, the reference RSs of the TCI state configured in the CORESET #3 may be considered as the next priority, the reference RS of QCL-TypeD may be a selection candidate by the RLM RS selection Method 2, and because this reference RS is a periodic RS, the P CSI-RS #4 612 may be selected as the second RLM RS by the RLM RS selection Method 3. Therefore, the finally selected RLM RS may be the P CSI-RS #2 and the P CSI-RS #4 (indicated by reference numeral 613).

### PDCCH: Regarding DCI

Next, downlink control information (DCI) in a 5G system will be described in detail.

In a 5G system, scheduling information regarding uplink data (or physical uplink shared channel (PUSCH)) or downlink data (or physical downlink shared channel (PDSCH)) is transferred from a base station to a UE through DCi. The UE may monitor, with regard to the PUSCH or PDSCH, a fallback DCI format and a non-fallback DCI format. The fallback DCI format may include a fixed field predefined between the base station and the UE, and the non-fallback DCI format may include a configurable field.

The DCI may be subjected to channel coding and modulation processes and then transmitted through a physical downlink control channel (PDCCH). A cyclic redundancy check is attached to the DCI message payload, and the CRC may be scrambled by a radio network temporary identifier (RNTI) corresponding to the identity of the UE. Different RNTIs may be used according to the purpose of the DCI message, for example, UE-specific data transmission, power control command, random access response, or the like. That is, the RNTI is not explicitly transmitted, but is transmitted while being included in a CRC calculation process. Upon receiving a DCI message transmitted through the PDCCH, the UE may identify the CRC by using the allocated RNTI. If the CRC identification result is right, the UE may know that the corresponding message has been transmitted to the UE.

For example, DCI for scheduling a PDSCH regarding system information (SI) may be scrambled by an SI-RNTI. DCI for scheduling a PDSCH regarding a random access response (RAR) message may be scrambled by an RA-RNTI. DCI for scheduling a PDSCH regarding a paging message may be scrambled by a P-RNTI. DCI for notifying of a slot format indicator (SFI) may be scrambled by an SFI-RNTI. DCI for notifying of transmit power control (TPC) may be scrambled by a TPC-RNTI. DCI for scheduling a UE-specific PDSCH or PUSCH may be scrambled by a cell RNTI (C-RNTI).

DCI format 0_0 may be used as fallback DCI for scheduling the PUSCH, and the CRC may be scrambled by a C-RNTI. DCI format 0_0 in which the CRC is scrambled by a C-RNTI may include the following pieces of information, for example, in Table 13 below:

TABLE 13
- Identifier for DCI formats - [1] bit
- Frequency domain resource assignment -[┌log₂(N_{RB}^{UL,BWP}(N_{RB}^{UL,BWP} + 1)/2┐] bits
- Time domain resource assignment - X bits
- Frequency hopping flag - 1 bit.
- Modulation and coding scheme - 5 bits
- New data indicator - 1 bit
- Redundancy version - 2 bits
- HARQ process number - 4 bits
- Transmit power control (TPC) command for scheduled PUSCH- [2] bits
- Uplink/supplementary uplink indicator (UL/SUL indicator) - 0 or 1 bit

DCI format 0_I may be used as non-fallback DCI for scheduling the PUSCH, and the CRC may be scrambled by a C-RNTI. DCI format 0_1 in which the CRC is scrambled by a C-RNTI may include the following pieces of information, for example, in Table 14 below:

```
TABLE 14
  Carrier indicator - 0 or 3 bits
  UL/SUL indicator - 0 or 1 bit
  Identifier for DCI formats - [1] bits
  Bandwidth part indicator - 0, 1 or 2 bits
  Frequency domain resource assignment
For resource allocation type 0, ┌N_{RB}^{UL,BWP}/P┐ bits
For resource allocation type 1, ┌log₂(N_{RB}^{UL,BWP}(N_{RB}^{UL,BWP} + 1)/2┐ bits
  Time domain resource assignment -1, 2, 3, or 4 bits
  Virtual resource block-to-physical resource block (VRB-to-PRB)
mapping - 0 or 1 bit, only for resource allocation type 1.
    0 bit if only resource allocation type 0 is configured;
    1 bit otherwise.
  Frequency hopping flag - 0 or 1 bit, only for resource allocation
  type 1.
    0 bit if only resource allocation type 0 is configured;
    1 bit otherwise.
  Modulation and coding scheme - 5 bits
  New data indicator - 1 bit
  Redundancy version - 2 bits
  HARQ process number - 4 bits
  1st downlink assignment index- 1 or 2 bits
    1 bit for semi-static HARQ-ACK codebook;
    2 bits for dynamic HARQ-ACK codebook with single
    HARQ-ACK codebook.
  2nd downlink assignment index - 0 or 2 bits
    2 bits for dynamic HARQ-ACK codebook with two
    HARQ-ACK sub-codebooks;
    0 bit otherwise.
  TPC command for scheduled PUSCH - 2 bits
  $SRS resource indicator - ⌈ {log}_{2} ( {\sum }_{k = 1}^{{L}_{max}} ( \begin{matrix}{N}_{SRS} \\ k\end{matrix} ) ) ⌉ or ⌈ {log}_{2} ( {N}_{SRS} ) ⌉ bits$
    $⌈ {log}_{2} ( {\sum }_{k = 1}^{{L}_{max}} ( \begin{matrix}{N}_{SRS} \\ k\end{matrix} ) ) ⌉ bits for non - codebook based PUSCH$
    transmission;
    ┌log₂(N_{SRS})┐ bits for codebook based PUSCH transmission.
  Precoding information and number of layers-up to 6 bits
  Antenna ports - up to 5 bits
  SRS request - 2 bits
  CSI request - 0, 1, 2, 3, 4, 5, or 6 bits
  Code block group (CBG) transmission information - 0, 2, 4, 6, or 8
  bits
  Phase tracking reference signal (PTRS)-demodulation reference signal
(DMRS) association- 0 or 2 bits.
  beta_offset indicator- 0 or 2 bits
  DMRS sequence initialization- 0 or 1 bit
```

DCI format 1_0 may be used as fallback DCI for scheduling the PDSCH, and the CRC may be scrambled by a C-RNTI. DCI format 1_0 in which the CRC is scrambled by a C-RNTI may include the following pieces of information, for example, in Table 15 below:

TABLE 15
- Identifier for DCI formats - [1] bit
- Frequency domain resource assignment -[┌log₂(N_{RB}^{DL,BWP}(N_{RB}^{DL,BWP} + 1)/2┐] bits
- Time domain resource assignment - X bits
- VRB-to-PRB mapping - 1 bit.
- Modulation and coding scheme - 5 bits
- New data indicator - 1 bit
- Redundancy version - 2 bits
- HARQ process number - 4 bits
- Downlink assignment index - 2 bits
- TPC command for scheduled PUCCH - [2] bits
- Physical uplink control channel (PUCCH) resource indicator- 3 bits
- PDSCH-to-HARQ feedback timing indicator- [3] bits

DCI format 1_I may be used as non-fallback DCI for scheduling the PDSCH, and the CRC may be scrambled by a C-RNTI. DCI format 1_1 in which the CRC is scrambled by a C-RNTI may include the following pieces of information, for example, in Table 16 below:

```
TABLE 16
- Carrier indicator - 0 or 3 bits
- Identifier for DCI formats - [1] bits
- Bandwidth part indicator - 0, 1 or 2 bits
- Frequency domain resource assignment
For resource allocation type 0, ┌N_{RB}^{DL,BWP}/P┐ bits
For resource allocation type 1, ┌log₂(N_{RB}^{DL,BWP}(N_{RB}^{DL,BWP} + 1)/2┐] bits
- Time domain resource assignment -1, 2, 3, or 4 bits
- VRB-to-PRB mapping - 0 or 1 bit, only for resource allocation type 1.
  • 0 bit if only resource allocation type 0 is configured;
  • 1 bit otherwise.
- PRB bundling size indicator - 0 or 1 bit
- Rate matching indicator - 0, 1, or 2 bits
- ZP CSI-RS trigger - 0, 1, or 2 bits
For transport block 1:
- Modulation and coding scheme - 5 bits
- New data indicator - 1 bit
- Redundancy version - 2 bits
For transport block 2:
- Modulation and coding scheme - 5 bits
- New data indicator - 1 bit
- Redundancy version - 2 bits
- HARQ process number - 4 bits
- Downlink assignment index - 0 or 2 or 4 bits
- TPC command for scheduled PUCCH - 2 bits
- PUCCH resource indicator - 3 bits
- PDSCH-to-HARQ feedback timing indicator - 3 bits
- Antenna ports - 4, 5 or 6 bits
- Transmission configuration indication- 0 or 3 bits
- SRS request - 2 bits
- CBG transmission information - 0, 2, 4, 6, or 8 bits
- CBG flushing out information - 0 or 1 bit
- DMRS sequence initialization - 1 bit
```

### PDCCH: CORESET, REG, CCE, Search Space

Hereinafter, a downlink control channel in a 5G communication system will be described in more detail with reference to the accompanying drawings.

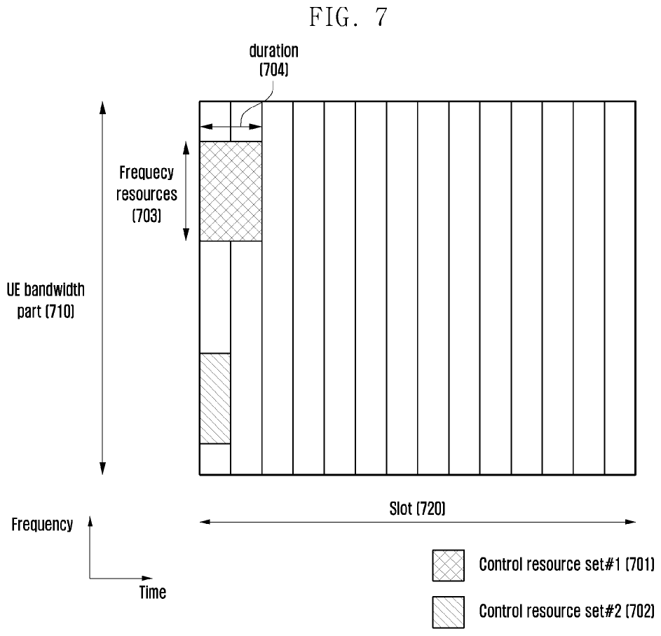

FIG. 7 illustrates an example of a control resource set (CORESET) used to transmit a downlink control channel in a wireless communication system according to an embodiment of the disclosure. FIG. 7 illustrates an example in which a UE bandwidth part 710 is configured along the frequency axis, and two control resource sets (control resource set #1 701 and control resource set #2 702) are configured within one a lot 720 along the time axis. The control resource sets 701 and 702 may be configured in a specific frequency resource 703 within the entire UE bandwidth part 710 along the frequency axis. One or multiple OFDM symbols may be configured along the time axis, and this may be defined as a control resource set duration 704. Referring to the example illustrated in FIG. 7, control resource set #1 701 is configured to have a control resource set duration corresponding to two symbols, and control resource set #2 702 is configured to have a control resource set duration corresponding to one symbol.

A control resource set in 5G described above may be configured for a UE by a base station through upper layer signaling (for example, system information, master information block (MIB), radio resource control (RRC) signaling). The description that a control resource set is configured for a UE means that information such as a control resource set identity, the control resource set's frequency location, and the control resource set's symbol duration is provided. For example, the control resource set may include the following pieces of information in Table 17 below:

TABLE 17

| | |
|---|---|
| ControlResourceSet ::= | SEQUENCE { |

```
      -- Corresponds to L1 parameter ‘CORESET-ID’
      controlResourceSetId
      ControlResourceSetId,
  (control resource set identity))
```

| | |
|---|---|
| frequencyDomainResources | BIT |

```
STRING (SIZE (45)),
  (frequency domain resource assignment information)
      duration
      INTEGER (1..maxCoReSetDuration),
  (time domain resource assignment information)
      cce-REG-MappingType
      CHOICE {
  (CCE-to-REG mapping type)
```

interleaved
SEQUENCE {
reg-BundleSize
ENUMERATED {n2, n3, n6},

(REG bundle size)

```
  precoderGranularity
ENUMERATED {sameAsREG-bundle, allContiguousRBs},
  interleaverSize
ENUMERATED {n2, n3, n6}
  (interleaver size)
  shiftIndex
  INTEGER(0..maxNrofPhysicalResourceBlocks-1)
```

OPTIONAL

(interleaver shift)

```
    },
      nonInterleaved
      NULL
      },
      tci-StatesPDCCH
      SEQUENCE(SIZE (1..maxNrofTCI-StatesPDCCH)) OF TCI-StateId
```

OPTIONAL,

```
  (QCL configuration information)
      tci-PresentInDCI
      ENUMERATED {enabled}
```

| | |
|---|---|
| OPTIONAL, | -- Need S |

}

In Table 17, tci-StatesPDCCH (simply referred to as transmission configuration indication (TCI) state) configuration information may include information of one or multiple synchronization signal (SS)/physical broadcast channel (PBCH) block index or channel state information reference signal (CSI-RS) index, which is quasi-co-located with a DMRS transmitted in a corresponding control resource set.

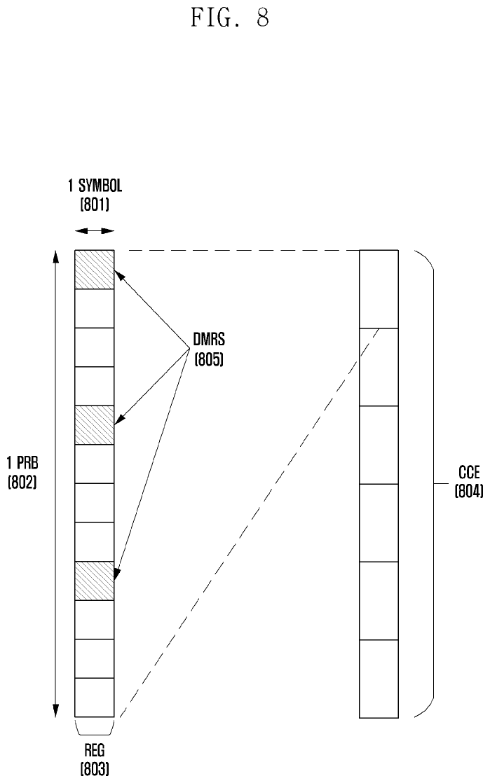

FIG. 8 illustrates an example of the basic unit of time and frequency resources constituting a downlink control channel in a wireless communication system according to an embodiment of the disclosure. According to FIG. 8, the basic unit of time and frequency resources constituting a control channel may be referred to as a resource element group (REG) 803, and the REG 803 may be defined by one OFDM symbol 801 along the time axis and one physical resource block (PRB) 802 (that is, 12 subcarriers) along the frequency axis. The base station may constitute a downlink control channel allocation unit by connecting REGs 803.

Provided that the basic unit of downlink control channel allocation in 5G is a control channel element 804 as illustrated in FIG. 8, one CCE 804 may include multiple REGs 803. To describe the REG 803 illustrated in FIG. 8, for example, the REG 803 may include 12 REs, and if one CCE 804 includes six REGs 803, one CCE 804 may then include 72 REs. A downlink control resource set, once configured, may include multiple CCEs 804, and a specific downlink control channel may be mapped to one or multiple CCEs 804 and then transmitted according to the aggregation level (AL) in the control resource set. The CCEs 804 in the control resource set are distinguished by numbers, and the numbers of CCEs 804 may be allocated according to a logical mapping scheme.

The basic unit of the downlink control channel illustrated in FIG. 8, that is, the REG 803 may include both REs to which DCI is mapped, and an area to which a reference signal (DMRS 805) for decoding the same is mapped. As in FIG. 8, three DRMSs 805 may be transmitted inside one REG 803. The number of CCEs necessary to transmit a PDCCH may be 1, 2, 4, 8, or 16 according to the aggregation level (AL), and different number of CCEs may be used to implement link adaption of the downlink control channel. For example, in the case of AL=L, one downlink control channel may be transmitted through L CCEs. The UE needs to detect a signal while being no information regarding the downlink control channel, and a search space indicating a set of CCEs has thus been defined for blind decoding. The search space is a set of downlink control channel candidates including CCEs which the UE needs to attempt to decode at a given AL. Since 1, 2, 4, 8, or 16 CCEs constitute a bundle at various ALs, the UE may have multiple search spaces. A search space set may be defined as a set of search spaces at all configured ALs.

Search spaces may be classified into common search spaces and UE-specific search spaces. A group of UEs or all UEs may investigate a common search space of the PDCCH in order to receive cell-common control information such as a paging message or dynamic scheduling regarding system information. For example, PDSCH scheduling allocation information for transmitting an SIB including a cell operator information or the like may be received by investigating the common search space of the PDCCH. In the case of a common search space, a group of UEs or all UEs need to receive the PDCCH, and the same may thus be defined as a pre-promised set of CCEs. Scheduling allocation information regarding a UE-specific PDSCH or PUSCH may be received by investigating the UE-specific search space of the PDCCH. The UE-specific search space may be defined UE-specifically as a function of various system parameters and the UE's identity.

In 5G, a parameter regarding a search parameter regarding a PDCCH may be configured for the UE by the base station through upper layer signaling (for example, SIB, MIB, RRC signaling). For example, the base station may provide the UE with configurations such as the number of PDCCH candidates at each aggregation level L, the monitoring cycle regarding the search space, the monitoring occasion with regard to each symbol in a slot regarding the search space, the search space type (common search space or UE-specific search space), a combination of an RNTI and a DCI format to be monitored in the corresponding search space, a control resource set index for monitoring the search space, and the like. For example, the parameter may include the following pieces of information in Table 18 below:

TABLE 18

| | |
|---|---|
| SearchSpace ::= | SEQUENCE { |

```
    -- Identity of the search space. SearchSpaceId = 0 identifies the SearchSpace
configured via PBCH (MIB) or ServingCellConfigCommon.
    searchSpaceId
    SearchSpaceId,
  (search space identity)
    controlResourceSetId
    ControlResourceSetId,
  (control resource set identity)
```

| | |
|---|---|
| monitoringSlotPeriodicityAndOffset | CHOICE { |

```
  (monitoring slot level cycle)
      sl1
        NULL,
      sl2
        INTEGER (0..1),
      sl4
        INTEGER (0..3),
      sl5
        INTEGER (0..4),
      sl8
        INTEGER (0..7),
      sl10
      INTEGER (0..9),
      sl16
      INTEGER (0..15),
      sl20
      INTEGER (0..19)
    }
        OPTIONAL,
```

| | |
|---|---|
| duration(monitoring duration) | INTEGER (2..2559) |
| monitoringSymbolsWithinSlot | BIT |

STRING (SIZE (14))

OPTIONAL,

```
  (monitoirng symbols within slot)
    nrofCandidates
    SEQUENCE {
  (number of PDCCH candidates per aggregation level)
      aggregationLevel1
    ENUMERATED {n0, n1, n2, n3, n4, n5, n6, n8},
      aggregationLevel2
    ENUMERATED {n0, n1, n2, n3, n4, n5, n6, n8},
      aggregationLevel4
    ENUMERATED {n0, n1, n2, n3, n4, n5, n6, n8},
      aggregationLevel8
    ENUMERATED {n0, n1, n2, n3, n4, n5, n6, n8},
      aggregationLevel16
    ENUMERATED {n0, n1, n2, n3, n4, n5, n6, n8}
    },
    searchSpaceType
    CHOICE {
    (search space type)
      -- Configures this search space as common search space (CSS) and
DCI formats to monitor.
      common
      SEQUENCE {
    (common search space)
    }
      ue-Specific
      SEQUENCE {
    (UE-specific search space)
        -- Indicates whether the UE monitors in this USS for DCI
formats 0-0 and 1-0 or for formats 0-1 and 1-1.
        formats
        ENUMERATED {formats0-0-And-1-0, formats0-1-And-1-
1},
        ...
      }
```

According to configuration information, the base station may configure one or multiple search space sets for the UE. According to some embodiments, the base station may configure search space set 1 and search space set 2 for the UE, may configure DCI format A scrambled by an a X-RNTI to be monitored in a common search space in search space set 1, and may configure DCI format B scrambled by a Y-RNTI to be monitored in a UE-specific search space in search space set 2.

According to configuration information, one or multiple search space sets may exist in a common search space or a UE-specific search space. For example, search space set #1 and search space set #2 may be configured as a common search space, and search space set #3 and search space set #4 may be configured as a UE-specific search space.

Combinations of DCI formats and RNTIs given below may be monitored in a common search space. The example given below is not limiting.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

Combinations of DCI formats and RNTIs given below may be monitored in a UE-specific search space. The example given below is not limiting.
DCI format 1_0/1_1 with CRC scrambled by C-RNTI, CS-RNTI, TC-RNTI

Enumerated RNTIs may follow the definition and usage given below:
Cell RNTI (C-RNTI): used to schedule a UE-specific PDSCH
Temporary cell RNTI (TC-RNTI): used to schedule a UE-specific PDSCH
Configured scheduling RNTI (CS-RNTI): used to schedule a semi-statically configured UE-specific PDSCH
Random access RNTI (RA-RNTI): used to schedule a PDSCH in a random access step
Paging RNTI (P-RNTI): used to schedule a PDSCH in which paging is transmitted
System information RNTI (SI-RNTI): used to schedule a PDSCH in which system information is transmitted
Interruption RNTI (INT-RNTI): used to indicate whether a PDSCH is punctured
Transmit power control for PUSCH RNTI (TPC-PUSCH-RNTI): used to indicate a power control command regarding a PUSCH
Transmit power control for PUCCH RNTI (TPC-PUCCH-RNTI): used to indicate a power control command regarding a PUCCHTransmit power control for SRS RNTI (TPC-SRS-RNTI): used to indicate a power control command regarding an SRS

The DCI formats enumerated above may follow the definitions given below in Table 19:

TABLE 19

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the |
| | slot format |
| 2_1 | Notifying a group of UEs of the |
| | PRB(s) and OFDM symbol(s) where |
| | UE may assume no transmission |
| | is intended for the UE |
| 2_2 | Transmission of TPC commands |
| | for PUCCH and PUSCH |
| 2_3 | Transmission of a group of TPC |
| | commands for SRS transmissions |
| | by one or more UEs |

In 5G, the search space at aggregation level L in connection with control resource set p and search space set s may be expressed by Equation 1 below:

$$L \cdot \{ ( {Y}_{p , {n}_{s , f}^{μ}} + ⌊ \frac{{m}_{s , {n}_{CI}} \cdot {N}_{C C E , p}}{L \cdot {M}_{s , max}^{( L )}} ⌋ + {n}_{CI} ) mod ⌊ \frac{{N}_{C C E , p}}{L} ⌋ \} + i \qquad ( 1 )$$

L: aggregation level
n_{CI}: carrier index
N_{CCE,p}: total number of CCEs existing in control resource set p
n_{s,f}^{μ}: slot index
M_{s,max}^{(L)}: number of PDCCH candidates at aggregation level L
m_{s,n}_{_{CI}}=0, . . . , M_{s,max}^{(L)}−1: PDCCH candidate index at aggregation level L
i=0, . . . , L−1

$${Y}_{p , {n}_{s , f}^{μ}} = ( {A}_{p} \cdot {Y}_{p , {n}_{s , f}^{μ} - 1} ) mod D ,$$

Y_{p,-1}=n_{RNTI}≠0, Aₚ=39827 for p mod 3=0, Aₚ=39829 for p mod 3=1, Aₚ=39839 for p mod 3=2, D=65537
n_{RNTI}: UE identity

The

$${Y}_{p , {n}_{s , f}^{μ}}$$

value may correspond to 0 in the case of a common search space.

The

$${Y}_{p , {n}_{s , f}^{μ}}$$

value may correspond to a value changed by the UE's identity (C-RNTI or ID configured for the UE by the base station) and the time index in the case of a UE-specific search space.

In 5G, multiple search space sets may be configured by different parameters (for example, parameters in Table 9), and the group of search space sets monitored by the UE at each timepoint may differ. For example, if search space set #1 is configured at by X-slot cycle, if search space set #2 is configured at by Y-slot cycle, and if X and Y are different, the UE may monitor search space set #1 and search space set #2 both in a specific slot, and may monitor one of search space set #1 and search space set #2 both in another specific slot.

### PDCCH: Regarding TCI State

Specific TCI state combinations applicable to a PDCCH DMRS antenna port are given in Table 20 below. The fourth row in Table 20 corresponds to a combination assumed by the UE before RRC configuration, and no configuration is possible after the RRC.

TABLE 20

| | | | DL RS 2 | qcl-Type2 |
|---|---|---|---|---|
| Valid TCI state | DL | qcl- | (if | (if |
| Configuration | RS 1 | Type1 | configured) | configured) |
| 1 | TRS | QCL-TypeA | TRS | QCL-TypeD |
| 2 | TRS | QCL-TypeA | CSI-RS | QCL-TypeD |
| | | | (BM) | |
| 3 | CSI-RS | QCL-TypeA | | |
| | (CSI) | | | |
| 4 | SS/PBCH | QCL-TypeA | SS/PBCH | QCL-TypeD |
| | Block | | Block | |

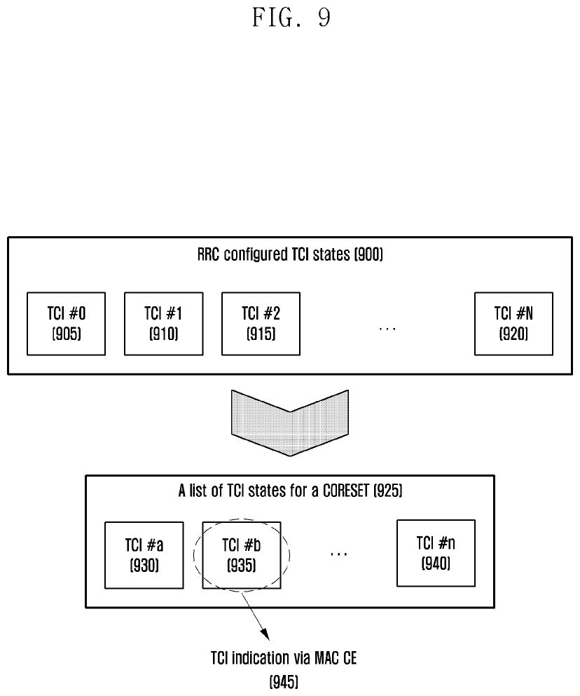

In NR, a hierarchical signaling method as illustrated in FIG. 9 is supported for dynamic allocation regarding a PDCCH beam. FIG. 9 illustrates an example of a method for TCI state allocation for a PDCCH in a wireless communication system according to an embodiment of the disclosure. Referring to FIG. 9, the base station may configure N TCI states 905, 910, . . . , 920 for the UE through RRC signaling 900, and may configure some thereof as TCI states for a CORESET (925). The base station may then indicate one of the TCI states 930, 935, and 940 for the CORESET to the UE through MAC CE signaling (945). The UE then receives a PDCCH, based on beam information included in the TCI state indicated by the MAC CE signaling.

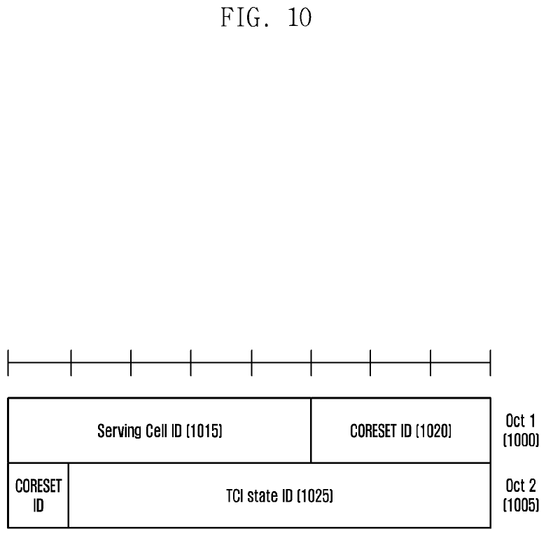

FIG. 10 illustrates a TCI indication MAC CE signaling structure for the PDCCH DMRS in a wireless communication system according to an embodiment of the disclosure. Referring to FIG. 10, the TCI indication MAC CE signaling for the PDCCH DMRS is configured by 2 bytes (16 bits), and includes a 5-bit serving cell ID 1015, a 4-bit CORESET ID 1020, and a 7-bit TCI state ID 1025.

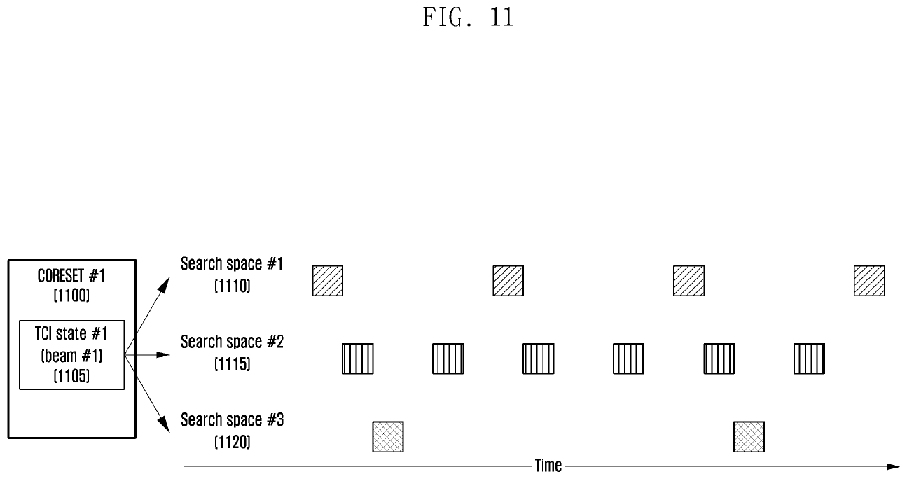

FIG. 11 illustrates a control resource set (CORESET) and beam configuration example of search spaces according to an embodiment of the disclosure. Referring to FIG. 11, the base station may indicate one of TCI state lists included in CORESET 1100 configuration through MAC CE signaling (1105). Until a different TCI state is indicated for the corresponding CORESET through different MAC CE signaling, the UE considers that identical QCL information (beam #1) 1005 is all applied to one or more search spaces 1110, 1115, and 1120 connected to the CORESET. The above-described PDCCH beam allocation method has a problem in that it is difficult to indicate a beam change faster than MAC CE signaling delay, and the same beam is unilaterally applied to each CORESET regardless of search space characteristics, thereby making flexible PDCCH beam operation difficult. Following embodiments of the disclosure provide more flexible PDCCH beam configuration and operation methods. Although multiple distinctive examples will be provided for convenience of description of embodiments of the disclosure, they are not mutually exclusive, and can be combined and applied appropriately for each situation.

The base station may configure one or multiple TCI states for the UE with regard to a specific control resource set, and may activate one of the configured TCI states through a MAC CE activation command. For example, if {TCI state #0, TCI state #1, TCI state #2} are configured as TCI states for control resource set #1, the base station may transmit an activation command to the UE through a MAC CE such that TCI state #0 is assumed as the TCI state regarding control resource set #1. Based on the activation command regarding the TCI state received through the MAC CE, the UE may correctly receive the DMRS of the corresponding control resource set, based on QCL information in the activated TCI state.

With regard to a control resource set having a configured index of 0 (control resource set #0), if the UE has failed to receive a MAC CE activation command regarding the TCI state of control resource set #0, the UE may assume that the DMRS transmitted in control resource set #0 has been QCL-ed with a SS/PBCH block identified in the initial access process, or in a non-contention-based random access process not triggered by a PDCCH command.

With regard to a control resource set having a configured index value other than 0 (control resource set #X), if the UE has no TCI state configured regarding control resource set #X, or if the UE has one or more TCI states configured therefor but has failed to receive a MAC CE activation command for activating one thereof, the UE may assume that the DMRS transmitted in control resource set #X has been QCL-ed with a SS/PBCH block identified in the initial access process.

### Regarding UE Capability Report

In LTE and NR, a UE may perform a procedure in which, while being connected to a serving base station, the UE reports capability supported by the UE to the corresponding base station. This will be referred to as a UE capability report in the following description.

The base station may transfer a UE capability enquiry message to the UE in a connected state so as to request a capability report. The message may include a UE capability request with regard to each radio access technology (RAT) type of the base station. The RAT type-specific request may include supported frequency band combination information and the like. In addition, in the case of the UE capability enquiry message, UE capability with regard to multiple RAT types may be requested through one RRC message container transmitted by the base station, or the base station may transfer a UE capability enquiry message including multiple UE capability requests with regard to respective RAT types. That is, multiple capability enquiries may be included in one message, and may configure a UE capability information message corresponding thereto and report the same multiple times. In next-generation mobile communication systems, a UE capability request may be made regarding multi-RAT dual connectivity (MR-DC), such as NR, LTE, E-UTRA—NR dual connectivity (EN-DC). In addition, the UE capability enquiry message is transmitted initially after the UE is connected to the base station, in general, but may be requested in any condition if needed by the base station.

Upon receiving the UE capability report request from the base station in the above step, the UE configures UE capability according to band information and RAT type as may be required by the base station. The method in which the UE configures UE capability in an NR system is summarized below:
1. If the UE receives a list regarding LTE and/or NR bands from the base station at a UE capability request, the UE constructs band combinations (BCs) regarding EN-DC and NR standalone (SA). That is, the UE configures a candidate list of BCs regarding EN-DC and NR SA, based on bands received from the base station at a request through FreqBandList. In addition, bands have priority in the order described in FreqBandList.
2. If the base station has set “eutra-nr-only” flag or “eutra” flag and requested a UE capability report, the UE removes everything related to NR SA BCs from the configured BC candidate list. Such an operation may occur only if an LTE base station (eNB) requests “eutra” capability.
3. The UE then remove fallback BCs from the BC candidate list configured in the above step. As used herein, a fallback BC refers to a BC that can be obtained by removing a band corresponding to at least one SCell from a specific BC, and since a BC before removal of the band corresponding to at least one SCell can already cover a fallback BC, the same can be omitted. This step is applied in MR-DC as well, that is, LTE bands are also applied. BCs remaining after this step constitute the final “candidate BC list”.
4. The UE selects BCs appropriate for the requested RAT type from the final “candidate BC list” and selects BCs to report. In this step, the UE configures supportedBandCombinationList in a determined order. That is, the UE configures BCs and UE capability to report according to a preconfigured rat-Type order (nr→eutra-nr→eutra). In addition, the UE configures featureSetCombination regarding the configured supportedBandCombinationList and configures a list of “candidate feature set combinations” from a candidate BC list from which a list regarding fallback BCs (including capability of the same or lower step) is removed. The “candidate feature set combinations” include all feature set combinations regarding NR and EUTRA-NR BCs, and are obtainable from feature set combinations of containers of UE-NR-Capabilities and UE-MRDC-Capabilities.

5. In addition, if the requested RAT type is eutra-nr and has an influence, featureSetCombinations is included on both containers of UE-MRDC-Capabilities and UE-NR-Capabilities. However, the feature set of NR is included only in UE-NR-Capabilities.

After the UE capability is configured, the UE transfers a UE capability information message including the UE capability to the base station. The base stations performs scheduling and transmission/reception management appropriate for the UE, based on the UE capability received from the UE.

### Rel-15 PCell BFR

Next, a beam failure recovery operation within a primary cell (PCell) is described in detail. To enable smooth downlink transmission between a base station and a UE, the UE should be able to normally receive a PDCCH transmitted by the base station. A case in which the UE is unable to receive the PDCCH normally may signify that a beam failure has occurred between the base station and the UE. The criteria and method for determining whether a UE can receive the PDCCH normally will be described later. The NR system supports a beam failure recovery (BFR) procedure to enable smooth downlink transmission by dealing with dynamic beam failures between the base station and the UE.

The BFR procedure in the NR system may be categorized into four main processes as follows:
Beam failure detection process;
New candidate beam identification process;
Beam failure recovery request process; and
gNB response reception process.

The first process is to detect a beam failure, which will be described later as a beam failure detection (BFD) process. In the BFD process, the UE determines whether a PDCCH can be received normally, and when the UE determines that the PDCCH is unable to be received normally, the UE reports a beam failure to a higher layer. The higher layer of the UE may detect the beam failure by the report and determine whether to perform the next process of the BFR.

The criterion for determining whether a UE can receive the PDCCH normally is a hypothetical PDCCH reception block error rate (BLER) of the UE, and the determination can be made by comparing the BLER with a predetermined threshold. In order to calculate the hypothetical PDCCH reception BLER of a UE, a set of reference signals (RS) for BFD may be required, which will be described as a BFD-RS set.

The BFD-RS set may include up to two RSs, which may be either periodic CSI-RSs transmitted through a single port or synchronous/broadcast channel blocks (SS/PBCH blocks, SSB). The BFD-RS set may be established through higher layer signaling of a base station. When the BFD-RS set is not established through higher layer signaling, the BFD-RS set may include some or all of the RSs referenced in the activated TCI state of the CORESET(s) established for PDCCH monitoring of the UE. When there is two or more RS referenced in the TCI state, RSs referenced for “QCL-typeD” including beam information may be included in the BFD-RS set. The UE may calculate a hypothetical PDCCH reception BLER based only on the RSs referenced in the activated TCI state of the CORESET(s) configured for PDCCH monitoring among the RSs included in the BFD-RS set. The UE may calculate the hypothetical PDCCH reception BLER by referring to Table 21 below.

TABLE 21

| Attribute | Value for BLER |
|---|---|
| DCI format | 1-0 |
| Number of control | Same as the number of |
| OFDM symbols | symbols of CORESET QCLed |
| | with respective CSI-RS for BFD |
| Aggregation level (CCE) | 8 |
| Ratio of hypothetical | 0 dB |
| PDCCH RE energy to | |
| average CSI-RS RE energy | |
| Ratio of hypothetical | 0 dB |
| PDCC DMRS energy to | |
| average CSI-RS RE energy | |
| Bandwidth (MHz) | Same as the number of PRBs of |
| | CORESET QCLed with respective |
| | CSI-RS for BFD |
| Sub-carrier | Same as the SCS of CORESET QCLed |
| spacing (kHz) | with respective CSI-RS for BFD |
| DMRS precoder | REG bundle size |
| granularity | |
| REG bundle size | 6 |
| CP length | Same as the CP length of CORESET |
| | QCLed with respective |
| | CSI-RS for BFD |
| Mapping from | Distributed |
| REG to CCE | |

Table 21 provides a configuration for the virtual PDCCH that the UE references when calculating the virtual PDCCH reception BLER. Referring to Table 21, the UE may calculate the hypothetical PDCCH reception BLER assuming the number of OFDM symbols, bandwidth, subcarrier spacing, and cyclic prefix (CP) length of the CORESET(s) having the activated TCI state referring to RSs included in the BFD-RS set.

The UE calculates the hypothetical PDCCH reception BLER for all CORESETs having activated TCI states referring to RSs included in the BFD-RS set, and reports a beam failure indication to a higher layer when the hypothetical PDCCH reception BLER value for all BFD-RSs exceeds a configured threshold. When the higher layer of the UE receives the beam failure indication report, the UE increases a beam failure instance count, and when a count value reaches a configured maximum value, the UE may determine whether to perform the next process of BFR, and refer to the following parameters configured for the higher layer operation process:
beamFailureInstanceMaxCount: The maximum number of beam failure indication reports of a UE lower layer that may be required to perform the next process of BFR.
beamFailureDetectionTimer: Timer configuration for initializing the number of beam failure reports of a UE.

The second process of the BFR procedure in the NR system is to find a new beam with good channel conditions, which will be described later as a new candidate beam identification process. When the higher layer of the UE detects a beam failure and determines to proceed with the process of finding a new beam, the higher layer of the UE may request the physical layer of the UE to report information about the new candidate beam, such as reference signal received power (L1-RSRP). To enable the UE to calculate information about the new candidate beam, the base station may establish a set of candidate beam RSs to the UE through higher layer signaling. The candidate beam RS set may include up to 16 RSs, and the corresponding RS may be periodic CSI-RS or SSB. When the higher layer of the UE requests the UE to report information about a new candidate beam, the UE reports index information and L1-RSRP measurement value for RS, which has an L1-RSRP value greater than the RSRP threshold configured through higher layer signaling, among RSs included in the candidate beam RS set. When the RS is a CSI-RS, the UE may consider a value obtained by applying powerControlOffsetSS, which is higher layer signaling, to the received power of the CSI-RS, as the final L1-RSRP measurement and compare the value with the RSRP threshold. The higher layer of the UE may obtain information about new beams with good channel conditions through reporting of the candidate beam RS from the physical layer of the UE.

Not in a DRX mode, when the state of the radio link for all BFD RSs is below the RSRP threshold, the physical layer of the UE may indicate BFD information to the higher layers of the UE, and a period of the BFD information indication may be determined by the shorter time among the shortest transmission period of the SSB or periodic CSI-RS transmitted by PCell or PSCell and 2 ms. In case of DRX mode, the physical layer of the UE may perform BFD information indications to the higher layer of the UE according to a period defined in the TS38.133 standard.

If the higher layer of the UE receives information about new beams with good channel conditions above the RSRP limit from a physical layer of the UE, the higher layer of the UE selects one of the new beams with good channel conditions above the RSRP limit and notifies the physical layer of the same, and the UE transmits a request signal for BFR to the base station. This is the third process of the BFR process, which will be described later as the BFR request process. Based on the information about the new beam, the higher layer of the UE selects a new RS from the set of candidate beam RSs to be referenced by the UE for the BFR request and notifies the physical layer of the same. Based on the new RS information for the BFR request and the BFR request resource information established through higher layer signaling, the UE may obtain configuration information for a physical random access channel (PRACH) transmission for sending the BFR request. For example, the base station and the UE may exchange higher layer signaling information, such as the following shown in Table 22, in order to transfer the configuration information for the PRACH transmission for sending the BFR request.

TABLE 22
BeamFailureRecoveryConfig information element
-- ASN1START
-- TAG-BEAMFAILURERECOVERYCONFIG-START

| BeamFailureRecoveryConfig ::= | SEQUENCE { | |
|---|---|---|
| rootSequenceIndex-BFR | INTEGER (0..137) | OPTIONAL, |

-- Need M

| | | |
|---|---|---|
| rach-ConfigBFR | RACH-ConfigGeneric | OPTIONAL, |

-- Need M

| | | |
|---|---|---|
| rsrp-ThresholdSSB | RSRP-Range | OPTIONAL, |

-- Need M

| candidateBeamRSList | SEQUENCE (SIZE(1..maxNrofCandidateBeams)) OF | |
|---|---|---|
| PRACH-ResourceDedicatedBFR | OPTIONAL, -- Need M | |
| ssb-perRACH-Occasion | ENUMERATED {oneEighth, oneFourth, oneHalf, one, two, | |
| | four, eight, sixteen} | OPTIONAL, -- Need |

M

| | | |
|---|---|---|
| ra-ssb-OccasionMaskIndex | INTEGER (0..15) | OPTIONAL, |

-- Need M

| | | |
|---|---|---|
| recoverySearchSpaceId | SearchSpaceId | OPTIONAL, |

-- Need R

| | | |
|---|---|---|
| ra-Prioritization | RA-Prioritization | OPTIONAL, - |

- Need R

| | |
|---|---|
| beamFailureRecoveryTimer | ENUMERATED {ms10, ms20, ms40, ms60, ms80, ms100, |
| ms150, ms200} | OPTIONAL, -- Need M |

```
  ...,
  [[
```

| | | |
|---|---|---|
| msg1-SubcarrierSpacing-v1530 | SubcarrierSpacing | OPTIONAL |

-- Need M
]]
}

| | |
|---|---|
| PRACH-ResourceDedicatedBFR ::= | CHOICE { |
| ssb | BFR-SSB-Resource, |
| csi-RS | BFR-CSIRS-Resource |

}

| | |
|---|---|
| BFR-SSB-Resource ::= | SEQUENCE { |
| ssb | SSB-Index, |
| ra-PreambleIndex | INTEGER (0..63), |

...
}

| BFR-CSIRS-Resource ::= | SEQUENCE { | |
|---|---|---|
| csi-RS | NZP-CSI-RS-ResourceId, | |
| ra-OccasionList | SEQUENCE (SIZE(1..maxRA-OccasionsPerCSIRS)) OF | |
| INTEGER (0..maxRA-Occasions-1) | OPTIONAL, -- Need R | |
| ra-PreambleIndex | INTEGER (0..63) | OPTIONAL, |

-- Need R
...
}
-- TAG-BEAMFAILURERECOVERYCONFIG-STOP
-- ASN1STOP

Higher layer Signaling Information BeamFailureRecoveryConfig includes information about PRACH transmission for sending the BFR request. The information included in the BeamFailureRecoveryConfig may have the following meanings. In other words, the BeamFailureRecoveryConfig may include the following information:
rootSequenceIndex-BFR: Root sequence index of the sequence used for PRACH transmission.
rach-ConfigBFR: PRACH configuration index, number of frequency resources, frequency resource start point, response monitoring window, and parameters for adjusting the strength of PRACH transmissions, among parameters for PRACH transmissions, are included.
rsrp-ThresholdSSB: RSRP threshold for which RSs in a candidate beam RS set can be selected as a new beam.
candidateBeamRSList: A set of candidate beam RSs.
ssb-perRACH-Occasion: Number of SSBs connected to a random access channel (RACH) transmission occasion.
ra-ssb-OccasionMaskIndex: PRACH mask index for random access resource selection of the UE.
recoverySearchSpaceId: Search space index for receiving PDCCHs used for random access response (RAR) signal transmission of a base station in response to a BFR request.
ra-Prioritization: A set of parameters used for the random access process with priority
beamFailureRecoveryTimer: A timer for initializing configuration for the PRACH resource to send a BFR request.
msgl-SubcarrierSpacing-v1530: Subcarrier spacing for PRACH transmissions to send a BFR request.

The UE may transmit a BFR request signal to the base station by referring to the configuration information for the PRACH transmission for sending the BFR request. The UE may be configured with a PRACH resource connected to each candidate beam RS through PRACH-ResourceDedicatedBFR, which is higher layer signaling, as shown in Table 22 above.

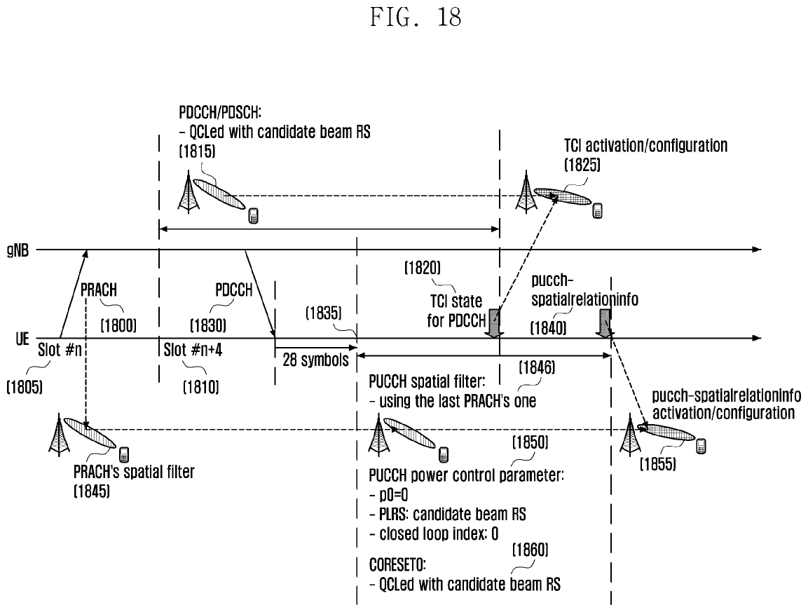

The fourth process of the BFR procedure in the NR system is the process in which the base station having received the BFR request signal from the UE sends a response signal to the UE, which will be described later as a gNB response process. This process may be described using FIG. 18.

FIG. 18 illustrates a response process of a base station with respect to a BFR request signal from a UE in a PCell BFR operation according to an embodiment of the disclosure. In order to response to the BFRQ signal from the UE, a base station may transmit a PDCCH by using resources of a search space established by higher layer signaling to the UE. Among the higher layer signaling-based configuration parameters for the base station response process and BFRQ configured for the UE, BeamFailureRecoveryConfig, which is the above-mentioned signaling information, includes the recoverySearchSpaceId, which is a search space index for receiving a PDCCH used for transmitting a random access response signal of the base station according to the BFR request. When PRACH transmission 18-00 associated with a candidate beam RS selected by the UE has been performed in an n-th slot (indicated by reference numeral 18-05), the UE may monitor a PDCCH including a CRC scrambled by a C-RNTI or MCS-C-RNTI from a (n+4)th slot 18-10 in a search space having the recoverySearchSpaceId. Upon monitoring the PDCCH in the search space having the recoverySearchSpaceId and receiving a PDSCH scheduled via the corresponding PDCCH, the UE may assume that DMRSs of the PDSCH and the PDCCH have the same quasi-co-location (QCL) parameters as those of a candidate beam RS corresponding to a PRACH transmitted by the UE (indicated by reference numeral 18-15). In other words, the UE may assume that, during reception of the corresponding PDCCH and PDSCH, channel parameters used to receive the candidate beam RS corresponding to the PRACH transmitted by the UE are used. Until the UE receives an activation for a TCI state from the higher layer of the UE, or receives tci-StatesPDCCH-ToAddList or tci-StatesPDCCH-ToReleaseList, which is higher layer signaling, or both signaling (indicated by reference numeral 18-20), it is possible to apply an assumption that, during reception of the PDCCH and PDSCH, the UE has the same channel parameter as that of the candidate beam RS reception. After the UE receives an activation of the TCI state from the higher layer of the UE, or receives tci-StatesPDCCH-ToAddList or tci-StatesPDCCH-ToReleaseList, which is higher layer signaling, or both signaling, the UE may utilize the changed TCI state upon reception of the PDCCH (indicated by reference numeral 18-25). After the UE receives a PDCCH containing a CRC scrambled by a C-RNTI or MCS-C-RNTI in a search space with recoverySearchSpaceId, but before the UE receives a MAC-CE for TCI state activation or receives tci-StatesPDCCH-ToAddList or tci-StatesPDCCH-ToReleaseList, which is higher layer signaling, the UE may perform monitoring of PDCCH candidates in a search space with recovery SearchSpaceId.

For the PCell or PSCell, after 28 symbols from a last symbol of a first PDCCH reception 18-30 including a CRC scrambled by a C-RNTI or MCS-C-RNTI in a search space with recoverySearchSpaceId (indicated by reference numeral 18-35), until the UE receives a MAC-CE for PUCCH-SpatialRelationInfo activation or until the UE receives PUCCH-SpatialRelationInfo, which is higher layer signaling for a specific PUCCH resource (indicated by reference numeral 18-40), the UE may use, at the time of transmitting a PUCCH in the same cell, the same spatial filter 18-45 as that of the last transmitted PRACH (indicated by reference numeral 18-46), may use p0 of index 0 as a power control parameter, may use a candidate beam RS used in the BFRQ above as a pathloss reference signal, and may use a power control closed loop index of 0 (indicated by reference numeral 18-50). After the UE receives a MAC-CE for PUCCH-SpatialRelationInfo activation, or receives PUCCH-SpatialRelationInfo, which is higher layer signaling, for a specific PUCCH resource, the UE may use the spatial filter and power control parameters based on the changed PUCCH-SpatialRelationInfo during the PUCCH transmission (indicated by reference numeral 18-55).

For the PCell or PSCell, after 28 symbols from a last symbol of a first PDCCH reception including a CRC scrambled by a C-RNTI or MCS-C-RNTI in a search space with recoverySearchSpaceId (indicated by reference numeral 18-35), it is possible to apply an assumption that, during monitoring of the PDCCH in CORESET #0, the UE has the same QCL parameter as that of the candidate beam RS reception (indicated by reference numeral 18-60).

When the UE is configured with TCI-State_r17, which is higher layer signaling having a meaning that the UE operates in a unified TCI method, in a PCell or PSCell, the UE may perform the following operations after 28 symbols from a last symbol of a first PDCCH reception including a CRC scrambled by a C-RNTI or MCS-C-RNTI in a search space with recoverySearchSpaceId.
In case that SSB-MTC-AdditionalPCI, which is higher layer signaling, is not configured for the UE, it is possible to apply an assumption that, during monitoring of all control resource sets, PDSCH reception, and reception of aperiodic CSI-RS resources, the UE has the same QCL parameter as that of the candidate beam RS reception. In this case, the aperiodic CSI-RS resource may be applied with a dynamically indicated unified TCI state and thus may be included in a set of CSI-RS resources that can be received in the same TCI state as that of the PDCCH and PDSCH.
When transmitting PUSCH, PUCCH, and SRS, the UE may use a spatial domain filter used for a last transmitted PRACH. In this case, the SRS may be applied with a dynamically indicated unified TCI state and thus may be transmitted through the same spatial domain filter as that of the PUSCH and PUCCH. Power control parameters used during transmission of PUSCH, PUCCH, and SRS of the UE may be based on details in the following:
   A pathloss reference signal may follow the candidate beam RS and measure a downlink pathloss value using the same.
   As power control parameters for PUSCH transmission, p0, alpha, and PUSCH power control adjustment states included in the p0-Alpha-CLID-PUSCH-Set associated with the lowest value of ul-powercontrolId in the PCell or PSCell are available.
   As power control parameters for PUCCH transmission, p0, alpha, and PUCCH power control adjustment state included in the p0-Alpha-CLID-PUCCH-Set associated with the lowest value of ul-powercontrolId in the PCell or PSCell are available.
   As power control parameters for SRS transmission, p0, alpha, and SRS power control adjustment state are available.

### Rel-16 SCell BFR

Next, a beam failure recovery (BFR) operation in a secondary cell (SCell) is described in detail. When the base station and the UE reuse a pre-defined BFR operation for a PCell as the BFR operation for the SCell, there may be additional considerations as follows:
SCell consideration 1: When one or more SCells are DL-only cells.
SCell consideration 2: One or more SCells do not include control resource set, search space, or both information.
SCell consideration 3: Multiple SCells exist, and one or more SCells among them have experienced a beam failure.

For SCell consideration 1 above, in case that the UE reuses the PCell BFR, when a beam failure occurs in a specific SCell, the UE may not be able to perform PRACH transmission for transmitting a beam failure recovery request (BFRQ) to the base station in the corresponding SCell, and thus a method in which another cell enabling uplink transmission reports the beam failure situation for the corresponding SCell to the base station may be required.

For SCell consideration 2 above, in case that the UE reuses the PCell BFR, when a beam failure occurs in a particular SCell, the UE may not be able to receive a response of the base station to the BFRQ in the corresponding SCell through a recovery search space from the base station, and thus a method of receiving the response from the base station by another cell where the control resource set and search space exist.

For SCell Consideration 3 above, in case that the UE reuses the PCell BFR, when a beam failure occurs in at least one SCell, the UE may need to perform a PRACH transmission for each SCell, which may cause a large signaling overhead burden on the UE, and for a situation where a beam failure occurs in a large number of SCells, a long delay may occur when transmitting BFRQs from the UE to the base station. Therefore, a method that considers the signaling overhead during BFRQ for multiple SCells may be required.

Based on the above considerations, the BFR operation for SCell is defined in NR release 16. The difference from traditional PCell BFR is a BFRQ process and a base station response process thereto, and a BFD-RS set may be configured via higher layer signaling for a downlink bandwidth part in each SCell, or if not configured up, the BFD-RS set may include some or all of the RSs referenced in the activated TCI state of the CORESET(s) established for PDCCH monitoring of the UE within the corresponding downlink bandwidth part. Further, the set of candidate beam RSs may be configured in the BeamFailureRecoverySCellConfig which is higher layer signaling in the downlink bandwidth part in each SCell. The UE may be configured with schedulingRequestID-BFR-SCell, which is higher layer signaling, from the base station, and this may be higher layer signaling configuration information for PUCCH transmission for a link recovery request (LRR).

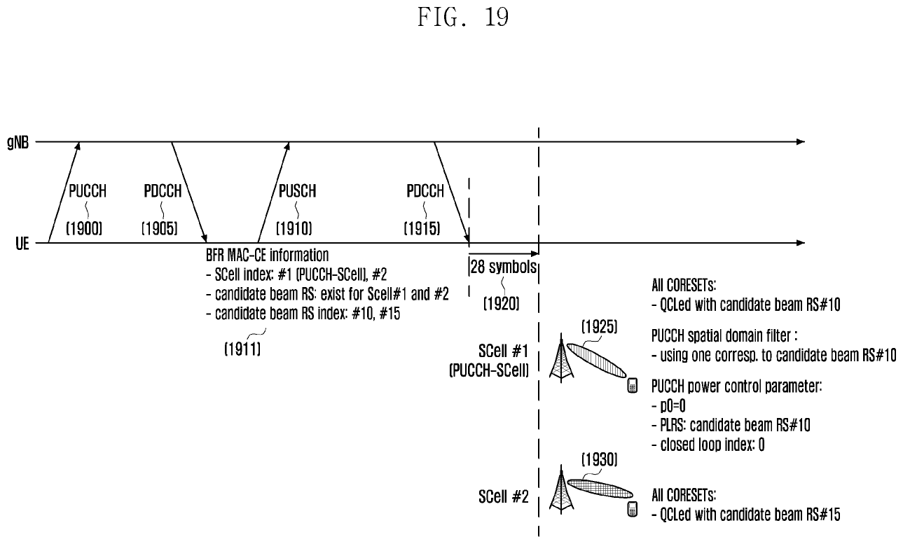

FIG. 19 illustrates a response process of a base station with respect to a BFR request signal of a UE during SCell BFR operation according to an embodiment of the disclosure. The UE may transmit a PUCCH resource having a value of schedulingRequestID-BFR-SCell to the base station, as a scheduling request signal (indicated by reference numeral 19-00). Through a response to the scheduling request PUCCH by the base station, the UE may receive a first PDCCH from the base station (indicated by reference numeral 19-05), and the UE may receive first PUSCH scheduling information through the first PDCCH and transmit a BFR MAC-CE by including the same in the first PUSCH, based on the scheduling information (indicated by reference numeral 19-10). The BFR MAC-CE may include an index of a SCell having a radio link quality lower than a reference value, information on whether a candidate beam RS exists for the corresponding SCell, and if existing, an index of the candidate beam RS identified in the corresponding SCell. For example, the BFR MAC-CE included in the first PUSCH may include indices 1 and 2 for SCells having a radio link quality lower than the reference value, a candidate beam RS index of 10 for the first SCell, and a candidate beam RS index of 15 for the second SCell (indicated by reference numeral 19-11). After the first PUSCH transmission, the UE may receive a second PDCCH from the base station (indicated by reference numeral 19-15), and the second PDCCH has the same HARQ process ID field value as that of the first PDCCH and may include a toggled NDI field value. The UE may perform the following operations, after 28 symbols from a last symbol of a second PDCCH reception from the base station. The subcarrier spacing of the 28 symbols may be determined as the smallest subcarrier spacing of the activated downlink bandwidth part in which the PDCCH has been received and the activated downlink bandwidth part within the at least one SCell.
In case of monitoring of the control resource set within one or more SCells, indexes of which are included in the BFR MAC-CE, if the BFR MAC-CE includes candidate beam RS information for each SCell in the BFR MAC-CE, the UE may assume the same QCL parameter as that of the candidate beam RS. In other words, the UE may assume channel parameters used to receive the candidate beam RS for each SCell in the BFR MAC-CE during monitoring of the control resource set in each SCell.
When transmitting PUCCH in a PUCCH SCell, the UE may use a spatial domain filter corresponding to the candidate beam RS included in the BFR MAC-CE and reported to the base station for the corresponding SCell, may use p0 of index 0, as a power control parameter, may use the candidate beam RS as the pathloss reference signal, and may use the power control closed loop index of 0. The conditions in this case may be as follows:
   When the UE has received PUCCH-SpatialRelationInfo configured or activated from the base station for the corresponding PUCCH,
   When the PUCCH for the LRR has not been transmitted, or has been transmitted to a PCell or PSCell, and
   When the PUCCH SCell index is included in the BFR MAC-CE.

For example, when the first SCell included in the BFR MAC-CE is a PUCCH-SCell, the UE may assume the same QCL parameter as that of candidate beam RS #10 during monitoring of all control resource sets in the first SCell, and the UE may use a spatial domain filter corresponding to candidate beam RS #10 during transmission of a PUCCH in the first SCell, may use p0 of an index of 0 as the power control parameter, may use the candidate beam RS #10 as the pathloss reference signal, and may use the power control closed loop index of 0 (indicated by reference numeral 19-25). Further, the UE may assume the same QCL parameter as that of candidate beam RS #15 during monitoring of all control resource sets in the second SCell (indicated by reference numeral 19-30).

When the UE is configured with TCI-State_r17, dl-OrJoint-TCIStateList, or TCI-UL-State, which are higher layer signaling having a meaning that the UE operates in a unified TCI method, in the PCell or PSCell, and after transmitting the first PUSCH including the BFR MAC-CE, the UE may receive a second PDCCH from the base station as described above, and the second PDCCH may have the same HARQ process ID field value as that of the first PDCCH and include a toggled NDI field value. The UE may perform the following operations after 28 symbols from the last symbol of receiving the second PDCCH from the base station:
It is possible to apply an assumption that, during monitoring for all control resource sets, PDSCH reception, and aperiodic CSI-RS resource reception, the UE has the same QCL parameter as that of the candidate beam RS reception. In this case, the aperiodic CSI-RS resource may be applied with a dynamically indicated unified TCI state and thus may be included in a set of CSI-RS resources that can be received in the same TCI state as that of the PDCCH and PDSCH.
When transmitting PUSCH, PUCCH, and SRS, the UE may use a spatial domain filter used when receiving the candidate beam RS. In this case, the SRS may be applied with a dynamically indicated unified TCI state and thus transmitted through the same spatial domain filter as that of the PUSCH and PUCCH. The power control parameters for transmission of the PUSCH, PUCCH, and SRS of the UE may be based on the details in the following:
   A pathloss reference signal may follow the candidate beam RS and measure a downlink pathloss value using the same.
   As power control parameters for PUSCH transmission, p0, alpha, and PUSCH power control adjustment states included in the p0-Alpha-CLID-PUSCH-Set associated with the lowest value of ul-powercontrolId in the SCell are available.
   As power control parameters for PUCCH transmission, p0, alpha, and PUCCH power control adjustment state included in the p0-Alpha-CLID-PUCCH-Set associated with the lowest value of ul-powercontrolId in the SCell are available.
   As power control parameters for SRS transmission, p0, alpha, and SRS power control adjustment state included in the p0-Alpha-CLID-SRS-Set associated with the lowest value of ul-powercontrolId in the SCell are available.

In a PCell or PSCell, when a BFR MAC-CE has been transmitted via Msg3 or MsgA in a contention based random access process and the UE has received PUCCH-spatialrelationinfo configured or activated for any PUCCH resource from the base station, the UE may transmit the corresponding PUCCH resource after 28 symbols after reception of the PDCCH as a completion stage of the contention based random access process.

If TCI-State_r17, dl-OrJoint-TCIStateList, or TCI-UL-State, which are higher layer signaling having a meaning that the UE operates in a unified TCI method, are configured in the PCell or PSCell and the BFR MAC-CE has been transmitted via Msg3 or MsgA in the contention based random access process, and when the UE has received PUCCH-spatialrelationinfo configured or activated for any PUCCH resource from the base station, the UE may perform the following operations after 28 symbols after reception of the PDCCH as a completion stage of the contention based random access process:
When SSB-MTC-AdditionalPCI, which is higher layer signaling, is not configured for the UE, it is possible to apply an assumption that, during monitoring of all control resource sets, reception of PDSCH, and reception of aperiodic CSI-RS resources, the UE has the same QCL parameter as that of the candidate beam RS reception. In this case, the aperiodic CSI-RS resource may be applied with a dynamically indicated unified TCI state and thus included in a set of CSI-RS resources that can be received in the same TCI state as that of the PDCCH and PDSCH.
When transmitting PUSCH, PUCCH, and SRS, the UE may use a spatial domain filter used for a last transmitted PRACH. In this case, the SRS may be applied with a dynamically indicated unified TCI state and thus may be transmitted through the same spatial domain filter as that of the PUSCH and PUCCH. The power control parameters for transmission of the PUSCH, PUCCH, and SRS of the UE may be based on the details in the following:
   A pathloss reference signal may follow the candidate beam RS and measure a downlink pathloss value using the same.
   As power control parameters for PUSCH transmission, p0, alpha, and PUSCH power control adjustment states included in the p0-Alpha-CLID-PUSCH-Set associated with the lowest value of ul-powercontrolId in the PCell or SCell are available.
   As power control parameters for PUCCH transmission, p0, alpha, and PUCCH power control adjustment state included in the p0-Alpha-CLID-PUCCH-Set associated with the lowest value of ul-powercontrolId in the PCell or SCell are available.
   As power control parameters for SRS transmission, p0, alpha, and SRS power control adjustment state included in the p0-Alpha-CLID-SRS-Set associated with the lowest value of ul-powercontrolId in the PCell or SCell are available.

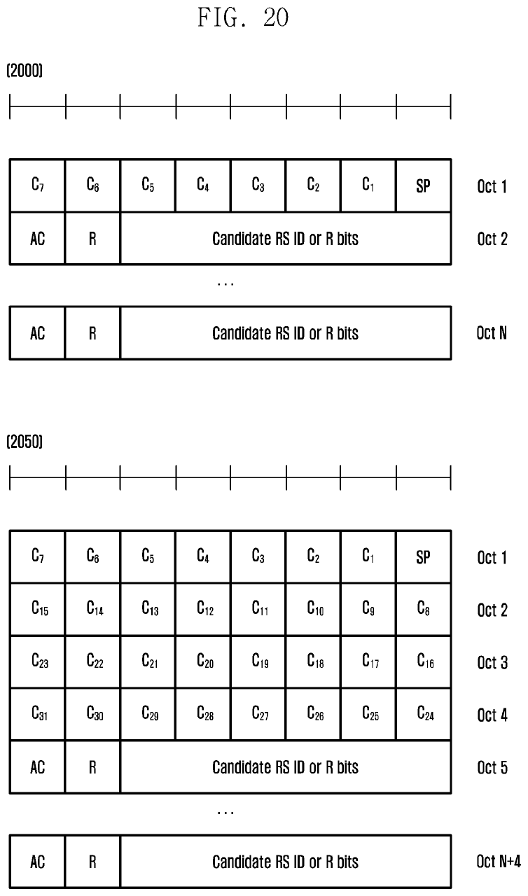

FIG. 20 illustrates the structure of a BFR MAC-CE according to an embodiment of the disclosure. FIG. 20 includes a BFR MAC-CE and a truncated BFR MAC-CE. The BFR MAC-CE and the truncated BFR MAC-CE may be distinguished by an MAC subheader including an LCID/eLCID.

The BFR MAC-CE and the truncated BFR MAC-CE may have variable sizes.

Both MAC-CE structures may include a bitmap of cell indices expressed in ascending order according to ServCellIndex value which is higher layer signaling, and may include candidate beam information for a cell corresponding to each bit position in the bitmap. For the BFR MAC-CE, when the largest ServCellIndex among indices of cells for which beam failures have been identified and for which performance evaluations of multiple candidate beams have been completed has a value smaller than 8, a bitmap for a cell index corresponding to one octet may be used (indicated by reference numeral 20-00). Otherwise (i.e., the largest ServCellIndex among indices of cells for which beam failures have been identified and for which performance evaluations of multiple candidate beams have been completed has a value greater than or equal to 8), a bitmap of cell indices corresponding to four octets may be used (indicated by reference numeral 20-50). One MAC PDU may include up to one BFR MAC-CE.

For truncated BFR MAC-CEs, a bitmap of cell indices corresponding to one octet may be used for the following cases (indicated by reference numeral 20-00), otherwise a bitmap of cell indices corresponding to four octets may be used (indicated by reference numeral 20-50).
In case that the largest ServCellIndex among indices of cells for which beam failures have been identified and for which performance evaluations of multiple candidate beams have been completed has a value smaller than 8, or
Beam failure has been identified in an SpCell, and the SpCell is included within the corresponding Truncated BFR MAC-CE, and the available UL-SCH resources are unable to accommodate the combined length of the bitmap and subheader for the cell indices corresponding to four octets due to LCP.

The description of each field may be as follows:
SP: This field may indicate information about beam failures in the SpCell. This field may be indicated as “1” when a BFR MAC-CE or Truncated BFR MAC-CE is included in the MAC PDU during the random access process and the beam failure has been identified in the SpCell. Otherwise, this field may be indicated as “0”.
Ci (BFR MAC-CE): This field may indicate information about beam failures and may determine the presence of octet corresponding to the ServCellIndex having a value of “i”. A case in which this field is indicated as “1” may signify that a beam failure has been identified in the ServCellIndex having a value of “i” and that the performance evaluations of multiple candidate beams in the corresponding cell have been completed, and that an octet corresponding thereto exists, which may include an AC field and a candidate RS ID field. A case in which this field is indicated as “0” may signify that no beam failures have been identified in the ServCellIndex having a value of i, or even if beam failures have been identified, the performance evaluations of multiple candidate beams in the corresponding cell have not been completed, and may signify that an octet corresponding thereto does not exist. Each octet corresponding to each Ci value may be placed in ascending order of the value of i.
Ci (Truncated BFR MAC-CE): This field may indicate information about beam failures and may determine the presence of octets corresponding to ServCellIndex having a value of i. A case in which this field is indicated as 1 may signify that a beam failure has been identified in the ServCellIndex having a value of i and that the performance evaluations of multiple candidate beams in the corresponding cell have been completed, and an octet corresponding thereto may exist or not, and if the corresponding octet exists, the octet may have an AC field and a candidate RS ID field. A case in which this field is indicated as 0 may signify that no beam failures have been identified in the ServCellIndex having a value of i, or even if beam failures have been identified, the performance evaluations of multiple candidate beams in the corresponding cell have not been completed, and an octet corresponding thereto does not exist. Each octet corresponding to each Ci value, if any, may be placed in ascending order of a value of i, and the number of octets including the AC field may be maximized within limitations without exceeding the available grant size. There may be no octets within a Truncated BFR MAC-CE that includes the AC field.
AC: This field may indicate the presence or absence of a candidate RS ID field in the corresponding octet. When at least one of multiple SSBs in candidateBeamRSSCellList which is higher layer signaling has an SS-RSRP value above rsrp-ThresholdBFR which is a reference value, or if at least one of the multiple CSI-RS in the candidateBeamRSSCellList which is higher layer signaling has a CSI-RSRP value above rsrp-ThresholdBFR which is a reference value, this field may be indicated as 1. Otherwise, this field may be indicated as 0. When this field is indicated as 1, the Candidate RS ID field in the same octet may exist, if this field is indicated as 0, the Candidate RS ID field in the same octet may not exist, and a reserved bit may exist instead.
Candidate RS ID: This field may indicate an index of SSB having an SS-RSRP value above rsrp-ThresholdBFR, which is a reference value, among the multiple SSBs in candidateBeamRSSCellList which is higher layer signaling, or the index of the CSI-RS with a CSI-RSRP value above rsrp-ThresholdBFR which is a reference value among the multiple CSI-RS in the candidateBeamRSSCellList which is higher layer signaling. The index of the SSB or CSI-RS may refer to an index of an entry order in the candidateBeamRSSCellList which is higher layer signaling. The indices 0 and 1 may refer to RSs of the first and second entries in the candidateBeamRSSCellList. This field may consist of 6 bits.

### Rel-17 Per-TRP BFR

Next, the beam failure recovery operation per TRP is described in detail. In the current NR system, the BFD-RS set may include up to two RSs, while a CORESET established for PDCCH monitoring of the UE may be configured up to three per bandwidth part. In addition, in Release 16 NR systems, the maximum number of CORESETs per bandwidth part has been increased to five in the case of multiple PDCCH-based multi-TRP transmissions, and in Release 16 NR-U, there has been discussion of increasing the maximum number of CORESETs per bandwidth part to support wideband operation. Therefore, as with the existing BFD operation, calculating a hypothetical PDCCH reception BLER for all RSs in the BFD-RS set and requiring all BLER values to exceed a threshold before reporting a beam failure indication to the higher layer may increase the latency to proceed to the remaining BFR processes, and may not be able to detect situations where only the BLER value for a specific RS in the BFD-RS set exceeds the threshold. Therefore, when the BFD-RS set has not been established for the UE through higher layer signaling, the UE may establish a beam failure indication for only some of the RSs in the BFD-RS set, selected from the RSs referenced in the activated TCI state of the CORESET(s) established for PDCCH monitoring of the UE, establish multiple BFD-RS sets for the UE through higher layer signaling, or indicate a method of arbitrarily selecting multiple BFD-RS sets to the UE by the base station, so as to increase the efficiency of the BFD process to determine whether smooth downlink transmission between the base station and the UE is possible, thereby enabling a low-latency BFR procedure to be performed.

In addition, since the BFR procedure of the current NR system is designed without considering a multi-TRP/panel operation of a base station, the BFR procedure may be performed more efficiently if each link between the multi-TRP/panel of the base station and the UE is used rather than following the existing BFR procedure during the multi-TRP/panel operation of the base station. For example, when one RS in the BFD-RS set is associated with TRP1 and the other RS is associated with TRP2, and a link between the UE and TRP1 is good while a link between the UE and TRP2 is degraded, a case may occur in which the performance of beam failure recovery operation is impossible because the hypothetical BLER for the RS associated with TRP1 is still calculated as good. Further, if a link between a UE and a TRP or panel which is not experiencing a beam failure among the multi-TRP/panel connected to the UE is used, the BFR for a link between the UE and a TRP or panel which is experiencing a beam failure may be recovered at a low latency. The above simplified BFR procedure considering multiple links of the multi-TRP/panel of the embodiments of the disclosure is not limited to multi-TRP/panel, but is equally applicable in a single-TRP/panel situation where multiple BFD-RS sets are defined and BFR is performed for each BFD-RS set.

Instead of one BFD-RS set and one candidate beam RS set, the UE may be configured with two BFD-RS sets and two candidate beam RS sets. The first BFD-RS set is associated with the first set of candidate beam RSs, and the second BFD-RS set is associated with the second set of candidate beam RSs. The UE may receive a configuration for the first and second BFD-RS sets from the base station via failureDetectionSet1 and failureDetectionSet2, which are higher layer signaling. When the UE does not receive a configuration for the first and second BFD-RS sets from the base station via the failureDetectionSet1 and failureDetectionSet2 which are higher layer signaling, the UE may include, in the first BFD-RS set, some or all of the RSs referenced by the activated TCI state in one or more first CORESETs in which the coresetPoolIndex value, which is higher layer signaling, is configured as 0, or the coresetPoolIndex value is not configured, and the UE may include, in the second BFD-RS set, some or all of the RSs referenced by activated the TCI state in one or more second CORESETs in which the coresetPoolIndex value, which is higher layer signaling, is configured as 1.

The UE may report, to the base station, the maximum number of RSs for each BFD-RS set and the maximum number of total RSs included within two BFD-RS sets, as UE capability information and when, based on the UE capability information, the UE has not received a configuration of the first and second BFD-RS sets via higher layer signaling, as described above, or the UE has configured the first and second BFD-RS sets using some or all of the RSs referenced in the activated TCI state in the first and second CORESETs at the time of not receiving a configuration of the first and second BFD-RS sets, the UE may expect the number of RSs for each BFD-RS set and the total number of RSs included in two BFD-RS sets to be smaller than or equal to the UE capability value reported to the base station. When the UE has not received the configuration for the first and second BFD-RS sets from the base station via failureDetectionSet1 and failureDetectionSet2 which are higher layer signaling, and the total number of RSs referenced by the activated TCI state in the first and second CORESETs is greater than the maximum value of the total number of RSs included in the two BFD-RS sets reported as the UE capability, the UE may first select an RS referenced in the activated TCI state in a CORESET having a short period of a search space to which the CORESET is connected, among multiple first and second CORESETs. When the search spaces connected to multiple first and second CORESETs have the same period, the UE may first select an RS referenced in the activated TCI state in a CORESET having a high index.

When the UE:
is not configured with coresetPoolIndex, which is higher layer signaling, or includes one or more first CORESETs for which a value of coresetPoolIndex is configured as 0, within an activated downlink bandwidth part of a predetermined serving cell,
includes one or more second CORESETs for which a value of coresetPoolIndex, which is higher layer signaling, is configured as 1, within the same activated downlink bandwidth part within the same serving cell, and
is configured with SSB-MTCAdditionalPCI, which is higher layer signaling, the UE may include, in the first or second set of candidate beam RSs, an SSB index associated with a physical cell ID that is different from the physCellId value in ServingCellConfigCommon which is higher layer signaling, and may consider the associated first or second BFD-RS set as being associated with the same physical cell ID. For example, when a value of physCellId in ServingCellConfigCommon is 0 and a particular SSB is associated with a physical cell ID value of 1, the UE may consider that the first BFD-RS set and the first set of candidate beam RSs are associated with 0, the physical cell ID of the serving cell, and that the second BFD-RS set and the second set of candidate beam RSs are associated with 1, a physical cell ID 1 to which the corresponding SSB is associated.

If the PCell and PSCell are associated with the first BFD-RS set and the first set of candidate beam RSs associated therewith, and the second BFD-RS set and the second set of candidate beam RSs associated therewith, the UE may report to the base station that there are two LRRs that can be configured via higher layer signaling by the base station through twoLRRcapacity, which is UE capacity report. The UE not performing the reporting may receive configuration information for the first LRR from the base station via schedulingRequestID-BFR which is higher layer signaling, and the UE performing the reporting may receive additional configuration information for the second LRR from the base station via schedulingRequestID-BFR2 which is higher layer signaling. When the UE has only received the configuration for the first LRR from the base station via higher layer signaling, the UE may perform PUCCH transmission for the LRR for the first and second BFD-RS set. When the UE receives the configuration for the first and second LRRs from the base station via higher layer signaling, the UE may use configuration information about the first LRR for the first BFD-RS set and configuration information about the second LRR for the second BFD-RS set.

If at least one serving cell is associated with a first BFD-RS set and a first set of candidate beam RSs associated therewith, and a second BFD-RS set and a second set of candidate beam RSs associated therewith, the UE may transmit a second PUSCH including an enhanced BFR MAC-CE to the base station. In this case, the enhanced BFR MAC-CE may include at least one of the following pieces of information:
Cell index(es) corresponding to a single BFD-RS set having a link quality lower than a reference value.
Whether a selected candidate beam RS exists in each single set of candidate beam RSs within the cell index(es) corresponding to the single BFD-RS set, and if existing, the index of the candidate beam RS.
Cell index(es) in which at least one of the first and second BFD-RS sets has a link quality lower than the reference value.
   Index(es) of the BFD-RS set, which has a link quality lower than the reference value, among the first and second sets of BFD RSs.
In each of the first and second sets of candidate beam RSs within the cell index(es) corresponding to the first and second sets of BFD RSs, whether the selected candidate beam RS exists, and if existing, the index of the candidate beam RS for each set.

For the serving cell(s), which are associated with the first BFD-RS set and the first set of candidate beam RSs associated therewith, and are associated with the second BFD-RS set and the second set of candidate beam RSs associated therewith, after 28 symbols from a last symbol of a (2-1)th PDCCH reception including the same HARQ process ID field and toggled NDI field value as those of a (1-1)th PDCCH that has scheduled the second PUSCH, the UE may perform the following operation. The subcarrier spacing for the 28 symbols may be determined as the smallest subcarrier spacing of the activated downlink bandwidth part receiving the PDCCH and the activated downlink bandwidth parts of the serving cells.
The UE may follow QCL parameter assumptions of a candidate beam RS selected from the first set of candidate beam RSs during monitoring of the first CORESET, in which coresetPoolIndex, which is higher layer signaling, is not configured, or in which the coresetPoolIndex is configured as 0.
The UE may follow QCL parameter assumptions of a candidate beam RS selected from the second set of candidate beam RSs during monitoring of the second CORESET in which the coresetPoolIndex, which is higher layer signaling, is configured as 1.

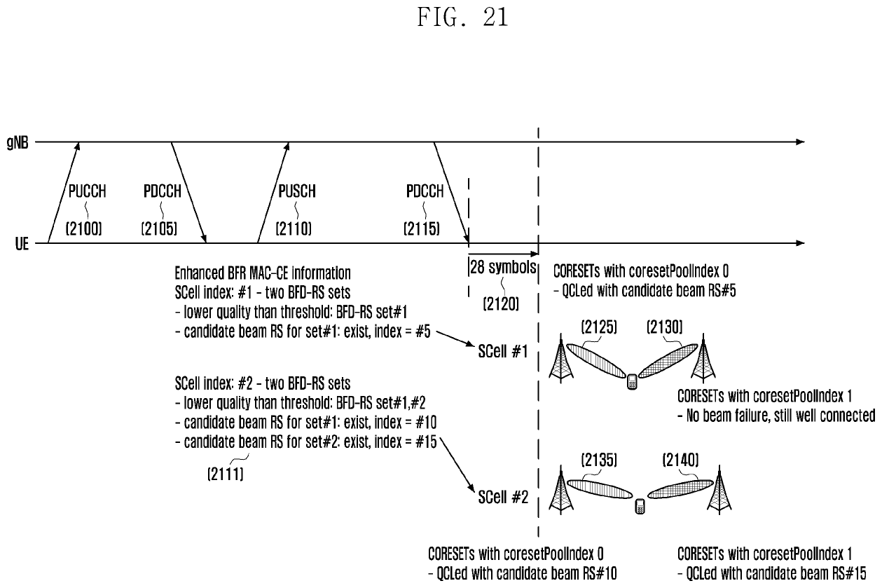

FIG. 21 illustrates a response process of a base station with respect to a BFR request signal of a UE during BFR operation for each TRP according to an embodiment of the disclosure. The UE may receive one or two pieces of LRR configuration information based on the UE capability report and higher layer signaling by the base station in response thereto, and may transmit, to the base station, a PUCCH for an LRR, which is selected depending on whether a first BFD-RS set or a second BFD-RS set is in a beam failure situation and a BFRQ operation is performed thereon (indicated by reference numeral 21-00). Through a response thereto by the base station, the UE may receive a (1-1)th PDCCH including the second PUSCH scheduling information from the base station (indicated by reference numeral 21-05). Based on the corresponding second PUSCH scheduling information, the UE may transmit a second PUSCH including an enhanced BFR MAC-CE to the base station (indicated by reference numeral 21-10), and for example, the enhanced BFR MAC-CE may include, for example, the following pieces of information (indicated by reference numeral 21-11):
SCell Index: #1, associated with multiple BFD-RS sets.
   A BFD-RS set having a hypothetical BLER below a reference value: the first BFD-RS set within SCell #1.
   Within the first set of candidate beam RSs associated with the first BFD-RS set in SCell #1, there exists a candidate beam RS selected by the UE and having a link quality higher than the reference value, and the index of the corresponding RS is #5.
SCell Index: #2, associated with multiple BFD-RS sets.
   A BFD-RS set having a hypothetical BLER lower than the reference value: the first and second sets of BFD RSs in SCell #2.
   Within the first set of candidate beam RSs associated with the first BFD-RS set in SCell #2, there exists a candidate beam RS selected by the UE and having a link quality higher than the reference value, and the index of the corresponding RS is #10
   Within the second set of candidate beam RSs associated with the second BFD-RS set in SCell #2, there exists a candidate beam RS selected by the UE and having a link quality higher than the reference value, and the index of the corresponding RS is #15.

After 28 symbols (indicated by reference numeral 21-20) from a last symbol of a (2-1)th PDCCH reception (indicated by reference numeral 21-15), which includes the same HARQ process ID field and toggled NDI field value as those of a (1-1)th PDCCH that has scheduled the second PUSCH, the UE may perform the following operations:
In SCell #1,
   the UE may follow QCL parameter assumptions of candidate beam RS #5 selected from the first set of candidate beam RSs during monitoring of the first CORESET in which coresetPoolIndex, which is higher layer signaling, is not configured or the coresetPoolIndex is configured as 0 (indicated by reference numeral 21-25).
   During monitoring of the second CORESET in which coresetPoolIndex, which is higher layer signaling, is configured as 1, since the second BFD-RS set in the corresponding cell has not been reported, through the enhanced BFR MAC-CE, as a BFD-RS set having a hypothetical BLER lower than a reference value, it is determined as not a beam failure situation, and the UE may perform monitoring using the TCI state previously configured or activated in the second CORESET (indicated by reference numeral 21-30).
In SCell #2,
   the UE may follow the QCL parameter assumptions of candidate beam RS #10 selected from the first set of candidate beam RSs during monitoring of the first CORESET in which coresetPoolIndex, which is higher layer signaling, is not configured or the coresetPoolIndex is configured as 0 (indicated by reference numeral 21-35).
   The UE may follow the QCL parameter assumptions of candidate beam RS #15 selected from the second set of candidate beam RSs during monitoring of the second CORESET in which coresetPoolIndex, which is higher layer signaling, is configured as 1 (indicated by reference numeral 21-40).

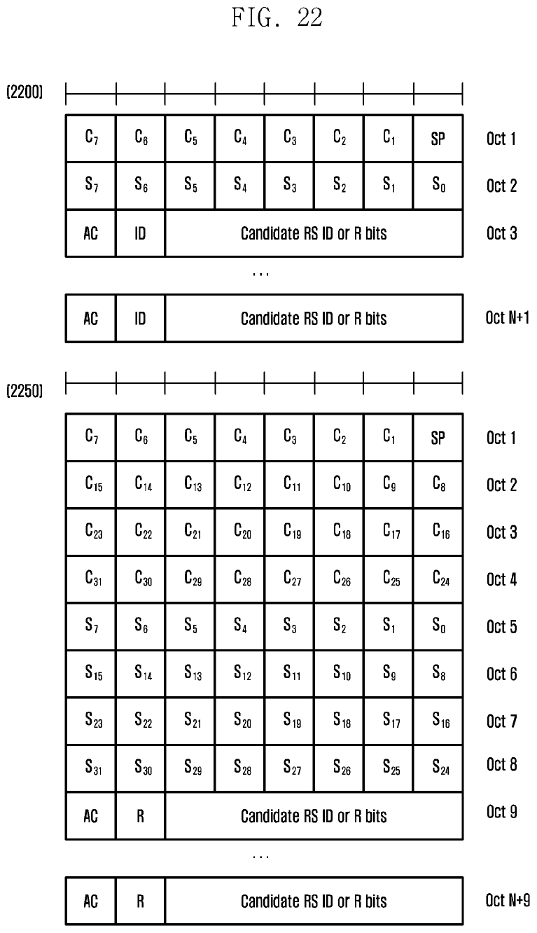

FIG. 22 illustrates a structure of an enhanced BFR MAC-CE according to an embodiment of the disclosure. FIG. 22 includes an enhanced BFR MAC-CE and a truncated enhanced BFR MAC-CE. The enhanced BFR MAC-CE and the truncated enhanced BFR MAC-CE may be distinguished by an MAC subheader containing the LCID/eLCID.

The enhanced BFR MAC-CE and the truncated enhanced BFR MAC-CE may have variable sizes. Both MAC-CE structures include a SP field, a Ci bitmap (represented by one or four octets), an Sj bitmap (represented by 0 to four octets), first beam failure recovery information (for SpCells containing two BFD-RS sets, an AC field indicating the candidate beam availability for each of the one or two BFD-RS sets is included), and second beam failure recovery information (for an SCell represented by a Ci bitmap, an AC field indicating the candidate beam availability for each of the one or two BFD-RS sets is included and the information is expressed in ascending order of the ServCellIndex).

For the Enhanced BFR MAC-CE, in the following case, a Ci bitmap corresponding to one octet may be used (indicated by reference numeral 22-00), and a Ci bitmap corresponding to four octets may be used otherwise (indicated by reference numeral 22-50). The MAC PDU should contain a MAC-CE for up to one BFR.
A case in which, for specific SCells associated with a single BFD-RS set, the largest ServCellIndex among indices of cells for which beam failures have been identified and for which performance evaluations of multiple candidate beams have been completed has a value smaller than 8, or
A case in which, for specific SCells associated with two BFD-RS sets, the largest ServCellIndex among indices of cells for which beam failures have been identified for at least one BFD-RS set and for which performance evaluations for multiple candidate beams have been completed has a value smaller than 8.

For a truncated enhanced BFR MAC-CE, a bitmap for a cell index corresponding to one octet may be used for the following cases (indicated by reference numeral 22-00), otherwise a bitmap for the cell index corresponding to four octets may be used (indicated by reference numeral 22-50).
A case in which, for specific SCells associated with a single BFD-RS set, the largest ServCellIndex among indices of cells for which beam failures have been identified and for which performance evaluations of multiple candidate beams have been completed has a value smaller than 8,
A case in which, for specific SCells associated with two BFD-RS sets, the largest ServCellIndex among indices of cells for which beam failures have been identified for at least one BFD-RS set and for which performance evaluations for multiple candidate beams have been completed a value smaller than 8,
A case in which a beam failure has been identified in an SpCell, the SpCell did not contain two BFD-RS sets, the SpCell is contained within a corresponding truncated BFR MAC-CE, and the available UL-SCH resources are unable to accommodate the combined length of the bitmap and subheader for the cell index corresponding to four octets due to LCP, or
A case in which the random access process has been initiated for a BFR process for two BFD-RS sets within an SpCell, the SpCell contains two BFD-RS sets, the SpCell is contained within a corresponding truncated BFR MAC-CE, and the available UL-SCH resources are unable to accommodate the combined length of the bitmap and subheader for the cell index corresponding to four octets due to LCP.

For enhanced BFR MAC-CE and truncated enhanced BFR MAC-CE, the Sk bitmap may have octets of the respective lengths as shown below, according to the following conditions:
When the number of serving cells including two BFD-RS sets and having the SP or Ci field of 1 is greater than 0 and smaller than 9, the Sk bitmap may be represented by one octet.
When the number of serving cells including two BFD-RS sets and having the SP or Ci field of 1 is greater than 8 and smaller than 17, the Sk bitmap may be represented by two octets.
When the number of serving cells including two BFD-RS sets and having the SP or Ci field of 1 is greater than 16 and smaller than 25, the Sk bitmap may be represented by three octets.
When the number of serving cells including two BFD-RS sets and having the SP or Ci field of 1 is greater than 24, the Sk bitmap may be represented by four octets.
When there are no serving cells including two BFD-RS sets and having the SP or Ci field of 1, the Sk bitmap may not be included.

For a truncated enhanced BFR MAC-CE, octets containing the AC field may exist first for the SpCell, followed by octets containing the AC field for each SCell in ascending order, and may be maximized within the limit that does not exceed the available grant size. Within a Truncated enhanced BFR MAC-CE, there may be no octets containing the AC field.

Each field may be described as follows:
SP (enhanced BFR MAC-CE): This field may indicate information about beam failure detection in an SpCell and, when the SpCell contains multiple BFD-RS sets, may indicate whether one or more octets containing the AC field exists or not. For an SpCell containing multiple BFD-RS sets, a case in which this field is indicated as 1 may signify that in at least one BFD-RS set in the corresponding SpCell, beam failure has been detected and performance evaluations of multiple candidate beams have been completed, and that at least one octet containing an AC field exists. Otherwise, this field may be indicated as 0. For SpCells, one or more octets containing the AC field may exist before the octets for SCells. For an SpCell containing a single BFD-RS set, this field may be indicated as 1 when a beam failure is detected in the correspondingSpCell, when the enhanced BFR MAC-CE is included in the MAC PDU during the random access process. Otherwise, this field may be indicated as 0.
SP (truncated enhanced BFR MAC-CE): This field may indicate information about beam failures in the SpCell. For an SpCell containing multiple BFD-RS sets, a case in which this field is indicated as 1 may signify that a beam failure has been detected in at least one BFD-RS set in the corresponding SpCell, performance evaluations of multiple candidate beams have been completed, and that at least one octet containing an AC field exists or absent. Otherwise, this field may be indicated as 0. For an SpCell containing a single BFD-RS set, the field being indicated as 1 may signify that, in case that the enhanced BFR MAC-CE is included in the MAC PDU during the random access process, this field may be indicated as 1 when a beam failure has been detected in the corresponding SpCell. Otherwise, this field may be indicated as 0.
Ci (enhanced BFR MAC-CE): This field may indicate information about beam failures and may determine the presence of an octet in the SCell corresponding to a ServCellIndex having a value of i. A case in which this field is indicated as 1 may signify that a beam failure has been identified for at least one BFD-RS set in the SCell corresponding to the ServCellIndex having a value of i, and the performance evaluations of multiple candidate beams in the corresponding cell have been completed, and that an octet corresponding thereto exists, which may contain an AC field and a candidate RS ID field. A case in which this field is indicated as 0 may signify that no beam failures have been identified for any BFD-RS set in the SCell corresponding to a ServCellIndex having a value of i, or that performance evaluations of multiple candidate beams in the corresponding cell have not been completed, even though beam failures have been identified for at least one BFD-RS set, and an octet corresponding thereto does not exist. Each octet corresponding to each Ci value may be placed in ascending order of values of “i”, and may be placed after the octet for the SpCell.
Ci (Truncated BFR MAC-CE): This field may indicate information about beam failures and may determine the presence of octets for the SCell corresponding to a ServCellIndex having a value of i. A case in which this field is indicated as 0 may signify that a beam failure has been identified for at least one BFD-RS set in the SCell corresponding to the ServCellIndex having a value of i, and the performance evaluations of multiple candidate beams in the corresponding cell have been completed, and that an octet corresponding thereto may exist or not and when the corresponding octet exists, the octet may have an AC field and a candidate RS ID field. A case in which this field is indicated as 0 may signify that no beam failures have been identified for any BFD-RS set in the SCell corresponding to a ServCellIndex having a value of i, or that performance evaluations of multiple candidate beams in the corresponding cell have not been completed even when beam failures have been identified for at least one BFD-RS set, and an octet corresponding thereto does not exist. Each octet corresponding to each Ci value, if existing, may be placed in ascending order of the i value, and the number of octets containing the AC field may be maximized without exceeding the available grant size. Within a Truncated BFR MAC-CE, there may be no octets containing the AC field.
Sk (enhanced BFR MAC-CE): This field may correspond to a kth serving cell having the SP or Ci field indicated as 1 and containing two BFD-RS sets. Multiple serving cells having SP or Ci field indicated as 1 and containing two BFD-RS sets may be ordered in ascending order of the index of the SCell corresponding to ServCellIndex having a value of i, starting with SpCell. This field may indicate whether, for a specific serving cell, a beam failure has occurred for one BFD-RS set, or for two BFD-RS sets, may indicate whether, for the corresponding serving cell, one or two octets containing the AC field exist. A Sk field value of 1 may indicate that a beam failure has been detected for two BFD-RS sets and that performance evaluations of multiple candidate beams have been completed for two BFD-RS sets, and may indicate the presence of two octets containing the AC field for the corresponding serving cell. A Sk field value of 0 may signify that a beam failure has been detected for one of the two BFD-RS sets and the performance evaluations of the multiple candidate beams have been completed, or that a beam failure has been detected for two BFD-RS sets but the performance evaluations of the multiple candidate beams have not been completed for two BFD-RS sets, and may signify that, for the corresponding serving cell, there is one octet containing the AC field. The Sk field, which does not map to any serving cell, may have a value of 0, which may be considered a cell that does not have two BFD-RS sets.
Sk (truncated enhanced BFR MAC-CE): This field may correspond to a kth serving cell having SP or Ci field indicated as 1 and containing two BFD-RS sets. Multiple serving cells having SP or Ci field indicated as 1 and containing two BFD-RS sets may be ordered in ascending order of the index of the SCell corresponding to ServCellIndex having a value of i, starting with SpCell. This field may indicate whether, for a specific serving cell, a beam failure has occurred for one BFD-RS set or for two BFD-RS sets, and may indicate whether, for the corresponding serving cell, one or two octets containing the AC field exist. A Sk field value of 1 may indicate that a beam failure has been detected for two BFD-RS sets and that performance evaluations of multiple candidate beams have been completed for two BFD-RS sets, and may indicate the presence of 0, 1, or 2 octets containing the AC field for the corresponding serving cell. A Sk field value of 0 may signify that a beam failure has been detected for one of the two BFD-RS sets and the performance evaluations of the multiple candidate beams have been completed, or that a beam failure has been detected for two BFD-RS sets but the performance evaluations of the multiple candidate beams have not been completed for two BFD-RS sets, and may signify that, for the corresponding serving cell, 0 or 1 octets containing the AC field exist. A Sk field that is not mapped to any serving cell may have a value of 0, which may be considered a cell that does not have two BFD-RS sets.
AC: This field may indicate the presence or absence of a candidate RS ID field for a corresponding octet. When at least one of the multiple SSBs in the list of candidate beams has an SS-RSRP value above rsrp-ThresholdBFR which is a reference value, or when at least one of the multiple CSI-RS in the list of candidate beams has a CSI-RSRP value above rsrp-ThresholdBFR which is a reference value, this field may be indicated as 1. Otherwise, this field may be indicated as 0. When this field is configured as 1, a candidate RS ID field in the same octet may exist and, when this field is configured as 0, the candidate RS ID field in the same octet does not exist and a reserved bit may exist instead. The list of candidate beams may use candidateBeamRS-List-r16, which is higher layer signaling, for SCells without two BFD-RS sets, and may use candidateBeamRS-List-r16 and candidateBeamRS-List2-r17, which are higher layer signaling, for serving cells with two BFD-RS sets.
ID: This field may indicate the index of the BFD-RS set. When this field has a value of 0, a corresponding octet may correspond to a first BFD-RS set (i.e., the octet may correspond to failureDetectionSet1-r17 which is higher layer signaling), and when this field has a value of 1, the octet may correspond to a second BFD-RS set (i.e., the octet may correspond to failureDetectionSet2-r17 which is higher layer signaling). For serving cells that do not contain two BFD-RS sets, this field may have a value of 0.
Candidate RS ID: This field may indicate an index of SSB having a SS-RSRP value above rsrp-ThresholdBFR. which is a reference value, among multiple SSBs in the list of candidate beams, or an index of a CSI-RS having a CS-RSRP value above rsrp-ThresholdBFR, which is a reference value, among multiple CSI-RS in the list of candidate beams. The index of the SSB or CSI-RS may refer to the index of the entry order in the list of candidate beams. The indices 0 and 1 may refer to RSs of the first and second entries in the list of candidate beams. The field may consist of 6 bits. The list of candidate beams may use candidateBeamRS-List-r16, which is higher layer signaling, for SCells that do not have two BFD-RS sets, and may use candidateBeamRS-List-r16 and candidateBeamRS-List2-r17, which are higher layer signaling, for serving cells that have two BFD-RS sets.

### Regarding NC-JT

According to an embodiment of the disclosure, non-coherent joint transmission (NC-JT) may be used for the UE to receive a PDSCH from multiple TRPs.

Unlike the conventional communication system, 5G wireless communication system can support not only a service requiring a high transmission rate, but also a service having a very short transmission delay and a service requiring a high connection density. In a wireless communication network including multiple cells, transmission and reception points (TRPs), or beams, coordinated transmission between respective cells, TRPs, and/or beams may satisfy various service requirements by increasing the strength of a signal received by the UE or efficiently performing interference control between respective cells, TRPs, and/or beams.

Joint transmission (JT) is a representative transmission technology for the above-described coordinated communication, and which performs signal transmission to one UE through multiple different cells, TRPs, and/or beams to increase the throughput or the strength of a signal received by the UE. Here, channels between the respective cells, TRPs, and/or beams and the UE may have significantly different characteristics. In particular, non-coherent joint transmission (NC-JT) supporting non-coherent precoding between cells, TRPs, and/or beams, individual precoding may require individual precoding, MCS, resource allocation, TCI indication, and the like according to link-specific channel characteristic between each cell, TRP, and/or beams and the UE.

The above-described NC-JT transmission may be applied to at least one channel among a downlink data channel (physical downlink shared channel (PDSCH)), a downlink control channel (physical downlink control channel (PDCCH)), an uplink data channel (physical uplink shared channel (PUSCH)), and an uplink control channel (physical uplink control channel (PUCCH)). During PDSCH transmission, transmission information such as precoding, MCS, resource allocation, and TCI is indicated by DL DCI, and in order to perform NC-JT transmission, the transmission information needs to be independently indicated for each cell, TRP, and/or beam. This is a major factor that increases the payload that may be required for DL DCI transmission, which may adversely affect the reception performance of PDCCH for transmission of DCI. Therefore, it is necessary to carefully design a tradeoff between the amount of DCI information and the control information reception performance for JT support of PDSCH.

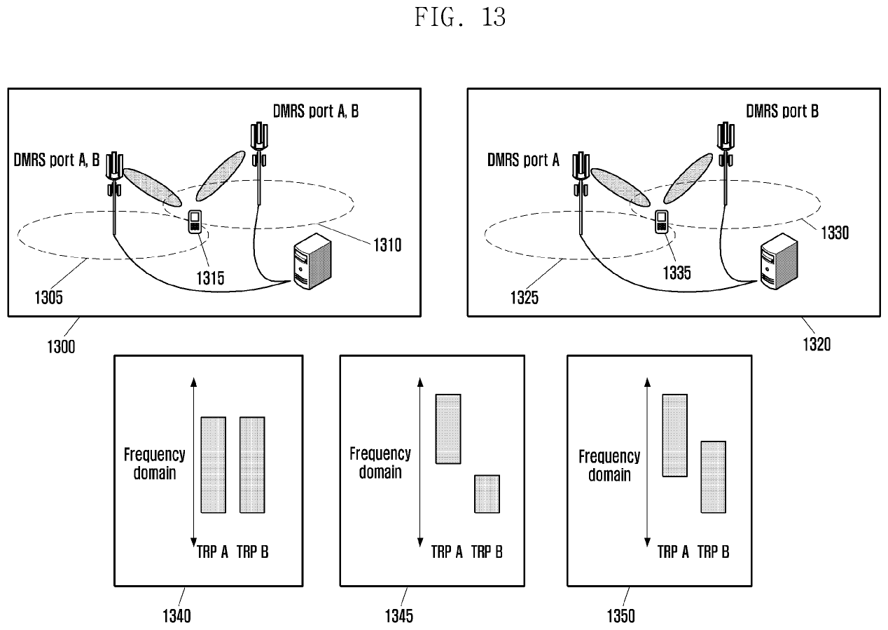

FIG. 13 illustrates an example of an antenna port configuration and resource allocation for PDSCH transmission using cooperative communication in a wireless communication system according to an embodiment of the disclosure.

Referring to FIG. 13, an example for PDSCH transmission is illustrated according to a joint transmission (JT) scheme, and examples of radio resource allocation for each TRP are illustrated.

In addition, referring to FIG. 13, an example (indicated by reference numeral 1300) of coherent joint transmission (C-JT) supporting coherent precoding between cells, TRPs, and/or beams is shown.

In a case of C-JT, TRP A 1305 and TRP B 1310 may transmit single data (PDSCH) to the UE 1315, and multiple TRPs may perform joint precoding. This may refer that the same DMRS ports are used for the same PDSCH transmission in TRP A 1305 and TRP B 1310. For example, TRP A 1305 and TRP B 1310 may transmit DRMS to the UE through DMRS port A and DMRS B, respectively. In this case, the UE may receive one DCI information for receiving one PDSCH demodulated based on the DMRS transmitted through the DMRS ports A and B.

In FIG. 13, an example (indicated by reference numeral 1320) of non-coherent joint transmission (NC-JT) supporting non-coherent precoding between respective cells, TRPs, and/or beams for PDSCH transmission is shown.

In a case of NC-JT, a PDSCH is transmitted to the UE 1335 for each cell, TRP, and/or beam, and individual precoding may be applied to each PDSCH. Each cell, TRP, and/or beam may be used for transmission of a different PDSCH or a different PDSCH layer to the UE to improve throughput compared to single cell, TRP, and/or beam transmission. In addition, each cell, TRP, and/or beam may repeatedly transmit the same PDSCH to the UE to improve reliability compared to single cell, TRP, and/or beam transmission. For convenience of explantion, a cell, a TRP, and/or a beam is hereinafter collectively referred to as a TRP.

Here, when all the frequency and time resources used for PDSCH transmission by multiple TRPs are the same (indicated by reference numeral 1340), when the frequency and time resources used by multiple TRPs do not overlap at all (indicated by reference numeral 1345), and when some of the frequency and time resources used by multiple TRPs overlap (indicated by reference numeral 1350), various radio resource allocations may be considered.

In order to simultaneously allocate multiple PDSCHs to one UE for NC-JT support, DCI of various types, structures, and relationships may be considered.

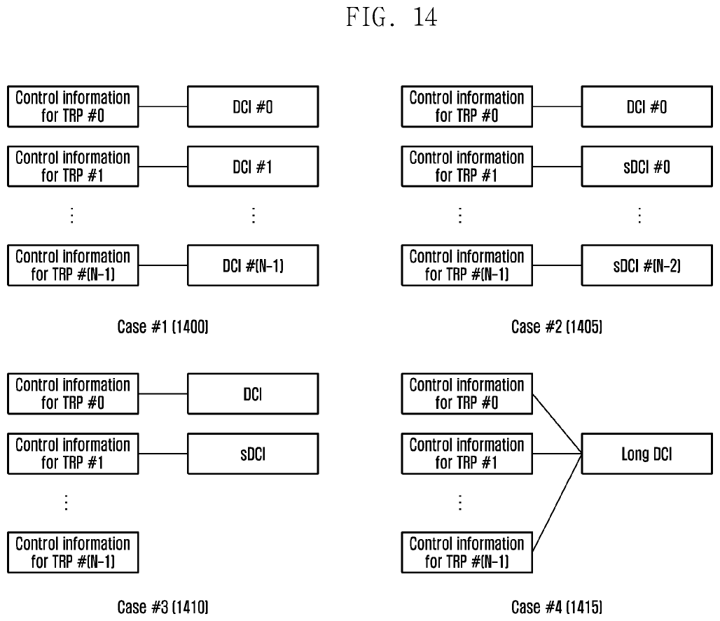

FIG. 14 illustrated an example of a configuration of downlink control information (DCI) for cooperative communication in a wireless communication system according to an embodiment of the disclosure. More particularly, FIG. 14 illustrates an example of a configuration of DCI for NC-JT for transmission of a different PDSCH or a different PDSCH layer to the UE by each TRP.

Referring to FIG. 14, case #1 (1400) illustrates, in a situation in which different (N−1) PDSCHs are transmitted from (N−1) additional TRPs (TRP #1 to TRP #(N−1)) in addition to a serving TRP (TRP #0) used for single PDSCH transmission, an example in which control information for PDSCHs transmitted from (N−1) additional TRPs and control information for PDSCHs transmitted in the serving TRP are transmitted independently from each other. In other words, the UE may acquire control information for PDSCHs transmitted from different TRPs (TRP #0 to TRP #(N−1)) through pieces of independent DCI (DCI #0 to DCI #(N−1)). The format between pieces of independent DCI may be the same or different from each other, and the payload between DCIs may also be the same or different from each other. In the above-described case #1, the freedom degree for control or allocation of each PDSCH can be completely guaranteed, but when each piece of DCI is transmitted from a different TRP, a coverage difference for each DCI may occur, and reception performance may deteriorate.

Case #2 (1405) illuatrates, in a situation in which different (N−1) PDSCHs are transmitted from (N−1) additional TRPs (TRP #1 to TRP #(N−1)) in addition to a serving TRP (TRP #0) used for single PDSCH transmission, an example in which each piece of control information (DCI) for PDSCH transmitted from (N−1) additional TRPs is transmitted and the each piece of DCI is dependent on control information for PDSCH transmitted from the serving TRP.

For example, in a case of DCI #0, which is control information for the PDSCH transmitted from the serving TRP (TRP #0), all information elements of DCI format 1_0, DCI format 1_1, and DCI format 1_2 are included, but shortened DCI (hereinafter, sDCI)) (sDCI #0 to sDCI #(N−2)), which is control information for PDSCHs transmitted from cooperative TRP (TRP #1 to TRP #(N−1)) may include only some of the information elements of DCI format 1_0, DCI format 1_1, DCI format 1_2. Therefore, in a case of sDCI for transmission of control information for PDSCHs transmitted from cooperative TRPs, the payload may be small compared to normal DCI (nDCI) for transmission of control information related to PDSCH transmitted from the serving TRP and thus it is possible to include reserved bits compared to nDCI.

In case #2 described above, the degree of freedom for control or allocation of each PDSCH may be limited according to the contents of the information element included in the sDCI, or since the reception performance of sDCI is superior to that of nDCI, the probability of occurrence of a coverage difference for each DCI may be lowered.

Case #3 (1410) illustrates, in a situation in which different (N−1) PDSCHs are transmitted from (N−1) additional TRPs (TRP #1 to TRP #(N−1)) other than a serving TRP (TRP #0) used when transmitting a single PDSCH, an example in which one piece of control information for PDSCHs of (N−1) additional TRPs is transmitted and this DCI is dependent on control information for PDSCHs transmitted from the serving TRP.

For example, in a case of DCI #0, which is control information for the PDSCH transmitted from the serving TRP (TRP #0), all information elements of DCI format 1_0, DCI format 1_1, and DCI format 1_2 are included, and in a case of control information for PDSCHs transmitted from cooperative TRP (TRP #1 to TRP #(N−1)), only some of the information elements of DCI format 1_0, DCI format 1_1, and DCI format 1_2 may be included in one “secondary” DCI (sDCI) and transmitted. For example, the sDCI may include at least one of HARQ-related information such as frequency domain resource assignment, time domain resource assignment, and MCS of cooperative TRPs. In addition, information not included in the sDCI, such as a bandwidth part (BWP) indicator or a carrier indicator, may be based on DCI (DCI #0, normal DCI, nDCI) of the serving TRP.

In case #3 (1410), the freedom degree for control or allocation of each PDSCH may be limited according to the contents of the information element included in the sDCI. However, it is possible to adjust the reception performance of sDCI, and the complexity of DCI blind decoding of the UE may be reduced compared to case #1 (1400) or case #2 (1405).

Case #4 (1415) illustrates, in a situation in which different (N−1) PDSCHs are transmitted from (N−1) additional TRPs (TRP #1 to TRP #(N−1)) in addition to a serving TRP (TRP #0) used for single PDSCH transmission, an example in which control information for PDSCHs transmitted from (N−1) additional TRPs is transmitted through the same DCI (long DCI (LDCI)) as control information for PDSCHs transmitted from the serving TRP. In other words, the UE may obtain control information for PDSCHs transmitted from different TRPs (TRP #0 to TRP #(N−1)) through single DCI. In case #4 (1415), the complexity of DCI blind decoding of the UE may not increase, but the degree of freedom of PDSCH control or allocation may be low, such that the number of cooperative TRPs is limited according to the long DCI payload limitation.

In the following descriptions and embodiments, sDCI may refer to various pieces of supplementary DCI such as shortened DCI, secondary DCI, or normal DCI (DCI format 1_0 to 1_1 described above) including PDSCH control information transmitted in the cooperative TRP. If not specified, the description is similarly applicable to the various pieces of supplementary DCI.

In the following description and embodiments, case #1 (1400), case #2 (1405), and case #3 (1410) in which at least one DCI (PDCCH) is used for NC-JT support are classified into multiple PDCCH-based NC-JTs, and case #4 (1415) in which single DCI (PDCCH) is used for NC-JT support can be classified into a single PDCCH-based NC-JT. In multiple PDCCH-based PDSCH transmission, a CORESET in which DCI of a serving TRP (TRP #0) is scheduled and a CORESET in which DCI of a cooperative TRPs (TRP #1 to TRP #(N−1)) are scheduled can be distinguished. As a method for distinguishing CORESETs, there may be a method for distinguishing through a higher layer indicator for each CORESET, a method for distinguishing through a beam configuration for each CORESET, and the like. In addition, in a single PDCCH-based NC-JT, single DCI schedules a single PDSCH having multiple layers instead of scheduling multiple PDSCHs, and the above-mentioned multiple layers may be transmitted from multiple TRPs. Here, a connection relationship between a layer and a TRP for transmission of the layer may be indicated through a transmission configuration indicator (TCI) indication for the layer.

In the embodiments of the disclosure, “cooperative TRP” may be replaced by various terms including a “cooperative panel” or a “cooperative beam” when actually used.

In embodiments of the disclosure, the expression that “NC-JT is applied” is used herein for convenience of explanation, but the same may be variously interpreted to fit the context, such as “the UE simultaneously receives one or more PDSCHs in one BWP”, “the UE simultaneously receives PDSCHs based on two or more transmission configuration indicator (TCI) indications in one BWP”, “a PDSCH received by the UE is associated with one or more DMRS port group”, and the like.

In the disclosure, a radio protocol architecture for NC-JT may be variously used depending on TRP development scenarios. For example, when there is no or little backhaul delay between cooperative TRPs, it is possible to use a structure based on MAC layer multiplexing similar to S10 of FIG. 5 (CA-like method). On the other hand, when the backhaul delay between cooperative TRPs is so large that the backhaul delay cannot be ignored (e.g., when 2 ms or more may be required for information exchange such as CSI, scheduling, HARQ-ACK, and the like between cooperative TRPs), similar to S20 of FIG. 5, it is possible to secure characteristics robust to delay by using an independent structure for each TRP from the RLC layer (DC-like method).

A UE supporting C-JT/NC-JT may receive a C-JT/NC-JT related parameter or setting value from a higher layer configuration, and may set an RRC parameter of the UE based on the received parameter or value. For higher layer configuration, the UE may utilize a UE capability parameter, for example, tci-StatePDSCH. Here, the UE capability parameter, for example, tci-StatePDSCH may define TCI states for the purpose of PDSCH transmission, and the number of TCI states may be configured to be 4, 8, 16, 32, 64, and 128 in FR1, may be configured to be 64 and 128 in FR2, and up to eight states, which can be indicated by 3 bits of the TCI field of DCI through a MAC CE message, among the configured numbers. The maximum value of 128 denotes a value indicated by maxNumberConfiguredTCIstatesPerCC in the tci-StatePDSCH parameter included in capability signaling of the UE. As such, a series of configuration processes from higher layer configuration to MAC CE configuration may be applied to a beamforming indication or a beamforming change command for at least one PDSCH in one TRP.

### Multi-DCI Based Multi-TRP

As an embodiment of the disclosure, a multi-DCI-based multi-TRP transmission method is described. The multi-DCI-based multi-TRP transmission method may establish a downlink control channel for NC-JT transmission based on multi-PDCCH.

In NC-JT based on multiple PDCCHs, when performing transmission of DCI for PDSCH scheduling of each TRP, there may be a CORESET or search space distinguished for each TRP. A CORESET or search space for each TRP may be configured as at least one of the following cases:
Higher layer index configuration by CORESET: The CORESET configuration information configured as the higher layer may include an index value, and a TRP for transmission of a PDCCH in the corresponding CORESET may be distinguished by the index value for each configured CORESET. In other words, in the set of CORESETs having the same higher layer index value, the same TRP may be considered to transmit a PDCCH, or a PDCCH for scheduling a PDSCH of the same TRP may be considered to be transmitted. The above-described index for each CORESET may be referred to as CORESETPoolIndex, and the PDCCH may be considered to be transmitted from the same TRP with regard to CORESETs in which the same CORESETPoolIndex value is configured. In a case of CORESET in which the CORESETPoolIndex value is not configured, the default value of CORESETPoolIndex may be considered as being configured, and the above-described default value may be 0.
   In this disclosure, when each of multiple CORESETs included in PDCCH-Config, which is higher layer signaling, has more than one type of CORESETPoolIndex, i.e., each CORESET has a different CORESETPoolIndex, the UE may consider that the base station can use the multi-DCI-based multi-TRP transmission method.
   On the contrary, in this disclosure, when each of multiple CORESETs included in PDCCH-Config, which is higher layer signaling, has only one type of CORESETPoolIndex, i.e., if all CORESETs have the same CORESETPoolIndex of 0 or 1, the UE may consider that the base station does not use the multi-DCI-based multi-TRP transmission method and perform transmission using single-TRP.
Multiple PDCCH-Config configurations: Multiple PDCCH-Configs in one BWP are configured, and each PDCCH-Config may include PDCCH configuration for each TRP. In other words, one PDCCH-Config may include a list of TRP-specific CORESET and/or a list of search spaces by TRP, one or more CORESETs and one or more search spaces included in one PDCCH-Config may be considered to correspond to a specific TRP.
CORESET beam/beam group configuration: The TRP corresponding to the corresponding CORESET may be distinguished through a beam or beam group configured for each CORESET. For example, when the same TCI state is configured in multiple CORESETs, the corresponding CORESETs may be considered to be transmitted through the same TRP, or the PDCCH for scheduling the PDSCH of the same TRP may be considered to be transmitted in the corresponding CORESET.
Search space beam/beam group configuration: A beam or beam group is configured for each search space, and through this, TRP for each search space may be distinguished. For example, when the same beam/beam group or TCI state is configured in multiple search spaces, the same TRP may be considered to transmit the PDCCH in the search space, or the PDCCH for scheduling the PDSCH of the same TRP may be considered to be transmitted in the search space.

By dividing the CORESET or search space for each TRP as described above, PDSCH and HARQ-ACK information may be classified for each TRP, and thus, an independent HARQ-ACK codebook for each TRP may be generated and independent PUCCH resources may be used.

The above configuration may be independent for each cell or for each BWP. For example, while two different CORESETPoolIndex values are configured in PCell, the CORESETPoolIndex value may not be configured in a specific SCell. Here, NC-JT transmission may be considered to be configured in the PCell, whereas NC-JT transmission is not configured in SCell in which the CORESETPoolIndex value is not configured.

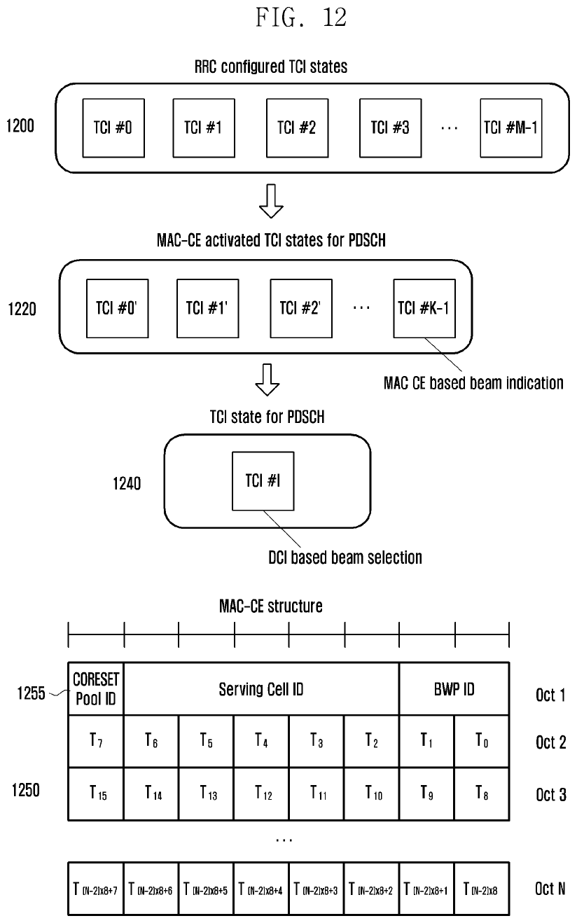

The PDSCH TCI state activation/deactivation MAC-CE applicable to the multi-DCI-based multi-TRP transmission method may follow FIG. 12. FIG. 12 illustrates a process for beam configuration and activation of a PDSCH in a wireless communication system according to an embodiment of the disclosure. Referring FIG. 12, the base station may configure M TCI states TCI #0, TCI #1, . . . , TCI #M−1 for the UE through RRC signaling (1200). The base station may active some thereof, i.e., TCI state #0′, TCI state #1′, . . . , TCI state #K−1, for PDSCH to the UE through MAC CE signaling (1220). This may be referred as MAC CE based beam indication. The base station may indicate one of the activated TCI states, i.e., TCI state #0′, TCI state #1′, . . . , TCI state #K−1, for the PDSCH through DCI (1240). This may be referred as DCI based beam indication. When the UE is not configured with CORESETPoolIndex for each of all CORESETs in PDCCH-Config, which is higher layer signaling, the UE may ignore a CORESET Pool ID field 1255 in a corresponding MAC-CE 1250. When the UE is capable of supporting a multi-DCI-based multi-TRP transmission method, i.e., when the UE has a different CORESETPoolIndex for each CORESET in PDCCH-Config which is higher layer signaling, the UE may activate the TCI state in DCI contained in PDCCHs transmitted from CORESETs having the same CORESETPoolIndex value as the value of the CORESET Pool ID field 1255 in the corresponding MAC-CE 1250. For example, if the value of the CORESET Pool ID field 1255 in the corresponding MAC-CE 1250 is 0, the TCI state in the DCI contained in PDCCHs transmitted from CORESETs having a CORESETPoolIndex of 0 may follow the activation information of the corresponding MAC-CE.

When the UE receives a configuration to use the multi-DCI-based multi-TRP transmission method from the base station, i.e., if the number of types of CORESETPoolIndex for each of the multiple CORESETs included in PDCCH-Config which is higher layer signaling exceeds one, or if each CORESET has a different CORESETPoolIndex, the UE may identify that the following constraints exist for PDSCHs scheduled from PDCCHs in each of CORESETs having two different CORESETPoolIndexes:
1. When PDSCHs indicated from PDCCHs in each CORESET having two different CORESETPoolIndexes completely or partially overlap, the UE may apply the TCI states indicated from each PDCCH to different CDM groups. In other words, no more than two TCI states may be applied to one CDM group.
2. When PDSCHs indicated from PDCCHs in each CORESET having two different CORESETPoolIndexes completely or partially overlap, the UE may expect that the actual number of front loaded DMRS symbols, the actual number of additional DMRS symbols, the actual position of DMRS symbols, and the DMRS type of each PDSCH shall not differ from each other.
3. The UE may expect that bandwidth parts indicated from PDCCHs in each CORESET having two different CORESETPoolIndexes are the same and subcarrier spacings are the same.
4. The UE may expect each PDCCH to completely contain information about PDSCHs scheduled from PDCCHs in each CORESET having two different CORESETPoolIndexes.

### Single-DCI-Based Multi-TRP

In an embodiment of the disclosure, a single-DCI-based multi-TRP transmission method is described. The single-DCI-based multi-TRP transmission method may establish a downlink control channel for NC-JT transmission based on a single-PDCCH.

In the single-DCI-based-multi-TRP transmission method, a PDSCH transmitted by multi-TRP may be scheduled by one DCI. Here, the number of TCI states may be used as a method of indicating the number of TRPs for transmission of the corresponding PDSCH. In other words, a case in which the number of TCI states indicated in DCI for scheduling the PDSCH is two may be considered as single PDCCH-based NC-JT transmission, and a case in which the number of TCI states is one may be considered as single-TRP transmission. The TCI states indicated through the DCI may correspond to one or two TCI states among TCI states activated by MAC-CE. When the TCI states of DCI correspond to the two TCI states activated by MAC-CE, a correspondence relationship between the TCI codepoint indicated through the DCI and the TCI states activated by MAC-CE is established, and two TCI states activated by MAC-CE corresponding to the TCI codepoint may exist.

In another example, if at least one codepoint among all codepoints of the TCI state field in the DCI indicates two TCI states, the UE may consider that the base station can perform transmission based on the single-DCI based multi-TRP method. In this case, at least one codepoint indicating two TCI states in the TCI state field may be activated through the enhanced PDSCH TCI state activation/deactivation MAC-CE.

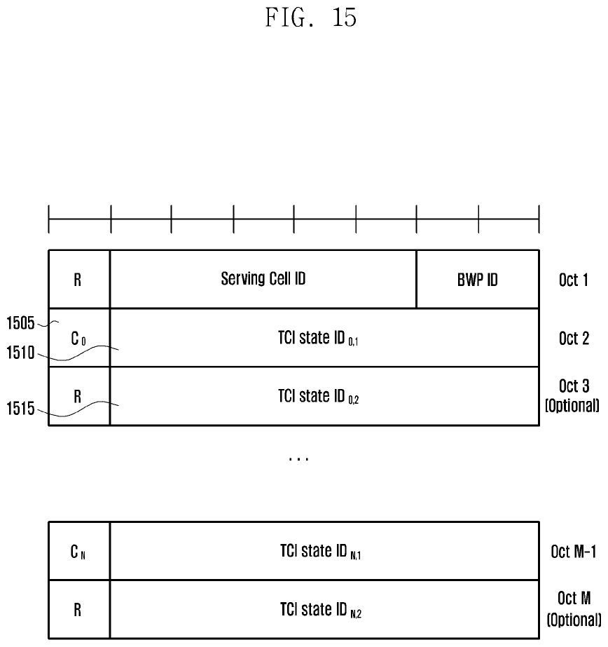

FIG. 15 illustrates an enhanced PDSCH TCI state activation/deactivation MAC-CE structure in a wireless communication system according to an embodiment of the disclosure. The meaning of each field in the MAC CE and the values configurable for each field are as follows:

TABLE 23

| | |
|---|---|
| - | Serving Cell ID: This field indicates the identity of the Serving Cell for which the |

MAC CE applies. The length of the field is 5 bits. If the indicated Serving Cell is configured as
part of a simultaneousTCI-UpdateList1 or simultaneousTCI-UpdateList2 as specified in TS
38.331 [5], this MAC CE applies to all the Serving Cells configured in the set simultaneousTCI-
UpdateList1 or simultaneousTCI-UpdateList2, respectively.

| | |
|---|---|
| - | BWP ID: This field indicates a DL BWP for which the MAC CE applies as the |

codepoint of the DCI bandwidth part indicator field as specified in TS 38.212 [9]. The length of
the BWP ID field is 2 bits.

| | |
|---|---|
| - | Cᵢ: This field indicates whether the octet containing TCI state ID_{i, 2} is present. If this |

field is configured as “1”, the octet containing TCI state ID_{i, 2} is present. If this field is configured
as “0”, the octet containing TCI state ID_{i, 2} is not present.

| | |
|---|---|
| - | TCI state ID_{i, j}: This field indicates the TCI state identified by TCI-StateId as specified |

in TS 38.331 [5], where i is the index of the codepoint of the DCI Transmission configuration
indication field as specified in TS 38.212 [9] and TCI state ID_{i, j} denotes the j-th TCI state
indicated for the i-th codepoint in the DCI Transmission Configuration Indication field. The TCI
codepoint to which the TCI States are mapped is determined by its ordinal position among all
the TCI codepoints with sets of TCI state ID_{i, j} fields, i.e. the first TCI codepoint with TCI state
ID_{0, 1} and TCI state ID_{0, 2} shall be mapped to the codepoint value 0, the second TCI codepoint
with TCI state ID_{1, 1} and TCI state ID_{1, 2} shall be mapped to the codepoint value 1 and so on. The
TCI state ID_{i, 2} is optional based on the indication of the Ci field. The maximum number of
activated TCI codepoint is 8 and the maximum number of TCI states mapped to a TCI codepoint
is 2.

| | |
|---|---|
| - | R: Reserved bit, set to “0”. |

In FIG. 15, if the value of a Co field 1505 is 1, the corresponding MAC-CE may include a TCI state ID_{0.2} field 1515 in addition to a TCI state ID_{0.1} field 1510. This means the corresponding TCI state ID_{0.1} and TCI state ID_{0.2} are activated for the 0th codepoint of the TCI state field included in the DCI, and if the base station indicates the corresponding codepoint to the UE, the UE may be indicated with two TCI states. If the value of the Co field 1505 is 0, the corresponding MAC-CE may not include the TCI state ID_{0.2} field 1515. This signifies that one TCI state corresponding to TCI state ID_{0.1} is activated for the 0th codepoint of the TCI state field included in the DCI.

The above configuration may be independent for each cell or for each BWP. For example, the PCell may have a maximum of two activated TCI states corresponding to one TCI codepoint, whereas a specific SCell may have a maximum of one activated TCI states corresponding to one TCI codepoint. Here, the NC-JT transmission may be considered as being configured in the PCell, whereas the NC-JT transmission is not configured in the aforementioned SCell.

Method for distinguishing Multi-TRP PDSCH repetition schemes based on Single-DCI (TDM/FDM/SDM)

Next, a method for distinguishing multi-TRP PDSCH repetition schemes based on single-DCI will be described. The UE may be indicated with different multi-TRP PDSCH repetition schemes based on single-DCI (e.g., time division multiplexing (TDM), frequency division multiplexing (FDM), spatial division multiplexing (SDM) according to the value indicated via the DCI field from the base station and the higher layer signaling configuration. Table 24 below shows a method for distinguishing between single or multiple TRP-based schemes indicated for the UE according to the value of a specific DCI field and higher layer signaling configuration.

TABLE 24

| | | | repetitionNumber | | Transmission |
|---|---|---|---|---|---|
| | Number | Number | configuration & | repetitionScheme | schemed |
| | of TCI | of CDM | indication | configuration | indicated |
| Combination | states | groups | condition | related | for UE |
| 1 | 1 | ≥1 | Condition 2 | Not configured | Single-TRP |
| 2 | 1 | ≥1 | Condition 2 | Configured | Single-TRP |
| 3 | 1 | ≥1 | Condition 3 | Configured | Single-TRP |
| 4 | 1 | 1 | Condition 1 | Configured or | Single-TRP |
| | | | | not configured | TDM scheme B |
| 5 | 2 | 2 | Condition 2 | Not configured | Multi-TRP SDM |
| 6 | 2 | 2 | Condition 3 | Not configured | Multi-TRP SDM |
| 7 | 2 | 2 | Condition 3 | Configured | Multi-TRP SDM |
| 8 | 2 | 1 | Condition 3 | Configured | Multi-TRP FDM |
| | | | | | scheme A/FDM |
| | | | | | scheme B/TDM |
| | | | | | scheme A |
| 9 | 2 | 1 | Condition 1 | Not configured | Multi-TRP |
| | | | | | TDM scheme B |

In Table 24, each column can be described as follows:
Number of TCI states (column 2): This refers to the number of TCI states indicated by the TCI state field in the DCI, and may be one or two.
Number of CDM groups (column 3): This refers to the number of different CDM groups of DMRS ports indicated by the antenna port field in the DCI. It may be 1, 2 or 3.
repetitionNumber configuration and indication condition (column 4): There may be three conditions depending on whether repetition Number is configured for all TDRA entries that can be indicated by a time domain resource allocation field in the DCI and whether the actually indicated TDRA entry has repetitionNumber configuration.
   Condition 1: In case that at least one of all TDRA entries that can be indicated by the time domain resource allocation field includes a configuration for repetitionNumber, and the TDRA entry indicated by the time domain resource allocation field in the DCI includes a configuration for repetitionNumber greater than 1.
   Condition 2: In case that at least one of all TDRA entries that can be indicated by the time domain resource allocation field includes a configuration for repetitionNumber, and the TDRA entry indicated by the time domain resource allocation field in the DCI does not include a configuration for repetitionNumber.
   Condition 3: In case that all TDRA entries that can be indicated by the time domain resource allocation field do not include a configuration for repetitionNumber.
repetitionScheme configuration related (column 5): This indicates whether repetitionScheme, which is a higher layer signaling, is configured. One of ‘tdmSchemeA’, ‘fdmSchemeA’, and ‘fdmSchemeB’ may be configured for repetitionScheme, which is higher layer signaling.
Transmission scheme indicated for the UE (column 6): This refers to single or multiple TRP schemes indicated according to each combination (column 1) shown in Table 24, above.
   Single-TRP: This refers to single-TRP based PDSCH transmission. When the UE is configured with pdsch-AggegationFactor in the higher layer signaling PDSCH-config, the UE may be scheduled with single-TRP based PDSCH repetition as many times as the configured number of times. Otherwise, the UE may be scheduled with a single-TRP based PDSCH single transmission.
   Single-TRP TDM scheme B: This refers to PDSCH repetition based on time resource division between slots based on single TRP. According to the above-described repetition Number related Condition 1, the UE repeatedly transmits the PDSCH on time resources by the number of slots having the repetition Number greater than 1 configured in the TDRA entry indicated by the time domain resource allocation field. At this time, the same start symbol and symbol length of the PDSCH indicated by the TDRA entry are applied to each slot as many times as repetitionNumber, and the same TCI state is applied to each PDSCH repetition. This scheme is similar to the slot aggregation scheme in that it performs PDSCH scheme between slots on time resources, but is different from the slot aggregation in that it is possible to dynamically determine whether to indicate repetition based on the time domain resource allocation field in the DCI.
   Multi-TRP SDM: This refers to a PDSCH transmission scheme based on multi-TRP based spatial resource division. This is a method of receiving each TRP by dividing layers. Although it is not a repetition method, it is possible to increase the reliability of PDSCH transmission in that transmission is possible at a lower coding rate by increasing the number of layers. The UE may receive the PDSCH by applying two TCI states indicated through the TCI state field in the DCI to two CDM groups indicated by the base station, respectively.
   Multi-TRP FDM scheme A: This refers to a PDSCH transmission scheme based on multi-TRP based frequency resource division. Although it is not a repetition method like multi-TRP SDM because it has one PDSCH transmission occasion, it is a scheme capable of transmission with high reliability by increasing the frequency resource amount and lowering the coding rate. Multi-TRP FDM scheme A may apply two TCI states indicated through the TCI state field in the DCI to frequency resources that do not overlap each other, respectively. If the PRB bundling size is determined to be wideband, and if the number of RBs indicated by the FDRA field is N, the UE receives the first ceil(N/2) RBs by applying the first TCI state and the remaining floor(N/2) RBs by applying the second TCI state. Here, ceil(.) and floor(.) are operators for rounding up and rounding off the first decimal place. If the PRB bundling size is determined to be 2 or 4, even-numbered PRGs apply the first TCI state, and odd-numbered PRGs apply the second TCI state.
   Multi-TRP FDM scheme B: This refers to a PDSCH repetition scheme based on multi-TRP based frequency resource division, and is capable of repeatedly transmitting the PDSCH at two PDSCH transmission occasions. Multi-TRP FDM scheme B, like A, may also apply two TCI states indicated through the TCI state field in the DCI to non-overlapping frequency resources, respectively. If the PRB bundling size is determined to be wideband, and if the number of RBs indicated by the FDRA field is N, the UE receives the first ceil(N/2) RBs by applying the first TCI state and the remaining floor(N/2) RBs by applying the second TCI state. Here, ceil(.) and floor(.) are operators for rounding up and rounding off the first decimal place. If the PRB bundling size is determined to be 2 or 4, even-numbered PRGs apply the first TCI state, and odd-numbered PRGs apply the second TCI state.
   Multi-TRP TDM scheme A: This refers to a PDSCH repetition scheme in a multi-TRP based time resource division slot. The UE has two PDSCH transmission occasions in one slot, and the first reception occasion may be determined based on the start symbol and symbol length of the PDSCH indicated through the time domain resource allocation field in the DCI. The start symbol of the second reception occasion of the PDSCH may be a position to which a symbol offset is applied as much as StartingSymbolOffsetK, which is higher layer signaling, from the last symbol of the first transmission occasion, and the transmission occasion may be determined by the symbol length indicated therefrom. If StartingSymbolOffsetK, which is higher layer signaling, is not configured, the symbol offset may be regarded as 0.
   Multi-TRP TDM scheme B: This refers to a PDSCH repetition scheme between multi-TRP based time resource division slots. The UE has one PDSCH transmission occasion in one slot, and may receive repetition based on the start symbol and symbol length of the same PDSCH for the number of repetition Number times indicated through the time domain resource allocation field in the DCI. If repetitionNumber is 2, the UE may receive PDSCH repetitions in the first and second slots by applying the first and second TCI states, respectively. If repetitionNumber is greater than 2, the UE may use different TCI state applying schemes depending on a scheme in which tciMapping, which is higher layer signaling, is configured. If tciMapping is configured as cyclicMapping, the first and second TCI states are applied to the first and second PDSCH transmission occasions, respectively, and this TCI state applying method is equally applied to the remaining PDSCH transmission occasions. If tciMapping is configured as sequentialMapping, the first TCI state is applied to the first and second PDSCH transmission occasions, and the second TCI state is applied to the third and fourth PDSCH transmission occasions. The same TCI state applying method is applied to the remaining PDSCH transmission occasions.

Hereinafter, embodiments of the disclosure will be described in detail with reference to the accompanying drawings. The content in the disclosure is applicable in FDD and TDD systems. As used herein, upper signaling (or upper layer signaling) is a method for transferring signals from a base station to a UE by using a downlink data channel of a physical layer, or from the UE to the base station by using an uplink data channel of the physical layer, and may also be referred to as RRC signaling, PDCP signaling, or a medium access control (MAC) control element (MAC CE).

Hereinafter, in the disclosure, the UE may use various methods to determine whether or not to apply cooperative communication, for example, PDCCH(s) that allocates a PDSCH to which cooperative communication is applied have a specific format, or PDCCH(s) that allocates a PDSCH to which cooperative communication is applied include a specific indicator indicating whether or not to apply cooperative communication, or PDCCH(s) that allocates a PDSCH to which cooperative communication is applied are scrambled by a specific RNTI, or cooperative communication application is assumed in a specific range indicated by an upper layer. Hereinafter, it will be assumed, for convenience of description, that NC-JT case refers to a case in which the UE receives a PDSCH to which cooperative communication is applied, based on conditions similar to those described above.

Hereinafter, the description that priority between A and B is determined may be variously mentioned, such as the entity having a high priority is selected according to a predetermined priority rule, and a corresponding operation is performed, or operations regarding the entity having a lower priority is omitted or dropped.

Hereinafter, the above examples may be described through multiple embodiments, but they are not independent of each other, and one or more embodiments may be applied simultaneously or in combination.

Hereinafter, for convenience of description, a cell, a transmission point, a panel, a beam, and/or a transmission direction which can be distinguished through an upper layer/L1 parameter such as a TCI state or spatial relation information, a cell ID, a TRP ID, or a panel ID may be described as a transmission reception point (TRP), a beam, or a TCI state as a whole. Therefore, during actual application, a TRP, a beam, or a TCI state may be appropriately replaced with one of the above terms.

Hereinafter, in the disclosure, the UE may use various methods to determine whether or not to apply cooperative communication, for example, PDCCH(s) that allocates a PDSCH to which cooperative communication is applied have a specific format, or PDCCH(s) that allocates a PDSCH to which cooperative communication is applied include a specific indicator indicating whether or not to apply cooperative communication, or PDCCH(s) that allocates a PDSCH to which cooperative communication is applied are scrambled by a specific RNTI, or cooperative communication application is assumed in a specific range indicated by an upper layer. Hereinafter, it will be assumed, for convenience of description, that NC-JT case refers to a case in which the UE receives a PDSCH to which cooperative communication is applied, based on conditions similar to those described above.

Hereinafter, embodiments of the disclosure will be described in detail with reference to the accompanying drawings. Hereinafter, a base station refers to an entity that allocates resources to a terminal, and may be at least one of a gNode B, a gNB, an eNode B, a node B, a base station (BS), a radio access unit, a base station controller, or a node on a network. A terminal may include user equipment (UE), a mobile station (MS), a cellular phone, a smart phone, a computer, or a multimedia system capable of performing a communication function. Hereinafter, although embodiments of the disclosure will be described with reference to a 5G system as an example, embodiments of the disclosure are also applicable to other communication systems having similar technical backgrounds or channel types. For example, LTE or LTE-A mobile communications and mobile communication technologies developed after 5G may be included therein. Therefore, embodiments of the disclosure are also applicable to other communication systems through a partial modification without substantially deviating from the scope of the disclosure as deemed by those skilled in the art. The content in the disclosure is applicable in FDD and TDD systems.

In addition, in the following description of the disclosure, detailed descriptions of related functions or configurations will be omitted if deemed to unnecessarily obscure the gist of the disclosure. The terminology used herein is defined in view of functions in the disclosure, and may be varied depending on the intent of the user/operator, practices, and the like. Therefore, the definition thereof is to be made based on the overall context of the disclosure.

In the following description of the disclosure, upper layer signaling may refer to signaling corresponding to at least one among the following signaling, or a combination of one or more thereof:
Master information block (MIB);
System information block (SIB) or SIB X (X=1, 2, . . . );
Radio resource control (RRC); and
Medium access control (MAC) control element (CE).

In addition, L1 may refer to signaling corresponding to at least one among signaling methods using the following physical layer channel or signaling, or a combination of one or more thereof:
Physical Downlink Control Channel (PDCCH);
Downlink Control Information (DCI);
UE-specific DCI;
Group common DCI;
Common DCI;
Scheduling DCI (for example, DCI used for the purpose of scheduling downlink or uplink data);
Non-scheduling DCI (for example, DCI not used for the purpose of scheduling downlink or uplink data);
Physical Uplink Control Channel (PUCCH); and
Uplink Control Information (UCI).

Hereinafter, the description that priority between A and B is determined may be variously mentioned, such as the entity having a high priority is selected according to a predetermined priority rule, and a corresponding operation is performed, or operations regarding the entity having a lower priority is omitted or dropped.

As used herein, the term “slot” may generally refer to a specific time unit corresponding to a transmit time interval (TTI), may specifically refer to a slot used in a 5G NR system, or may refer to a slot or a subframe used in a 4G LTE system.

Hereinafter, the above examples may be described through multiple embodiments, but they are not independent of each other, and one or more embodiments may be applied simultaneously or in combination.

### First Embodiment: TRP-Specific BFR Method Using a Unified TCI State Method in a Multi-DCI-Based Multi-TRP

As an embodiment of the disclosure, a BFR method for each TRP using a unified TCI state method in a multi-DCI-based multi-TRP environment is described. Conditions commonly applied in situations to be described later in this embodiment may be as follows:
Multi-DCI-based multi-TRP environment: In this embodiment, a multi-DCI-based multi-TRP environment may be assumed. As described above, a multi-DCI multi-TRP environment may refer to a case in which a UE is configured with two different CORESETPoolIndexes. More specifically, a UE may be assumed to operate in a multi-DCI-based multi-TRP environment when the UE i) is not configured with coresetPoolIndex, which is higher layer signaling, within an activated downlink bandwidth part in a serving cell, or includes one or more first CORESETs configured with a coresetPoolIndex of 0, and ii) includes one or more second CORESETs configured with a coresetPooIndex having a value of 1, which is higher layer signaling, within the same active downlink bandwidth part in the serving cell.
Using unified TCI state: In this embodiment, an environment may be assumed in which the UE uses the unified TCI state described above. More specifically, the use of unified TCI state may refer to a case in which the UE is configured with TCI-State_r17, which is higher layer signaling having a meaning that the UE operates in a unified TCI method within a specific serving cell, in a PCell or primary secondary cell group (SCG) Cell (primary secondary cell) (PSCell).
BFD-RS sets and candidate beam RS sets: In this embodiment, the following assumptions may be made about BFD-RS sets and candidate beam RSs. The UE may be configured with two BFD-RS sets and two candidate beam RS sets as described above. A first BFD-RS set is associated with a first candidate beam RS set, and a second BFD-RS set is associated with a second candidate beam RS set. The UE may receive a configuration for the first BFD-RS set and the second BFD-RS set from the base station via failureDetectionSet1 and failureDetectionSet2, which are higher layer signaling. When the UE does not receive a configuration for the first BFD-RS set and the second BFD-RS set from the base station via failureDetectionSet1 and failureDetectionSet2, which are higher layer signaling, the UE may include, in the first BFD-RS set, some or all of RSs referenced by the activated TCI state in one or more first CORESETs in which the coresetPoolIndex value, which is higher layer signaling, is configured as 0, or the coresetPoolIndex value is not configured, and the UE may include, in the second BFD-RS set, some or all of RSs referenced by activated the TCI state in one or more second CORESETs in which the coresetPoolIndex value, which is higher layer signaling, is configured as 1. The UE may report, to the base station, the maximum number of RSs for each BFD-RS set and the maximum number of total RSs included within two BFD-RS sets, as UE capability information. Based on the UE capability information, the UE may receive a configuration of the first and second BFD-RS sets via higher layer signaling, as described above. In addition, in case that the UE has not received a configuration of the first and second BFD-RS sets via higher layer signaling, when the UE has configured the first and second BFD-RS sets using some or all of the RSs referenced in the activated TCI state in the first and second CORESETs, the UE may expect the number of RSs for each BFD-RS set and the total number of RSs included in two BFD-RS sets to be smaller than or equal to the UE capability value reported to the base station. When the UE has not received a configuration of the first and second BFD-RS sets from the base station via failureDetectionSet1 and failureDetectionSet2 which are higher layer signaling, and the total number of RSs referenced by the activated TCI state in the first and second CORESETs is greater than the maximum value of the total number of RSs included in the two BFD-RS sets reported as the UE capability, the UE may first select an RS referenced in the activated TCI state in a CORESET having a short period of a search space to which the CORESET is connected, among the multiple first and second CORESETs. When the search spaces connected to multiple first and second CORESETs have the same period, the UE may first select an RS referenced in the activated TCI state in a CORESET having a high index.
Regarding link recovery request (LRR): In this embodiment, the following may be assumed regarding an LRR for a BFRQ of a UE. If the PCell and PSCell are associated with the first BFD-RS set and the first candidate beam RS set associated therewith, and are associated with the second BFD-RS set and the second candidate beam RS set associated therewith, the UE may report to the base station that there are two LRRs that may be configured via higher layer signaling by the base station through twoLRRcapacity, which is UE capacity report. The UE not performing the reporting may receive configuration information for the first LRR from the base station via schedulingRequestID-BFR which is higher layer signaling, and the UE performing the reporting may receive additional configuration information for the second LRR from the base station via schedulingRequestID-BFR2 which is higher layer signaling. When the UE has only received a configuration for the first LRR from the base station via higher layer signaling, the UE may perform PUCCH transmission for the LRR for the first and second BFD-RS set. When the UE receives a configuration for the first and second LRRs from the base station via higher layer signaling, the UE may use configuration information about the first LRR for the first BFD-RS set and configuration information about the second LRR for the second BFD-RS set.

In the following, the above conditions may be assumed by default when defining the operation of the UE and the base station, unless otherwise stated.

### Intra-Cell Multi-TRP Operation

When a UE is not configured with SSB-MTCAdditionalPCI, which is higher layer signaling, that is, when all TRPs have the same physical cell ID as the physical cell ID of a serving cell, the UE and the base station may refer to operating in an intra-cell multi-TRP environment.

When the first BFD-RS set, the second BFD-RS set, or both two BFD-RS sets are identified as in a beam failure situation as described above, the UE may transmit the LRR to the base station, and the base station may transmit a (1-1)th PDCCH corresponding thereto to the UE so as to indicate second PUSCH scheduling information (scheduling information for a second PUSCH). The second PUSCH may include an enhanced BFR MAC-CE or a truncated enhanced BFR MAC-CE. The enhanced BFR MAC-CE or truncated enhanced BFR MAC-CE may include at least one of the following pieces of information:
Cell index(es) corresponding to a single BFD-RS set having a link quality lower than a reference value.
Whether a selected candidate beam RS exists in each single candidate beam RS set within the cell index(es) corresponding to the single BFD-RS set, and if existing, the index of the candidate beam RS.
Cell index(es) in which at least one of the first and second BFD-RS sets has a link quality lower than the reference value.
   Index(es) of the BFD-RS set, which has a link quality lower than the reference value, among the first and second BFD-RS sets. As an example, the BFD-RS set index(es) may be included in enhanced BFR MAC-CE or truncated enhanced BFR MAC-CE together with the cell index(es). As an example, the BFD set index(es) may correspond to lower layer information of the cell index(es).
In each of the first and second sets of candidate beam RSs within the cell index(es) corresponding to the first and second BFD-RS sets, whether the selected candidate beam RS exists, and if existing, the index of the candidate beam RS for each set.

For the serving cell(s), which are associated with the first BFD-RS set and the first candidate beam RS set associated therewith, and are associated with the second BFD-RS set and the second candidate beam RS set associated therewith, after 28 symbols from a last symbol of a (2-1)th PDCCH reception including the same HARQ process ID field and toggled NDI field value as those of a (1-1)th PDCCH that has scheduled the second PUSCH, the UE may perform a combination of at least one of the following operations:
The UE may follow QCL parameter assumptions of a candidate beam RS selected from the first candidate beam RS set during monitoring of the first CORESET, in which coresetPoolIndex, which is higher layer signaling, is not configured, or in which the coresetPoolIndex is configured as 0.
The UE may assume that the reception of a scheduled PDSCH from all of the first CORESETs has the same QCL parameter as that of the reception of a candidate beam RS selected from the first candidate beam RS set.
The UE may assume that the reception of an aperiodic CSI-RS resource under a specific condition has the same QCL parameters as that of the reception of the candidate beam RS selected from the first candidate beam RS set. In this case, the aperiodic CSI-RS resource of the specific condition may be a combination of at least one of the following:
   The aperiodic CSI-RS resource may refer to a case in which a specific coresetPoolIndex (e.g., coresetPoolIndex 0) is configured within the aperiodic CSI-RS resource or a CSI-RS resource set including the aperiodic CSI-RS resource. The case in which a specific coresetPoolIndex (e.g., coresetPoolIndex 0) for a specific aperiodic CSI-RS resource or a specific CSI-RS resource set has been configured for the UE may signify that the UE may receive the corresponding aperiodic CSI-RS resource or aperiodic CSI-RS resources within the corresponding CSI-RS resource set by using a unified TCI state indicated via DCI transmitted from a specific CORESET (e.g., a first CORESET) in which a specific coresetPoolIndex (e.g., coresetPoolIndex 0) has been configured.
   The aperiodic CSI-RS resource may refer to a case in which specific higher layer signaling has been configured within the aperiodic CSI-RS resource, or within a CSI-RS resource set including the aperiodic CSI-RS resource, and in which the specific higher layer signaling is associated with the coresetPoolIndex. The case in which specific higher layer signaling for a specific aperiodic CSI-RS resource or a specific CSI-RS resource set has been configured for the UE and the configured higher layer signaling has been associated with a specific coresetPoolIndex (e.g., coresetPoolIndex 0) may signify that the UE may receive the corresponding aperiodic CSI-RS resource or aperiodic CSI-RS resources within the corresponding CSI-RS resource set by using a unified TCI state indicated via DCI transmitted from a specific CORESET (e.g., a first CORESET) in which a specific coresetPoolIndex (e.g., coresetPoolIndex 0) has been configured.
   The aperiodic CSI-RS resource may signify that, when DCI triggering the CSI-RS resource set including the aperiodic CSI-RS resource is transmitted from a specific CORESET (e.g., a first CORESET) in which a specific coresetPoolIndex (e.g., coresetPoolIndex 1) has been configured, the aperiodic CSI-RS resources included within the corresponding CSI-RS resource set may be received by the UE using a unified TCI state indicated by the DCI transmitted from the corresponding CORESET in which the corresponding coresetPoolIndex has been configured.
The UE may use a spatial domain filter used to receive a candidate beam RS selected from the first candidate beam RS set during transmission of the scheduled PUSCH in all of the first CORESETs.
The UE may use a spatial domain filter used to receive a candidate beam RS selected from the first candidate beam RS set during transmission of a PUCCH of a specific condition. In this case, the PUCCH of the specific condition may be a combination of at least one of the following:
   The PUCCH may refer to a case in which a specific coresetPoolIndex (e.g., coresetPoolIndex 0) is configured in the corresponding PUCCH resource. The case in which a specific coresetPoolIndex (e.g., coresetPoolIndex 0) for a specific PUCCH resource has been configured for the UE may signify that the PUCCH resource may be transmitted by the UE using a unified TCI state indicated by DCI transmitted from a specific CORESET (e.g., the first CORESET) in which a specific coresetPoolIndex (e.g., coresetPoolIndex 0) has been configured.
   The PUCCH may refer to a case in which specific higher layer signaling has been configured within the PUCCH resource, and the specific higher layer signaling is associated with the coresetPoolIndex. The case in which specific higher layer signaling for a specific PUCCH resource has been configured for the UE and the configured higher layer signaling has been associated with a specific coresetPoolIndex (e.g., coresetPoolIndex 0) may signify that the PUCCH resource may be transmitted by the UE using a unified TCI state indicated by DCI transmitted from a specific CORESET (e.g., the first CORESET) in which a specific coresetPoolIndex (e.g., coresetPoolIndex 0) has been configured.
   The PUCCH may signify that, when DCI triggering the PUCCH resource is transmitted from a specific CORESET (e.g., the first CORESET) having a specific coresetPoolIndex (e.g., coresetPoolIndex 0) configured, the PUCCH resource may be transmitted by the UE using the unified TCI state indicated by the DCI transmitted from the corresponding CORESET in which the corresponding coresetPoolIndex has been configured.
The UE may use the spatial domain filter used to receive a candidate beam RS selected from the first candidate beam RS set during transmission of an SRS of a specific condition. In this case, the SRS of the specific condition may be a combination of at least one of the following:
   The SRS may refer to a case in which a specific coresetPoolIndex (e.g., coresetPoolIndex 0) is configured within the SRS resource or a SRS resource set including the SRS resource. The case in which a specific coresetPoolIndex (e.g., coresetPoolIndex 0) for a specific SRS resource or a specific SRS resource set including the corresponding SRS resource has been configured for the UE may signify that the UE may transmit the corresponding SRS resource or the SRS resources within the SRS resource set including the corresponding SRS resource by using a unified TCI state indicated via DCI transmitted from a specific CORESET (e.g., a first CORESET) in which a specific coresetPoolIndex (e.g., coresetPoolIndex 0) has been configured.
   The SRS may refer to a case in which specific higher layer signaling has been configured within the SRS resource, or within an SRS resource set including the SRS resource, and in which the specific higher layer signaling is associated with the coresetPoolIndex. The case in which specific higher layer signaling for a specific SRS resource or a specific SRS resource set including the corresponding SRS resource has been configured for the UE and the configured higher layer signaling has been associated with a specific coresetPoolIndex (e.g., coresetPoolIndex 0) may signify that the UE may transmit the corresponding SRS resource or the SRS resources within the SRS resource set including the corresponding SRS resource by using a unified TCI state indicated via DCI transmitted from a specific CORESET (e.g., a first CORESET) in which a specific coresetPoolIndex (e.g., coresetPoolIndex 0) has been configured.
   The SRS may signify that, when DCI triggering the SRS resource set including the SRS resource is transmitted from a specific CORESET (e.g., a first CORESET) having a specific coresetPoolIndex (e.g., coresetPoolIndex 1) configured, the corresponding SRS resource or the SRS resources included within the corresponding SRS resource set including the corresponding SRS resource may be transmitted by the UE using a unified TCI state indicated by the DCI transmitted from the corresponding CORESET in which the corresponding coresetPoolIndex has been configured.
When the UE transmits a PUSCH using a spatial domain filter that the UE used to receive a candidate beam RS selected from the first candidate beam RS set, power control parameters for the corresponding PUSCH transmission of the UE may follow a combination of at least one of the following:
   A candidate beam RS selected from the first candidate beam RS set may be used as a pathloss reference signal for the PUSCH transmission, and the UE may measure a downlink pathloss value by using the selected candidate beam RS.
   As a method of determining the power control parameters for the PUSCH transmission, the UE may use p0, alpha, and PUSCH power control adjustment state included in the p0-Alpha-CLID-PUSCH-Set associated with ul-powercontrolId of the lowest value in Uplink-powerControl, which is higher layer signaling, in the corresponding PCell, PSCell, SCell, or serving cell. In other words, the p0, alpha, and PUSCH power control adjustment state included in the p0-Alpha-CLID-PUSCH-Set associated with the ul-powercontrolId of the lowest value in the Uplink-powerControl, which is higher layer signaling, in the corresponding PCell, PSCell, SCell, or serving cell may be determined as the power control parameter for the PUSCH transmission.
   As another method of determining the power control parameters for PUSCH transmissions, the UE may use the p0, alpha, and PUSCH power control adjustment state included in the p0-Alpha-CLID-PUSCH-Set associated with ul-powercontrolId of the lowest value in Uplink-powerControl configured with coresetPoolIndex of 0, which is higher layer signaling in the corresponding PCell, PSCell, SCell, or serving cell. In other words, the p0, alpha, and PUSCH power control adjustment state included in the p0-Alpha-CLID-PUSCH-Set associated with the ul-powercontrolId of the lowest value in the Uplink-powerControl configured with coresetPoolIndex of 0, which is higher layer signaling, in the corresponding PCell, PSCell, SCell, or serving cell, may be determined as the power control parameter for the PUSCH transmission.
   As yet another method of determining the power control parameters for PUSCH transmissions, the UE may use the p0, alpha, and PUSCH power control adjustment state included in the p0-Alpha-CLID-PUSCH-Set associated with ul-powercontrolId of the lowest value within the first list (e.g., Uplink-powerControl1-r18) among two lists for the unified TCI state-based power control parameters configured by higher layer signaling in the corresponding PCell, PSCell, SCell, or serving cell. In other words, the p0, alpha, and PUSCH power control adjustment state, which are included within the p0-Alpha-CLID-PUSCH-Set associated with ul-powercontrolld of the lowest value within the first list (e.g., Uplink-powerControl1-r18) among two lists for unified TCI state-based power control parameters configured by higher layer signaling in the corresponding PCell, PSCell, SCell, or serving cell, may be determined as the power control parameter for the PUSCH transmission.
When the UE transmits a PUCCH using the spatial domain filter that the UE used to receive a candidate beam RS selected from the first candidate beam RS set, the power control parameters for the corresponding PUCCH transmission of the UE may follow a combination of at least one of the following:
   A candidate beam RS selected from the first candidate beam RS set may be used as a pathloss reference signal for the PUCCH transmission, and the UE may measure a downlink pathloss value by using the selected candidate beam RS.
   As a method of determining the power control parameters for the PUCCH transmission, the UE may use p0, alpha, and PUCCH power control adjustment state included in the p0-Alpha-CLID-PUCCH-Set associated with ul-powercontrolId of the lowest value in Uplink-powerControl, which is higher layer signaling, in the corresponding PCell, PSCell, SCell, or serving cell. In other words, the p0, alpha, and PUCCH power control adjustment state included in the p0-Alpha-CLID-PUSCH-Set associated with the ul-powercontrolId of the lowest value of the Uplink-powerControl, which is higher layer signaling, in the corresponding PCell, PSCell, SCell, or serving cell may be determined as the power control parameter for the PUCCH transmission.
   As another method of determining the power control parameters for PUCCH transmissions, the UE may use the p0, alpha, and PUCCH power control adjustment state included in the p0-Alpha-CLID-PUCCH-Set associated with ul-powercontrolId of the lowest value in Uplink-powerControl configured with coresetPoolIndex of 0, which is higher layer signaling in the corresponding PCell, PSCell, SCell, or serving cell. In other words, the p0, alpha, and PUCCH power control adjustment state included in the p0-Alpha-CLID-PUSCH-Set associated with the ul-powercontrolId of the lowest value of the Uplink-powerControl configured with coresetPoolIndex of 0, which is higher layer signaling, in the corresponding PCell, PSCell, SCell, or serving cell, may be determined as the power control parameter for the PUCCH transmission.
   As yet another method of determining the power control parameters for PUCCH transmissions, the UE may use the p0, alpha, and PUCCH power control adjustment state included in the p0-Alpha-CLID-PUCCH-Set associated with ul-powercontrolId of the lowest value within the first list (e.g., Uplink-powerControl1-r18) among two lists for the unified TCI state-based power control parameters configured by higher layer signaling in the corresponding PCell, PSCell, SCell, or serving cell. In other words, the p0, alpha, and PUCCH power control adjustment state, which are included within the p0-Alpha-CLID-PUCCH-Set associated with ul-powercontrolId of the lowest value within the first list (e.g., Uplink-powerControl1-r18) among two lists for unified TCI state-based power control parameters configured by higher layer signaling in the corresponding PCell, PSCell, SCell, or serving cell, may be determined as the power control parameter for the PUCCH transmission.
When the UE transmits an SRS using a spatial domain filter that was used when the UE received the candidate beam RS selected from the first candidate beam RS set, the power control parameters for the corresponding SRS transmission of the UE may follow a combination of at least one of the following:
   A candidate beam RS selected from the first candidate beam RS set may be used as a pathloss reference signal for the SRS transmission, and the UE may measure a downlink pathloss value by using the selected candidate beam RS.
   As a method of determining the power control parameters for the SRS transmission, the UE may use p0, alpha, and SRS power control adjustment state included in the p0-Alpha-CLID-SRS-Set associated with ul-powercontrolId of the lowest value in Uplink-powerControl, which is higher layer signaling, in the corresponding PCell, PSCell, SCell, or serving cell. In other words, the p0, alpha, and SRS power control adjustment state included in the p0-Alpha-CLID-SRS-Set associated with the ul-powercontrolId of the lowest value of the Uplink-powerControl, which is higher layer signaling, in the corresponding PCell, PSCell, SCell, or serving cell may be determined as the power control parameter for the SRS transmission.
   As another method of determining the power control parameters for SRS transmissions, the UE may use the p0, alpha, and SRS power control adjustment state included in the p0-Alpha-CLID-SRS-Set associated with ul-powercontrolId of the lowest value in Uplink-powerControl configured with coresetPoolIndex of 0, which is higher layer signaling in the corresponding PCell, PSCell, SCell, or serving cell. In other words, the p0, alpha, and SRS power control adjustment state included in the p0-Alpha-CLID-SRS-Set associated with the ul-powercontrolId of the lowest value of the Uplink-powerControl configured with coresetPoolIndex of 0, which is higher layer signaling, in the corresponding PCell, PSCell, SCell, or serving cell, may be determined as the power control parameter for the SRS transmission.
   As yet another method of determining the power control parameters for SRS transmissions, the UE may use the p0, alpha, and SRS power control adjustment state included in the p0-Alpha-CLID-SRS-Set associated with ul-powercontrolId of the lowest value within the first list (e.g., Uplink-powerControl1-r18) among two lists for the unified TCI state-based power control parameters configured by higher layer signaling in the corresponding PCell, PSCell, SCell, or serving cell. In other words, the p0, alpha, and SRS power control adjustment state, which are included within the p0-Alpha-CLID-SRS-Set associated with ul-powercontrolId of the lowest value within the first list (e.g., Uplink-powerControl1-r18) among two lists for unified TCI state-based power control parameters configured by higher layer signaling in the corresponding PCell, PSCell, SCell, or serving cell, may be determined as the power control parameter for the SRS transmission.
The UE may follow the QCL parameter assumptions of the candidate beam RS selected from the second candidate beam RS set when monitoring all of the second CORESETs in which coresetPoolIndex, which is higher layer signaling, is configured as 1.
The UE may assume that the reception of a scheduled PDSCH in all of the second CORESETs has the same QCL parameters as the reception of a candidate beam RS selected from the second candidate beam RS set.
The UE may assume that the reception of an aperiodic CSI-RS resource of a specific condition has the same QCL parameters as the reception of a candidate beam RS selected from the second candidate beam RS set. In this case, the aperiodic CSI-RS resource under the above specific condition may be a combination of at least one of the following:
   The aperiodic CSI-RS resource may refer to a case in which a specific coresetPoolIndex (e.g., coresetPoolIndex 1) is configured within the aperiodic CSI-RS resource or a CSI-RS resource set including the aperiodic CSI-RS resource. The case in which a specific coresetPoolIndex (e.g., coresetPoolIndex 1) for a specific aperiodic CSI-RS resource or a specific CSI-RS resource set has been configured for the UE may signify that the UE may receive the corresponding aperiodic CSI-RS resource or aperiodic CSI-RS resources within the corresponding CSI-RS resource set by using a unified TCI state indicated via DCI transmitted from a specific CORESET (e.g., a second CORESET) in which a specific coresetPoolIndex (e.g., coresetPoolIndex 1) has been configured.
   The aperiodic CSI-RS resource may refer to a case in which specific higher layer signaling has been configured within the aperiodic CSI-RS resource, or within a CSI-RS resource set including the aperiodic CSI-RS resource, and in which the specific higher layer signaling is associated with the coresetPoolIndex. The case in which specific higher layer signaling for a specific aperiodic CSI-RS resource or a specific CSI-RS resource set has been configured for the UE and the configured higher layer signaling has been associated with a specific coresetPoolIndex (e.g., coresetPoolIndex 1) may signify that the UE may receive the corresponding aperiodic CSI-RS resource or aperiodic CSI-RS resources within the corresponding CSI-RS resource set by using a unified TCI state indicated via DCI transmitted from a specific CORESET (e.g., a second CORESET) in which a specific coresetPoolIndex (e.g., coresetPoolIndex 1) has been configured.
   The aperiodic CSI-RS resource may signify that, when DCI triggering the CSI-RS resource set including the aperiodic CSI-RS resource is transmitted from a specific CORESET (e.g., a second CORESET) in which a specific coresetPoolIndex (e.g., coresetPoolIndex 1) has been configured, the aperiodic CSI-RS resources included within the corresponding CSI-RS resource set may be received by the UE using a unified TCI state indicated by the DCI transmitted from the corresponding CORESET in which the corresponding coresetPoolIndex has been configured.
The UE may use a spatial domain filter used to receive a candidate beam RS selected from the second candidate beam RS set during transmission of a scheduled PUSCH in all of the second CORESETs.
The UE may use a spatial domain filter used to receive a candidate beam RS selected from the second candidate beam RS set during transmission of a PUCCH of a specific condition. In this case, the PUCCH of the specific condition may be a combination of at least one of the following:
   The PUCCH may refer to a case in which a specific coresetPoolIndex (e.g., coresetPoolIndex 1) is configured in the corresponding PUCCH resource. The case in which a specific coresetPoolIndex (e.g., coresetPoolIndex 1) for a specific PUCCH resource has been configured for the UE may signify that the PUCCH resource may be transmitted by the UE using a unified TCI state indicated by DCI transmitted from a specific CORESET (e.g., the second CORESET) in which a specific coresetPoolIndex (e.g., coresetPoolIndex 1) has been configured.
   The PUCCH may refer to a case in which specific higher layer signaling has been configured within the PUCCH resource, and the specific higher layer signaling is associated with the coresetPoolIndex. The case in which specific higher layer signaling for a specific PUCCH resource has been configured for the UE and the configured higher layer signaling has been associated with a specific coresetPoolIndex (e.g., coresetPoolIndex 1) may signify that the PUCCH resource may be transmitted by the UE using a unified TCI state indicated by DCI transmitted from a specific CORESET (e.g., the second CORESET) in which a specific coresetPoolIndex (e.g., coresetPoolIndex 1) has been configured.
   The PUCCH may signify that, when DCI triggering the PUCCH resource is transmitted from a specific CORESET (e.g., the second CORESET) in which a specific coresetPoolIndex (e.g., coresetPoolIndex 1) has been configured, the PUCCH resource may be transmitted by the UE using the unified TCI state indicated by the DCI transmitted from the corresponding CORESET in which the corresponding coresetPoolIndex has been configured.
The UE may use the spatial domain filter used to receive a candidate beam RS selected from the second set of candidate beam RS during transmission of the SRS of the specific condition. In this case, the SRS of the specific condition may be a combination of at least one of the following:
   The SRS may refer to a case in which a specific coresetPoolIndex (e.g., coresetPoolIndex 1) is configured within the SRS resource or a SRS resource set including the SRS resource. The case in which a specific coresetPoolIndex (e.g., coresetPoolIndex 1) for a specific SRS resource or a specific SRS resource set including the corresponding SRS resource has been configured for the UE may signify that the UE may transmit the corresponding SRS resource or the SRS resources within the SRS resource set including the corresponding SRS resource by using a unified TCI state indicated via DCI transmitted from a specific CORESET (e.g., a second CORESET) in which a specific coresetPoolIndex (e.g., coresetPoolIndex 1) has been configured.
   The SRS may refer to a case in which specific higher layer signaling has been configured within the SRS resource, or within an SRS resource set including the SRS resource, and in which the specific higher layer signaling is associated with the coresetPoolIndex. The case in which specific higher layer signaling for a specific SRS resource or a specific SRS resource set including the corresponding SRS resource has been configured for the UE and the configured higher layer signaling has been associated with a specific coresetPoolIndex (e.g., coresetPoolIndex 1) may signify that the UE may transmit the corresponding SRS resource or the SRS resources within the SRS resource set including the corresponding SRS resource by using a unified TCI state indicated via DCI transmitted from a specific CORESET (e.g., a second CORESET) in which a specific coresetPoolIndex (e.g., coresetPoolIndex 1) has been configured.
   The SRS may signify that, when DCI triggering the SRS resource set including the SRS resource is transmitted from a specific CORESET (e.g., a second CORESET) having a specific coresetPoolIndex (e.g., coresetPoolIndex 1) configured, the corresponding SRS resource or the SRS resources included within the corresponding SRS resource set including the corresponding SRS resource may be transmitted by the UE using a unified TCI state indicated by the DCI transmitted from the corresponding CORESET in which the corresponding coresetPoolIndex has been configured.
When the UE transmits a PUSCH using a spatial domain filter that the UE used to receive a candidate beam RS selected from the second candidate beam RS set, power control parameters for the corresponding PUSCH transmission of the UE may follow a combination of at least one of the following:
   A candidate beam RS selected from the second candidate beam RS set may be used as a pathloss reference signal for the PUSCH transmission, and the UE may measure a downlink pathloss value by using the selected candidate beam RS.
   As a method of determining the power control parameters for the PUSCH transmission, the UE may use p0, alpha, and PUSCH power control adjustment state included in the p0-Alpha-CLID-PUSCH-Set associated with ul-powercontrolId of the lowest value in Uplink-powerControl, which is higher layer signaling, in the corresponding PCell, PSCell, SCell, or serving cell. In other words, the p0, alpha, and PUSCH power control adjustment state included in the p0-Alpha-CLID-PUSCH-Set associated with the ul-powercontrolId of the lowest value in the Uplink-powerControl, which is higher layer signaling, in the corresponding PCell, PSCell, SCell, or serving cell may be determined as the power control parameter for the PUSCH transmission.
   As another method of determining the power control parameters for PUSCH transmissions, the UE may use the p0, alpha, and PUSCH power control adjustment state included in the p0-Alpha-CLID-PUSCH-Set associated with ul-powercontrolId of the second lowest value in Uplink-powerControl having coresetPoolIndex, which is higher layer signaling, in the corresponding PCell, PSCell, SCell, or serving cell. In other words, the p0, alpha, and PUSCH power control adjustment state included in the p0-Alpha-CLID-PUSCH-Set associated with the ul-powercontrolId of the second lowest value in the Uplink-powerControl, which is higher layer signaling, in the corresponding PCell, PSCell, SCell, or serving cell, may be determined as the power control parameter for the PUSCH transmission.
   As yet another method of determining the power control parameters for PUSCH transmissions, the UE may use the p0, alpha, and PUSCH power control adjustment state included in the p0-Alpha-CLID-PUSCH-Set associated with ul-powercontrolId of the lowest value in Uplink-powerControl configured with coresetPoolIndex of 1, which is higher layer signaling, in the corresponding PCell, PSCell, SCell, or serving cell. In other words, the p0, alpha, and PUSCH power control adjustment state, which are included within the p0-Alpha-CLID-PUSCH-Set associated with ul-powercontrolId of the lowest value in Uplink-powerControl configured with coresetPoolIndex of 1, which is higher layer signaling, in the corresponding PCell, PSCell, SCell, or serving cell may be determined as the power control parameter for the PUSCH transmission.
   As still another method of determining the power control parameters for PUSCH transmissions, the UE may use the p0, alpha, and PUSCH power control adjustment state included in the p0-Alpha-CLID-PUSCCH-Set associated with ul-powercontrolId of the lowest value within the second list (e.g., Uplink-powerControl2-r18) among two lists for the unified TCI state-based power control parameters configured by higher layer signaling in the corresponding PCell, PSCell, SCell, or serving cell. At this time, the first list and the second list may be associated with coresetPoolIndices 0 and 1, respectively. In other words, the p0, alpha, and PUSCH power control adjustment state, which are included within the p0-Alpha-CLID-PUSCH-Set associated with ul-powercontrolId of the lowest value within the second list (e.g., Uplink-powerControl2-r18) among two lists for unified TCI state-based power control parameters configured by higher layer signaling in the corresponding PCell, PSCell, SCell, or serving cell, may be determined as the power control parameter for the PUSCH transmission.
When the UE transmits a PUCCH using the spatial domain filter that the UE used to receive a candidate beam RS selected from the second set of candidate beam RS, the power control parameters for the corresponding PUCCH transmission of the UE may follow a combination of at least one of the following:
   A candidate beam RS selected from the second candidate beam RS set may be used as a pathloss reference signal for the PUCCH transmission, and the UE may measure a downlink pathloss value by using the selected candidate beam RS.
   As a method of determining the power control parameters for the PUCCH transmission, the UE may use p0, alpha, and PUCCH power control adjustment state included in the p0-Alpha-CLID-PUCCH-Set associated with ul-powercontrolId of the lowest value in Uplink-powerControl, which is higher layer signaling, in the corresponding PCell, PSCell, SCell, or serving cell. In other words, the p0, alpha, and PUCCH power control adjustment state included in the p0-Alpha-CLID-PUCCH-Set associated with the ul-powercontrolId of the lowest value of the Uplink-powerControl, which is higher layer signaling, in the corresponding PCell, PSCell, SCell, or serving cell may be determined as the power control parameter for the PUCCH transmission.
   As another method of determining the power control parameters for PUCCH transmissions, the UE may use the p0, alpha, and PUCCH power control adjustment state included in the p0-Alpha-CLID-PUCCH-Set associated with ul-powercontrolId of the second lowest value in Uplink-powerControl having coresetPoolIndex, which is higher layer signaling, in the corresponding PCell, PSCell, SCell, or serving cell. In other words, the p0, alpha, and PUCCH power control adjustment state included in the p0-Alpha-CLID-PUCCH-Set associated with the ul-powercontrolld of the second lowest value in the Uplink-powerControl, which is higher layer signaling, in the corresponding PCell, PSCell, SCell, or serving cell, may be determined as the power control parameter for the PUCCH transmission.
   As another method of determining the power control parameters for PUCCH transmissions, the UE may use the p0, alpha, and PUCCH power control adjustment state included in the p0-Alpha-CLID-PUCCH-Set associated with ul-powercontrolId of the lowest value in Uplink-powerControl configured with coresetPoolIndex of 1, which is higher layer signaling in the corresponding PCell, PSCell, SCell, or serving cell. In other words, the p0, alpha, and PUCCH power control adjustment state included in the p0-Alpha-CLID-PUCCH-Set associated with the ul-powercontrolId of the lowest value of the Uplink-powerControl configured with coresetPoolIndex of 1, which is higher layer signaling, in the corresponding PCell, PSCell, SCell, or serving cell, may be determined as the power control parameter for the PUCCH transmission.
   As yet another method of determining the power control parameters for PUCCH transmissions, the UE may use the p0, alpha, and PUCCH power control adjustment state included in the p0-Alpha-CLID-PUCCH-Set associated with ul-powercontrolId of the lowest value within the second list (e.g., Uplink-powerControl2-r18) among two lists for the unified TCI state-based power control parameters configured by higher layer signaling in the corresponding PCell, PSCell, SCell, or serving cell. At this time, the first list and the second list may be associated with coresetPoolIndices 0 and 1, respectively. In other words, the p0, alpha, and PUCCH power control adjustment state, which are included within the p0-Alpha-CLID-PUCCH-Set associated with ul-powercontrolId of the lowest value within the second list (e.g., Uplink-powerControl2-r18) among two lists for unified TCI state-based power control parameters configured by higher layer signaling in the corresponding PCell, PSCell, SCell, or serving cell, may be determined as the power control parameter for the PUCCH transmission.
When the UE transmits an SRS using a spatial domain filter that was used when the UE received the candidate beam RS selected from the second candidate beam RS set, the power control parameters for the corresponding SRS transmission of the UE may follow a combination of at least one of the following:
   A candidate beam RS selected from the second candidate beam RS set may be used as a pathloss reference signal for the SRS transmission, and the UE may measure a downlink pathloss value by using the selected candidate beam RS.
   As a method of determining the power control parameters for the SRS transmission, the UE may use p0, alpha, and SRS power control adjustment state included in the p0-Alpha-CLID-SRS-Set associated with ul-powercontrolId of the lowest value in Uplink-powerControl, which is higher layer signaling, in the corresponding PCell, PSCell, SCell, or serving cell. In other words, the p0, alpha, and SRS power control adjustment state included in the p0-Alpha-CLID-SRS-Set associated with the ul-powercontrolId of the lowest value of the Uplink-powerControl, which is higher layer signaling, in the corresponding PCell, PSCell, SCell, or serving cell may be determined as the power control parameter for the SRS transmission.
   As another method of determining the power control parameters for SRS transmissions, the UE may use the p0, alpha, and SRS power control adjustment state included in the p0-Alpha-CLID-SRS-Set associated with ul-powercontrolId of the second lowest value in Uplink-powerControl having coresetPoolIndex, which is higher layer signaling, in the corresponding PCell, PSCell, SCell, or serving cell. In other words, the p0, alpha, and SRS power control adjustment state included in the p0-Alpha-CLID-SRS-Set associated with the ul-powercontrolId of the second lowest value in the Uplink-powerControl, which is higher layer signaling, in the corresponding PCell, PSCell, SCell, or serving cell, may be determined as the power control parameter for the SRS transmission.
   As yet another method of determining the power control parameters for SRS transmissions, the UE may use the p0, alpha, and SRS power control adjustment state included in the p0-Alpha-CLID-SRS-Set associated with ul-powercontrolId of the lowest value in Uplink-powerControl configured with coresetPoolIndex of 1, which is higher layer signaling in the corresponding PCell, PSCell, SCell, or serving cell. In other words, the p0, alpha, and SRS power control adjustment state included in the p0-Alpha-CLID-SRS-Set associated with the ul-powercontrolId of the lowest value of the Uplink-powerControl configured with coresetPoolIndex of 1, which is higher layer signaling, in the corresponding PCell, PSCell, SCell, or serving cell, may be determined as the power control parameter for the SRS transmission.
   As still another method of determining the power control parameters for SRS transmissions, the UE may use the p0, alpha, and SRS power control adjustment state included in the p0-Alpha-CLID-SRS-Set associated with ul-powercontrolId of the lowest value within the second list (e.g., Uplink-powerControl2-r18) among two lists for the unified TCI state-based power control parameters configured by higher layer signaling in the corresponding PCell, PSCell, SCell, or serving cell. At this time, the first list and the second list may be associated with coresetPoolIndices 0 and 1, respectively. In other words, the p0, alpha, and SRS power control adjustment state, which are included within the p0-Alpha-CLID-SRS-Set associated with ul-powercontrolId of the lowest value within the second list (e.g., Uplink-powerControl2-r18) among two lists for unified TCI state-based power control parameters configured by higher layer signaling in the corresponding PCell, PSCell, SCell, or serving cell, may be determined as the power control parameter for the SRS transmission.
At this time, the subcarrier spacing for the 28 symbols may be determined as the smallest subcarrier spacing among at least one combination of the followings:
   Subcarrier spacing of activated downlink bandwidth parts in which the (1-1)th PDCCH or (2-1)th PDCCH is received.
   Subcarrier spacings of activated downlink bandwidth parts of all serving cells
   Subcarrier spacings of activated downlink bandwidth parts of serving cells configured to use a unified TCI state.
   Subcarrier spacings of activated downlink bandwidth parts of serving cells for which SSB-MTCAdditionalPCI, which is higher layer signaling, is not configured.
   Subcarrier spacings of activated downlink bandwidth parts of serving cells included in the second PUSCH and having a beam failure.
   Activated downlink bandwidth parts of serving cells, which are configured to use a unified TCI state, among serving cells included in the second PUSCH and having a beam failure.
   Activated downlink bandwidth parts of serving cells, which are configured to use a unified TCI state and for which SSB-MTCAdditionalPCI that is higher layer signaling is not configured, among serving cells included in the second PUSCH and having a beam failure.

In the intra-cell multi-TRP operation, the “lowest value” is described as, for example, the lowest value of Uplink-powerControl, the lowest value in the first list (e.g., Uplink-powerControl1-r18) among two lists for unified TCI state-based power control parameters, or the lowest value in the second list (e.g., Uplink-powerControl2-r18) among two lists for unified TCI state-based power control parameters, but this is an example, and the disclosure described above is not limited thereto and may be replaced by “the highest value” or generalized to “a specific value.”

### Inter-Cell Multi-TRP Operation

When the UE:
is not configured with coresetPoolIndex, which is higher layer signaling, or includes one or more first CORESETs for which a value of coresetPoolIndex is configured as 0, within an activated downlink bandwidth part of a predetermined serving cell,
includes one or more second CORESETs for which a value of coresetPoolIndex, which is higher layer signaling, is configured as 1, within the same activated downlink bandwidth part within the same serving cell, and
is configured with SSB-MTCAdditionalPCI, which is higher layer signaling,
   the UE and base station may refer to operate in an inter-cell multi-TRP environment. In other words, inter-cell multi-TRP operation may refer to a case in which different TRPs have different physical cell IDs. The UE may include an SSB index associated with a physical cell ID different from a value of physCellId in ServingCellConfigCommon, which is higher layer signaling, in a first candidate beam RS set or a second candidate beam RS set, and a first BFD-RS set or a second BFD-RS set associated therewith may also be considered to be associated with the same physical cell ID. For example, when the value of physCellId in ServingCellConfigCommon is 0 and a specific SSB is associated with a physical cell ID value of 1, the UE may consider that the first BFD-RS set and the first candidate beam RS set are associated with 0, which is a physical cell ID of the serving cell, and the second BFD-RS set and the second candidate beam RS set are associated with 1, which is a physical cell ID with which the SSB is associated.

For a UE and a base station performing inter-cell multi-TRP operation, the UE may receive a configuration and an indication from the base station about the BFD-RS set and the candidate beam RS set using one of the following two methods.

### RS Set Notification Method 1-1

The UE may receive a configuration of the first BFD-RS set and the second BFD-RS set from the base station via higher layer signaling, or the UE may implicitly determine the same if higher layer signaling is not configured. Similar to the intra-cell multi-TRP operation above, the UE may use only two BFD-RS sets, such as a first BFD-RS set and a second BFD-RS set, and two candidate beam RS sets, such as a first candidate beam RS set and the second candidate beam RS set corresponding thereto. In this case, the first BFD-RS set and the first candidate beam RS set may be associated with a physical cell ID of a serving cell, and the second BFD-RS set and the second candidate beam RS set may be associated with a physical cell ID different from the serving cell ID configured through SSB-MTCAdditionalPCI which is higher layer signaling, and vice versa. Further, as described above, the first BFD-RS set and the first candidate beam RS set may be associated with coresetPoolIndex 0, which is higher layer signaling, and the second BFD-RS set and the second candidate beam RS set may be associated with coresetPoolIndex 1, which is higher layer signaling.

When using the RS set Notification Method 1-1, the UE may change all of candidate beam RSs of a specific candidate beam RS set via higher layer signaling reconfiguration, and after changing via higher layer signaling reconfiguration, all of candidate beam RSs in the corresponding candidate beam RS set may be associated with one specific physical cell ID that is different from the previous one. For example, if all of candidate beam RSs in a specific candidate beam RS set have been associated with physical cell ID 0 before higher layer signaling reconfiguration, higher layer signaling reconfiguration may cause all of candidate beam RSs in the corresponding candidate beam RS set to be associated with physical cell ID 1, for example, rather than physical cell ID 0.

The UE may change an RS in a specific candidate beam RS set using MAC-CE when using the above RS set Notification Method 1-1. In this case, when a candidate beam RS is changed via MAC-CE, if all of candidate beam RSs in the candidate beam RS set before the change have been associated with a specific physical cell ID (e.g., physical cell ID 0) different from the serving cell ID, the UE may expect that all of candidate beam RSs in the candidate beam RS set may be associated with, via MAC-CE, a specific one physical cell ID different from the physical cell ID having been associated before the change. That is, after the change, all of candidate beam RSs may be associated with physical cell ID 1, for example, rather than physical cell ID 0.

### RS Set Notification Method 1-2

Depending on the number of physical cell IDs different from that of the serving cell ID that may be configured with via SSB-MTCAdditionalPCI, which is higher layer signaling, the UE may receive a configuration of (N+1) BFD-RS sets, such as a first to (N+1) BFD-RS set (e.g., a value of N is possible up to 7), and (N+1) candidate beam RS sets, such as a first to (N+1) candidate beam RS set (e.g., a value of N is possible up to 7) corresponding thereto, respectively, and may receive up to two of each of the (N+1) BFD-RS sets and (N+1) candidate beam RS sets indicated or selected from the base station. For example, the UE may receive a configuration from the base station via higher layer signaling, receive an indication dynamically via L1 signaling, receive activation of some RS sets among total RS sets via MAC-CE, or receive a notification of a combination of higher layer signaling and L1 signaling. In this case, one BFD-RS set among a maximum of (N+1) BFD-RS sets and one candidate beam RS set among a maximum of (N+1) candidate beam RS sets may be associated with (or correspond to) a physical cell ID of a serving cell, and the remaining N BFD-RS sets and candidate beam RS sets may be associated with (or correspond to) a respective physical cell ID that is different from the serving cell ID that the UE receives from the base station via SSB-MTCAdditionalPCI, which is higher layer signaling. When the UE receives a selection of two BFD-RS sets and two candidate beam RS sets from the base station, the UE may expect to receive a selection of pairs of BFD-RS sets and candidate beam RS sets associated with each other. When the UE receives a selection of two BFD-RS sets and two candidate beam RS sets from the base station, the UE may not expect to receive a selection of pairs of BFD-RS sets and candidate beam RS sets that are not associated with each other. Furthermore, as described above, the UE may associate one of the two BFD-RS sets and the two candidate beam RS sets associated therewith, which are selected by the base station, with coresetPoolIndex 0, and may associate the other with coresetPoolIndex 1.

When the UE receives a selection of two BFD-RS sets and two candidate beam RS sets from the base station based on RS set Notification Method 1-2, the UE may expect that the selection at least includes a pair of BFD-RS sets and candidate beam RS sets associated with the physical cell ID of the serving cell. For example, among a total of eight BFD-RS sets and candidate beam RS sets, the UE may receive a selection from the base station of a first BFD-RS set and a first candidate beam RS set associated with a physical cell ID of a serving cell, and a second BFD-RS set and a second candidate beam RS set associated with a physical cell ID different from that of the serving cell ID.

### RS Set Notification Method 1-3

The UE may receive a configuration of a first BFD-RS set and a second BFD-RS set from the base station via higher layer signaling or, if not received, the UE may implicitly determine the first BFD-RS set and the second BFD-RS set, and depending on the number of physical cell IDs different from that of a serving cell ID that may be configured with SSB-MTCAdditionalPCI, which is higher layer signaling, the UE may receive a configuration of (N+1) candidate beam RS sets, such as a first to (N+1) candidate beam RS set (e.g., a value of N is possible up to 7), and may be indicated or selected by the base station for up to two of the candidate beam RS sets. For example, the UE may receive a configuration from the base station via higher layer signaling, receive an indication dynamically via L1 signaling, receive activation of some RS sets among total RS sets via MAC-CE, or receive a notification of a combination of higher layer signaling and L1 signaling. In this case, one BFD-RS set among two BFD-RS sets and one candidate beam RS set among a maximum of (N+1) candidate beam RS sets may be associated with (or correspond to) a physical cell ID of a serving cell, the remaining one BFD-RS set among two BFD-RS sets and one candidate beam RS set, a selection of which is received by the UE from the base station, may be associated with (or correspond to) a physical cell ID different from the serving cell ID, and the remaining candidate beam RS sets among the maximum (N+1) candidate beam RS sets may be associated with (or correspond to) a respective physical cell ID that is different from the serving cell ID that the UE receives from the base station via SSB-MTCAdditionalPCI, which is higher layer signaling. The UE may receive, from the base station, a selection of one of up to N candidate beam RS sets respectively corresponding to up to N different physical cell IDs via higher layer signaling, MAC-CE, L1 signaling, or a combination thereof. At the same time, BFD RSs within the first or second BFD-RS set corresponding thereto may be changed via MAC-CE and here, the newly changed BFD RSs may be associated with a physical cell ID associated with a candidate beam RS set newly selected by the base station.

In RS set Notification Method 1-1 to RS set Notification Method 1-3 above, the number of RS sets selected by the base station is described as two, but the disclosure is not limited thereto and may be generalized to natural number greater than two (e.g., three or four, etc.).

An LRR association method that may be used in combination with RS set Notification Method 1-1 to RS set Notification Method 1-3 above is described below.

LRR Association Method 1-1: Association with a first BFD-RS set and a second BFD-RS set

The UE may expect one or two LRRs to be associated with the first BFD-RS set and the second BFD-RS set. That is, for the first BFD-RS set and the second BFD-RS set that are finally selected and determined as described above, the UE may expect one or each of two LRRs to be associated with each of the first BFD-RS set and the second BFD-RS set and to be used. For example, the UE may associate one first LRR or each of the first LRR and the second LRR with the first BFD-RS set and the second BFD-RS set, which are two BFD-RS sets selected from a maximum of (N+1) BFD-RS sets through [RS set Notification Method 1-2] above, so as to use the same in the beam failure recovery request indication.

LRR Association Method 1-2: Predetermination of association relationship with each of (N+1) BFD-RS sets, the determination made by selection of two of the BFD-RS sets

The UE may expect one or two LRRs to be associated with each BFD-RS set. In other words, definition as to which LRRs are associated with multiple BFD-RS sets, respectively, may be made, and for the first BFD-RS set and the second BFD-RS set that are finally selected and determined as described above, the UE may notify the base station of a beam failure recovery request by using an association relationship with which one or two LRRs has been pre-defined. For example, in [RS set Notification Method 1-2] above, for up to (N+1) BFD-RS sets, when the UE has an association relationship in which the first LRR is associated with the first BFD-RS set to the (N−1) BFD-RS set, and an association relationship in which the second LRR is associated with the N BFD-RS set and the (N+1) BFD-RS set and, when the first BFD-RS set and the Nth BFD-RS set are the two BFD-RS sets finally selected, the UE may associate the first LRR with the first BFD-RS set and associate the second LRR with the Nth BFD-RS set so as to use the same for the beam failure recovery request indication.

LRR Association Method 1-3: Define UE capability reporting by extending the number of LRRs (considering up to (N+1) physical cell IDs)

The UE may report, as UE capability, that the UE is able to use a larger number of LRRs than the existing two LRRs to the base station, depending on the maximum number of physical cell IDs different from the serving cell ID configured through SSB-MTCAdditionalPCI, which is higher layer signaling, and in response thereto, the UE may receive, from the base station, as many LRRs as the number of physical cell IDs different from the serving cell ID via higher layer signaling. In other words, for each of the multiple BFD-RS sets, each corresponding LRR is associated therewith, and for the first BFD-RS set and the second BFD-RS set finally selected and determined as described above, the UE may notify the base station of a beam failure recovery request using the LRRs for which an association relationship with each BFD-RS set is configured.

The UE may receive two different timing advance (TA) values configured within a specific serving cell. TA association methods that may be used in combination with RS set Notification method 1-1 to RS set Notification Method 1-3 and LRR Association Method 1-1 to LRR Association Method 1-3 are described below.

### TA Association Method 1-1: Using TCI State

A UE may associate one TA value with each TCI state, and perform uplink transmission by applying the corresponding TA value to a specific uplink transmission to which the corresponding TCI state is applied.

TA Association Method 1-2: Using coresetPoolIndex

Depending on a coresetPoolIndex having been associated with respect to a specific uplink transmission, the UE may associate a specific TA value with coresetPoolIndex and use the same during the uplink transmission. For example, the UE may perform uplink transmission by applying a TA value, which is associated with the corresponding coresetPoolIndex, to an uplink transmission scheduled or triggered from a first CORESET or a second CORESET configured with a specific coresetPoolIndex.

### TA Association Method 1-3: Using Physical Cell ID

Depending on whether to use a spatial domain filter or TCI state, which has been associated with a physical cell ID, for a specific uplink transmission, the UE may associate a specific TA value with a physical cell ID and use the same during the uplink transmission. For example, the UE may be configured with SSB-MTCAdditionalPCI, which is higher layer signaling and, within each physical cell ID configuration, may receive additional higher layer signaling configured for the associated TA value.

In RS set Notification method 1-1 to RS set Notification method 1-3 above, some methods do not select a specific set of RSs (e.g., RS set Notification Method 2-1 has no selection of a BFD-RS set and a candidate beam RS set, and a method in which the BFD RS set and the candidate beam RS set are each fixed to a maximum of 2, and the RSs included in each set are changed may exist). In order to use a generalized representation in the following, although the UE receives a selection from the base station or not, two BFD-RS sets and two candidate beam RS sets corresponding thereto, which will be used in the per-TRP beam failure recovery operation in a multi-TRP environment, may be named “BFD-RS set #1”, “BFD-RS set #2”, “candidate beam RS set #1”, and “candidate beam RS set #2”, respectively. For example, when RS set Notification Method 1-2 is used as described above, the UE may receive a selection of two of the (N+1) BFD-RS sets (e.g., the first BFD-RS set and the fourth BFD-RS set) and two of the maximum (N+1) candidate beam RS sets (e.g., the first candidate beam RS set and the fourth candidate beam RS set) from the base station and use the same to perform the beam failure recovery operation for each TRP. Accordingly, the first BFD-RS set and the fourth BFD-RS set may be named BFD-RS set #1 and BFD-RS set #2, respectively, and the first candidate beam RS set and the fourth candidate beam RS set may be named candidate beam RS set #1 and candidate beam RS set #2, respectively.

When the first BFD-RS set or the second BFD-RS set, or both sets, are identified as having a beam failure situation as described above, the UE may transmit the above LRR to the base station, and the base station may transmit a (1-1)th PDCCH corresponding thereto to the UE to indicate second PUSCH scheduling information. The second PUSCH may include an enhanced BFR MAC-CE or a truncated enhanced BFR MAC-CE. The enhanced BFR MAC-CE or truncated enhanced BFR MAC-CE may include at least one of the following pieces of information:
Cell index(es) corresponding to a single BFD-RS set having a link quality lower than a reference value.
Whether a selected candidate beam RS exists in each single candidate beam RS set within the cell index(es) corresponding to the single BFD-RS set, and if existing, the index of the candidate beam RS.
Cell index(es) in which at least one of the first and second BFD-RS sets has a link quality lower than the reference value.
   Index(es) of the BFD-RS set, which has a link quality lower than the reference value, among the first and second BFD-RS sets. As an example, the BFD-RS set index(es) may be included in enhanced BFR MAC-CE or truncated enhanced BFR MAC-CE together with the cell index(es). As an example, the BFD set index(es) may correspond to lower layer information of the cell index(es).
In each of the first and second sets of candidate beam RSs within the cell index(es) corresponding to the first and second BFD-RS sets, whether the selected candidate beam RS exists, and if existing, the index of the candidate beam RS for each set.

For the serving cell(s), which are associated with the first BFD-RS set and the first candidate beam RS set associated therewith, and with the second BFD-RS set and the second candidate beam RS set associated therewith, after 28 symbols from a last symbol of a (2-1)th PDCCH reception including the same HARQ process ID field and toggled NDI field value as those of a (1-1)th PDCCH that has scheduled the second PUSCH, the UE may perform a combination of at least one of the following operations:
The UE may follow QCL parameter assumptions of a candidate beam RS selected from the first candidate beam RS set during monitoring of the first CORESET, in which coresetPoolIndex, which is higher layer signaling, is not configured, or in which the coresetPoolIndex is configured as 0.
The UE may assume that the reception of a scheduled PDSCH from all of the first CORESETs has the same QCL parameter as that of the reception of a candidate beam RS selected from the first candidate beam RS set.
The UE may assume that the reception of an aperiodic CSI-RS resource under a specific condition has the same QCL parameters as that of the reception of the candidate beam RS selected from the first candidate beam RS set. In this case, the aperiodic CSI-RS resource of the specific condition may be a combination of at least one of the following:
   The aperiodic CSI-RS resource may refer to a case in which a specific coresetPoolIndex (e.g., coresetPoolIndex 0) is configured within the aperiodic CSI-RS resource or a CSI-RS resource set including the aperiodic CSI-RS resource. The case in which a specific coresetPoolIndex (e.g., coresetPoolIndex 0) for a specific aperiodic CSI-RS resource or a specific CSI-RS resource set has been configured for the UE may signify that the UE may receive the corresponding aperiodic CSI-RS resource or aperiodic CSI-RS resources within the corresponding CSI-RS resource set by using a unified TCI state indicated via DCI transmitted from a specific CORESET (e.g., a first CORESET) in which a specific coresetPoolIndex (e.g., coresetPoolIndex 0) has been configured.
   The aperiodic CSI-RS resource may refer to a case in which specific higher layer signaling has been configured within the aperiodic CSI-RS resource, or within a CSI-RS resource set including the aperiodic CSI-RS resource, and in which the specific higher layer signaling is associated with the coresetPoolIndex. The case in which specific higher layer signaling for a specific aperiodic CSI-RS resource or a specific CSI-RS resource set has been configured for the UE and the configured higher layer signaling has been associated with a specific coresetPoolIndex (e.g., coresetPoolIndex 0) may signify that the UE may receive the corresponding aperiodic CSI-RS resource or aperiodic CSI-RS resources within the corresponding CSI-RS resource set by using a unified TCI state indicated via DCI transmitted from a specific CORESET (e.g., a first CORESET) in which a specific coresetPoolIndex (e.g., coresetPoolIndex 0) has been configured.
   The aperiodic CSI-RS resource may signify that, when DCI triggering the CSI-RS resource set including the aperiodic CSI-RS resource is transmitted from a specific CORESET (e.g., a first CORESET) having a specific coresetPoolIndex (e.g., coresetPoolIndex 0) configured, the aperiodic CSI-RS resources included within the corresponding CSI-RS resource set may be received by the UE using a unified TCI state indicated by the DCI transmitted from the corresponding CORESET in which the corresponding coresetPoolIndex has been configured.
The UE may use a spatial domain filter used to receive a candidate beam RS selected from the first candidate beam RS set during transmission of the scheduled PUSCH in all of the first CORESETs.
The UE may use a spatial domain filter used to receive a candidate beam RS selected from the first candidate beam RS set during transmission of a PUCCH of a specific condition. In this case, the PUCCH of the specific condition may be a combination of at least one of the following:
   The PUCCH may refer to a case in which a specific coresetPoolIndex (e.g., coresetPoolIndex 0) is configured in the corresponding PUCCH resource. The case in which a specific coresetPoolIndex (e.g., coresetPoolIndex 0) for a specific PUCCH resource has been configured for the UE may signify that the PUCCH resource may be transmitted by the UE using a unified TCI state indicated by DCI transmitted from a specific CORESET (e.g., the first CORESET) in which a specific coresetPoolIndex (e.g., coresetPoolIndex 0) has been configured.
   The PUCCH may refer to a case in which specific higher layer signaling has been configured within the PUCCH resource, and the specific higher layer signaling is associated with the coresetPoolIndex. The case in which specific higher layer signaling for a specific PUCCH resource has been configured for the UE and the configured higher layer signaling has been associated with a specific coresetPoolIndex (e.g., coresetPoolIndex 0) may signify that the PUCCH resource may be transmitted by the UE using a unified TCI state indicated by DCI transmitted from a specific CORESET (e.g., the first CORESET) in which a specific coresetPoolIndex (e.g., coresetPoolIndex 0) has been configured.
   The PUCCH may signify that, when DCI triggering the PUCCH resource is transmitted from a specific CORESET (e.g., the first CORESET) having a specific coresetPoolIndex (e.g., coresetPoolIndex 0) configured, the PUCCH resource may be transmitted by the UE using the unified TCI state indicated by the DCI transmitted from the corresponding CORESET in which the corresponding coresetPoolIndex has been configured.
The UE may use the spatial domain filter used to receive a candidate beam RS selected from the first candidate beam RS set during transmission of an SRS of a specific condition. In this case, the SRS of the specific condition may be a combination of at least one of the following:
   The SRS may refer to a case in which a specific coresetPoolIndex (e.g., coresetPoolIndex 0) is configured within the SRS resource or a SRS resource set including the SRS resource. The case in which a specific coresetPoolIndex (e.g., coresetPoolIndex 0) for a specific SRS resource or a specific SRS resource set has been configured for the UE may signify that the UE may transmit the corresponding SRS resource or the SRS resources within the SRS resource set including the corresponding SRS resource by using a unified TCI state indicated via DCI transmitted from a specific CORESET (e.g., a first CORESET) in which a specific coresetPoolIndex (e.g., coresetPoolIndex 0) has been configured.
   The SRS may refer to a case in which specific higher layer signaling has been configured within the SRS resource, or within an SRS resource set including the SRS resource, and in which the specific higher layer signaling is associated with the coresetPoolIndex. The case in which specific higher layer signaling for a specific SRS resource or a specific SRS resource set including the corresponding SRS resource has been configured for the UE and the configured higher layer signaling has been associated with a specific coresetPoolIndex (e.g., coresetPoolIndex 0) may signify that the UE may transmit the corresponding SRS resource or the SRS resources within the SRS resource set including the corresponding SRS resource by using a unified TCI state indicated via DCI transmitted from a specific CORESET (e.g., a first CORESET) in which a specific coresetPoolIndex (e.g., coresetPoolIndex 0) has been configured.
   The SRS may signify that, when DCI triggering the SRS resource set including the SRS resource is transmitted from a specific CORESET (e.g., a first CORESET) having a specific coresetPoolIndex (e.g., coresetPoolIndex 0) configured, the corresponding SRS resource or the SRS resources included within the corresponding SRS resource set including the corresponding SRS resource may be transmitted by the UE using a unified TCI state indicated by the DCI transmitted from the corresponding CORESET in which the corresponding coresetPoolIndex has been configured.
When the UE transmits a PUSCH using a spatial domain filter that the UE used to receive a candidate beam RS selected from the first candidate beam RS set, power control parameters for the corresponding PUSCH transmission of the UE may follow a combination of at least one of the following:
   A candidate beam RS selected from the first candidate beam RS set may be used as a pathloss reference signal for the PUSCH transmission, and the UE may measure a downlink pathloss value by using the selected candidate beam RS.
   As a method of determining the power control parameters for the PUSCH transmission, the UE may use p0, alpha, and PUSCH power control adjustment state included in the p0-Alpha-CLID-PUSCH-Set associated with ul-powercontrolId of the lowest value in Uplink-powerControl, which is higher layer signaling, in the corresponding PCell, PSCell, SCell, or serving cell. In other words, the p0, alpha, and PUSCH power control adjustment state included in the p0-Alpha-CLID-PUSCH-Set associated with the ul-powercontrolId of the lowest value in the Uplink-powerControl, which is higher layer signaling, in the corresponding PCell, PSCell, SCell, or serving cell may be determined as the power control parameter for the PUSCH transmission.
   As another method of determining the power control parameters for PUSCH transmissions, the UE may use the p0, alpha, and PUSCH power control adjustment state included in the p0-Alpha-CLID-PUSCH-Set associated with ul-powercontrolId of the lowest value in Uplink-powerControl configured with coresetPoolIndex of 0, which is higher layer signaling, in the corresponding PCell, PSCell, SCell, or serving cell. In other words, the p0, alpha, and PUSCH power control adjustment state included in the p0-Alpha-CLID-PUSCH-Set associated with the ul-powercontrolId of the lowest value in the Uplink-powerControl configured with coresetPoolIndex of 0, which is higher layer signaling, in the corresponding PCell, PSCell, SCell, or serving cell, may be determined as the power control parameter for the PUSCH transmission.
   As yet another method of determining the power control parameters for PUSCH transmissions, the UE may use the p0, alpha, and PUSCH power control adjustment state included in the p0-Alpha-CLID-PUSCH-Set associated with ul-powercontrolId of the lowest value within the first list (e.g., Uplink-powerControl1-r18) among two lists for the unified TCI state-based power control parameters configured by higher layer signaling in the corresponding PCell, PSCell, SCell, or serving cell. In other words, the p0, alpha, and PUSCH power control adjustment state, which are included within the p0-Alpha-CLID-PUSCH-Set associated with ul-powercontrolId of the lowest value within the first list (e.g., Uplink-powerControl1-r18) among two lists for unified TCI state-based power control parameters configured by higher layer signaling in the corresponding PCell, PSCell, SCell, or serving cell, may be determined as the power control parameter for the PUSCH transmission.
When the UE transmits a PUCCH using the spatial domain filter that the UE used to receive a candidate beam RS selected from the first candidate beam RS set, the power control parameters for the corresponding PUCCH transmission of the UE may follow a combination of at least one of the following:
   A candidate beam RS selected from the first candidate beam RS set may be used as a pathloss reference signal for the PUCCH transmission, and the UE may measure a downlink pathloss value by using the selected candidate beam RS.
   As a method of determining the power control parameters for the PUCCH transmission, the UE may use p0, alpha, and PUCCH power control adjustment state included in the p0-Alpha-CLID-PUCCH-Set associated with ul-powercontrolId of the lowest value in Uplink-powerControl, which is higher layer signaling, in the corresponding PCell, PSCell, SCell, or serving cell. In other words, the p0, alpha, and PUCCH power control adjustment state included in the p0-Alpha-CLID-PUSCH-Set associated with the ul-powercontrolId of the lowest value of the Uplink-powerControl, which is higher layer signaling, in the corresponding PCell, PSCell, SCell, or serving cell may be determined as the power control parameter for the PUCCH transmission.
   As another method of determining the power control parameters for PUCCH transmissions, the UE may use the p0, alpha, and PUCCH power control adjustment state included in the p0-Alpha-CLID-PUCCH-Set associated with ul-powercontrolId of the lowest value in Uplink-powerControl configured with coresetPoolIndex of 0, which is higher layer signaling in the corresponding PCell, PSCell, SCell, or serving cell. In other words, the p0, alpha, and PUCCH power control adjustment state included in the p0-Alpha-CLID-PUSCH-Set associated with the ul-powercontrolId of the lowest value of the Uplink-powerControl configured with coresetPoolIndex of 0, which is higher layer signaling, in the corresponding PCell, PSCell, SCell, or serving cell, may be determined as the power control parameter for the PUCCH transmission.
   As yet another method of determining the power control parameters for PUCCH transmissions, the UE may use the p0, alpha, and PUCCH power control adjustment state included in the p0-Alpha-CLID-PUCCH-Set associated with ul-powercontrolId of the lowest value within the first list (e.g., Uplink-powerControl1-r18) among two lists for the unified TCI state-based power control parameters configured by higher layer signaling in the corresponding PCell, PSCell, SCell, or serving cell. In other words, the p0, alpha, and PUCCH power control adjustment state, which are included within the p0-Alpha-CLID-PUCCH-Set associated with ul-powercontrolId of the lowest value within the first list (e.g., Uplink-powerControl1-r18) among two lists for unified TCI state-based power control parameters configured by higher layer signaling in the corresponding PCell, PSCell, SCell, or serving cell, may be determined as the power control parameter for the PUCCH transmission.
When the UE transmits an SRS using a spatial domain filter that was used when the UE received the candidate beam RS selected from the first candidate beam RS set, the power control parameters for the corresponding SRS transmission of the UE may follow a combination of at least one of the following:
   A candidate beam RS selected from the first candidate beam RS set may be used as a pathloss reference signal for the SRS transmission, and the UE may measure a downlink pathloss value by using the selected candidate beam RS.
   As a method of determining the power control parameters for the SRS transmission, the UE may use p0, alpha, and SRS power control adjustment state included in the p0-Alpha-CLID-SRS-Set associated with ul-powercontrolId of the lowest value in Uplink-powerControl, which is higher layer signaling, in the corresponding PCell, PSCell, SCell, or serving cell. In other words, the p0, alpha, and SRS power control adjustment state included in the p0-Alpha-CLID-SRS-Set associated with the ul-powercontrolId of the lowest value of the Uplink-powerControl, which is higher layer signaling, in the corresponding PCell, PSCell, SCell, or serving cell may be determined as the power control parameter for the SRS transmission.
   As another method of determining the power control parameters for SRS transmissions, the UE may use the p0, alpha, and SRS power control adjustment state included in the p0-Alpha-CLID-SRS-Set associated with ul-powercontrolId of the lowest value in Uplink-powerControl configured with coresetPoolIndex of 0, which is higher layer signaling in the corresponding PCell, PSCell, SCell, or serving cell. In other words, the p0, alpha, and SRS power control adjustment state included in the p0-Alpha-CLID-SRS-Set associated with the ul-powercontrolId of the lowest value of the Uplink-powerControl configured with coresetPoolIndex of 0, which is higher layer signaling, in the corresponding PCell, PSCell, SCell, or serving cell, may be determined as the power control parameter for the SRS transmission.
   As yet another method of determining the power control parameters for SRS transmissions, the UE may use the p0, alpha, and SRS power control adjustment state included in the p0-Alpha-CLID-SRS-Set associated with ul-powercontrolId of the lowest value within the first list (e.g., Uplink-powerControl1-r18) among two lists for the unified TCI state-based power control parameters configured by higher layer signaling in the corresponding PCell, PSCell, SCell, or serving cell. In other words, the p0, alpha, and SRS power control adjustment state, which are included within the p0-Alpha-CLID-SRS-Set associated with ul-powercontrolId of the lowest value within the first list (e.g., Uplink-powerControl1-r18) among two lists for unified TCI state-based power control parameters configured by higher layer signaling in the corresponding PCell, PSCell, SCell, or serving cell, may be determined as the power control parameter for the SRS transmission.
The UE may follow the QCL parameter assumptions of the candidate beam RS selected from the second candidate beam RS set when monitoring all of the second CORESETs in which coresetPoolIndex, which is higher layer signaling, is configured as 1.
   In this case, since an SSB corresponding to a physical cell ID different from a serving cell ID may not be a direct QCL source for PDCCH DMRS, the UE may, only in case that the candidate beam RS selected from the second candidate beam RS set is a CSI-RS, follow the QCL parameter assumption of the corresponding candidate beam RS during monitoring of all of the second CORESETs in which coresetPoolIndex, which is higher layer signaling, configured as 1. Here, the direct QCL source may refer to a case in which a reference RS, such as SSB or CSI-RS, is a source RS with respect to a specific target RS. In addition, an indirect QCL source may refer to a case in which a specific reference RS is a source RS for a certain RS, and in which the certain RS is a source RS with respect to a specific target RS. In other words, the indirect QCL source may refer to a case in which a specific reference RS is not a direct source RS with respect to a specific target RS, but a specific reference RS is a source RS with respect to a source RS of a specific target RS.
The UE may assume that the reception of a scheduled PDSCH in all of the second CORESETs has the same QCL parameters as the reception of a candidate beam RS selected from the second candidate beam RS set.
   In this case, similar to the above, since an SSB corresponding to a physical cell ID different from a serving cell ID is unable to be a direct QCL source for PDSCH DMRS, the UE may, only in case that the candidate beam RS selected from the second candidate beam RS set is a CSI-RS, follow the QCL parameter assumption of the corresponding candidate beam RS during monitoring of all of the second CORESETs in which coresetPoolIndex, which is higher layer signaling, configured as 1.
The UE may assume that the reception of an aperiodic CSI-RS resource of a specific condition has the same QCL parameters as the reception of a candidate beam RS selected from the second candidate beam RS set. In this case, the aperiodic CSI-RS resource under the above specific condition may be a combination of at least one of the following. On the other hand, since an SSB corresponding to a physical cell ID different from the serving cell ID may be a direct QCL source of the aperiodic CSI-RS, the UE may perform at least one of the following operations in any case in which the candidate beam RS selected from the second candidate beam RS set is an SSB or a CSI-RS:
   The aperiodic CSI-RS resource may refer to a case in which a specific coresetPoolIndex (e.g., coresetPoolIndex 1) is configured within the aperiodic CSI-RS resource or a CSI-RS resource set including the aperiodic CSI-RS resource. The case in which a specific coresetPoolIndex (e.g., coresetPoolIndex 1) for a specific aperiodic CSI-RS resource or a specific CSI-RS resource set has been configured for the UE may signify that the UE may receive the corresponding aperiodic CSI-RS resource or aperiodic CSI-RS resources within the corresponding CSI-RS resource set by using a unified TCI state indicated via DCI transmitted from a specific CORESET (e.g., a second CORESET) in which a specific coresetPoolIndex (e.g., coresetPoolIndex 1) has been configured.
   The aperiodic CSI-RS resource may refer to a case in which specific higher layer signaling has been configured within the aperiodic CSI-RS resource, or within a CSI-RS resource set including the aperiodic CSI-RS resource, and in which the specific higher layer signaling is associated with the coresetPoolIndex. The case in which specific higher layer signaling for a specific aperiodic CSI-RS resource or a specific CSI-RS resource set has been configured for the UE and the configured higher layer signaling has been associated with a specific coresetPoolIndex (e.g., coresetPoolIndex 1) may signify that the UE may receive the corresponding aperiodic CSI-RS resource or aperiodic CSI-RS resources within the corresponding CSI-RS resource set by using a unified TCI state indicated via DCI transmitted from a specific CORESET (e.g., a second CORESET) in which a specific coresetPoolIndex (e.g., coresetPoolIndex 1) has been configured. For example, the specific higher layer signaling may be a physical cell ID that is different from the serving cell ID and corresponding to one entry of the SSB-MTCAdditionalPCIs.
   The aperiodic CSI-RS resource may signify that, when DCI triggering the CSI-RS resource set including the aperiodic CSI-RS resource is transmitted from a specific CORESET (e.g., a second CORESET) in which a specific coresetPoolIndex (e.g., coresetPoolIndex 1) has been configured, the aperiodic CSI-RS resources included within the corresponding CSI-RS resource set may be received by the UE using a unified TCI state indicated by the DCI transmitted from the corresponding CORESET in which the corresponding coresetPoolIndex has been configured.
The UE may use a spatial domain filter used to receive a candidate beam RS selected from the second candidate beam RS set during transmission of a scheduled PUSCH in all of the second CORESETs. In this case, since an SSB corresponding to a physical cell ID different from the serving cell ID may be a direct QCL source as a reference RS for QCL-TypeD during PUSCH transmission, the UE may perform the above operation in any case in which the candidate beam RS selected from the second candidate beam RS set is an SSB or a CSI-RS.
The UE may use a spatial domain filter used to receive a candidate beam RS selected from the second candidate beam RS set during transmission of a PUCCH of a specific condition. In this case, the PUCCH of the specific condition may be a combination of at least one of the following. In this case, since an SSB corresponding to a physical cell ID different from the serving cell ID may be a direct QCL source as a reference RS for QCL-TypeD during PUCCH transmission, the UE may perform at least one of the following operations in any case in which the candidate beam RS selected from the second candidate beam RS set is an SSB or a CSI-RS:
   The PUCCH may refer to a case in which a specific coresetPoolIndex (e.g., coresetPoolIndex 1) is configured in the corresponding PUCCH resource. The case in which a specific coresetPoolIndex (e.g., coresetPoolIndex 1) for a specific PUCCH resource has been configured for the UE may signify that the PUCCH resource may be transmitted by the UE using a unified TCI state indicated by DCI transmitted from a specific CORESET (e.g., the second CORESET) in which a specific coresetPoolIndex (e.g., coresetPoolIndex 1) has been configured.
   The PUCCH may refer to a case in which specific higher layer signaling has been configured within the PUCCH resource, and the specific higher layer signaling is associated with the coresetPoolIndex. The case in which specific higher layer signaling for a specific PUCCH resource has been configured for the UE and the configured higher layer signaling has been associated with a specific coresetPoolIndex (e.g., coresetPoolIndex 1) may signify that the PUCCH resource may be transmitted by the UE using a unified TCI state indicated by DCI transmitted from a specific CORESET (e.g., the second CORESET) in which a specific coresetPoolIndex (e.g., coresetPoolIndex 1) has been configured. For example, the specific higher layer signaling may be a physical cell ID that is different from the serving cell ID and corresponding to one entry of the SSB-MTCAdditionalPCIs.
   The PUCCH may signify that, when DCI triggering the PUCCH resource is transmitted from a specific CORESET (e.g., the second CORESET) in which a specific coresetPoolIndex (e.g., coresetPoolIndex 1) has been configured, the PUCCH resource may be transmitted by the UE using the unified TCI state indicated by the DCI transmitted from the corresponding CORESET in which the corresponding coresetPoolIndex has been configured.
The UE may use the spatial domain filter used to receive a candidate beam RS selected from the second set of candidate beam RS during transmission of the SRS of the specific condition. In this case, the SRS of the specific condition may be a combination of at least one of the following. In this case, since an SSB corresponding to a physical cell ID different from the serving cell ID may be a direct QCL source as a reference RS for QCL-TypeD during SRS transmission, the UE may perform at least one of the following operations in any case in which the candidate beam RS selected from the second candidate beam RS set is an SSB or a CSI-RS:
   The SRS may refer to a case in which a specific coresetPoolIndex (e.g., coresetPoolIndex 1) is configured within the SRS resource or a SRS resource set including the SRS resource. The case in which a specific coresetPoolIndex (e.g., coresetPoolIndex 1) for a specific SRS resource or a specific SRS resource set including the corresponding SRS resource has been configured for the UE may signify that the UE may transmit the corresponding SRS resource or the SRS resources within the SRS resource set including the corresponding SRS resource by using a unified TCI state indicated via DCI transmitted from a specific CORESET (e.g., a second CORESET) in which a specific coresetPoolIndex (e.g., coresetPoolIndex 1) has been configured.
   The SRS may refer to a case in which specific higher layer signaling has been configured within the SRS resource, or within an SRS resource set including the SRS resource, and in which the specific higher layer signaling is associated with the coresetPoolIndex. The case in which specific higher layer signaling for a specific SRS resource or a specific SRS resource set including the corresponding SRS resource has been configured for the UE and the configured higher layer signaling has been associated with a specific coresetPoolIndex (e.g., coresetPoolIndex 1) may signify that the UE may transmit the corresponding SRS resource or the SRS resources within the SRS resource set including the corresponding SRS resource by using a unified TCI state indicated via DCI transmitted from a specific CORESET (e.g., a second CORESET) in which a specific coresetPoolIndex (e.g., coresetPoolIndex 1) has been configured. For example, the specific higher layer signaling may be a physical cell ID that is different from the serving cell ID and corresponding to one entry of the SSB-MTCAdditionalPCIs.
   The SRS may signify that, when DCI triggering the SRS resource set including the SRS resource is transmitted from a specific CORESET (e.g., a second CORESET) having a specific coresetPoolIndex (e.g., coresetPoolIndex 1) configured, the corresponding SRS resource or the SRS resources included within the corresponding SRS resource set including the corresponding SRS resource may be transmitted by the UE using a unified TCI state indicated by the DCI transmitted from the corresponding CORESET in which the corresponding coresetPoolIndex has been configured.
When the UE transmits a PUSCH using a spatial domain filter that the UE used to receive a candidate beam RS selected from the second candidate beam RS set, power control parameters for the corresponding PUSCH transmission of the UE may follow a combination of at least one of the following:
   A candidate beam RS selected from the second candidate beam RS set may be used as a pathloss reference signal for the PUSCH transmission, and the UE may measure a downlink pathloss value by using the selected candidate beam RS.
   As a method of determining the power control parameters for the PUSCH transmission, the UE may use p0, alpha, and PUSCH power control adjustment state included in the p0-Alpha-CLID-PUSCH-Set associated with ul-powercontrolId of the lowest value in Uplink-powerControl, which is higher layer signaling, in the corresponding PCell, PSCell, SCell, or serving cell. In other words, the p0, alpha, and PUSCH power control adjustment state included in the p0-Alpha-CLID-PUSCH-Set associated with the ul-powercontrolId of the lowest value in the Uplink-powerControl, which is higher layer signaling, in the corresponding PCell, PSCell, SCell, or serving cell may be determined as the power control parameter for the PUSCH transmission.
   As another method of determining the power control parameters for PUSCH transmissions, the UE may use the p0, alpha, and PUSCH power control adjustment state included in the p0-Alpha-CLID-PUSCH-Set associated with ul-powercontrolId of the second lowest value in Uplink-powerControl having coresetPoolIndex, which is higher layer signaling, in the corresponding PCell, PSCell, SCell, or serving cell. In other words, the p0, alpha, and PUSCH power control adjustment state included in the p0-Alpha-CLID-PUSCH-Set associated with the ul-powercontrolId of the second lowest value in the Uplink-powerControl, which is higher layer signaling, in the corresponding PCell, PSCell, SCell, or serving cell, may be determined as the power control parameter for the PUSCH transmission.
   As yet another method of determining the power control parameters for PUSCH transmissions, the UE may use the p0, alpha, and PUSCH power control adjustment state included in the p0-Alpha-CLID-PUSCH-Set associated with ul-powercontrolId of the lowest value in Uplink-powerControl configured with coresetPoolIndex of 1, which is higher layer signaling, in the corresponding PCell, PSCell, SCell, or serving cell. In other words, the p0, alpha, and PUSCH power control adjustment state, which are included within the p0-Alpha-CLID-PUSCH-Set associated with ul-powercontrolId of the lowest value in Uplink-powerControl configured with coresetPoolIndex of 1, which is higher layer signaling, in the corresponding PCell, PSCell, SCell, or serving cell may be determined as the power control parameter for the PUSCH transmission.
   As still another method of determining the power control parameters for PUSCH transmissions, the UE may use the p0, alpha, and PUSCH power control adjustment state included in the p0-Alpha-CLID-PUSCH-Set associated with ul-powercontrolId of the lowest value within the second list (e.g., Uplink-powerControl2-r18) among two lists for the unified TCI state-based power control parameters configured by higher layer signaling in the corresponding PCell, PSCell, SCell, or serving cell. At this time, the first list and the second list may be associated with coresetPoolIndices 0 and 1, respectively. In other words, the p0, alpha, and PUSCH power control adjustment state, which are included within the p0-Alpha-CLID-PUSCH-Set associated with ul-powercontrolId of the lowest value within the second list (e.g., Uplink-powerControl2-r18) among two lists for unified TCI state-based power control parameters configured by higher layer signaling in the corresponding PCell, PSCell, SCell, or serving cell, may be determined as the power control parameter for the PUSCH transmission.
   As still further another method of determining the power control parameters for PUSCH transmissions, the UE may use the p0, alpha, and PUSCH power control adjustment state included in the p0-Alpha-CLID-PUSCH-Set associated with ul-powercontrolId of the lowest value within a list associated with the second candidate beam RS set among up to (N+1) lists for the unified TCI state-based power control parameters configured by higher layer signaling in the corresponding PCell, PSCell, SCell, or serving cell. In this case, up to (N+1) lists for power control parameters may each be associated with a serving cell ID and N different physical cell IDs that are different from the serving cell ID. In other words, the p0, alpha, and PUSCH power control adjustment state, which are included within the p0-Alpha-CLID-PUSCH-Set associated with ul-powercontrolId of the lowest value within a list associated with the second candidate beam RS set among up to (N+1) lists for the unified TCI state-based power control parameters configured by higher layer signaling in the corresponding PCell, PSCell, SCell, or serving cell, may be determined as the power control parameter for the PUSCH transmission.
When the UE transmits a PUCCH using the spatial domain filter that the UE used to receive a candidate beam RS selected from the second set of candidate beam RS, the power control parameters for the corresponding PUCCH transmission of the UE may follow a combination of at least one of the following:
   A candidate beam RS selected from the second candidate beam RS set may be used as a pathloss reference signal for the PUCCH transmission, and the UE may measure a downlink pathloss value by using the selected candidate beam RS.
   As a method of determining the power control parameters for the PUCCH transmission, the UE may use p0, alpha, and PUCCH power control adjustment state included in the p0-Alpha-CLID-PUCCH-Set associated with ul-powercontrolId of the lowest value in Uplink-powerControl, which is higher layer signaling, in the corresponding PCell, PSCell, SCell, or serving cell. In other words, the p0, alpha, and PUCCH power control adjustment state included in the p0-Alpha-CLID-PUCCH-Set associated with the ul-powercontrolId of the lowest value of the Uplink-powerControl, which is higher layer signaling, in the corresponding PCell, PSCell, SCell, or serving cell may be determined as the power control parameter for the PUCCH transmission.
   As another method of determining the power control parameters for PUCCH transmissions, the UE may use the p0, alpha, and PUCCH power control adjustment state included in the p0-Alpha-CLID-PUCCH-Set associated with ul-powercontrolId of the second lowest value in Uplink-powerControl having coresetPoolIndex, which is higher layer signaling, in the corresponding PCell, PSCell, SCell, or serving cell. In other words, the p0, alpha, and PUCCH power control adjustment state included in the p0-Alpha-CLID-PUCCH-Set associated with the ul-powercontrolId of the second lowest value in the Uplink-powerControl, which is higher layer signaling, in the corresponding PCell, PSCell, SCell, or serving cell, may be determined as the power control parameter for the PUCCH transmission.
   As another method of determining the power control parameters for PUCCH transmissions, the UE may use the p0, alpha, and PUCCH power control adjustment state included in the p0-Alpha-CLID-PUCCH-Set associated with ul-powercontrolId of the lowest value in Uplink-powerControl configured with coresetPoolIndex of 1, which is higher layer signaling in the corresponding PCell, PSCell, SCell, or serving cell. In other words, the p0, alpha, and PUCCH power control adjustment state included in the p0-Alpha-CLID-PUCCH-Set associated with the ul-powercontrolId of the lowest value of the Uplink-powerControl configured with coresetPoolIndex of 1, which is higher layer signaling, in the corresponding PCell, PSCell, SCell, or serving cell, may be determined as the power control parameter for the PUCCH transmission.
   As yet another method of determining the power control parameters for PUCCH transmissions, the UE may use the p0, alpha, and PUCCH power control adjustment state included in the p0-Alpha-CLID-PUCCH-Set associated with ul-powercontrolId of the lowest value within the second list (e.g., Uplink-powerControl2-r18) among two lists for the unified TCI state-based power control parameters configured by higher layer signaling in the corresponding PCell, PSCell, SCell, or serving cell. At this time, the first list and the second list may be associated with coresetPoolIndices 0 and 1, respectively. In other words, the p0, alpha, and PUCCH power control adjustment state, which are included within the p0-Alpha-CLID-PUCCH-Set associated with ul-powercontrolId of the lowest value within the second list (e.g., Uplink-powerControl2-r18) among two lists for unified TCI state-based power control parameters configured by higher layer signaling in the corresponding PCell, PSCell, SCell, or serving cell, may be determined as the power control parameter for the PUCCH transmission.
   As still further another method of determining the power control parameters for PUCCH transmissions, the UE may use the p0, alpha, and PUCCH power control adjustment state included in the p0-Alpha-CLID-PUCCH-Set associated with ul-powercontrolId of the lowest value within a list associated with the second candidate beam RS set among up to (N+1) lists for the unified TCI state-based power control parameters configured by higher layer signaling in the corresponding PCell, PSCell, SCell, or serving cell. In this case, up to (N+1) lists for power control parameters may each be associated with a serving cell ID and N different physical cell IDs that are different from the serving cell ID. In other words, the p0, alpha, and PUCCH power control adjustment state, which are included within the p0-Alpha-CLID-PUCCH-Set associated with ul-powercontrolId of the lowest value within a list associated with the second candidate beam RS set among up to (N+1) lists for the unified TCI state-based power control parameters configured by higher layer signaling in the corresponding PCell, PSCell, SCell, or serving cell, may be determined as the power control parameter for the PUCCH transmission.
When the UE transmits an SRS using a spatial domain filter that was used when the UE received the candidate beam RS selected from the second candidate beam RS set, the power control parameters for the corresponding SRS transmission of the UE may follow a combination of at least one of the following:
   A candidate beam RS selected from the second candidate beam RS set may be used as a pathloss reference signal for the SRS transmission, and the UE may measure a downlink pathloss value by using the selected candidate beam RS.
   As a method of determining the power control parameters for the SRS transmission, the UE may use p0, alpha, and SRS power control adjustment state included in the p0-Alpha-CLID-SRS-Set associated with ul-powercontrolId of the lowest value in Uplink-powerControl, which is higher layer signaling, in the corresponding PCell, PSCell, SCell, or serving cell. In other words, the p0, alpha, and SRS power control adjustment state included in the p0-Alpha-CLID-SRS-Set associated with the ul-powercontrolId of the lowest value of the Uplink-powerControl, which is higher layer signaling, in the corresponding PCell, PSCell, SCell, or serving cell may be determined as the power control parameter for the SRS transmission.
   As another method of determining the power control parameters for SRS transmissions, the UE may use the p0, alpha, and SRS power control adjustment state included in the p0-Alpha-CLID-SRS-Set associated with ul-powercontrolId of the second lowest value in Uplink-powerControl having coresetPoolIndex, which is higher layer signaling, in the corresponding PCell, PSCell, SCell, or serving cell. In other words, the p0, alpha, and SRS power control adjustment state included in the p0-Alpha-CLID-SRS-Set associated with the ul-powercontrolId of the second lowest value in the Uplink-powerControl, which is higher layer signaling, in the corresponding PCell, PSCell, SCell, or serving cell, may be determined as the power control parameter for the SRS transmission.
   As yet another method of determining the power control parameters for SRS transmissions, the UE may use the p0, alpha, and SRS power control adjustment state included in the p0-Alpha-CLID-SRS-Set associated with ul-powercontrolId of the lowest value in Uplink-powerControl configured with coresetPoolIndex of 1, which is higher layer signaling in the corresponding PCell, PSCell, SCell, or serving cell. In other words, the p0, alpha, and SRS power control adjustment state included in the p0-Alpha-CLID-SRS-Set associated with the ul-powercontrolId of the lowest value of the Uplink-powerControl configured with coresetPoolIndex of 1, which is higher layer signaling, in the corresponding PCell, PSCell, SCell, or serving cell, may be determined as the power control parameter for the SRS transmission.
   As still another method of determining the power control parameters for SRS transmissions, the UE may use the p0, alpha, and SRS power control adjustment state included in the p0-Alpha-CLID-SRS-Set associated with ul-powercontrolId of the lowest value within the second list (e.g., Uplink-powerControl2-r18) among two lists for the unified TCI state-based power control parameters configured by higher layer signaling in the corresponding PCell, PSCell, SCell, or serving cell. At this time, the first list and the second list may be associated with coresetPoolIndices 0 and 1, respectively. In other words, the p0, alpha, and SRS power control adjustment state, which are included within the p0-Alpha-CLID-SRS-Set associated with ul-powercontrolId of the lowest value within the second list (e.g., Uplink-powerControl2-r18) among two lists for unified TCI state-based power control parameters configured by higher layer signaling in the corresponding PCell, PSCell, SCell, or serving cell, may be determined as the power control parameter for the SRS transmission.
   As still further another method of determining the power control parameters for SRS transmissions, the UE may use the p0, alpha, and SRS power control adjustment state included in the p0-Alpha-CLID-SRS-Set associated with ul-powercontrolId of the lowest value within a list associated with the second candidate beam RS set among up to (N+1) lists for the unified TCI state-based power control parameters configured by higher layer signaling in the corresponding PCell, PSCell, SCell, or serving cell. In this case, up to (N+1) lists for power control parameters may each be associated with a serving cell ID and N different physical cell IDs the serving cell ID. In other words, the p0, alpha, and SRS power control adjustment state, which are included within the p0-Alpha-CLID-SRS-Set associated with ul-powercontrolId of the lowest value within a list associated with the second candidate beam RS set among up to (N+1) lists for the unified TCI state-based power control parameters configured by higher layer signaling in the corresponding PCell, PSCell, SCell, or serving cell, may be determined as the power control parameter for the SRS transmission.
At this time, the subcarrier spacing for the 28 symbols may be determined as the smallest subcarrier spacing among at least one combination of the followings:
   Subcarrier spacing of activated downlink bandwidth parts in which the (1-1)th PDCCH or (2-1)th PDCCH is received.
   Subcarrier spacings of activated downlink bandwidth parts of all serving cells.
   Subcarrier spacings of activated downlink bandwidth parts of serving cells configured to use a unified TCI state.
   Subcarrier spacings of activated downlink bandwidth parts of serving cells for which SSB-MTCAdditionalPCI, which is higher layer signaling, is configured.
   Subcarrier spacings of the activated downlink bandwidth parts of serving cells included in the second PUSCH and having a beam failure.
   Activated downlink bandwidth parts of serving cells, which are configured to use a unified TCI state, among serving cells included in the second PUSCH and having a beam failure.
   Activated downlink bandwidth parts of serving cells, which are configured to use a unified TCI state and for which SSB-MTCAdditionalPCI that is higher layer signaling is configured, among serving cells included in the second PUSCH and having a beam failure.

In the inter-cell multi-TRP operation, the “lowest value” is described as, for example, the lowest value of Uplink-powerControl, the lowest value in the first list (e.g., Uplink-powerControl1-r18) among two lists for unified TCI state-based power control parameters, or the lowest value in the second list (e.g., Uplink-powerControl2-r18) among two lists for unified TCI state-based power control parameters, but this is an example, and the disclosure described above is not limited thereto and may be replaced by “the highest value” or generalized to “a specific value.”

### Second Embodiment: TRP-Specific BFR Method Using a Unified TCI State Method in a Single-DCI-Based Multi-TRP

As an embodiment of the disclosure, a BFR method for each TRP using a unified TCI state method in a single-DCI-based multi-TRP environment is described. Conditions commonly applied in situations to be described later in this embodiment may be as follows:
Single-DCI-based multi-TRP environment: In this embodiment, a single-DCI-based multi-TRP environment may be assumed. As described above, a single-DCI multi-TRP environment may refer to a case in which a UE receives two TCI states activated in at least one code point of a TCI state field in DCI from a base station.
Using unified TCI state: In this embodiment, an environment may be assumed in which a UE uses the unified TCI state described above. More specifically, the use of unified TCI state may refer to a case in which the UE is configured with TCI-State_r17, which is higher layer signaling having a meaning that the UE operates in a unified TCI method within a specific serving cell, in a PCell or PSCell.
Regarding CORESETs: The following may be assumed for CORESETs in this embodiment. The UE may receive, from a base station, a configuration regarding a unified TCI state, which will be used for reception of PDCCHs transmitted in the corresponding CORESET, among multiple unified TCI states indicated for the UE, via higher layer signaling for each CORESET or group of CORESETs, as described below.
   For example, the UE may receive PDCCHs transmitted within a CORESET by using a first unified TCI state among the two unified TCI states indicated for the UE via higher layer signaling within the CORESET, by using the second unified TCI state, by using both the first unified TCI state and the second unified TCI state, or using the unified TCI state configured or activated in the CORESET instead of using the indicated unified TCI state. For example, the UE may be configured with higher layer signaling, for a first CORESET among three CORESETs established within the activated bandwidth part, to receive PDCCHs by using the first unified TCI state among two unified TCI states indicated for the UE, may be configured with higher layer signaling, for a second CORESET, to receive PDCCHs by using the second unified TCI state, and may be configured with higher layer signaling, for the third CORESET, to receive PDCCHs by using the unified TCI state configured or activated for the corresponding CORESET instead of using the indicated unified TCI state.
   In another example, the UE may receive a configuration relating to which CORESET group the corresponding CORESET is included in, from a base station via higher layer signaling within the corresponding CORESET and, at the time of reception of PDCCHs transmitted within all CORESETs included within the corresponding CORESET group, similar to the above, the UE may use the first unified TCI state among the two unified TCI states indicated for the UE, may use the second unified TCI state, may use both the first unified TCI state and the second unified TCI state, or may use a unified TCI state configured or activated for the corresponding CORESET instead of using the indicated unified TCI state. In an example, the number of CORESET groups may be two, and the UE may be configured with higher layer signaling, for all of CORESETs within a first CORESET group established within the activated bandwidth part, to receive PDCCHs by using the first unified TCI state among two unified TCI states indicated for the UE, and may be configured with higher layer signaling, for all of CORESETs within a second CORESET group, to receive PDCCHs by using the second unified TCI state. In another example, the number of CORESET groups may be two, and the UE may receive PDCCHs using the first unified TCI state when a specific CORESET is included in the first CORESET group, the UE may receive PDCCHs using the second unified TCI state when a specific CORESET is included in the second CORESET group, the UE may receive PDCCHs using both the first unified TCI state and the second unified TCI state when a specific CORESET is included in both the first CORESET group and the second CORESET group, and the UE may receive PDCCHs using the unified TCI state configured or activated for the corresponding CORESET instead of using the indicated unified TCI state when a specific CORESET is not included in both the first CORESET group and the second CORESET group.
BFD-RS sets and candidate beam RS sets: In this embodiment, the following assumptions may be made about BFD-RS sets and candidate beam RSs. The UE may be configured with two BFD-RS sets and two candidate beam RS sets as described above. A first BFD-RS set is associated with a first candidate beam RS set, and a second BFD-RS set is associated with a second candidate beam RS set.
   The UE may receive configurations for the first BFD-RS set and the second BFD-RS set from the base station via failureDetectionSet1 and failureDetectionSet2, which are higher layer signaling. When the UE has not received the configurations for the first BFD-RS set and the second BFD-RS set from the base station via failureDetectionSet1 and failureDetectionSet2, which are higher layer signaling, the UE may determine a first BFD-RS set and a second BFD-RS set according to the CORESET-specific or CORESET group-specific higher layer signaling.
   The UE may define a first CORESET associated with the first BFD-RS set and a second CORESET associated with the second BFD-RS set according to the CORESET-specific or CORESET group-specific higher layer signaling.
   When the UE is configured with CORESET-specific higher layer signaling regarding information about a unified TCI state, which is used to receive PDCCHs, among the multiple unified TCI states, the UE may define the first CORESET and the second CORESET using at least one combination of the followings:
      The UE may include, in the first CORESET, CORESETs for which higher layer signaling is configured so as to receive PDCCHs by using a first unified TCI state among the multiple indicated unified TCI states.
      The UE may include, in the second CORESET, CORESETs for which higher layer signaling is configured so as to receive PDCCHs by using the second unified TCI state among the multiple indicated unified TCI states.
      The UE may include, in both the first CORESET and the second CORESET, CORESETs for which higher layer signaling is configured so as to receive PDCCHs using both the first unified TCI state and the second unified TCI state among the multiple indicated unified TCI states. Including a specific CORESET in both the first CORESET and the second CORESET may signify that the corresponding CORESET is affected for all subsequent operation even if a beam failure occurs for at least one of the first BFD-RS set or the second BFD-RS set.
      The UE may include, in the first CORESET, CORESETs for which higher layer signaling is configured so as to receive PDCCHs using the unified TCI state configured or activated in the corresponding CORESET, instead of using the indicated unified TCI state.
      The UE may include, in the second CORESET, CORESETs for which higher layer signaling is configured so as to receive PDCCHs using the unified TCI state configured or activated in the corresponding CORESET, instead of using the indicated unified TCI state.
      The UE may not include, in both the first and second CORESETs, CORESETs for which higher layer signaling is configured so as to receive PDCCHs using the unified TCI state configured or activated for the corresponding CORESETs, instead of using the indicated unified TCI state. Not including of a specific CORESET in both the first CORESET and the second CORESET may signify that the CORESET is not affected for all subsequent operations even if a beam failure occurs for at least one of the first BFD-RS set and the second BFD-RS set.
   When the UE is configured with CORESET group-specific higher layer signaling regarding information about a unified TCI state, which is used to receive PDCCHs, among multiple indicated unified TCI states, the UE may define the first CORESET and the second CORESET using at least one combination of the following:
      The UE may include, in the first CORESET, CORESETs for which higher layer signaling is configured so as to receive PDCCHs by using a first unified TCI state among the multiple indicated unified TCI states.
      The UE may include, in the second CORESET, CORESETs for which higher layer signaling is configured so as to receive PDCCHs by using the second unified TCI state among the multiple indicated unified TCI states.
      The UE may include, in both the first CORESET and the second CORESET, all CORESETs within the first CORESET group or the second CORESET group, for which higher layer signaling is configured, so as to receive PDCCHs using both the first unified TCI state and the second unified TCI state among the multiple indicated unified TCI states. Including a specific CORESET in both the first CORESET and the second CORESET may signify that the corresponding CORESET is affected for all subsequent operation even if a beam failure occurs for at least one of the first BFD-RS set or the second BFD-RS set.
      The UE may include, in the first CORESET, CORESETs for which higher layer signaling is configured so as to receive PDCCHs using the unified TCI state configured or activated in the corresponding CORESET, instead of using the indicated unified TCI state.
      The UE may include, in the second CORESET, CORESETs for which higher layer signaling is configured so as to receive PDCCHs using the unified TCI state configured or activated in the corresponding CORESET, instead of using the indicated unified TCI state.
      The UE may not include, in both the first and second CORESETs, CORESETs for which higher layer signaling is configured so as to receive PDCCHs using the unified TCI state configured or activated for the corresponding CORESETs, instead of using the indicated unified TCI state. Not including of a specific CORESET in both the first CORESET and the second CORESET may signify that the corresponding CORESET is not affected for all subsequent operations even if a beam failure occurs for at least one of the first BFD-RS set and the second BFD-RS set.
      The coresetPoolIndex may be used to indicate a group of CORESETs. In other words, despite being a single DCI-based multi-TRP environment, in a situation where the unified TCI state is extended to multi-TRP, the UE may be configured with the above coresetPoolIndex via higher layer signaling to distinguish CORESET groups.
   The UE may report, to the base station, the maximum number of RSs for each BFD-RS set and the maximum number of total RSs included within two BFD-RS sets, as UE capability information and when, based on the UE capability information, the UE has received the configurations of the first and second BFD-RS sets via higher layer signaling, as described above, or the UE has configured the first and second BFD-RS sets using some or all of the RSs referenced in the activated TCI state in the first and second CORESETs when the configurations of the first and second BFD-RS sets are not received, the UE may expect the number of RSs for each BFD-RS set and the total number of RSs included in two BFD-RS sets to be smaller than or equal to the UE capability value reported to the base station. When the UE has not received the configurations for the first and second BFD-RS sets from the base station via failureDetectionSet1 and failureDetectionSet2 which are higher layer signaling, and the total number of RSs referenced by the activated TCI state in the first and second CORESETs is greater than the maximum value of the total number of RSs included in the two BFD-RS sets reported by the UE capability, the UE may first select an RS referenced in the activated TCI state in a CORESET having a short period of a search space to which the CORESET is connected, among multiple first and second CORESETs. When the search spaces connected to the multiple first and second CORESETs have the same period, the UE may first select an RS referenced in the activated TCI state in a CORESET having a high index.
Regarding link recovery request (LRR): In this embodiment, the following may be assumed regarding an LRR for a BFRQ of a UE. If the PCell and PSCell are associated with the first BFD-RS set and the first candidate beam RS set associated therewith, and are associated with the second BFD-RS set and the second candidate beam RS set associated therewith, the UE may report to the base station that there are two LRRs that may be configured via higher layer signaling by the base station through twoLRRcapacity, which is UE capacity report. The UE not performing the reporting may receive configuration information for the first LRR from the base station via schedulingRequestID-BFR which is higher layer signaling, and the UE performing the reporting may receive additional configuration information for the second LRR from the base station via schedulingRequestID-BFR2 which is higher layer signaling. When the UE has only received the configuration for the first LRR from the base station via higher layer signaling, the UE may perform PUCCH transmission for the LRR for the first and second BFD-RS set. When the UE receives the configurations for the first and second LRRs from the base station via higher layer signaling, the UE may use configuration information about the first LRR for the first BFD-RS set and configuration information about the second LRR for the second BFD-RS set.

In the following, the above conditions may be assumed by default when defining the operation of the UE and the base station, unless otherwise stated.

### Intra-Cell Multi-TRP Operation

When a UE is not configured with SSB-MTCAdditionalPCI, which is higher layer signaling, that is, when all TRPs have the same physical cell ID as the physical cell ID of a serving cell, the UE and the base station may refer to operating in an intra-cell multi-TRP environment.

When the first BFD-RS set, the second BFD-RS set, or both two BFD-RS sets are identified as in a beam failure situation as described above, the UE may transmit the LRR to the base station, and the base station may transmit a (1-1)th PDCCH corresponding thereto to the UE so as to indicate second PUSCH scheduling information. The corresponding second PUSCH may include an enhanced BFR MAC-CE or a truncated enhanced BFR MAC-CE. The enhanced BFR MAC-CE or truncated enhanced BFR MAC-CE may include at least one of the following pieces of information:
Cell index(es) corresponding to a single BFD-RS set having a link quality lower than a reference value.
Whether a selected candidate beam RS exists in each single candidate beam RS set within the cell index(es) corresponding to the single BFD-RS set, and if existing, the index of the candidate beam RS.
Cell index(es) in which at least one of the first and second BFD-RS sets has a link quality lower than the reference value.
   Index(es) of the BFD-RS set, which has a link quality lower than the reference value, among the first and second sets of BFD-RS set. As an example, the BFD-RS set index(es) may be included in enhanced BFR MAC-CE or truncated enhanced BFR MAC-CE together with the cell index(es). As an example, the BFD set index(es) may be lower layer information of the cell index(es).
In each of the first and second sets of candidate beam RSs within the cell index(es) corresponding to the first and second sets of BFD-RS set, whether the selected candidate beam RS exists, and if existing, the index of the candidate beam RS for each set.

For the serving cell(s), which are associated with the first BFD-RS set and the first candidate beam RS set associated therewith, and with the second BFD-RS set and the second candidate beam RS set associated therewith, after 28 symbols from a last symbol of a (2-1)th PDCCH reception including the same HARQ process ID field and toggled NDI field value as those of a (1-1)th PDCCH that has scheduled the second PUSCH, the UE may perform a combination of at least one of the following operations:
When monitoring the first CORESET, the UE may perform PDCCH reception using a combination of at least one of the following:
   When some of the first CORESET are included in the first CORESET only, i.e., not included in the second CORESET, the UE may follow QCL parameter assumptions of a candidate beam RS selected from the first set of candidate beam RS during monitoring the first CORESET.
   When the beam failure occurs only for a first BFD-RS set, i.e., the beam failure does not occur for a second BFD-RS set, and some of the CORESETs of the first CORESET are also included in the second CORESET, i.e., when the UE uses both the first unified TCI state and the second unified TCI state among multiple unified TCI states indicated when receiving the PDCCH within the corresponding some CORESETs, the UE may perform PDCCH reception within the correspond some CORESETs using both the QCL parameters of the candidate beam RS selected from the first set of candidate beam RSs and the previously indicated second unified TCI state.
   When a beam failure occurs for both the first BFD-RS set and the second BFD-RS set, and some of the CORESETs in the first CORESET are also included in the second CORESET, i.e., when the UE may use both the first unified TCI state and the second unified TCI state among the multiple unified TCI states indicated when receiving PDCCHs within the corresponding CORESETs, the UE may use both the QCL parameters of the candidate beam RS selected within the first set of candidate beam RS and the QCL parameters of the candidate beam RS selected within the second set of candidate beam RS to perform PDCCH reception within the corresponding some CORESETs.
The UE may assume that the reception of a scheduled PDSCH from all of the first CORESETs has the same QCL parameter as that of the reception of a candidate beam RS selected from the first candidate beam RS set.
The UE may assume that the reception of an aperiodic CSI-RS resource under a specific condition has the same QCL parameter as that of the reception of the candidate beam RS selected from the first candidate beam RS set. In this case, the aperiodic CSI-RS resource of the specific condition may be a combination of at least one of the following:
   The aperiodic CSI-RS resource may refer to a case in which a specific CORESET group index or coresetPoolIndex (e.g., CORESET group 0 or coresetPoolIndex 0) is configured within the aperiodic CSI-RS resource or a CSI-RS resource set including the aperiodic CSI-RS resource. The case in which a specific CORESET group index or coresetPoolIndex (e.g., CORESET group 0 or coresetPoolIndex 0) for a specific aperiodic CSI-RS resource or a specific CSI-RS resource set has been configured for the UE may signify that the UE may receive the corresponding aperiodic CSI-RS resource or aperiodic CSI-RS resources within the corresponding CSI-RS resource set by using a specific unified TCI state (e.g., a first unified TCI state) corresponding to a specific CORESET group index or coresetPoolIndex (e.g., CORESET group 0 or coresetPoolIndex 0) among the multiple indicated unified TCI states.
   The aperiodic CSI-RS resource may refer to a case in which specific higher layer signaling has been configured within the aperiodic CSI-RS resource or within a CSI-RS resource set including the aperiodic CSI-RS resource, and in which the specific higher layer signaling is associated with a CORESET group or coresetPoolIndex. The case in which specific higher layer signaling for a specific aperiodic CSI-RS resource or a specific CSI-RS resource set has been configured for the UE and the configured higher layer signaling has been associated with a specific CORESET group index or coresetPoolIndex (e.g., CORESET group 0 or coresetPoolIndex 0) may signify that the UE may receive the corresponding aperiodic CSI-RS resource or aperiodic CSI-RS resources within the corresponding CSI-RS resource set by using a specific unified TCI state (e.g., a first unified TCI state) corresponding to a specific CORESET group index or coresetPoolIndex (e.g., CORESET group 0 or coresetPoolIndex 0) among the multiple indicated unified TCI states.
   The aperiodic CSI-RS resource may refer to a case in which specific higher layer signaling has been configured within the aperiodic CSI-RS resource or within a CSI-RS resource set including the aperiodic CSI-RS resource, and the specific higher layer signaling may refer to information about a unified TCI state (e.g., a first unified TCI state), which is used to receive among the multiple indicated unified TCI states. The case in which specific higher layer signaling for a specific aperiodic CSI-RS resource or a specific CSI-RS resource set has been configured for the UE and the configured higher layer signaling has been received using a specific TCI state (e.g., a first unified TCI state) among the multiple indicated unified TCI states may signify that the UE may receive the corresponding aperiodic CSI-RS resource or aperiodic CSI-RS resources within the corresponding CSI-RS resource set by using a specific unified TCI state (e.g., a first unified TCI state) among the multiple indicated unified TCI states.
   The aperiodic CSI-RS resource may signify that, when DCI triggering the CSI-RS resource set including the aperiodic CSI-RS resource is transmitted from a specific CORESET (e.g., a first CORESET), the aperiodic CSI-RS resources included within the corresponding CSI-RS resource set may be received by the UE using a specific TCI state (e.g., a first unified TCI state) corresponding to the corresponding CORESET.
The UE may use a spatial domain filter used to receive a candidate beam RS selected from the first candidate beam RS set during transmission of the scheduled PUSCH in all of the first CORESETs.
The UE may use a spatial domain filter used to receive a candidate beam RS selected from the first candidate beam RS set during transmission of a PUCCH of a specific condition. In this case, the PUCCH of the specific condition may be a combination of at least one of the following:
   The PUCCH may refer to a case in which a specific CORESET group index or coresetPoolIndex (e.g., CORESET group 0 or coresetPoolIndex 0) is configured in the corresponding PUCCH resource. The case in which a specific CORESET group index or coresetPoolIndex (e.g., CORESET group 0 or coresetPoolIndex 0) for a specific PUCCH resource has been configured for the UE may signify that the PUCCH resource may be transmitted by the UE using a specific unified TCI state (e.g., a first unified TCI state) corresponding to a specific CORESET group index or coresetPoolIndex (e.g., CORESET group 0 or coresetPoolIndex 0) among the multiple indicated unified TCI states.
   The PUCCH may refer to a case in which specific higher layer signaling has been configured within the PUCCH resource, and the specific higher layer signaling is associated with a CORESET group or coresetPoolIndex. The case in which specific higher layer signaling for a specific PUCCH resource has been configured for the UE and the configured higher layer signaling has been associated with a specific CORESET group index or coresetPoolIndex (e.g., CORESET group 0 or coresetPoolIndex 0) may signify that the PUCCH resource may be transmitted by the UE using a specific unified TCI state (e.g., a first unified TCI state) corresponding to a specific CORESET group index or coresetPoolIndex (e.g., CORESET group 0 or coresetPoolIndex 0) among the multiple indicated unified TCI states.
   The PUCCH resource may refer to a case in which specific higher layer signaling has been configured within the corresponding PUCCH resource, and refer to information about a unified TCI state (e.g., a first unified TCI state), which is used to transmit the specific higher layer signaling, among the multiple indicated unified TCI states. The case in which specific higher layer signaling for a specific PUCCH resource has been configured for the UE and the configured higher layer signaling has been transmitted using a specific TCI state (e.g., a first unified TCI state) among the multiple indicated unified TCI states may signify that the UE may transmit the corresponding PUCCH resource by using a specific unified TCI state (e.g., a first unified TCI state) among the multiple indicated unified TCI states.
   The PUCCH may signify that, when DCI triggering the PUCCH resource is transmitted from a specific CORESET (e.g., a CORESET in CORESET group 0, or a CORESET configured with coresetPoolIndex of 0, or the first CORESET), the PUCCH resource may be transmitted by the UE using a specific TCI state (e.g., a first unified TCI state) corresponding to the corresponding CORESET.
The UE may use the spatial domain filter used to receive a candidate beam RS selected from the first candidate beam RS set during transmission of an SRS of a specific condition. In this case, the SRS of the specific condition may be a combination of at least one of the following:
   The SRS may refer to a case in which a specific CORESET group index or coresetPoolIndex (e.g., CORESET group 0 or coresetPoolIndex 0) is configured within the SRS resource or a SRS resource set including the SRS resource. The case in which a specific CORESET group index or coresetPoolIndex (e.g., CORESET group 0 or coresetPoolIndex 0) for a specific SRS resource or a specific SRS resource set including the corresponding SRS resource has been configured for the UE may signify that the UE may transmit the corresponding SRS resource or SRS resources within the SRS resource set including the corresponding SRS resource by using a specific unified TCI state (e.g., a first unified TCI state) corresponding to a specific CORESET group index or coresetPoolIndex (e.g., CORESET group 0 or coresetPoolIndex 0) among the multiple indicated unified TCI states.
   The SRS may refer to a case in which specific higher layer signaling has been configured within the SRS resource, or within an SRS resource set including the SRS resource, and in which the specific higher layer signaling is associated with a CORESET group or coresetPoolIndex. The case in which specific higher layer signaling for a specific SRS resource or a specific SRS resource set including the corresponding SRS resource has been configured for the UE and the configured higher layer signaling has been associated with a specific CORESET group index or coresetPoolIndex (e.g., CORESET group 0 or coresetPoolIndex 0) may signify that the UE may transmit the corresponding SRS resource or the SRS resources within the SRS resource set including the corresponding SRS resource by using a specific unified TCI state (e.g., a first unified TCI state) corresponding to a specific CORESET group index or coresetPoolIndex (e.g., CORESET group 0 or coresetPoolIndex 0) among the multiple indicated unified TCI states.
   The SRS may refer to a case in which specific higher layer signaling has been configured within the corresponding SRS resource or within an SRS resource set including the corresponding SRS resource, and refer to information about a unified TCI state (e.g., a first unified TCI state), which is used to transmit the specific higher layer signaling, among the multiple indicated unified TCI states. The case in which specific higher layer signaling for a specific SRS resource or a specific SRS resource set including the corresponding SRS resource set has been configured for the UE and the configured higher layer signaling has been transmitted using a specific TCI state (e.g., a first unified TCI state) among the multiple indicated unified TCI states may signify that the UE may transmit the corresponding SRS resource or SRS resources within the SRS resource set including the corresponding SRS resource by using a specific unified TCI state (e.g., a first unified TCI state) among the multiple indicated unified TCI states.
   The SRS may signify that, when DCI triggering the SRS resource set including the SRS resource is transmitted from a specific CORESET (e.g., a CORESET in CORESET group 0, or a CORESET configured with coresetPoolIndex of 0, or the first CORESET), the corresponding SRS resource or the SRS resources included within the corresponding SRS resource set including the corresponding SRS resource may be transmitted by the UE using a specific TCI state (e.g., a first unified TCI state) corresponding to the corresponding CORESET.
When the UE transmits a PUSCH using a spatial domain filter that the UE used to receive a candidate beam RS selected from the first candidate beam RS set, power control parameters for the corresponding PUSCH transmission of the UE may follow a combination of at least one of the following:
   A candidate beam RS selected from the first candidate beam RS set may be used as a pathloss reference signal for the PUSCH transmission, and the UE may measure a downlink pathloss value by using the selected candidate beam RS.
   As a method of determining the power control parameters for the PUSCH transmission, the UE may use p0, alpha, and PUSCH power control adjustment state included in the p0-Alpha-CLID-PUSCH-Set associated with ul-powercontrolId of the lowest value in Uplink-powerControl, which is higher layer signaling, in the corresponding PCell, PSCell, SCell, or serving cell. In other words, the p0, alpha, and PUSCH power control adjustment state included in the p0-Alpha-CLID-PUSCH-Set associated with the ul-powercontrolId of the lowest value in the Uplink-powerControl, which is higher layer signaling, in the corresponding PCell, PSCell, SCell, or serving cell may be determined as the power control parameter for the PUSCH transmission.
   As another method of determining the power control parameters for PUSCH transmissions, the UE may use the p0, alpha, and PUSCH power control adjustment state included in the p0-Alpha-CLID-PUSCH-Set associated with ul-powercontrolId of the lowest value in Uplink-powerControl configured with a coresetPoolIndex of 0 or a CORESET group index of 0, which is higher layer signaling, in the corresponding PCell, PSCell, SCell, or serving cell, or configured with a specific higher layer signaling configured upon transmission of the PUCCH resource and SRS resource (e.g., the higher layer signaling indicating to transmit using a first unified TCI state among the multiple indicated unified TCI states). In other words, the p0, alpha, and PUSCH power control adjustment state included in the p0-Alpha-CLID-PUSCH-Set associated with ul-powercontrolId of the lowest value in Uplink-powerControl configured with a coresetPoolIndex of 0 or a CORESET group index of 0, which is higher layer signaling, in the corresponding PCell, PSCell, SCell, or serving cell, or configured with a specific higher layer signaling configured upon transmission of the PUCCH resource and SRS resource may be determined as the power control parameter for the PUSCH transmission.
   As yet another method of determining the power control parameters for PUSCH transmissions, the UE may use the p0, alpha, and PUSCH power control adjustment state included in the p0-Alpha-CLID-PUSCH-Set associated with ul-powercontrolId of the lowest value within the first list (e.g., Uplink-powerControl1-r18) among two lists for the unified TCI state-based power control parameters configured by higher layer signaling in the corresponding PCell, PSCell, SCell, or serving cell. In other words, the p0, alpha, and PUSCH power control adjustment state, which are included within the p0-Alpha-CLID-PUSCH-Set associated with ul-powercontrolld of the lowest value within the first list (e.g., Uplink-powerControl1-r18) among two lists for unified TCI state-based power control parameters configured by higher layer signaling in the corresponding PCell, PSCell, SCell, or serving cell, may be determined as the power control parameter for the PUSCH transmission.
When the UE transmits a PUCCH using the spatial domain filter that the UE used to receive a candidate beam RS selected from the first candidate beam RS set, the power control parameters for the corresponding PUCCH transmission of the UE may follow a combination of at least one of the following:
   A candidate beam RS selected from the first candidate beam RS set may be used as a pathloss reference signal for the PUCCH transmission, and the UE may measure a downlink pathloss value by using the selected candidate beam RS.
   As a method of determining the power control parameters for the PUCCH transmission, the UE may use p0, alpha, and PUCCH power control adjustment state included in the p0-Alpha-CLID-PUCCH-Set associated with ul-powercontrolId of the lowest value in Uplink-powerControl, which is higher layer signaling, in the corresponding PCell, PSCell, SCell, or serving cell. In other words, the p0, alpha, and PUCCH power control adjustment state included in the p0-Alpha-CLID-PUSCH-Set associated with the ul-powercontrolId of the lowest value of the Uplink-powerControl, which is higher layer signaling, in the corresponding PCell, PSCell, SCell, or serving cell may be determined as the power control parameter for the PUCCH transmission.
   As another method of determining the power control parameters for PUCCH transmissions, the UE may use the p0, alpha, and PUCCH power control adjustment state included in the p0-Alpha-CLID-PUCCH-Set associated with ul-powercontrolId of the lowest value in Uplink-powerControl configured with a coresetPoolIndex of 0 or a CORESET group index of 0, which is higher layer signaling, in the corresponding PCell, PSCell, SCell, or serving cell, or configured with a specific higher layer signaling configured upon transmission of the PUCCH resource and SRS resource (e.g., the higher layer signaling indicating to transmit using a first unified TCI state among the multiple indicated unified TCI states). In other words, the p0, alpha, and PUCCH power control adjustment state included in the p0-Alpha-CLID-PUCCH-Set associated with ul-powercontrolId of the lowest value in Uplink-powerControl configured with a coresetPoolIndex of 0 or a CORESET group index of 0, which is higher layer signaling, in the corresponding PCell, PSCell, SCell, or serving cell, or configured with a specific higher layer signaling configured upon transmission of the PUCCH resource and SRS resource may be determined as the power control parameter for the PUCCH transmission.
   As yet another method of determining the power control parameters for PUCCH transmissions, the UE may use the p0, alpha, and PUCCH power control adjustment state included in the p0-Alpha-CLID-PUCCH-Set associated with ul-powercontrolId of the lowest value within the first list (e.g., Uplink-powerControl1-r18) among two lists for the unified TCI state-based power control parameters configured by higher layer signaling in the corresponding PCell, PSCell, SCell, or serving cell. In other words, the p0, alpha, and PUCCH power control adjustment state, which are included within the p0-Alpha-CLID-PUCCH-Set associated with ul-powercontrolId of the lowest value within the first list (e.g., Uplink-powerControl1-r18) among two lists for unified TCI state-based power control parameters configured by higher layer signaling in the corresponding PCell, PSCell, SCell, or serving cell, may be determined as the power control parameter for the PUCCH transmission.
When the UE transmits an SRS using a spatial domain filter that has been used when the UE received the candidate beam RS selected from the first candidate beam RS set, the power control parameters for the corresponding SRS transmission of the UE may follow a combination of at least one of the following:
   A candidate beam RS selected from the first candidate beam RS set may be used as a pathloss reference signal for the SRS transmission, and the UE may measure a downlink pathloss value by using the selected candidate beam RS.
   As a method of determining the power control parameters for the SRS transmission, the UE may use p0, alpha, and SRS power control adjustment state included in the p0-Alpha-CLID-SRS-Set associated with ul-powercontrolId of the lowest value in Uplink-powerControl, which is higher layer signaling, in the corresponding PCell, PSCell, SCell, or serving cell. In other words, the p0, alpha, and SRS power control adjustment state included in the p0-Alpha-CLID-SRS-Set associated with the ul-powercontrolId of the lowest value of the Uplink-powerControl, which is higher layer signaling, in the corresponding PCell, PSCell, SCell, or serving cell may be determined as the power control parameter for the SRS transmission.
   As another method of determining the power control parameters for SRS transmissions, the UE may use the p0, alpha, and SRS power control adjustment state included in the p0-Alpha-CLID-SRS-Set associated with ul-powercontrolId of the lowest value in Uplink-powerControl configured with a coresetPoolIndex of 0 or a CORESET group index of 0, which is higher layer signaling, in the corresponding PCell, PSCell, SCell, or serving cell, or configured with a specific higher layer signaling configured upon transmission of the PUCCH resource and SRS resource (e.g., the higher layer signaling indicating to transmit using a first unified TCI state among the multiple indicated unified TCI states). In other words, the p0, alpha, and SRS power control adjustment state included in the p0-Alpha-CLID-SRS-Set associated with ul-powercontrolId of the lowest value in Uplink-powerControl configured with a coresetPoolIndex of 0 or a CORESET group index of 0, which is higher layer signaling, in the corresponding PCell, PSCell, SCell, or serving cell, or configured with a specific higher layer signaling configured upon transmission of the PUCCH resource and SRS resource may be determined as the power control parameter for the SRS transmission.
   As yet another method of determining the power control parameters for SRS transmissions, the UE may use the p0, alpha, and SRS power control adjustment state included in the p0-Alpha-CLID-SRS-Set associated with ul-powercontrolId of the lowest value within the first list (e.g., Uplink-powerControl1-r18) among two lists for the unified TCI state-based power control parameters configured by higher layer signaling in the corresponding PCell, PSCell, SCell, or serving cell. In other words, the p0, alpha, and SRS power control adjustment state, which are included within the p0-Alpha-CLID-SRS-Set associated with ul-powercontrolId of the lowest value within the first list (e.g., Uplink-powerControl1-r18) among two lists for unified TCI state-based power control parameters configured by higher layer signaling in the corresponding PCell, PSCell, SCell, or serving cell, may be determined as the power control parameter for the SRS transmission.
When monitoring the second CORESET, the UE may perform PDCCH reception using a combination of at least one of the following:
   When some of the second CORESET are included in the second CORESET only, i.e., not included in the first CORESET, the UE may follow QCL parameter assumptions of a candidate beam RS selected from the second set of candidate beam RS during monitoring the second CORESET.
   When the beam failure occurs only for a second BFD-RS set, i.e., the beam failure does not occur for a first BFD-RS set, and some of the CORESETs of the second CORESET are also included in the second CORESET, i.e., when the UE uses both the first unified TCI state and the second unified TCI state among multiple unified TCI states indicated when receiving the PDCCH within the corresponding some CORESETs, the UE may perform PDCCH reception within the correspond some CORESETs using both the QCL parameters of the candidate beam RS selected from the second set of candidate beam RSs and the previously indicated first unified TCI state.
   When a beam failure occurs for both the first BFD-RS set and the second BFD-RS set, and some of the CORESETs in the second CORESET are also included in the first CORESET, i.e., when the UE may use both the first unified TCI state and the second unified TCI state among the multiple unified TCI states indicated when receiving PDCCHs within the corresponding CORESETs, the UE may use both the QCL parameters of the candidate beam RS selected within the first set of candidate beam RS and the QCL parameters of the candidate beam RS selected within the first set of candidate beam RS to perform PDCCH reception within the corresponding some CORESETs.
The UE may assume that the reception of a scheduled PDSCH from all of the second CORESETs has the same QCL parameter as that of the reception of a candidate beam RS selected from the second candidate beam RS set.
The UE may assume that the reception of an aperiodic CSI-RS resource under a specific condition has the same QCL parameter as that of the reception of the candidate beam RS selected from the second candidate beam RS set. In this case, the aperiodic CSI-RS resource of the specific condition may be a combination of at least one of the following:
   The aperiodic CSI-RS resource may refer to a case in which a specific CORESET group index or coresetPoolIndex (e.g., CORESET group 0 or coresetPoolIndex 0) is configured within the aperiodic CSI-RS resource or a CSI-RS resource set including the aperiodic CSI-RS resource. The case in which a specific CORESET group index or coresetPoolIndex (e.g., CORESET group 1 or coresetPoolIndex 1) for a specific aperiodic CSI-RS resource or a specific CSI-RS resource set has been configured for the UE may signify that the UE may receive the corresponding aperiodic CSI-RS resource or aperiodic CSI-RS resources within the corresponding CSI-RS resource set by using a specific unified TCI state (e.g., a second unified TCI state) corresponding to a specific CORESET group index or coresetPoolIndex (e.g., CORESET group 1 or coresetPoolIndex 1) among the multiple indicated unified TCI states.
   The aperiodic CSI-RS resource may refer to a case in which specific higher layer signaling has been configured within the aperiodic CSI-RS resource or within a CSI-RS resource set including the aperiodic CSI-RS resource, and in which the specific higher layer signaling is associated with a CORESET group or coresetPoolIndex. The case in which specific higher layer signaling for a specific aperiodic CSI-RS resource or a specific CSI-RS resource set has been configured for the UE and the configured higher layer signaling has been associated with a specific CORESET group index or coresetPoolIndex (e.g., CORESET group 0 or coresetPoolIndex 0) may signify that the UE may receive the corresponding aperiodic CSI-RS resource or aperiodic CSI-RS resources within the corresponding CSI-RS resource set by using a specific unified TCI state (e.g., a second unified TCI state) corresponding to a specific CORESET group index or coresetPoolIndex (e.g., CORESET group 1 or coresetPoolIndex 1) among the multiple indicated unified TCI states.
   The aperiodic CSI-RS resource may refer to a case in which specific higher layer signaling has been configured within the aperiodic CSI-RS resource or within a CSI-RS resource set including the aperiodic CSI-RS resource, and refer to information about a unified TCI state (e.g., a second unified TCI state), which is used to receive the specific higher layer signaling, among the multiple indicated unified TCI states. The case in which specific higher layer signaling for a specific aperiodic CSI-RS resource or a specific CSI-RS resource set has been configured for the UE and the configured higher layer signaling has been received using a specific TCI state (e.g., a second unified TCI state) among the multiple indicated unified TCI states may signify that the UE may receive the corresponding aperiodic CSI-RS resource or aperiodic CSI-RS resources within the corresponding CSI-RS resource set by using a specific unified TCI state (e.g., a second unified TCI state) among the multiple indicated unified TCI states.
   The aperiodic CSI-RS resource may signify that, when DCI triggering the CSI-RS resource set including the aperiodic CSI-RS resource is transmitted from a specific CORESET (e.g., a second CORESET), the aperiodic CSI-RS resources included within the corresponding CSI-RS resource set may be received by the UE using a specific TCI state (e.g., a second unified TCI state) corresponding to the corresponding CORESET.
The UE may use a spatial domain filter used to receive a candidate beam RS selected from the second candidate beam RS set during transmission of the scheduled PUSCH in all of the second CORESETs.
The UE may use a spatial domain filter used to receive a candidate beam RS selected from the second candidate beam RS set during transmission of a PUCCH of a specific condition. In this case, the PUCCH of the specific condition may be a combination of at least one of the following:
   The PUCCH may refer to a case in which a specific CORESET group index or coresetPoolIndex (e.g., CORESET group 1 or coresetPoolIndex 1) is configured in the corresponding PUCCH resource. The case in which a specific CORESET group index or coresetPoolIndex (e.g., CORESET group 1 or coresetPoolIndex 1) for a specific PUCCH resource has been configured for the UE may signify that the PUCCH resource may be transmitted by the UE using a specific unified TCI state (e.g., a second unified TCI state) corresponding to a specific CORESET group index or coresetPoolIndex (e.g., CORESET group 1 or coresetPoolIndex 1) among the multiple indicated unified TCI states.
   The PUCCH may refer to a case in which specific higher layer signaling has been configured within the PUCCH resource, and the specific higher layer signaling is associated with a CORESET group or coresetPoolIndex. The case in which specific higher layer signaling for a specific PUCCH resource has been configured for the UE and the configured higher layer signaling has been associated with a specific CORESET group index or coresetPoolIndex (e.g., CORESET group 0 or coresetPoolIndex 0) may signify that the PUCCH resource may be transmitted by the UE using a specific unified TCI state (e.g., a second unified TCI state) corresponding to a specific CORESET group index or coresetPoolIndex (e.g., CORESET group 1 or coresetPoolIndex 1) among the multiple indicated unified TCI states.
   The PUCCH resource may refer to a case in which specific higher layer signaling has been configured within the corresponding PUCCH resource, and refer to information about a unified TCI state (e.g., a second unified TCI state), which is used to transmit the specific higher layer signaling, among the multiple indicated unified TCI states. The case in which specific higher layer signaling for a specific PUCCH resource or a specific CSI-RS resource set has been configured for the UE and the configured higher layer signaling has been transmitted using a specific TCI state (e.g., a second unified TCI state) among the multiple indicated unified TCI states may signify that the UE may transmit the corresponding PUCCH resource by using a specific unified TCI state (e.g., a second unified TCI state) among the multiple indicated unified TCI states.
   The PUCCH may signify that, when DCI triggering the PUCCH resource is transmitted from a specific CORESET (e.g., a CORESET in CORESET group 1, or a CORESET configured with coresetPoolIndex of 1, or a second CORESET), the PUCCH resource may be transmitted by the UE using a specific TCI state (e.g., a second unified TCI state) corresponding to the corresponding CORESET.
The UE may use the spatial domain filter used to receive a candidate beam RS selected from the second candidate beam RS set during transmission of an SRS of a specific condition. In this case, the SRS of the specific condition may be a combination of at least one of the following:
   The SRS may refer to a case in which a specific CORESET group index or coresetPoolIndex (e.g., CORESET group 1 or coresetPoolIndex 1) is configured within the SRS resource or a SRS resource set including the SRS resource. The case in which a specific CORESET group index or coresetPoolIndex (e.g., CORESET group 1 or coresetPoolIndex 1) for a specific SRS resource or a specific SRS resource set including the corresponding SRS resource has been configured for the UE may signify that the UE may transmit the corresponding SRS resource or SRS resources within the SRS resource set including the corresponding SRS resource by using a specific unified TCI state (e.g., a second unified TCI state) corresponding to a specific CORESET group index or coresetPoolIndex (e.g., CORESET group 1 or coresetPoolIndex 1) among the multiple indicated unified TCI states.
   The SRS may refer to a case in which specific higher layer signaling has been configured within the SRS resource, or within an SRS resource set including the SRS resource, and in which the specific higher layer signaling is associated with a CORESET group or coresetPoolIndex. The case in which specific higher layer signaling for a specific SRS resource or a specific SRS resource set including the corresponding SRS resource has been configured for the UE and the configured higher layer signaling has been associated with a specific CORESET group index or coresetPoolIndex (e.g., CORESET group 1 or coresetPoolIndex 1) may signify that the UE may transmit the corresponding SRS resource or the SRS resources within the SRS resource set including the corresponding SRS resource by using a specific unified TCI state (e.g., a second unified TCI state) corresponding to a specific CORESET group index or coresetPoolIndex (e.g., CORESET group 1 or coresetPoolIndex 1) among the multiple indicated unified TCI states.
   The SRS may refer to a case in which specific higher layer signaling has been configured within the corresponding SRS resource or within an SRS resource set including the corresponding SRS resource, and refer to information about a unified TCI state (e.g., a second unified TCI state), which is used to transmit the specific higher layer signaling, among the multiple indicated unified TCI states. The case in which specific higher layer signaling for a specific SRS resource or a specific SRS resource set including the corresponding SRS resource set has been configured for the UE and the configured higher layer signaling has been transmitted using a specific TCI state (e.g., a second unified TCI state) among the multiple indicated unified TCI states may signify that the UE may transmit the corresponding SRS resource or SRS resources within the SRS resource set including the corresponding SRS resource by using a specific unified TCI state (e.g., a second unified TCI state) among the multiple indicated unified TCI states.
   The SRS may signify that, when DCI triggering the SRS resource set including the SRS resource is transmitted from a specific CORESET (e.g., a CORESET in CORESET group 1, or a CORESET configured with coresetPoolIndex of 1, or a second CORESET), the corresponding SRS resource or the SRS resources included within the corresponding SRS resource set including the corresponding SRS resource may be transmitted by the UE using a specific TCI state (e.g., a second unified TCI state) corresponding to the corresponding CORESET.
When the UE transmits a PUSCH using a spatial domain filter that the UE used to receive a candidate beam RS selected from the second candidate beam RS set, power control parameters for the corresponding PUSCH transmission of the UE may follow a combination of at least one of the following:
   A candidate beam RS selected from the second candidate beam RS set may be used as a pathloss reference signal for the PUSCH transmission, and the UE may measure a downlink pathloss value by using the selected candidate beam RS.
   As a method of determining the power control parameters for the PUSCH transmission, the UE may use p0, alpha, and PUSCH power control adjustment state included in the p0-Alpha-CLID-PUSCH-Set associated with ul-powercontrolId of the lowest value in Uplink-powerControl, which is higher layer signaling, in the corresponding PCell, PSCell, SCell, or serving cell. In other words, the p0, alpha, and PUSCH power control adjustment state included in the p0-Alpha-CLID-PUSCH-Set associated with the ul-powercontrolId of the lowest value in the Uplink-powerControl, which is higher layer signaling, in the corresponding PCell, PSCell, SCell, or serving cell may be determined as the power control parameter for the PUSCH transmission.
   As another method of determining the power control parameters for PUSCH transmissions, the UE may use the p0, alpha, and PUSCH power control adjustment state included in the p0-Alpha-CLID-PUSCH-Set associated with ul-powercontrolId of the second lowest value in Uplink-powerControl having coresetPoolIndex, which is higher layer signaling, in the corresponding PCell, PSCell, SCell, or serving cell. In other words, the p0, alpha, and PUSCH power control adjustment state included in the p0-Alpha-CLID-PUSCH-Set associated with the ul-powercontrolld of the second lowest value in the Uplink-powerControl, which is higher layer signaling, in the corresponding PCell, PSCell, SCell, or serving cell, may be determined as the power control parameter for the PUSCH transmission.
   As yet another method of determining the power control parameters for PUSCH transmissions, the UE may use the p0, alpha, and PUSCH power control adjustment state included in the p0-Alpha-CLID-PUSCH-Set associated with ul-powercontrolId of the lowest value in Uplink-powerControl configured with a coresetPoolIndex of 1 or a CORESET group index of 1, which is higher layer signaling, in the corresponding PCell, PSCell, SCell, or serving cell, or configured with a specific higher layer signaling configured upon transmission of the PUCCH resource and SRS resource (e.g., the higher layer signaling indicating to transmit using a second unified TCI state among the multiple indicated unified TCI states). In other words, the p0, alpha, and PUSCH power control adjustment state included in the p0-Alpha-CLID-PUSCH-Set associated with ul-powercontrolId of the lowest value in Uplink-powerControl configured with a coresetPoolIndex of 1 or a CORESET group index of 1, which is higher layer signaling, in the corresponding PCell, PSCell, SCell, or serving cell, or configured with a specific higher layer signaling configured upon transmission of the PUCCH resource and SRS resource (e.g., the higher layer signaling indicating to transmit using a second unified TCI state among the multiple indicated unified TCI states) may be determined as the power control parameter for the PUSCH transmission.
   As still another method of determining the power control parameters for PUSCH transmissions, the UE may use the p0, alpha, and PUSCH power control adjustment state included in the p0-Alpha-CLID-PUSCH-Set associated with ul-powercontrolId of the lowest value within the second list (e.g., Uplink-powerControl2-r18) among two lists for the unified TCI state-based power control parameters configured by higher layer signaling in the corresponding PCell, PSCell, SCell, or serving cell. At this time, the first list and the second list may be associated with CORESET group indices 0 and 1, or coresetPoolIndices 0 and 1, or specific higher layer signaling (e.g., higher layer signaling that indicates to transmit using the first or second unified TCI state among the multiple indicated unified TCI states), respectively. In other words, the p0, alpha, and PUSCH power control adjustment state, which are included within the p0-Alpha-CLID-PUSCH-Set associated with ul-powercontrolId of the lowest value within the second list (e.g., Uplink-powerControl2-r18) among two lists for unified TCI state-based power control parameters configured by higher layer signaling in the corresponding PCell, PSCell, SCell, or serving cell, may be determined as the power control parameter for the PUSCH transmission.
When the UE transmits a PUCCH using a spatial domain filter that the UE used to receive a candidate beam RS selected from the second candidate beam RS set, the power control parameters for the corresponding PUCCH transmission of the UE may follow a combination of at least one of the following:
   A candidate beam RS selected from the second candidate beam RS set may be used as a pathloss reference signal for the PUCCH transmission, and the UE may measure a downlink pathloss value by using the selected candidate beam RS.
   As a method of determining the power control parameters for the PUCCH transmission, the UE may use p0, alpha, and PUCCH power control adjustment state included in the p0-Alpha-CLID-PUCCH-Set associated with ul-powercontrolId of the lowest value in Uplink-powerControl, which is higher layer signaling, in the corresponding PCell, PSCell, SCell, or serving cell. In other words, the p0, alpha, and PUCCH power control adjustment state included in the p0-Alpha-CLID-PUSCH-Set associated with the ul-powercontrolId of the lowest value of the Uplink-powerControl, which is higher layer signaling, in the corresponding PCell, PSCell, SCell, or serving cell may be determined as the power control parameter for the PUCCH transmission.
   As another method of determining the power control parameters for PUCCH transmissions, the UE may use the p0, alpha, and PUCCH power control adjustment state included in the p0-Alpha-CLID-PUCCH-Set associated with ul-powercontrolId of the second lowest value in Uplink-powerControl having coresetPoolIndex, which is higher layer signaling, in the corresponding PCell, PSCell, SCell, or serving cell. In other words, the p0, alpha, and PUCCH power control adjustment state included in the p0-Alpha-CLID-PUCCH-Set associated with the ul-powercontrolld of the second lowest value in the Uplink-powerControl, which is higher layer signaling, in the corresponding PCell, PSCell, SCell, or serving cell, may be determined as the power control parameter for the PUCCH transmission.
   As yet another method of determining the power control parameters for PUCCH transmissions, the UE may use the p0, alpha, and PUCCH power control adjustment state included in the p0-Alpha-CLID-PUCCH-Set associated with ul-powercontrolId of the lowest value in Uplink-powerControl configured with a coresetPoolIndex of 1 or a CORESET group index of 1, which is higher layer signaling, in the corresponding PCell, PSCell, SCell, or serving cell, or configured with a specific higher layer signaling configured upon transmission of the PUCCH resource and SRS resource (e.g., the higher layer signaling indicating to transmit using a second unified TCI state among the multiple indicated unified TCI states). In other words, the p0, alpha, and PUCCH power control adjustment state included in the p0-Alpha-CLID-PUCCH-Set associated with ul-powercontrolId of the lowest value in Uplink-powerControl configured with a coresetPoolIndex of 1 or a CORESET group index of 1, which is higher layer signaling, in the corresponding PCell, PSCell, SCell, or serving cell, or configured with a specific higher layer signaling configured upon transmission of the PUCCH resource and SRS resource (e.g., the higher layer signaling indicating to transmit using a second unified TCI state among the multiple indicated unified TCI states) may be determined as the power control parameter for the PUCCH transmission.
   As still another method of determining the power control parameters for PUCCH transmissions, the UE may use the p0, alpha, and PUCCH power control adjustment state included in the p0-Alpha-CLID-PUCCH-Set associated with ul-powercontrolId of the lowest value within the second list (e.g., Uplink-powerControl2-r18) among two lists for the unified TCI state-based power control parameters configured by higher layer signaling in the corresponding PCell, PSCell, SCell, or serving cell. At this time, the first list and the second list may be associated with CORESET group indices 0 and 1, or coresetPoolIndices 0 and 1, or specific higher layer signaling (e.g., higher layer signaling that indicates to transmit using the first or second unified TCI state among the multiple indicated unified TCI states), respectively. In other words, the p0, alpha, and PUCCH power control adjustment state, which are included within the p0-Alpha-CLID-PUCCH-Set associated with ul-powercontrolId of the lowest value within the second list (e.g., Uplink-powerControl2-r18) among two lists for unified TCI state-based power control parameters configured by higher layer signaling in the corresponding PCell, PSCell, SCell, or serving cell, may be determined as the power control parameter for the PUCCH transmission.
When the UE transmits an SRS using a spatial domain filter that has been used when the UE received the candidate beam RS selected from the second candidate beam RS set, the power control parameters for the corresponding SRS transmission of the UE may follow a combination of at least one of the following:
   A candidate beam RS selected from the second candidate beam RS set may be used as a pathloss reference signal for the SRS transmission, and the UE may measure a downlink pathloss value by using the selected candidate beam RS.
   As a method of determining the power control parameters for the SRS transmission, the UE may use p0, alpha, and SRS power control adjustment state included in the p0-Alpha-CLID-SRS-Set associated with ul-powercontrolId of the lowest value in Uplink-powerControl, which is higher layer signaling, in the corresponding PCell, PSCell, SCell, or serving cell. In other words, the p0, alpha, and SRS power control adjustment state included in the p0-Alpha-CLID-SRS-Set associated with the ul-powercontrolId of the lowest value of the Uplink-powerControl, which is higher layer signaling, in the corresponding PCell, PSCell, SCell, or serving cell may be determined as the power control parameter for the SRS transmission.
   As another method of determining the power control parameters for SRS transmissions, the UE may use the UE may use the p0, alpha, and SRS power control adjustment state included in the p0-Alpha-CLID-SRS-Set associated with ul-powercontrolId of the second lowest value in Uplink-powerControl having coresetPoolIndex, which is higher layer signaling, in the corresponding PCell, PSCell, SCell, or serving cell. In other words, the p0, alpha, and SRS power control adjustment state included in the p0-Alpha-CLID-SRS-Set associated with the ul-powercontrolId of the second lowest value in the Uplink-powerControl, which is higher layer signaling, in the corresponding PCell, PSCell, SCell, or serving cell, may be determined as the power control parameter for the SRS transmission.
   As yet another method of determining the power control parameters for SRS transmissions, the UE may use the p0, alpha, and SRS power control adjustment state included in the p0-Alpha-CLID-SRS-Set associated with ul-powercontrolId of the lowest value in Uplink-powerControl configured with a coresetPoolIndex of 1 or a CORESET group index of 1, which is higher layer signaling, in the corresponding PCell, PSCell, SCell, or serving cell, or configured with a specific higher layer signaling configured upon transmission of the PUCCH resource and SRS resource (e.g., the higher layer signaling indicating to transmit using a second unified TCI state among the multiple indicated unified TCI states). In other words, the p0, alpha, and SRS power control adjustment state included in the p0-Alpha-CLID-SRS-Set associated with ul-powercontrolId of the lowest value in Uplink-powerControl configured with a coresetPoolIndex of 1 or a CORESET group index of 1, which is higher layer signaling, in the corresponding PCell, PSCell, SCell, or serving cell, or configured with a specific higher layer signaling configured upon transmission of the PUCCH resource and SRS resource (e.g., the higher layer signaling indicating to transmit using a second unified TCI state among the multiple indicated unified TCI states) may be determined as the power control parameter for the SRS transmission.
   As still another method of determining the power control parameters for SRS transmissions, the UE may use the p0, alpha, and SRS power control adjustment state included in the p0-Alpha-CLID-SRS-Set associated with ul-powercontrolId of the lowest value within the second list (e.g., Uplink-powerControl2-r18) among two lists for the unified TCI state-based power control parameters configured by higher layer signaling in the corresponding PCell, PSCell, SCell, or serving cell. At this time, the first list and the second list may be associated with CORESET group indices 0 and 1, or coresetPoolIndices 0 and 1, or specific higher layer signaling (e.g., higher layer signaling that indicates to transmit using the first or second unified TCI state among the multiple indicated unified TCI states), respectively. In other words, the p0, alpha, and SRS power control adjustment state, which are included within the p0-Alpha-CLID-SRS-Set associated with ul-powercontrolId of the lowest value within the second list (e.g., Uplink-powerControl2-r18) among two lists for unified TCI state-based power control parameters configured by higher layer signaling in the corresponding PCell, PSCell, SCell, or serving cell, may be determined as the power control parameter for the SRS transmission.
At this time, the subcarrier spacing for the 28 symbols may be determined as the smallest subcarrier spacing among at least one combination of the followings:
   Subcarrier spacing of activated downlink bandwidth parts in which the (1-1)th PDCCH or (2-1)th PDCCH is received.
   Subcarrier spacings of activated downlink bandwidth parts of all serving cells
   Subcarrier spacings of activated downlink bandwidth parts of serving cells configured to use a unified TCI state.
   Subcarrier spacings of activated downlink bandwidth parts of serving cells for which SSB-MTCAdditionalPCI, which is higher layer signaling, is not configured
   Subcarrier spacings of activated downlink bandwidth parts of serving cells included in the second PUSCH and having a beam failure.
   Activated downlink bandwidth parts of serving cells, which are configured to use a unified TCI state, among serving cells included in the second PUSCH and having a beam failure.
Activated downlink bandwidth parts of serving cells, which are configured to use a unified TCI state and for which SSB-MTCAdditionalPCI that is higher layer signaling is not configured, among serving cells included in the second PUSCH and having a beam failure.

In the intra-cell multi-TRP operation, the “lowest value” is described as, for example, the lowest value of Uplink-powerControl, the lowest value in the first list (e.g., Uplink-powerControl1-r18) among two lists for unified TCI state-based power control parameters, or the lowest value in the second list (e.g., Uplink-powerControl2-r18) among two lists for unified TCI state-based power control parameters, but this is an example, and the disclosure described above is not limited thereto and may be replaced by “the highest value” or generalized to “a specific value.”

### Inter-Cell Multi-TRP Operation

When a UE is configured with coresetPoolIndex, which is higher layer signaling, the UE and base station may refer to operate in an inter-cell multi-TRP environment. In other words, inter-cell multi-TRP operation may refer to a case in which different TRPs have different physical cell IDs. The UE may include an SSB index associated with a physical cell ID different from a value of physCellId in ServingCellConfigCommon, which is higher layer signaling, in a first candidate beam RS set or a second candidate beam RS set, and a first BFD-RS set or a second BFD-RS set associated therewith may also be considered to be associated with the same physical cell ID. For example, when the value of physCellId in ServingCellConfigCommon is 0 and a specific SSB is associated with a physical cell ID value of 1, the UE may consider that the first BFD-RS set and the first candidate beam RS set are associated with 0, which is a physical cell ID of the serving cell, and the second BFD-RS set and the second candidate beam RS set are associated with 1, which is a physical cell ID with which the SSB is associated.

For a UE and a base station performing inter-cell multi-TRP operation, the UE may receive a configuration and an indication from the base station about the BFD-RS set and the candidate beam RS set using one of the following two methods.

### RS Set Notification Method 2-1

The UE may receive a configuration of the first BFD-RS set and the second BFD-RS set from the base station via higher layer signaling, or the UE may implicitly determine the same if higher layer signaling is not configured. Similar to the intra-cell multi-TRP operation above, the UE may use only two BFD-RS sets, such as a first BFD-RS set and a second BFD-RS set, and two candidate beam RS sets, such as a first candidate beam RS set and a second candidate beam RS set corresponding thereto. In this case, the first BFD-RS set and the first candidate beam RS set may be associated with a physical cell ID of a serving cell, and the second BFD-RS set and the second candidate beam RS set may be associated with a physical cell ID different from the serving cell ID configured through SSB-MTCAdditionalPCI, which is higher layer signaling, and vice versa. Further, as described above, the first BFD-RS set and the first candidate beam RS set may be associated with coresetPoolIndex 0, which is higher layer signaling, and the second BFD-RS set and the second candidate beam RS set may be associated with coresetPoolIndex 1 which is higher layer signaling.

When using the RS set Notification Method 2-1, the UE may change all of candidate beam RSs of a specific candidate beam RS set via higher layer signaling reconfiguration, and after changing via higher layer signaling reconfiguration, all of candidate beam RSs in the corresponding candidate beam RS set may be associated with one specific physical cell ID that is different from the previous one. For example, if all of candidate beam RSs in a specific candidate beam RS set have been associated with physical cell ID 0 before higher layer signaling reconfiguration, higher layer signaling reconfiguration may cause all of candidate beam RSs in the corresponding candidate beam RS set to be associated with physical cell ID 1, for example, rather than physical cell ID 0.

The UE may change an RS in a specific candidate beam RS set using MAC-CE when using the above RS set Notification Method 2-1. In this case, when a candidate beam RS is changed via MAC-CE, if all of candidate beam RSs in the candidate beam RS set before the change have been associated with a specific physical cell ID (e.g., physical cell ID 0) different from the serving cell ID, the UE may expect that all of candidate beam RSs in the candidate beam RS set may be associated with, via MAC-CE, a specific one physical cell ID different from the physical cell ID having been associated before the change. That is, after the change, all of candidate beam RSs may be associated with physical cell ID 1, for example, rather than physical cell ID 0.

### RS Set Notification Method 2-2

Depending on the number of physical cell IDs different from the serving cell ID that may be configured with via SSB-MTCAdditionalPCI, which is higher layer signaling, the UE may receive a configuration of (N+1) BFD-RS sets, such as a first to (N+1) BFD-RS set (e.g., a value of N is possible up to 7), and (N+1) candidate beam RS sets, such as a first to (N+1) candidate beam RS set (e.g., a value of N is possible up to 7) corresponding thereto, respectively, and may receive up to two of each of the (N+1) BFD-RS sets and (N+1) candidate beam RS sets indicated or selected from the base station. For example, the UE may receive a configuration from the base station via higher layer signaling, receive an indication dynamically via L1 signaling, receive activation of some RS sets among total RS sets via MAC-CE, or receive a notification of a combination of higher layer signaling and L1 signaling. In this case, one BFD-RS set among a maximum of (N+1) BFD-RS sets and one candidate beam RS set among a maximum of (N+1) candidate beam RS sets may be associated with (or correspond to) a physical cell ID of a serving cell, and the remaining N BFD-RS sets and candidate beam RS sets may be associated with (or correspond to) a respective physical cell ID different from a serving cell ID that the UE receives from the base station via SSB-MTCAdditionalPCI, which is higher layer signaling. When the UE receives a selection of two BFD-RS sets and two candidate beam RS sets from the base station, the UE may expect to receive a selection of pairs of BFD-RS sets and candidate beam RS sets associated with each other. When the UE receives a selection of two BFD-RS sets and two candidate beam RS sets from the base station, the UE may not expect to receive a selection of pairs of BFD-RS sets and candidate beam RS sets that are not associated with each other. Furthermore, as described above, the UE may associate one of the two BFD-RS sets and the two candidate beam RS sets associated therewith, which are selected by the base station, with coresetPoolIndex 0, and may associate the other with coresetPoolIndex 1.

When the UE receives a selection of two BFD-RS sets and two candidate beam RS sets from the base station based on [RS set Notification Method 2-2], the UE may expect that the selection at least includes a pair of BFD-RS sets and candidate beam RS sets associated with the physical cell ID of the serving cell. For example, among a total of eight BFD-RS sets and candidate beam RS sets, the UE may receive a selection from the base station of a first BFD-RS set and a first candidate beam RS set associated with a physical cell ID of a serving cell, and a second BFD-RS set and a second candidate beam RS set associated with a physical cell ID different from that of the serving cell ID.

### RS Set Notification Method 2-3

The UE may receive a configuration of a first BFD-RS set and a second BFD-RS set from the base station via higher layer signaling or, if not received, the UE may implicitly determine the first BFD-RS set and the second BFD-RS set, and depending on the number of physical cell IDs different from a serving cell ID that may be configured with SSB-MTCAdditionalPCI, which is higher layer signaling, the UE may receive a configuration of (N+1) candidate beam RS sets, such as a first to (N+1) candidate beam RS set (e.g., a value of N is possible up to 7), and may be indicated or selected by the base station for up to two of the candidate beam RS sets. For example, the UE may receive a configuration from the base station via higher layer signaling, receive an indication dynamically via L1 signaling, receive activation of some RS sets among total RS sets via MAC-CE, or receive a notification of a combination of higher layer signaling and L1 signaling. In this case, one BFD-RS set among two BFD-RS sets and one candidate beam RS set among a maximum of (N+1) candidate beam RS sets may be associated with (or correspond to) a physical cell ID of a serving cell, the remaining one BFD-RS set among two BFD-RS sets and one candidate beam RS set, a selection of which is received by the UE from the base station, may be associated with (or correspond to) a physical cell ID different from the serving cell ID, and the remaining candidate beam RS sets among the maximum (N+1) candidate beam RS sets may be associated with (or correspond to) a respective physical cell ID that is different from the serving cell ID that the UE receives from the base station via SSB-MTCAdditionalPCI, which is higher layer signaling. The UE may receive, from the base station, a selection of one of up to N candidate beam RS sets respectively corresponding to up to N different physical cell IDs via higher layer signaling, MAC-CE, L1 signaling, or a combination thereof. At the same time, BFD RSs within the first or second BFD-RS set corresponding thereto may be changed via MAC-CE and here, the newly changed BFD RSs may be associated with a physical cell ID associated with a candidate beam RS set newly selected by the base station.

In RS set Notification Method 2-1 to RS set Notification Method 2-3 above, the number of RS sets selected by the base station is described as two, but the disclosure is not limited thereto and may be generalized to natural number greater than two (e.g., three or four, etc.).

An LRR association method that may be used in combination with RS set Notification Method 2-1 to RS set Notification Method 2-3 above is described below.

LRR Association Method 2-1: Association with a first BFD-RS set and a second BFD-RS set

The UE may expect one or two LRRs to be associated with the first BFD-RS set and the second BFD-RS set. That is, for the first BFD-RS set and the second BFD-RS set that are finally selected and determined as described above, the UE may expect one or each of two LRRs to be associated with each of the first BFD-RS set and the second BFD-RS set and to be used. For example, the UE may associate one first LRR or each of the first LRR and the second LRR with the first BFD-RS set and the second BFD-RS set, which are two BFD-RS sets selected from a maximum of (N+1) BFD-RS sets through RS set Notification Method 2-2 above, so as to use the same in a beam failure recovery request indication.

LRR Association Method 2-2: Predetermination of association relationship with each of (N+1) BFD-RS sets, the determination made by selection of two of the BFD-RS sets

The UE may expect one or two LRRs to be associated with each BFD-RS set. In other words, definition as to which LRRs are associated with multiple BFD-RS sets, respectively, may be made and, for a first BFD-RS set and a second BFD-RS set that are finally selected and determined as described above, the UE may notify the base station of a beam failure recovery request by using one or two LRRs with which an association relationship has been pre-defined. For example, in [RS set Notification Method 2-2] above, for up to (N+1) BFD-RS sets, when the UE has an association relationship in which the first LRR is associated with the first BFD-RS set to the (N−1) BFD-RS set, and an association relationship in which the second LRR is associated with the N BFD-RS set and the (N+1) BFD-RS set and, when the first BFD-RS set and the Nth BFD-RS set are the two BFD-RS sets finally selected, the UE may associate the first LRR with the first BFD-RS set and associate the second LRR with the Nth BFD-RS set so as to use the same for the beam failure recovery request indication.

LRR Association Method 2-3: Define UE capability reporting by extending the number of LRRs (considering up to (N+1) physical cell IDs)

The UE may report, as UE capability, that the UE is able to use a larger number of LRRs than the existing two LRRs to the base station, depending on the maximum number of physical cell IDs different from the serving cell ID configured with SSB-MTCAdditionalPCI, which is higher layer signaling and, in response thereto, the UE may receive, from the base station, as many LRRs as the number of physical cell IDs different from the serving cell ID via higher layer signaling. In other words, for each of the multiple BFD-RS sets, each corresponding LRR is associated therewith, and for the first BFD-RS set and the second BFD-RS set finally selected and determined as described above, the UE may notify the base station of a beam failure recovery request using the LRRs for which an association relationship with each BFD-RS set is configured.

The UE may receive two different timing advance (TA) values configured within a specific serving cell. TA association methods that may be used in combination with RS set Notification method 2-1 to RS set Notification Method 2-3 and LRR Association Method 2-1] to LRR Association Method 2-3 are described below.

### TA Association Method 2-1: Using TCI State

A UE may associate one TA value with each TCI state, and perform uplink transmission by applying the corresponding TA value to a specific uplink transmission to which the corresponding TCI state is applied.

TA Association Method 2-2: Using coresetPoolIndex or CORESET Group Index

Depending on a CORESET group index or coresetPoolIndex having been associated with respect to a specific uplink transmission, the UE may associate a specific TA value with the CORESET group index or coresetPoolIndex and use the same during the uplink transmission. For example, the UE may perform uplink transmission by applying a TA value, which is associated with the corresponding coresetPoolIndex or the corresponding CORESET group index, to an uplink transmission scheduled or triggered from a first CORESET or a second CORESET configured with a specific coresetPoolIndex or CORESET group index.

### TA Association Method 2-3: Using Physical Cell ID

Depending on whether to use a spatial domain filter or TCI state, which has been associated with a physical cell ID, for a specific uplink transmission, the UE may associate a specific TA value with a physical cell ID and use the same during the uplink transmission. For example, the UE may be configured with SSB-MTCAdditionalPCI, which is higher layer signaling, and may be configured with, in each physical cell ID configuration, additional higher layer signaling for a TA value associated therewith.

In RS set Notification method 2-1 to RS set Notification method 2-3 above, some methods do not select a specific set of RSs (e.g., RS set Notification Method 2-1 has no selection of a BFD-RS set and a candidate beam RS set, and a method in which the BFD RS set and the candidate beam RS set are each fixed to a maximum of 2, and the RSs included in each set are changed may exist). In order to use a generalized representation in the following, although the UE receives a selection from the base station or not, two BFD-RS sets and two candidate beam RS sets corresponding thereto, which will be used in the per-TRP beam failure recovery operation in a multi-TRP environment, may be named “BFD-RS set #1”, “BFD-RS set #2”, “candidate beam RS set #1”, and “candidate beam RS set #2”, respectively. For example, when RS set Notification Method 2-2 is used as described above, the UE may receive a selection of two of the (N+1) BFD-RS sets (e.g., the first BFD-RS set and the fourth BFD-RS set) and two of the maximum (N+1) candidate beam RS sets (e.g., the first candidate beam RS set and the fourth candidate beam RS set) from the base station, and use the same to perform the beam failure recovery operation for each TRP. Accordingly, the first BFD-RS set and the fourth BFD-RS set may be named BFD-RS set #1 and BFD-RS set #2, respectively, and the first candidate beam RS set and the fourth candidate beam RS set may be named candidate beam RS set #1 and candidate beam RS set #2, respectively.

When the first BFD-RS set, the second BFD-RS set, or both two BFD-RS sets are identified as in a beam failure situation as described above, the UE may transmit the LRR to the base station, and the base station may transmit a (1-1)th PDCCH corresponding thereto to the UE so as to indicate second PUSCH scheduling information. The corresponding second PUSCH may include an enhanced BFR MAC-CE or a truncated enhanced BFR MAC-CE. The enhanced BFR MAC-CE or truncated enhanced BFR MAC-CE may include at least one of the following pieces of information:
Cell index(es) corresponding to a single BFD-RS set having a link quality lower than a reference value.
Whether a selected candidate beam RS exists in each single candidate beam RS set within the cell index(es) corresponding to the single BFD-RS set, and if existing, the index of the candidate beam RS.
Cell index(es) in which at least one of the first and second BFD-RS sets has a link quality lower than the reference value.
   Index(es) of the BFD-RS set, which has a link quality lower than the reference value, among the first and second BFD-RS sets. As an example, the BFD-RS set index(es) may be included in enhanced BFR MAC-CE or truncated enhanced BFR MAC-CE together with the cell index(es). As an example, the BFD set index(es) may correspond to lower layer information of the cell index(es).
In each of the first and second sets of candidate beam RSs within the cell index(es) corresponding to the first and second BFD-RS sets, whether the selected candidate beam RS exists, and if existing, the index of the candidate beam RS for each set.

For the serving cell(s), which are associated with the first BFD-RS set and the first candidate beam RS set associated therewith, and with the second BFD-RS set and the second candidate beam RS set associated therewith, after 28 symbols from a last symbol of a (2-1)th PDCCH reception including the same HARQ process ID field and toggled NDI field value as those of a (1-1)th PDCCH that has scheduled the second PUSCH, the UE may perform a combination of at least one of the following operations:
When monitoring the first CORESET, the UE may perform PDCCH reception using a combination of at least one of the following:
   When some of the first CORESET are included in the first CORESET only, i.e., not included in the second CORESET, the UE may follow QCL parameter assumptions of a candidate beam RS selected from the first set of candidate beam RS during monitoring the first CORESET.
   When the beam failure occurs only for a first BFD-RS set, i.e., the beam failure does not occur for a second BFD-RS set, and some of the CORESETs of the first CORESET are also included in the second CORESET, i.e., when the UE uses both the first unified TCI state and the second unified TCI state among multiple unified TCI states indicated when receiving the PDCCH within the corresponding some CORESETs, the UE may perform PDCCH reception within the correspond some CORESETs using both the QCL parameters of the candidate beam RS selected from the first set of candidate beam RSs and the previously indicated second unified TCI state.
   When a beam failure occurs for both the first BFD-RS set and the second BFD-RS set, and some of the CORESETs in the first CORESET are also included in the second CORESET, i.e., when the UE may use both the first unified TCI state and the second unified TCI state among the multiple unified TCI states indicated when receiving PDCCHs within the corresponding CORESETs, the UE may use both the QCL parameters of the candidate beam RS selected within the first set of candidate beam RS and the QCL parameters of the candidate beam RS selected within the second set of candidate beam RS to perform PDCCH reception within the corresponding some CORESETs.
The UE may assume that the reception of a scheduled PDSCH from all of the first CORESETs has the same QCL parameter as that of the reception of a candidate beam RS selected from the first candidate beam RS set.
The UE may assume that the reception of an aperiodic CSI-RS resource under a specific condition has the same QCL parameter as that of the reception of the candidate beam RS selected from the first candidate beam RS set. In this case, the aperiodic CSI-RS resource of the specific condition may be a combination of at least one of the following:
   The aperiodic CSI-RS resource may refer to a case in which a specific CORESET group index or coresetPoolIndex (e.g., CORESET group 0 or coresetPoolIndex 0) is configured within the aperiodic CSI-RS resource or a CSI-RS resource set including the aperiodic CSI-RS resource. The case in which a specific CORESET group index or coresetPoolIndex (e.g., CORESET group 0 or coresetPoolIndex 0) for a specific aperiodic CSI-RS resource or a specific CSI-RS resource set has been configured for the UE may signify that the UE may receive the corresponding aperiodic CSI-RS resource or aperiodic CSI-RS resources within the corresponding CSI-RS resource set by using a specific unified TCI state (e.g., a first unified TCI state) corresponding to a specific CORESET group index or coresetPoolIndex (e.g., CORESET group 0 or coresetPoolIndex 0) among the multiple indicated unified TCI states.
   The aperiodic CSI-RS resource may refer to a case in which specific higher layer signaling has been configured within the aperiodic CSI-RS resource or within a CSI-RS resource set including the aperiodic CSI-RS resource, and in which the specific higher layer signaling is associated with a CORESET group or coresetPoolIndex. The case in which specific higher layer signaling for a specific aperiodic CSI-RS resource or a specific CSI-RS resource set has been configured for the UE and the configured higher layer signaling has been associated with a specific CORESET group index or coresetPoolIndex (e.g., CORESET group 0 or coresetPoolIndex 0) may signify that the UE may receive the corresponding aperiodic CSI-RS resource or aperiodic CSI-RS resources within the corresponding CSI-RS resource set by using a specific unified TCI state (e.g., a first unified TCI state) corresponding to a specific CORESET group index or coresetPoolIndex (e.g., CORESET group 0 or coresetPoolIndex 0) among the multiple indicated unified TCI states.
   The aperiodic CSI-RS resource may refer to a case in which specific higher layer signaling has been configured within the aperiodic CSI-RS resource or within a CSI-RS resource set including the aperiodic CSI-RS resource, and refer to information about a unified TCI state (e.g., a first unified TCI state), which is used to receive the specific higher layer signaling, among the multiple indicated unified TCI states. The case in which specific higher layer signaling for a specific aperiodic CSI-RS resource or a specific CSI-RS resource set has been configured for the UE and the configured higher layer signaling has been received using a specific TCI state (e.g., a first unified TCI state) among the multiple indicated unified TCI states may signify that the UE may receive the corresponding aperiodic CSI-RS resource or aperiodic CSI-RS resources within the corresponding CSI-RS resource set by using a specific unified TCI state (e.g., a first unified TCI state) among the multiple indicated unified TCI states.
   The aperiodic CSI-RS resource may signify that, when DCI triggering the CSI-RS resource set including the aperiodic CSI-RS resource is transmitted from a specific CORESET (e.g., a first CORESET), the aperiodic CSI-RS resources included within the corresponding CSI-RS resource set may be received by the UE using a specific TCI state (e.g., a first unified TCI state) corresponding to the corresponding CORESET.
The UE may use a spatial domain filter used to receive a candidate beam RS selected from the first candidate beam RS set during transmission of the scheduled PUSCH in all of the first CORESETs.
The UE may use a spatial domain filter used to receive a candidate beam RS selected from the first candidate beam RS set during transmission of a PUCCH of a specific condition. In this case, the PUCCH of the specific condition may be a combination of at least one of the following:
   The PUCCH may refer to a case in which a specific CORESET group index or coresetPoolIndex (e.g., CORESET group 0 or coresetPoolIndex 0) is configured in the corresponding PUCCH resource. The case in which a specific CORESET group index or coresetPoolIndex (e.g., CORESET group 0 or coresetPoolIndex 0) for a specific PUCCH resource has been configured for the UE may signify that the PUCCH resource may be transmitted by the UE using a specific unified TCI state (e.g., a first unified TCI state) corresponding to a specific CORESET group index or coresetPoolIndex (e.g., CORESET group 0 or coresetPoolIndex 0) among the multiple indicated unified TCI states.
   The PUCCH may refer to a case in which specific higher layer signaling has been configured within the PUCCH resource, and the specific higher layer signaling is associated with a CORESET group or coresetPoolIndex. The case in which specific higher layer signaling for a specific PUCCH resource has been configured for the UE and the configured higher layer signaling has been associated with a specific CORESET group index or coresetPoolIndex (e.g., CORESET group 0 or coresetPoolIndex 0) may signify that the PUCCH resource may be transmitted by the UE using a specific unified TCI state (e.g., a first unified TCI state) corresponding to a specific CORESET group index or coresetPoolIndex (e.g., CORESET group 0 or coresetPoolIndex 0) among the multiple indicated unified TCI states.
   The PUCCH resource may refer to a case in which specific higher layer signaling has been configured within the corresponding PUCCH resource, and refer to information about a unified TCI state (e.g., a first unified TCI state), which is used to transmit the specific higher layer signaling, among the multiple indicated unified TCI states. The case in which specific higher layer signaling for a specific PUCCH resource has been configured for the UE and the configured higher layer signaling has been transmitted using a specific TCI state (e.g., a first unified TCI state) among the multiple indicated unified TCI states may signify that the UE may transmit the corresponding PUCCH resource by using a specific unified TCI state (e.g., a first unified TCI state) among the multiple indicated unified TCI states.
   The PUCCH may signify that, when DCI triggering the PUCCH resource is transmitted from a specific CORESET (e.g., a CORESET in CORESET group 0, or a CORESET configured with coresetPoolIndex of 0, or the first CORESET), the PUCCH resource may be transmitted by the UE using a specific TCI state (e.g., a first unified TCI state) corresponding to the corresponding CORESET.
The UE may use the spatial domain filter used to receive a candidate beam RS selected from the first candidate beam RS set during transmission of an SRS of a specific condition. In this case, the SRS of the specific condition may be a combination of at least one of the following:
   The SRS may refer to a case in which a specific CORESET group index or coresetPoolIndex (e.g., CORESET group 0 or coresetPoolIndex 0) is configured within the SRS resource or a SRS resource set including the SRS resource. The case in which a specific CORESET group index or coresetPoolIndex (e.g., CORESET group 0 or coresetPoolIndex 0) for a specific SRS resource or a specific SRS resource set including the corresponding SRS resource has been configured for the UE may signify that the UE may transmit the corresponding SRS resource or SRS resources within the SRS resource set including the corresponding SRS resource by using a specific unified TCI state (e.g., a first unified TCI state) corresponding to a specific CORESET group index or coresetPoolIndex (e.g., CORESET group 0 or coresetPoolIndex 0) among the multiple indicated unified TCI states.
   The SRS may refer to a case in which specific higher layer signaling has been configured within the SRS resource, or within an SRS resource set including the SRS resource, and in which the specific higher layer signaling is associated with a CORESET group or coresetPoolIndex. The case in which specific higher layer signaling for a specific SRS resource or a specific SRS resource set including the corresponding SRS resource has been configured for the UE and the configured higher layer signaling has been associated with a specific CORESET group index or coresetPoolIndex (e.g., CORESET group 0 or coresetPoolIndex 0) may signify that the UE may transmit the corresponding SRS resource or the SRS resources within the SRS resource set including the corresponding SRS resource by using a specific unified TCI state (e.g., a first unified TCI state) corresponding to a specific CORESET group index or coresetPoolIndex (e.g., CORESET group 0 or coresetPoolIndex 0) among the multiple indicated unified TCI states.
   The SRS may refer to a case in which specific higher layer signaling has been configured within the corresponding SRS resource or within an SRS resource set including the corresponding SRS resource, and refer to information about a unified TCI state (e.g., a first unified TCI state), which is used to transmit the specific higher layer signaling, among the multiple indicated unified TCI states. The case in which specific higher layer signaling for a specific SRS resource or a specific SRS resource set including the corresponding SRS resource set has been configured for the UE and the configured higher layer signaling has been transmitted using a specific TCI state (e.g., a first unified TCI state) among the multiple indicated unified TCI states may signify that the UE may transmit the corresponding SRS resource or SRS resources within the SRS resource set including the corresponding SRS resource by using a specific unified TCI state (e.g., a first unified TCI state) among the multiple indicated unified TCI states.
   The SRS may signify that, when DCI triggering the SRS resource set including the SRS resource is transmitted from a specific CORESET (e.g., a CORESET in CORESET group 0, or a CORESET configured with coresetPoolIndex of 0, or the first CORESET), the corresponding SRS resource or the SRS resources included within the corresponding SRS resource set including the corresponding SRS resource may be transmitted by the UE using a specific TCI state (e.g., a first unified TCI state) corresponding to the corresponding CORESET.
When the UE transmits a PUSCH using a spatial domain filter that the UE used to receive a candidate beam RS selected from the first candidate beam RS set, power control parameters for the corresponding PUSCH transmission of the UE may follow a combination of at least one of the following:
   A candidate beam RS selected from the first candidate beam RS set may be used as a pathloss reference signal for the PUSCH transmission, and the UE may measure a downlink pathloss value by using the selected candidate beam RS.
   As a method of determining the power control parameters for the PUSCH transmission, the UE may use p0, alpha, and PUSCH power control adjustment state included in the p0-Alpha-CLID-PUSCH-Set associated with ul-powercontrolId of the lowest value in Uplink-powerControl, which is higher layer signaling, in the corresponding PCell, PSCell, SCell, or serving cell. In other words, the p0, alpha, and PUSCH power control adjustment state included in the p0-Alpha-CLID-PUSCH-Set associated with the ul-powercontrolId of the lowest value in the Uplink-powerControl, which is higher layer signaling, in the corresponding PCell, PSCell, SCell, or serving cell may be determined as the power control parameter for the PUSCH transmission.
   As another method of determining the power control parameters for PUSCH transmissions, the UE may use the p0, alpha, and PUSCH power control adjustment state included in the p0-Alpha-CLID-PUSCH-Set associated with ul-powercontrolId of the lowest value in Uplink-powerControl configured with a coresetPoolIndex of 0 or a CORESET group index of 0, which is higher layer signaling, in the corresponding PCell, PSCell, SCell, or serving cell, or configured with a specific higher layer signaling configured upon transmission of the PUCCH resource and SRS resource (e.g., the higher layer signaling indicating to transmit using a first unified TCI state among the multiple indicated unified TCI states). In other words, the p0, alpha, and PUSCH power control adjustment state included in the p0-Alpha-CLID-PUSCH-Set associated with ul-powercontrolId of the lowest value in Uplink-powerControl configured with a coresetPoolIndex of 0 or a CORESET group index of 0, which is higher layer signaling, in the corresponding PCell, PSCell, SCell, or serving cell, or configured with a specific higher layer signaling configured upon transmission of the PUCCH resource and SRS resource may be determined as the power control parameter for the PUSCH transmission.
   As yet another method of determining the power control parameters for PUSCH transmissions, the UE may use the p0, alpha, and PUSCH power control adjustment state included in the p0-Alpha-CLID-PUSCH-Set associated with ul-powercontrolId of the lowest value within the first list (e.g., Uplink-powerControl1-r18) among two lists for the unified TCI state-based power control parameters configured by higher layer signaling in the corresponding PCell, PSCell, SCell, or serving cell. In other words, the p0, alpha, and PUSCH power control adjustment state, which are included within the p0-Alpha-CLID-PUSCH-Set associated with ul-powercontrolId of the lowest value within the first list (e.g., Uplink-powerControl1-r18) among two lists for unified TCI state-based power control parameters configured by higher layer signaling in the corresponding PCell, PSCell, SCell, or serving cell, may be determined as the power control parameter for the PUSCH transmission.
When the UE transmits a PUCCH using the spatial domain filter that the UE used to receive a candidate beam RS selected from the first candidate beam RS set, the power control parameters for the corresponding PUCCH transmission of the UE may follow a combination of at least one of the following:
   A candidate beam RS selected from the first candidate beam RS set may be used as a pathloss reference signal for the PUCCH transmission, and the UE may measure a downlink pathloss value by using the selected candidate beam RS.
   As a method of determining the power control parameters for the PUCCH transmission, the UE may use p0, alpha, and PUCCH power control adjustment state included in the p0-Alpha-CLID-PUCCH-Set associated with ul-powercontrolId of the lowest value in Uplink-powerControl, which is higher layer signaling, in the corresponding PCell, PSCell, SCell, or serving cell. In other words, the p0, alpha, and PUCCH power control adjustment state included in the p0-Alpha-CLID-PUSCH-Set associated with the ul-powercontrolId of the lowest value of the Uplink-powerControl, which is higher layer signaling, in the corresponding PCell, PSCell, SCell, or serving cell may be determined as the power control parameter for the PUCCH transmission.
   As another method of determining the power control parameters for PUCCH transmissions, the UE may use the p0, alpha, and PUCCH power control adjustment state included in the p0-Alpha-CLID-PUCCH-Set associated with ul-powercontrolId of the lowest value in Uplink-powerControl configured with a coresetPoolIndex of 0 or a CORESET group index of 0, which is higher layer signaling, in the corresponding PCell, PSCell, SCell, or serving cell, or configured with a specific higher layer signaling configured upon transmission of the PUCCH resource and SRS resource (e.g., the higher layer signaling indicating to transmit using a first unified TCI state among the multiple indicated unified TCI states). In other words, the p0, alpha, and PUCCH power control adjustment state included in the p0-Alpha-CLID-PUCCH-Set associated with ul-powercontrolId of the lowest value in Uplink-powerControl configured with a coresetPoolIndex of 0 or a CORESET group index of 0, which is higher layer signaling, in the corresponding PCell, PSCell, SCell, or serving cell, or configured with a specific higher layer signaling configured upon transmission of the PUCCH resource and SRS resource may be determined as the power control parameter for the PUCCH transmission.
   As yet another method of determining the power control parameters for PUCCH transmissions, the UE may use the p0, alpha, and PUCCH power control adjustment state included in the p0-Alpha-CLID-PUCCH-Set associated with ul-powercontrolId of the lowest value within the first list (e.g., Uplink-powerControl1-r18) among two lists for the unified TCI state-based power control parameters configured by higher layer signaling in the corresponding PCell, PSCell, SCell, or serving cell. In other words, the p0, alpha, and PUCCH power control adjustment state, which are included within the p0-Alpha-CLID-PUCCH-Set associated with ul-powercontrolId of the lowest value within the first list (e.g., Uplink-powerControl1-r18) among two lists for unified TCI state-based power control parameters configured by higher layer signaling in the corresponding PCell, PSCell, SCell, or serving cell, may be determined as the power control parameter for the PUCCH transmission.
When the UE transmits an SRS using a spatial domain filter that has been used when the UE received the candidate beam RS selected from the first candidate beam RS set, the power control parameters for the corresponding SRS transmission of the UE may follow a combination of at least one of the following:
   A candidate beam RS selected from the first candidate beam RS set may be used as a pathloss reference signal for the SRS transmission, and the UE may measure a downlink pathloss value by using the selected candidate beam RS.
   As a method of determining the power control parameters for the SRS transmission, the UE may use p0, alpha, and SRS power control adjustment state included in the p0-Alpha-CLID-SRS-Set associated with ul-powercontrolId of the lowest value in Uplink-powerControl, which is higher layer signaling, in the corresponding PCell, PSCell, SCell, or serving cell. In other words, the p0, alpha, and SRS power control adjustment state included in the p0-Alpha-CLID-SRS-Set associated with the ul-powercontrolId of the lowest value of the Uplink-powerControl, which is higher layer signaling, in the corresponding PCell, PSCell, SCell, or serving cell may be determined as the power control parameter for the SRS transmission.
   As another method of determining the power control parameters for SRS transmissions, the UE may use the p0, alpha, and SRS power control adjustment state included in the p0-Alpha-CLID-SRS-Set associated with ul-powercontrolId of the lowest value in Uplink-powerControl configured with a coresetPoolIndex of 0 or a CORESET group index of 0, which is higher layer signaling, in the corresponding PCell, PSCell, SCell, or serving cell, or configured with a specific higher layer signaling configured upon transmission of the PUCCH resource and SRS resource (e.g., the higher layer signaling indicating to transmit using a first unified TCI state among the multiple indicated unified TCI states). In other words, the p0, alpha, and SRS power control adjustment state included in the p0-Alpha-CLID-SRS-Set associated with ul-powercontrolId of the lowest value in Uplink-powerControl configured with a coresetPoolIndex of 0 or a CORESET group index of 0, which is higher layer signaling, in the corresponding PCell, PSCell, SCell, or serving cell, or configured with a specific higher layer signaling configured upon transmission of the PUCCH resource and SRS resource may be determined as the power control parameter for the SRS transmission.
   As yet another method of determining the power control parameters for SRS transmissions, the UE may use the p0, alpha, and SRS power control adjustment state included in the p0-Alpha-CLID-SRS-Set associated with ul-powercontrolId of the lowest value within the first list (e.g., Uplink-powerControl1-r18) among two lists for the unified TCI state-based power control parameters configured by higher layer signaling in the corresponding PCell, PSCell, SCell, or serving cell. In other words, the p0, alpha, and SRS power control adjustment state, which are included within the p0-Alpha-CLID-SRS-Set associated with ul-powercontrolId of the lowest value within the first list (e.g., Uplink-powerControl1-r18) among two lists for unified TCI state-based power control parameters configured by higher layer signaling in the corresponding PCell, PSCell, SCell, or serving cell, may be determined as the power control parameter for the SRS transmission.
When monitoring the second CORESET, the UE may perform PDCCH reception using a combination of at least one of the following:
   When some of the second CORESET are included in the second CORESET only, i.e., not included in the first CORESET, the UE may follow QCL parameter assumptions of a candidate beam RS selected from the second set of candidate beam RS during monitoring the second CORESET.
   When the beam failure occurs only for a second BFD-RS set, i.e., the beam failure does not occur for a first BFD-RS set, and some of the CORESETs of the second CORESET are also included in the second CORESET, i.e., when the UE uses both the first unified TCI state and the second unified TCI state among multiple unified TCI states indicated when receiving the PDCCH within the corresponding some CORESETs, the UE may perform PDCCH reception within the correspond some CORESETs using both the QCL parameters of the candidate beam RS selected from the second set of candidate beam RSs and the previously indicated first unified TCI state.
   When a beam failure occurs for both the first BFD-RS set and the second BFD-RS set, and some of the CORESETs in the second CORESET are also included in the first CORESET, i.e., when the UE may use both the first unified TCI state and the second unified TCI state among the multiple unified TCI states indicated when receiving PDCCHs within the corresponding CORESETs, the UE may use both the QCL parameters of the candidate beam RS selected within the first set of candidate beam RS and the QCL parameters of the candidate beam RS selected within the first set of candidate beam RS to perform PDCCH reception within the corresponding some CORESETs.
   In this case, since an SSB corresponding to a physical cell ID different from a serving cell ID may not be a direct QCL source for PDCCH DMRS, the UE may, only in case that the candidate beam RS selected from the second candidate beam RS set is a CSI-RS, follow the QCL parameter assumption of the corresponding candidate beam RS during monitoring of the second CORESET. Here, the direct QCL source may refer to a case in which a reference RS, such as SSB or CSI-RS, is a source RS with respect to a specific target RS. In addition, an indirect QCL source may refer to a case in which a specific reference RS is a source RS for a certain RS, and in which the certain RS is a source RS with respect to a specific target RS. In other words, the indirect QCL source may refer to a case in which a specific reference RS is not a direct source RS with respect to a specific target RS, but a specific reference RS is a source RS with respect to a source RS of a specific target RS.
The UE may assume that the reception of a scheduled PDSCH from all of the second CORESETs has the same QCL parameter as that of the reception of a candidate beam RS selected from the second candidate beam RS set.
   In this case, similar to the above, since an SSB corresponding to a physical cell ID different from a serving cell ID is unable to be a direct QCL source for PDSCH DMRS, the UE may, only in case that the candidate beam RS selected from the second candidate beam RS set is a CSI-RS, follow the QCL parameter assumption of the corresponding candidate beam RS during monitoring of all of the second CORESETs.
The UE may assume that the reception of an aperiodic CSI-RS resource under a specific condition has the same QCL parameter as that of the reception of the candidate beam RS selected from the second candidate beam RS set. In this case, the aperiodic CSI-RS resource of the specific condition may be a combination of at least one of the following. On the other hand, since an SSB corresponding to a physical cell ID different from the serving cell ID may be a direct QCL source of the aperiodic CSI-RS, the UE may perform at least one of the following operations in any case in which the candidate beam RS selected from the second candidate beam RS set is an SSB or a CSI-RS:
   The aperiodic CSI-RS resource may refer to a case in which a specific CORESET group index or coresetPoolIndex (e.g., CORESET group 1 or coresetPoolIndex 1) is configured within the aperiodic CSI-RS resource or a CSI-RS resource set including the aperiodic CSI-RS resource. The case in which a specific CORESET group index or coresetPoolIndex (e.g., CORESET group 1 or coresetPoolIndex 1) for a specific aperiodic CSI-RS resource or a specific CSI-RS resource set has been configured for the UE may signify that the UE may receive the corresponding aperiodic CSI-RS resource or aperiodic CSI-RS resources within the corresponding CSI-RS resource set by using a specific unified TCI state (e.g., a second unified TCI state) corresponding to a specific CORESET group index or coresetPoolIndex (e.g., CORESET group 1 or coresetPoolIndex 1) among the multiple indicated unified TCI states.
   The aperiodic CSI-RS resource may refer to a case in which specific higher layer signaling has been configured within the aperiodic CSI-RS resource or within a CSI-RS resource set including the aperiodic CSI-RS resource, and in which the specific higher layer signaling is associated with a CORESET group or coresetPoolIndex. The case in which specific higher layer signaling for a specific aperiodic CSI-RS resource or a specific CSI-RS resource set has been configured for the UE and the configured higher layer signaling has been associated with a specific CORESET group index or coresetPoolIndex (e.g., CORESET group 1 or coresetPoolIndex 1) may signify that the UE may receive the corresponding aperiodic CSI-RS resource or aperiodic CSI-RS resources within the corresponding CSI-RS resource set by using a specific unified TCI state (e.g., a second unified TCI state) corresponding to a specific CORESET group index or coresetPoolIndex (e.g., CORESET group 1 or coresetPoolIndex 1) among the multiple indicated unified TCI states. For example, the specific higher layer signaling may be a physical cell ID that is different from the serving cell ID and corresponding to one entry of the SSB-MTCAdditionalPCIs.
   The aperiodic CSI-RS resource may refer to a case in which specific higher layer signaling has been configured within the aperiodic CSI-RS resource or within a CSI-RS resource set including the aperiodic CSI-RS resource, and refer to information about a unified TCI state (e.g., a second unified TCI state), which is used to receive the specific higher layer signaling, among the multiple indicated unified TCI states. The case in which specific higher layer signaling for a specific aperiodic CSI-RS resource or a specific CSI-RS resource set has been configured for the UE and the configured higher layer signaling has been received using a specific TCI state (e.g., a second unified TCI state) among the multiple indicated unified TCI states may signify that the UE may receive the corresponding aperiodic CSI-RS resource or aperiodic CSI-RS resources within the corresponding CSI-RS resource set by using a specific unified TCI state (e.g., a second unified TCI state) among the multiple indicated unified TCI states.
   The aperiodic CSI-RS resource may signify that, when DCI triggering the CSI-RS resource set including the aperiodic CSI-RS resource is transmitted from a specific CORESET (e.g., a second CORESET), the aperiodic CSI-RS resources included within the corresponding CSI-RS resource set may be received by the UE using a specific TCI state (e.g., a second unified TCI state) corresponding to the corresponding CORESET.
The UE may use a spatial domain filter used to receive a candidate beam RS selected from the second candidate beam RS set during transmission of the scheduled PUSCH in all of the second CORESETs. In this case, since an SSB corresponding to a physical cell ID different from the serving cell ID may be a direct QCL source as a reference RS for QCL-TypeD during PUSCH transmission, the UE may perform the above operation in any case in which the candidate beam RS selected from the second candidate beam RS set is an SSB or a CSI-RS.
The UE may use a spatial domain filter used to receive a candidate beam RS selected from the second candidate beam RS set during transmission of a PUCCH of a specific condition. In this case, the PUCCH of the specific condition may be a combination of at least one of the following. In this case, since an SSB corresponding to a physical cell ID different from the serving cell ID may be a direct QCL source as a reference RS for QCL-TypeD during PUCCH transmission, the UE may perform at least one of the following operations in any case in which the candidate beam RS selected from the second candidate beam RS set is an SSB or a CSI-RS:
   The PUCCH may refer to a case in which a specific CORESET group index or coresetPoolIndex (e.g., CORESET group 1 or coresetPoolIndex 1) is configured in the corresponding PUCCH resource. The case in which a specific CORESET group index or coresetPoolIndex (e.g., CORESET group 1 or coresetPoolIndex 1) for a specific PUCCH resource has been configured for the UE may signify that the PUCCH resource may be transmitted by the UE using a specific unified TCI state (e.g., a second unified TCI state) corresponding to a specific CORESET group index or coresetPoolIndex (e.g., CORESET group 1 or coresetPoolIndex 1) among the multiple indicated unified TCI states.
   The PUCCH may refer to a case in which specific higher layer signaling has been configured within the PUCCH resource, and the specific higher layer signaling is associated with a CORESET group or coresetPoolIndex. The case in which specific higher layer signaling for a specific PUCCH resource has been configured for the UE and the configured higher layer signaling has been associated with a specific CORESET group index or coresetPoolIndex (e.g., CORESET group 0 or coresetPoolIndex 0) may signify that the PUCCH resource may be transmitted by the UE using a specific unified TCI state (e.g., a second unified TCI state) corresponding to a specific CORESET group index or coresetPoolIndex (e.g., CORESET group 1 or coresetPoolIndex 1) among the multiple indicated unified TCI states. For example, the specific higher layer signaling may be a physical cell ID that is different from the serving cell ID and corresponding to one entry of the SSB-MTCAdditionalPCIs.
   The PUCCH resource may refer to a case in which specific higher layer signaling has been configured within the corresponding PUCCH resource, and refer to information about a unified TCI state (e.g., a second unified TCI state), which is used to transmit the specific higher layer signaling, among the multiple indicated unified TCI states. The case in which specific higher layer signaling for a specific PUCCH resource or a specific CSI-RS resource set has been configured for the UE and the configured higher layer signaling has been transmitted using a specific TCI state (e.g., a second unified TCI state) among the multiple indicated unified TCI states may signify that the UE may transmit the corresponding PUCCH resource by using a specific unified TCI state (e.g., a second unified TCI state) among the multiple indicated unified TCI states.
   The PUCCH may signify that, when DCI triggering the PUCCH resource is transmitted from a specific CORESET (e.g., a CORESET in CORESET group 1, or a CORESET configured with coresetPoolIndex of 1, or a second CORESET), the PUCCH resource may be transmitted by the UE using a specific TCI state (e.g., a second unified TCI state) corresponding to the corresponding CORESET.
The UE may use the spatial domain filter used to receive a candidate beam RS selected from the second candidate beam RS set during transmission of an SRS of a specific condition. In this case, the SRS of the specific condition may be a combination of at least one of the following. In this case, since an SSB corresponding to a physical cell ID different from the serving cell ID may be a direct QCL source as a reference RS for QCL-TypeD during SRS transmission, the UE may perform at least one of the following operations in any case in which the candidate beam RS selected from the second candidate beam RS set is an SSB or a CSI-RS:
   The SRS may refer to a case in which a specific CORESET group index or coresetPoolIndex (e.g., CORESET group 1 or coresetPoolIndex 1) is configured within the SRS resource or a SRS resource set including the SRS resource. The case in which a specific CORESET group index or coresetPoolIndex (e.g., CORESET group 1 or coresetPoolIndex 1) for a specific SRS resource or a specific SRS resource set including the corresponding SRS resource has been configured for the UE may signify that the UE may transmit the corresponding SRS resource or SRS resources within the SRS resource set including the corresponding SRS resource by using a specific unified TCI state (e.g., a second unified TCI state) corresponding to a specific CORESET group index or coresetPoolIndex (e.g., CORESET group 1 or coresetPoolIndex 1) among the multiple indicated unified TCI states.
   The SRS may refer to a case in which specific higher layer signaling has been configured within the SRS resource, or within an SRS resource set including the SRS resource, and in which the specific higher layer signaling is associated with a CORESET group or coresetPoolIndex. The case in which specific higher layer signaling for a specific SRS resource or a specific SRS resource set including the corresponding SRS resource has been configured for the UE and the configured higher layer signaling has been associated with a specific CORESET group index or coresetPoolIndex (e.g., CORESET group 1 or coresetPoolIndex 1) may signify that the UE may transmit the corresponding SRS resource or the SRS resources within the SRS resource set including the corresponding SRS resource by using a specific unified TCI state (e.g., a second unified TCI state) corresponding to a specific CORESET group index or coresetPoolIndex (e.g., CORESET group 1 or coresetPoolIndex 1) among the multiple indicated unified TCI states. For example, the specific higher layer signaling may be a physical cell ID that is different from the serving cell ID and corresponding to one entry of the SSB-MTCAdditionalPCIs.
   The SRS may refer to a case in which specific higher layer signaling has been configured within the corresponding SRS resource or within an SRS resource set including the corresponding SRS resource, and refer to information about a unified TCI state (e.g., a second unified TCI state), which is used to transmit the specific higher layer signaling, among the multiple indicated unified TCI states. The case in which specific higher layer signaling for a specific SRS resource or a specific SRS resource set including the corresponding SRS resource set has been configured for the UE and the configured higher layer signaling has been transmitted using a specific TCI state (e.g., a second unified TCI state) among the multiple indicated unified TCI states may signify that the UE may transmit the corresponding SRS resource or SRS resources within the SRS resource set including the corresponding SRS resource by using a specific unified TCI state (e.g., a second unified TCI state) among the multiple indicated unified TCI states.
   The SRS may signify that, when DCI triggering the SRS resource set including the SRS resource is transmitted from a specific CORESET (e.g., a CORESET in CORESET group 1, or a CORESET configured with coresetPoolIndex of 1, or a second CORESET), the corresponding SRS resource or the SRS resources included within the corresponding SRS resource set including the corresponding SRS resource may be transmitted by the UE using a specific TCI state (e.g., a second unified TCI state) corresponding to the corresponding CORESET.
When the UE transmits a PUSCH using a spatial domain filter that the UE used to receive a candidate beam RS selected from the second candidate beam RS set, power control parameters for the corresponding PUSCH transmission of the UE may follow a combination of at least one of the following:
   A candidate beam RS selected from the second candidate beam RS set may be used as a pathloss reference signal for the PUSCH transmission, and the UE may measure a downlink pathloss value by using the selected candidate beam RS.
   As a method of determining the power control parameters for the PUSCH transmission, the UE may use p0, alpha, and PUSCH power control adjustment state included in the p0-Alpha-CLID-PUSCH-Set associated with ul-powercontrolId of the lowest value in Uplink-powerControl, which is higher layer signaling, in the corresponding PCell, PSCell, SCell, or serving cell. In other words, the p0, alpha, and PUSCH power control adjustment state included in the p0-Alpha-CLID-PUSCH-Set associated with the ul-powercontrolId of the lowest value in the Uplink-powerControl, which is higher layer signaling, in the corresponding PCell, PSCell, SCell, or serving cell may be determined as the power control parameter for the PUSCH transmission.
   As another method of determining the power control parameters for PUSCH transmissions, the UE may use the p0, alpha, and PUSCH power control adjustment state included in the p0-Alpha-CLID-PUSCH-Set associated with ul-powercontrolId of the second lowest value in Uplink-powerControl having coresetPoolIndex, which is higher layer signaling, in the corresponding PCell, PSCell, SCell, or serving cell. In other words, the p0, alpha, and PUSCH power control adjustment state included in the p0-Alpha-CLID-PUSCH-Set associated with the ul-powercontrolld of the second lowest value in the Uplink-powerControl, which is higher layer signaling, in the corresponding PCell, PSCell, SCell, or serving cell, may be determined as the power control parameter for the PUSCH transmission.
   As yet another method of determining the power control parameters for PUSCH transmissions, the UE may use the p0, alpha, and PUSCH power control adjustment state included in the p0-Alpha-CLID-PUSCH-Set associated with ul-powercontrolId of the lowest value in Uplink-powerControl configured with a coresetPoolIndex of 1 or a CORESET group index of 1, which is higher layer signaling, in the corresponding PCell, PSCell, SCell, or serving cell, or configured with a specific higher layer signaling configured upon transmission of the PUCCH resource and SRS resource (e.g., the higher layer signaling indicating to transmit using a second unified TCI state among the multiple indicated unified TCI states). In other words, the p0, alpha, and PUSCH power control adjustment state included in the p0-Alpha-CLID-PUSCH-Set associated with ul-powercontrolId of the lowest value in Uplink-powerControl configured with a coresetPoolIndex of 1 or a CORESET group index of 1, which is higher layer signaling, in the corresponding PCell, PSCell, SCell, or serving cell, or configured with a specific higher layer signaling configured upon transmission of the PUCCH resource and SRS resource (e.g., the higher layer signaling indicating to transmit using a second unified TCI state among the multiple indicated unified TCI states) may be determined as the power control parameter for the PUSCH transmission.
   As still another method of determining the power control parameters for PUSCH transmissions, the UE may use the p0, alpha, and PUSCH power control adjustment state included in the p0-Alpha-CLID-PUSCH-Set associated with ul-powercontrolId of the lowest value within the second list (e.g., Uplink-powerControl2-r18) among two lists for the unified TCI state-based power control parameters configured by higher layer signaling in the corresponding PCell, PSCell, SCell, or serving cell. At this time, the first list and the second list may be associated with CORESET group indices 0 and 1, or coresetPoolIndices 0 and 1, or specific higher layer signaling (e.g., higher layer signaling that indicates to transmit using the first or second unified TCI state among the multiple indicated unified TCI states), respectively. In other words, the p0, alpha, and PUSCH power control adjustment state, which are included within the p0-Alpha-CLID-PUSCH-Set associated with ul-powercontrolId of the lowest value within the second list (e.g., Uplink-powerControl2-r18) among two lists for unified TCI state-based power control parameters configured by higher layer signaling in the corresponding PCell, PSCell, SCell, or serving cell, may be determined as the power control parameter for the PUSCH transmission.
   As still further another method of determining the power control parameters for PUSCH transmissions, the UE may use the p0, alpha, and PUSCH power control adjustment state included in the p0-Alpha-CLID-PUSCH-Set associated with ul-powercontrolId of the lowest value within a list associated with the second candidate beam RS set among up to (N+1) lists for the unified TCI state-based power control parameters configured by higher layer signaling in the corresponding PCell, PSCell, SCell, or serving cell. In this case, up to (N+1) lists for power control parameters may each be associated with a serving cell ID and N different physical cell IDs that are different from the serving cell ID. In other words, the p0, alpha, and PUSCH power control adjustment state, which are included within the p0-Alpha-CLID-PUSCH-Set associated with ul-powercontrolId of the lowest value within a list associated with the second candidate beam RS set among up to (N+1) lists for the unified TCI state-based power control parameters configured by higher layer signaling in the corresponding PCell, PSCell, SCell, or serving cell, may be determined as the power control parameter for the PUSCH transmission.
When the UE transmits a PUCCH using a spatial domain filter that the UE used to receive a candidate beam RS selected from the second candidate beam RS set, the power control parameters for the corresponding PUCCH transmission of the UE may follow a combination of at least one of the following:
   A candidate beam RS selected from the second candidate beam RS set may be used as a pathloss reference signal for the PUCCH transmission, and the UE may measure a downlink pathloss value by using the selected candidate beam RS.
   As a method of determining the power control parameters for the PUCCH transmission, the UE may use p0, alpha, and PUCCH power control adjustment state included in the p0-Alpha-CLID-PUCCH-Set associated with ul-powercontrolId of the lowest value in Uplink-powerControl, which is higher layer signaling, in the corresponding PCell, PSCell, SCell, or serving cell. In other words, the p0, alpha, and PUCCH power control adjustment state included in the p0-Alpha-CLID-PUSCH-Set associated with the ul-powercontrolId of the lowest value of the Uplink-powerControl, which is higher layer signaling, in the corresponding PCell, PSCell, SCell, or serving cell may be determined as the power control parameter for the PUCCH transmission.
   As another method of determining the power control parameters for PUCCH transmissions, the UE may use the p0, alpha, and PUCCH power control adjustment state included in the p0-Alpha-CLID-PUCCH-Set associated with ul-powercontrolId of the second lowest value in Uplink-powerControl having coresetPoolIndex, which is higher layer signaling, in the corresponding PCell, PSCell, SCell, or serving cell. In other words, the p0, alpha, and PUCCH power control adjustment state included in the p0-Alpha-CLID-PUCCH-Set associated with the ul-powercontrolId of the second lowest value in the Uplink-powerControl, which is higher layer signaling, in the corresponding PCell, PSCell, SCell, or serving cell, may be determined as the power control parameter for the PUCCH transmission.
   As yet another method of determining the power control parameters for PUCCH transmissions, the UE may use the p0, alpha, and PUCCH power control adjustment state included in the p0-Alpha-CLID-PUCCH-Set associated with ul-powercontrolId of the lowest value in Uplink-powerControl configured with a coresetPoolIndex of 1 or a CORESET group index of 1, which is higher layer signaling, in the corresponding PCell, PSCell, SCell, or serving cell, or configured with a specific higher layer signaling configured upon transmission of the PUCCH resource and SRS resource (e.g., the higher layer signaling indicating to transmit using a second unified TCI state among the multiple indicated unified TCI states). In other words, the p0, alpha, and PUCCH power control adjustment state included in the p0-Alpha-CLID-PUCCH-Set associated with ul-powercontrolId of the lowest value in Uplink-powerControl configured with a coresetPoolIndex of 1 or a CORESET group index of 1, which is higher layer signaling, in the corresponding PCell, PSCell, SCell, or serving cell, or configured with a specific higher layer signaling configured upon transmission of the PUCCH resource and SRS resource (e.g., the higher layer signaling indicating to transmit using a second unified TCI state among the multiple indicated unified TCI states) may be determined as the power control parameter for the PUCCH transmission.
   As still another method of determining the power control parameters for PUCCH transmissions, the UE may use the p0, alpha, and PUCCH power control adjustment state included in the p0-Alpha-CLID-PUCCH-Set associated with ul-powercontrolId of the lowest value within the second list (e.g., Uplink-powerControl2-r18) among two lists for the unified TCI state-based power control parameters configured by higher layer signaling in the corresponding PCell, PSCell, SCell, or serving cell. At this time, the first list and the second list may be associated with CORESET group indices 0 and 1, or coresetPoolIndices 0 and 1, or specific higher layer signaling (e.g., higher layer signaling that indicates to transmit using the first or second unified TCI state among the multiple indicated unified TCI states), respectively. In other words, the p0, alpha, and PUCCH power control adjustment state, which are included within the p0-Alpha-CLID-PUCCH-Set associated with ul-powercontrolId of the lowest value within the second list (e.g., Uplink-powerControl2-r18) among two lists for unified TCI state-based power control parameters configured by higher layer signaling in the corresponding PCell, PSCell, SCell, or serving cell, may be determined as the power control parameter for the PUCCH transmission.
   As still further another method of determining the power control parameters for PUCCH transmissions, the UE may use the p0, alpha, and PUCCH power control adjustment state included in the p0-Alpha-CLID-PUCCH-Set associated with ul-powercontrolId of the lowest value within a list associated with the second candidate beam RS set among up to (N+1) lists for the unified TCI state-based power control parameters configured by higher layer signaling in the corresponding PCell, PSCell, SCell, or serving cell. In this case, up to (N+1) lists for power control parameters may each be associated with a serving cell ID and N different physical cell IDs that are different from the serving cell ID. In other words, the p0, alpha, and PUCCH power control adjustment state, which are included within the p0-Alpha-CLID-PUCCH-Set associated with ul-powercontrolId of the lowest value within a list associated with the second candidate beam RS set among up to (N+1) lists for the unified TCI state-based power control parameters configured by higher layer signaling in the corresponding PCell, PSCell, SCell, or serving cell, may be determined as the power control parameter for the PUCCH transmission.
When the UE transmits an SRS using a spatial domain filter that has been used when the UE received the candidate beam RS selected from the second candidate beam RS set, the power control parameters for the corresponding SRS transmission of the UE may follow a combination of at least one of the following:
   A candidate beam RS selected from the second candidate beam RS set may be used as a pathloss reference signal for the SRS transmission, and the UE may measure a downlink pathloss value by using the selected candidate beam RS.
   As a method of determining the power control parameters for the SRS transmission, the UE may use p0, alpha, and SRS power control adjustment state included in the p0-Alpha-CLID-SRS-Set associated with ul-powercontrolId of the lowest value in Uplink-powerControl, which is higher layer signaling, in the corresponding PCell, PSCell, SCell, or serving cell. In other words, the p0, alpha, and SRS power control adjustment state included in the p0-Alpha-CLID-SRS-Set associated with the ul-powercontrolId of the lowest value of the Uplink-powerControl, which is higher layer signaling, in the corresponding PCell, PSCell, SCell, or serving cell may be determined as the power control parameter for the SRS transmission.
   As another method of determining the power control parameters for SRS transmissions, the UE may use the UE may use the p0, alpha, and SRS power control adjustment state included in the p0-Alpha-CLID-SRS-Set associated with ul-powercontrolId of the second lowest value in Uplink-powerControl having coresetPoolIndex, which is higher layer signaling, in the corresponding PCell, PSCell, SCell, or serving cell. In other words, the p0, alpha, and SRS power control adjustment state included in the p0-Alpha-CLID-SRS-Set associated with the ul-powercontrolId of the second lowest value in the Uplink-powerControl, which is higher layer signaling, in the corresponding PCell, PSCell, SCell, or serving cell, may be determined as the power control parameter for the SRS transmission.
   As yet another method of determining the power control parameters for SRS transmissions, the UE may use the p0, alpha, and SRS power control adjustment state included in the p0-Alpha-CLID-SRS-Set associated with ul-powercontrolId of the lowest value in Uplink-powerControl configured with a coresetPoolIndex of 1 or a CORESET group index of 1, which is higher layer signaling, in the corresponding PCell, PSCell, SCell, or serving cell, or configured with a specific higher layer signaling configured upon transmission of the PUCCH resource and SRS resource (e.g., the higher layer signaling indicating to transmit using a second unified TCI state among the multiple indicated unified TCI states). In other words, the p0, alpha, and SRS power control adjustment state included in the p0-Alpha-CLID-SRS-Set associated with ul-powercontrolId of the lowest value in Uplink-powerControl configured with a coresetPoolIndex of 1 or a CORESET group index of 1, which is higher layer signaling, in the corresponding PCell, PSCell, SCell, or serving cell, or configured with a specific higher layer signaling configured upon transmission of the PUCCH resource and SRS resource (e.g., the higher layer signaling indicating to transmit using a second unified TCI state among the multiple indicated unified TCI states) may be determined as the power control parameter for the SRS transmission.
   As still another method of determining the power control parameters for SRS transmissions, the UE may use the p0, alpha, and SRS power control adjustment state included in the p0-Alpha-CLID-SRS-Set associated with ul-powercontrolId of the lowest value within the second list (e.g., Uplink-powerControl2-r18) among two lists for the unified TCI state-based power control parameters configured by higher layer signaling in the corresponding PCell, PSCell, SCell, or serving cell. At this time, the first list and the second list may be associated with CORESET group indices 0 and 1, or coresetPoolIndices 0 and 1, or specific higher layer signaling (e.g., higher layer signaling that indicates to transmit using the first or second unified TCI state among the multiple indicated unified TCI states), respectively. In other words, the p0, alpha, and SRS power control adjustment state, which are included within the p0-Alpha-CLID-SRS-Set associated with ul-powercontrolId of the lowest value within the second list (e.g., Uplink-powerControl2-r18) among two lists for unified TCI state-based power control parameters configured by higher layer signaling in the corresponding PCell, PSCell, SCell, or serving cell, may be determined as the power control parameter for the SRS transmission.
   As still further another method of determining the power control parameters for SRS transmissions, the UE may use the p0, alpha, and SRS power control adjustment state included in the p0-Alpha-CLID-SRS-Set associated with ul-powercontrolId of the lowest value within a list associated with the second candidate beam RS set among up to (N+1) lists for the unified TCI state-based power control parameters configured by higher layer signaling in the corresponding PCell, PSCell, SCell, or serving cell. In this case, up to (N+1) lists for power control parameters may each be associated with a serving cell ID and N different physical cell IDs that are different from the serving cell ID. In other words, the p0, alpha, and SRS power control adjustment state, which are included within the p0-Alpha-CLID-PUSCH-Set associated with ul-powercontrolId of the lowest value within a list associated with the second candidate beam RS set among up to (N+1) lists for the unified TCI state-based power control parameters configured by higher layer signaling in the corresponding PCell, PSCell, SCell, or serving cell, may be determined as the power control parameter for the SRS transmission.
At this time, the subcarrier spacing for the 28 symbols may be determined as the smallest subcarrier spacing among at least one combination of the followings:
   Subcarrier spacing of activated downlink bandwidth parts in which the (1-1)th PDCCH or (2-1)th PDCCH is received.
   Subcarrier spacings of activated downlink bandwidth parts of all serving cells.
   Subcarrier spacings of activated downlink bandwidth parts of serving cells configured to use a unified TCI state.
   Subcarrier spacings of activated downlink bandwidth parts of serving cells for which SSB-MTCAdditionalPCI, which is higher layer signaling, is not configured.
   Subcarrier spacings of activated downlink bandwidth parts of serving cells included in the second PUSCH and having a beam failure.
   Activated downlink bandwidth parts of serving cells, which are configured to use a unified TCI state, among serving cells included in the second PUSCH and having a beam failure.
   Activated downlink bandwidth parts of serving cells, which are configured to use a unified TCI state and for which SSB-MTCAdditionalPCI that is higher layer signaling is not configured, among serving cells included in the second PUSCH and having a beam failure.

In the intra-cell multi-TRP operation, the “lowest value” is described as, for example, the lowest value of Uplink-powerControl, the lowest value in the first list (e.g., Uplink-powerControl1-r18) among two lists for unified TCI state-based power control parameters, or the lowest value in the second list (e.g., Uplink-powerControl2-r18) among two lists for unified TCI state-based power control parameters, but this is an example, and the disclosure described above is not limited thereto and may be replaced by “the highest value” or generalized to “a specific value.”

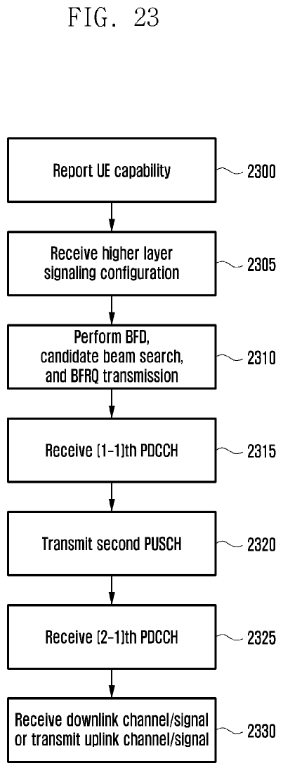

FIG. 23 illustrates a flowchart of the operation of a UE according to an embodiment of the disclosure.

The UE reports a UE capability to a base station (indicated by reference numeral 23-00). The UE capability may correspond to information indicating to the base station that the UE is capable of supporting at least one combination of the various methods mentioned in the above embodiments, for example, information indicating to the base station that the UE supports for a unified TCI state or not, whether BFR operation is possible for each TRP in multi-DCI multi-TRP during intra-cell or inter-cell multi-TRP operation mentioned in the first embodiment above, whether BFR operation is possible for each TRP in a single-DCI multi-TRP during intra-cell or inter-cell multi-TRP operation mentioned in the RS set notification method 1-1 to RS set notification method 1-3, LRR association method 1-1 to LRR association method 1-3, TA association method 1-1 to [TA association method 1-3, or second embodiment above, or information indicating whether the UE supports each of one or more combinations of the RS set notification method 2-1 to RS set notification method 2-3, LRR association method 2-1 to LRR association method 2-3, and TA association method 2-1 to TA association method 2-3 above.

The UE may receive higher layer signaling by the base station based on the reported UE capability information (indicated by reference numeral 23-05). For example, the higher layer signaling may be higher layer signaling related to the unified TCI state, to the TRP-specific BFR operation in a multi-DCI multi-TRP during the intra-cell or inter-cell multi-TRP operation mentioned in the first embodiment above, to the TRP-specific BFR operation in a single-DCI multi-TRP during intra-cell or inter-cell multi-TRP operation mentioned in the RS set notification method 1-1 to RS set notification method 1-3, LRR association method 1-1 to LRR association method 1-3, the TA association method 1-1 to TA association method 1-3, or second embodiment above, or to the RS set notification method 2-1 to RS set notification method 2-3, LRR association method 2-1 to LRR association method 2-3, and TA association method 2-1 to TA association method 2-3 above.

Based on the above higher layer signaling received from the base station, the UE may perform a BFD using the first and second BFD-RS sets and a candidate beam search using the first and second candidate beam RS sets, and may transmit a BFRQ to the base station when a beam failure occurs for at least one of the first and second BFD-RS sets (indicated by reference numeral 23-10).

The UE may receive the (1-1)th PDCCH, as the response of the base station with respect to the BFRQ of the UE (indicated by reference numeral 23-15). Scheduling information for the second PUSCH is included in the (1-1)th PDCCH, and the UE may transmit the second PUSCH to the base station by including the enhanced BFR MAC-CE or truncated enhanced BFR MAC-CE in the second PUSCH (indicated by reference numeral 23-20). The UE may receive the (2-1)th PDCCH from the base station (indicated by reference numeral 23-25), in which the (2-1)th PDCCH may include the same HARQ process ID field and toggled NDI field values as that of the (1-1) PDCCH that scheduled the second PUSCH.

After 28 symbols from the last symbol of receiving the (2-1) PDCCH, the UE may receive downlink channels and signals (e.g., PDCCH, PDSCH, and aperiodic CSI-RS) from the base station and transmit uplink channels and signals (e.g., PUSCH, PUCCH, and SRS) to the base station, based on a combination of at least one of the methods mentioned in the above embodiments (indicated by reference numeral 23-30).

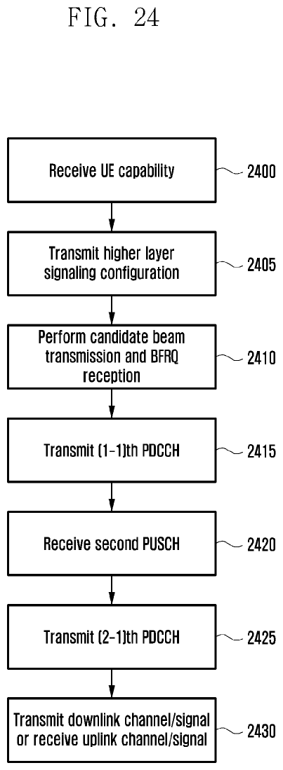

FIG. 24 illustrates a flowchart of the operation of a base station according to an embodiment of the disclosure.

The base station receives a UE capability from a UE (indicated by reference numeral 24-00). The UE capability may correspond to information indicating to the base station that the UE is capable of supporting at least one combination of the various methods mentioned in the above embodiments, for example, information indicating to the base station that the UE supports for a unified TCI state or not, whether BFR operation is possible for each TRP in multi-DCI multi-TRP during intra-cell or inter-cell multi-TRP operation mentioned in the first embodiment above, whether BFR operation is possible for each TRP in a single-DCI multi-TRP during intra-cell or inter-cell multi-TRP operation mentioned in the RS set notification method 1-1 to RS set notification method 1-3, LRR association method 1-1 to LRR association method 1-3, TA association method 1-1 to TA association method 1-3, or second embodiment above, or information indicating whether the UE supports each of one or more combinations of the RS set notification method 2-1 to RS set notification method 2-3, LRR association method 2-1 to LRR association method 2-3, and TA association method 2-1 to TA association method 2-3 above.

The base station may transmit higher layer signaling to the UE based on the received UE capability information (indicated by reference numeral 24-05). For example, the higher layer signaling may be higher layer signaling related to the unified TCI state, to the TRP-specific BFR operation in a multi-DCI multi-TRP during the intra-cell or inter-cell multi-TRP operation mentioned in the first embodiment above, to the TRP-specific BFR operation in a single-DCI multi-TRP during intra-cell or inter-cell multi-TRP operation mentioned in the RS set notification method 1-1 to RS set notification method 1-3, LRR association method 1-1 to LRR association method 1-3, the TA association method 1-1 to TA association method 1-3, or second embodiment above, or to the RS set notification method 2-1 to RS set notification method 2-3, LRR association method 2-1 to LRR association method 2-3, and TA association method 2-1 to TA association method 2-3 above.

Based on the higher layer signaling transmitted to the UE, the base station may transmit candidate beam RSs using the first and second candidate beam RS sets to the UE, and may receive a BFRQ from the UE in the event of a beam failure for at least one of the first and second BFD-RS sets (indicated by reference numeral 24-10).

In response to the BFRQ from the UE, the base station may transmit the above (1-1)th PDCCH (indicated by reference numeral 24-15). The (1-1)th PDCCH includes scheduling information for the second PUSCH, and the base station may receive the second PUSCH from the UE and identify whether the enhanced BFR MAC-CE or truncated enhanced BFR MAC-CE is included in the second PUSCH to determine a beam failure situation of the UE (indicated by reference numeral 24-20). The base station may transmit the (2-1)th PDCCH to the UE (indicated by reference numeral 24-25), in which the (2-1)th PDCCH may include the same HARQ process ID field and toggled NDI field values as that of the (1-1)th PDCCH that scheduled the second PUSCH.

After 28 symbols from the last symbol at the time of reception of the (2-1)th PDCCH by the UE, the base station may transmit downlink channels and signals (e.g., PDCCH, PDSCH, and aperiodic CSI-RS) to the UE and receive uplink channels and signals (e.g., PUSCH, PUCCH, and SRS) from the UE based on a combination of at least one of the methods mentioned in the above embodiments (indicated by reference numeral 24-30).

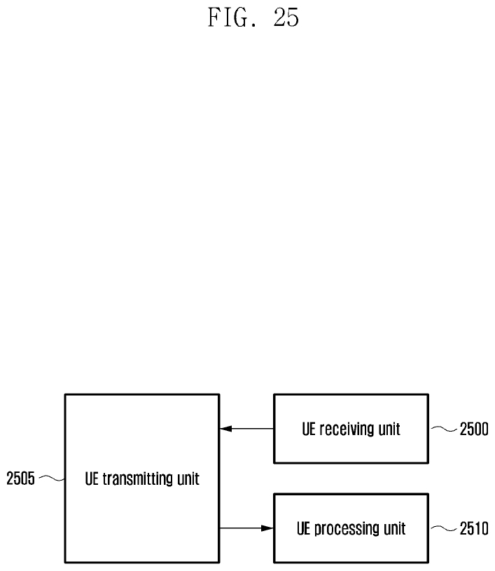

FIG. 25 illustrates a structure of a UE in a wireless communication system according to an embodiment of the disclosure.

Referring to FIG. 25, the UE may include a transceiver, which refers to a UE receiving unit 2500 and a UE transmitting unit 2510 as a whole, a memory (not illustrated), and a UE processing unit 2505 (or UE controller or processor). According to the above-described communication methods of the UE, the UE's transceiver 2500 and 2510, memory, and the UE processing unit 2505 may operate. Components of the UE are not limited to the above-described example. For example, the UE may include a larger or smaller number of components than the above-described components. Furthermore, the transceiver, the memory, and the processor may be implemented as a single chip.

The transceiver may transmit/receive signals with the base station. The signals may include control information and data. To this end, the transceiver may include an RF transmitter configured to up-convert and amplify the frequency of transmitted signals, an RF receiver configured to low-noise-amplify received signals and down-convert the frequency thereof, and the like. This is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for the UE's operations. In addition, the memory may store control information or data included in signals transmitted/received by the UE. The memory may include storage media such as a ROM, a RAM, a hard disk, a CD-ROM, and a DVD, or a combination of storage media. In addition, the UE may include multiple memories.

In addition, the processor may control a series of processes such that the UE can operate according to the above-described embodiments. For example, the processor may control components of the UE so as to receive DCI configured in two layers such that multiple PDSCHs are received simultaneously. The UE may include multiple processors, and the processors may perform the UE's component control operations by executing programs stored in the memory.

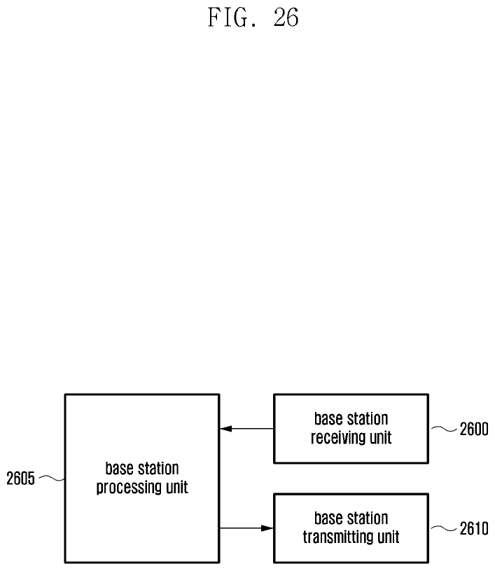

FIG. 26 illustrates a structure of a base station in a wireless communication system according to an embodiment of the disclosure.

Referring to FIG. 26, the base station may include a transceiver, which refers to a base station receiving unit 2600 and a base station transmitting unit 2610 as a whole, a memory (not illustrated), and a base station processing unit 2605 (or base station controller or processor). According to the above-described communication methods of the base station, the base station's transceiver 2600 and 2610, memory, and the base station processing unit 2605 may operate. Components of the base station are not limited to the above-described example. For example, the base station may include a larger or smaller number of components than the above-described components. Furthermore, the transceiver, the memory, and the processor may be implemented as a single chip.

The transceiver may transmit/receive signals with the UE. The signals may include control information and data. To this end, the transceiver may include an RF transmitter configured to up-convert and amplify the frequency of transmitted signals, an RF receiver configured to low-noise-amplify received signals and down-convert the frequency thereof, and the like. This is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for the base station's operations. In addition, the memory may store control information or data included in signals transmitted/received by the base station. The memory may include storage media such as a ROM, a RAM, a hard disk, a CD-ROM, and a DVD, or a combination of storage media. In addition, the base station may include multiple memories.

The processor may control a series of processes such that the base station can operate according to the above-described embodiments of the disclosure. For example, the processor may control components of the base station so as to configure DCI configured in two layers including allocation information regarding multiple PDSCHs and to transmit the same. The base station may include multiple processors, and the processors may perform the base station's component control operations by executing programs stored in the memory.

The methods according to various embodiments described in the claims or the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Further, a plurality of such memories may be included in the electronic device.

In addition, the programs may be stored in an attachable storage device which may access the electronic device through communication networks such as the Internet, Intranet, Local Area Network (LAN), Wide LAN (WLAN), and Storage Area Network (SAN) or a combination thereof. Such a storage device may access the electronic device via an external port. Further, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Furthermore, the above respective embodiments may be employed in combination, as necessary. For example, a part of one embodiment of the disclosure may be combined with a part of another embodiment to operate a base station and a terminal. As an example, a part of embodiment 1 of the disclosure may be combined with a part of embodiment 2 to operate a base station and a terminal. Moreover, although the above embodiments have been described based on the FDD LTE system, other variants based on the technical idea of the embodiments may also be implemented in other systems such as TDD LTE, 5G, and NR systems.

In the drawings in which methods of the disclosure are described, the order of the description does not always correspond to the order in which steps of each method are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

Furthermore, in methods of the disclosure, some or all of the contents of each embodiment may be implemented in combination without departing from the essential spirit and scope of the disclosure.

Various embodiments of the disclosure have been described above. The above description of the disclosure is merely for the purpose of illustration, and embodiments of the disclosure are not limited to the embodiments set forth herein. Those skilled in the art will appreciate that other particular modifications and changes may be easily made without departing from the technical idea or the essential features of the disclosure. The scope of the disclosure should be determined not by the above description but by the appended claims, and all modifications or changes derived from the meaning and scope of the claims and equivalent concepts thereof shall be construed as falling within the scope of the disclosure.

What is claimed is:

1. A method performed by a user equipment (UE) in a communication system, the method comprising:
receiving a first configuration associated with a unified transmission configuration indication (TCI) state and a second configuration associated with beam failure recovery, wherein the second configuration includes a first failure detection set associated with a first reference signal list and a second failure detection set associated with a second reference signal list;
transmitting, based on the second configuration, information on a first reference signal in the first reference signal list and information on a second reference signal in the second reference signal list; and
in case that the UE is configured with a plurality of control resource sets (CORESETs) including a first CORESET and a second CORESET, wherein a CORESET pool index value of 1 is configured for the second CORESET:
receiving, based on a first TCI state corresponding to the first CORESET, a first physical downlink control channel (PDCCH) in the first CORESET and a first physical downlink shared channel (PDSCH) scheduled by the first PDCCH by using a quasi co-location parameter associated with the first reference signal; and
receiving, based on a second TCI state corresponding to the second CORESET, a second PDCCH in the second CORESET and a second PDSCH scheduled by the second PDCCH by using a quasi co-location parameter associated with the second reference signal.

2. The method of claim 1, further comprising:
receiving, based on the first TCI state, a first aperiodic channel state reference signal (CSI-RS) by using the quasi co-location parameter associated with the first reference signal; and
receiving, based on the second TCI state, a second aperiodic CSI-RS by using the quasi co-location parameter associated with the second reference signal.

3. The method of claim 1, further comprising:
transmitting, based on the first TCI state or a first uplink (UL) TCI state, first uplink signals by using a spatial domain filter associated with the first reference signal, wherein the first reference signal is used for obtaining a downlink pathloss estimate to determine transmission power for the first uplink signals; and
transmitting, based on the second TCI state or a second UL TCI state, second uplink signals by using a spatial domain filter associated with the second reference signal, wherein the second reference signal is used for obtaining a downlink pathloss estimate to determine transmission power for the second uplink signals, and
wherein the first uplink signals and the second uplink signals respectively include a physical uplink shared channel (PUSCH), a physical uplink control channel (PUCCH), and a sounding reference signal (SRS).

4. The method of claim 1, further comprising:
in case that the UE is indicated with a third TCI state and a fourth TCI state in a codepoint of downlink control information (DCI):
receiving, based on the third TCI state, first downlink signals by using a quasi co-location parameter associated with the first reference signal; and
receiving, based on the fourth TCI state, second downlink signals by using a quasi co-location parameter associated with the second reference signal.

5. The method of claim 4, further comprising:
transmitting, based on the third TCI state, third uplink signals by using a spatial domain filter associated with the first reference signal, wherein the first reference signal is used for obtaining a downlink pathloss estimate to determine transmission power for the third uplink signals; and
transmitting, based on the fourth TCI state, fourth uplink signals by using a spatial domain filter associated with the second reference signal, wherein the second reference signal is used for obtaining a downlink pathloss estimate to determine transmission power for the fourth uplink signals.

6. The method of claim 1, wherein the CORESET pool index value of 0 is configured for the first CORESET or the CORESET pool index value is not configured for the first CORESET.

7. The method of claim 1, further comprising:
receiving DCI scheduling a first PUSCH on a PDCCH,
wherein the DCI scheduling the first PUSCH includes a toggled new data indicator (NDI) field and a hybrid automatic repeat request (HARQ) process number,
wherein the HARQ process number is the same as a HARQ process number in DCI scheduling a second PUSCH on which the information on the first reference signal and the information on the second reference signal are transmitted, and
wherein the first PDCCH, the first PDSCH, the second PDCCH and the second PDSCH are received after 28 symbols from a last symbol of the PDCCH.

8. A user equipment (UE) in a communication system, the UE comprising:
a transceiver; and
a processor coupled with the transceiver, configured to:
receive a first configuration associated with a unified transmission configuration indication (TCI) state and a second configuration associated with beam failure recovery, wherein the second configuration includes a first failure detection set associated with a first reference signal list and a second failure detection set associated with a second reference signal list;
transmit, based on the second configuration, information on a first reference signal in the first reference signal list and information on a second reference signal in the second reference signal list; and
in case that the UE is configured with a plurality of control resource sets (CORESETs) including a first CORESET and a second CORESET, wherein a CORESET pool index value of 1 is configured for the second CORESET:
receive, based on a first TCI state corresponding to the first CORESET, a first physical downlink control channel (PDCCH) in the first CORESET and a first physical downlink shared channel (PDSCH) scheduled by the first PDCCH by using a quasi co-location parameter associated with the first reference signal; and
receive, based on a second TCI state corresponding to the second CORESET, a second PDCCH in the second CORESET and a second PDSCH scheduled by the second PDCCH by using a quasi co-location parameter associated with the second reference signal.

9. The UE of claim 8, wherein the processor is further configured to:
receive, based on the first TCI state, a first aperiodic channel state reference signal (CSI-RS) by using the quasi co-location parameter associated with the first reference signal; and
receive, based on the second TCI state, a second aperiodic CSI-RS by using the quasi co-location parameter associated with the second reference signal.

10. The UE of claim 8, wherein the processor is further configured to:
transmit, based on the first TCI state or a first uplink (UL) TCI state, first uplink signals by using a spatial domain filter associated with the first reference signal, wherein the first reference signal is used for obtaining a downlink pathloss estimate to determine transmission power for the first uplink signals; and
transmit, based on the second TCI state or a second UL TCI state, second uplink signals by using a spatial domain filter associated with the second reference signal, wherein the second reference signal is used for obtaining a downlink pathloss estimate to determine transmission power for the second uplink signals, and
wherein the first uplink signals and the second uplink signals respectively include a physical uplink shared channel (PUSCH), a physical uplink control channel (PUCCH), and a sounding reference signal (SRS).

11. The UE of claim 8, wherein the processor is further configured to:
in case that the UE is indicated with a third TCI state and a fourth TCI state in a codepoint of downlink control information (DCI):
receive, based on the third TCI state, first downlink signals by using a quasi co-location parameter associated with the first reference signal; and
receive, based on the fourth TCI state, second downlink signals by using a quasi co-location parameter associated with the second reference signal.

12. The UE of claim 11, wherein the processor is further configured to:
transmit, based on the third TCI state, third uplink signals by using a spatial domain filter associated with the first reference signal, wherein the first reference signal is used for obtaining a downlink pathloss estimate to determine transmission power for the third uplink signals; and
transmit, based on the fourth TCI state, fourth uplink signals by using a spatial domain filter associated with the second reference signal, wherein the second reference signal is used for obtaining a downlink pathloss estimate to determine transmission power for the fourth uplink signals.

13. The UE of claim 8, wherein the CORESET pool index value of 0 is configured for the first CORESET or the CORESET pool index value is not configured for the first CORESET.

14. The UE of claim 8, wherein the processor is further configured to:
receive DCI scheduling a first PUSCH on a PDCCH,
wherein the DCI scheduling the first PUSCH includes a toggled new data indicator (NDI) field and a hybrid automatic repeat request (HARQ) process number,
wherein the HARQ process number is the same as a HARQ process number in DCI scheduling a second PUSCH on which the information on the first reference signal and the information on the second reference signal are transmitted, and
wherein the first PDCCH, the first PDSCH, the second PDCCH and the second PDSCH are received after 28 symbols from a last symbol of the PDCCH.

15. A method performed by a base station in a communication system, the method comprising:
transmitting a first configuration associated with a unified transmission configuration indication (TCI) state and a second configuration associated with beam failure recovery, wherein the second configuration includes a first failure detection set associated with a first reference signal list and a second failure detection set associated with a second reference signal list;
receiving information on a first reference signal in the first reference signal list and information on a second reference signal in the second reference signal list; and
in case that a plurality of control resource sets (CORESETs) including a first CORESET and a second CORESET is configured, wherein a CORESET pool index value of 1 is configured for the second CORESET:
transmitting, based on a first TCI state corresponding to the first CORESET, a first physical downlink control channel (PDCCH) in the first CORESET and a first physical downlink shared channel (PDSCH) scheduled by the first PDCCH by using a quasi co-location parameter associated with the first reference signal; and
transmitting, based on a second TCI state corresponding to the second CORESET, a second PDCCH in the second CORESET and a second PDSCH scheduled by the second PDCCH by using a quasi co-location parameter associated with the second reference signal.

16. The method of claim 15, further comprising:
in case that a third TCI state and a fourth TCI state is indicated in a codepoint of downlink control information (DCI):
transmitting, based on the third TCI state, first downlink signals by using a quasi co-location parameter associated with the first reference signal; and
transmitting, based on the fourth TCI state, second downlink signals by using a quasi co-location parameter associated with the second reference signal.

17. The method of claim 15, further comprising:
transmitting DCI scheduling a first PUSCH on a PDCCH,
wherein the DCI scheduling the first PUSCH includes a toggled new data indicator (NDI) field and a hybrid automatic repeat request (HARQ) process number,
wherein the HARQ process number is the same as a HARQ process number in DCI scheduling a second PUSCH on which the information on the first reference signal and the information on the second reference signal are received, and
wherein the first PDCCH, the first PDSCH, the second PDCCH and the second PDSCH are transmitted after 28 symbols from a last symbol of the PDCCH.

18. A base station in a communication system, the base station comprising:
a transceiver; and
a processor coupled with the transceiver, configured to:
transmit a first configuration associated with a unified transmission configuration indication (TCI) state and a second configuration associated with beam failure recovery, wherein the second configuration includes a first failure detection set associated with a first reference signal list and a second failure detection set associated with a second reference signal list;
receive information on a first reference signal in the first reference signal list and information on a second reference signal in the second reference signal list; and
in case that a plurality of control resource sets (CORESETs) including a first CORESET and a second CORESET is configured, wherein a CORESET pool index value of 1 is configured for the second CORESET:
transmit, based on a first TCI state corresponding to the first CORESET, a first physical downlink control channel (PDCCH) in the first CORESET and a first physical downlink shared channel (PDSCH) scheduled by the first PDCCH by using a quasi co-location parameter associated with the first reference signal; and
transmit, based on a second TCI state corresponding to the second CORESET, a second PDCCH in the second CORESET and a second PDSCH scheduled by the second PDCCH by using a quasi co-location parameter associated with the second reference signal.

19. The base station of claim 18, wherein the processor is further configured to:
in case that a third TCI state and a fourth TCI state is indicated in a codepoint of downlink control information (DCI):
transmit, based on the third TCI state, first downlink signals by using a quasi co-location parameter associated with the first reference signal; and
transmit, based on the fourth TCI state, second downlink signals by using a quasi co-location parameter associated with the second reference signal.

20. The base station of claim 18, wherein the processor is further configured to:
transmit DCI scheduling a first PUSCH on a PDCCH,
wherein the DCI scheduling the first PUSCH includes a toggled new data indicator (NDI) field and a hybrid automatic repeat request (HARQ) process number,
wherein the HARQ process number is the same as a HARQ process number in DCI scheduling a second PUSCH on which the information on the first reference signal and the information on the second reference signal are received, and
wherein the first PDCCH, the first PDSCH, the second PDCCH and the second PDSCH are transmitted after 28 symbols from a last symbol of the PDCCH.
